(19) United States
(12) Patent Application Publication
(10) Pub. No.: US 2018/0071986 A1
(43) Pub. Date: Mar. 15, 2018

(54) THREE-DIMENSIONAL PRINTING

(71) Applicant: Velo3D, Inc., Campbell, CA (US)

(72) Inventors: Benyamin BULLER, Cupertino, CA (US); Erel MILSHTEIN, Cupertino, CA (US); Andrei KOROBKOV, Sunnyvale, CA (US)

(21) Appl. No.: 15/808,777

(22) Filed: Nov. 9, 2017

Related U.S. Application Data
(63) Continuation-in-part of application No. 15/490,219, filed on Apr. 18, 2017.
Application No. 15/490,219 is a continuation of application No. 15/339,759, filed on Oct. 31, 2016, now Pat. No. 9,662,840.
Application No. 15/339,759 is a continuation-in-part of application No. PCT/US16/34857, filed on May 27, 2016.
(60) Provisional application No. 62/252,330, filed on Nov. 6, 2015.
(60) Provisional application No. 62/396,584, filed on Sep. 19, 2016.
(60) Provisional application No. 62/169,534, filed on Jun. 1, 2015.
(60) Provisional application No. 62/239,805, filed on Oct. 9, 2015.

(51) Int. Cl. B22F 3/105; B28B 17/00; B28B 1/00; B29K 105/00

(52) U.S. Cl. CPC B29C 64/386; B22F 3/1055; B33Y 30/00; B33Y 50/02; B28B 17/0081; B29K 2105/251; B33Y 10/00; B29C 64/393; B29C 64/20; B22F 2003/1056; B22F 2003/1057; B28B 1/001

(57) ABSTRACT

The present disclosure provides three dimensional (3D) printing processes, apparatuses, software, and systems for the production of a 3D object. These may reduce deformation (e.g., warping or bending) in the printed 3D object, as well as facilitate the formation of nested 3D objects. The reduction of deformation may comprise open loop control and/or deviation form a model of the 3D object to generate the 3D object.

### CROSS-REFERENCE

This application is also a continuation in part of U.S. patent application Ser. No. 15/490,219 filed on Apr. 18, 2017, which is a continuation of U.S. patent application Ser. No. 15/339,759, filed on Oct. 31, 2016 and issued as U.S. Pat. No. 9,662,840 on May 30, 2017, which claims priority to U.S. Provisional Patent Application Ser. No. 62/252,330 filed on Nov. 6, 2015, and U.S. Provisional Patent Application Ser. No. 62/396,584 filed on Sep. 19, 2016; this application is also a continuation in part of PCT Patent Application Serial No. PCT/US16/34857 filed May 27, 2016, which claims priority to U.S. Provisional Patent Application Ser. No. 62/169,534, filed on Jun. 1, 2015, and to U.S. Provisional Patent Application Ser. No. 62/239,805, filed on Oct. 9, 2015; each of which is entirely incorporated herein by reference.

### BACKGROUND

Three-dimensional (3D) printing (or additive manufacturing) is a process for making a three dimensional object of any shape from a design. The design may be in the form of a data source such as an electronic data source, or may be in the form of a hard copy. The hard copy may be a two dimensional representation of a 3D object. The data source may be an electronic 3D model. 3D printing may be accomplished through an additive process in which successive layers of material are laid down one on top of another. This process may be controlled (e.g., computer controlled, manually controlled, or both). A 3D printer can be an industrial robot.

3D printing can generate custom parts. A variety of materials can be used in a 3D printing process including elemental metal, metal alloy, ceramic, elemental carbon, or polymeric material. In some 3D printing processes (e.g., additive manufacturing), a first layer of hardened material is formed (e.g., by welding powder), and thereafter successive layers of hardened material are added one by one, wherein each new layer of hardened material is added on a pre-formed layer of hardened material, until the entire designed three-dimensional structure (3D object) is layer-wise materialized.

3D models may be created with a computer aided design package, via 3D scanner, or manually. The manual modeling process of preparing geometric data for 3D computer graphics may be similar to plastic arts, such as sculpting or animating. 3D scanning is a process of analyzing and collecting digital data on the shape and appearance of a real object (e.g., real-life object). Based on this data, 3D models of the scanned object can be produced.

A number of 3D printing processes are currently available. They may differ in the manner layers are deposited to create the materialized 3D structure (e.g., hardened 3D structure). They may vary in the material or materials that are used to materialize the designed 3D object. Some methods melt, sinter, or soften material to produce the layers that form the 3D object. Examples for 3D printing methods include selective laser melting (SLM), selective laser sintering (SLS), direct metal laser sintering (DMLS) or fused deposition modeling (FDM). Other methods cure liquid materials using different technologies such as stereo lithography (SLA). In the method of laminated object manufacturing (LOM), thin layers (made inter alia of paper, polymer, or metal) are cut to shape and joined together.

At times, the printed 3D object may bend (e.g., warp, roll, curl), or otherwise deform during and/or after the 3D printing process. Auxiliary support (e.g., anchors) may be inserted to circumvent such bending, warping, rolling, curling, or other deformation. The auxiliary support may be removed from the printed 3D object to produce a desired (or predetermined) 3D product (e.g., 3D object). Some 3D printing methods require the use of auxiliary support to maintain the desired shape of the 3D printed 3D object during and/or subsequent to the printing process. The auxiliary support structure (also “auxiliary support” herein) is prevalent, for example, in non-polymeric 3D printing (e.g., using metal and/or metal alloy). The auxiliary support structure is typically removed subsequent to the 3D printing process. The presence of auxiliary support may hinder the generation of nested objects, hanging structures and/or various types of adjacent surfaces when they are difficult or impossible to remove (e.g., in a post processing procedure). The presence of auxiliary support may hinder design and/or materialization of a desired 3D object.

### SUMMARY

The present disclosure delineates methods, systems, apparatuses, and software that allow control of deformation in the printed 3D object (e.g., during their printing). The deformation may comprise, for example, bending deformation. The control may comprise open loop control and/or closed loop control.

In some embodiments, the present disclosure delineates modeling of 3D objects with reduced amount constraints (e.g., no design constraints). The present disclosure delineates methods, systems, apparatuses, and software that allow materialization of these 3D object models having a reduced amount of design constraints. The present invention may allow an extended degree of freedom in designing and materialization of 3D objects. For example, the present invention may allow actual materialization in the real world of (e.g., substantially) freely designed 3D object.

In some embodiments, the 3D objects are arranged in a nested arrangement. For example, one (e.g., internal) 3D object is enclosed within another (e.g., external) 3D object. The enclosed 3D object may be an internal and/or nested 3D object. The enclosed 3D object may not connect to the external 3D object. The enclosed 3D object may freely float anchorlessly within the external 3D object. In some embodiments, the 3D objects comprise adjacent surface that are separated by a gap and wherein the gap is devoid of auxiliary support. The 3D object may be floating anchorlessly in the material bed.

In an aspect, a method for generating a three-dimensional (3D) object comprises: (a) depositing a layer of pre-transformed material to form a material bed; (b) providing a first energy beam to a first portion of the layer of pre-transformed material at a first location to transform the pre-transformed material at the first portion to a first tile of transformed material; (c) moving the first energy beam to a second location at the layer of pre-transformed material; and (d) providing the first energy beam to a second portion of the layer of pre-transformed material at the second location to transform the pre-transformed material at the second portion to a second tile of transformed material; wherein the first tile and second tile harden form at least a portion of the 3D object, wherein the first energy beam has an exposure time of at least about 1 microsecond to form the first tile and the second tile separately, wherein the pre-transformed material comprises a particulate material selected from the group consisting of elemental metal, metal alloy, ceramic, and an allotrope of elemental carbon, and wherein the 3D object is suspended anchorlessly in the material bed.

The first tile and second tile may be material stamps. The first tile and second tile may overlap. The first tile and second tile may contact each other. The first tile and second tile may be sequential. The method may further comprising providing a second energy beam to a third portion of the layer of pre-transformed material at a second location to transform the pre-transformed material at the third location to form a transformed material that forms a portion of the 3D object. The first energy beam and second energy beam travel in different paths. During the formation of the 3D object the second energy beam may differ from the first energy beam in at least one of the cross section, travel speed, power per unit area, and focus. During the formation of the 3D object the second energy beam may have at least one of the following characteristics: (i) the second energy beam has a smaller cross section than the first energy beam, (ii) the second energy beam travels at a speed that is faster than the first energy beam, and (iii) the second energy beam has a power per unit area that is higher than the first energy beam. Moving may be at a speed of at most about 500 millimeters per second. Moving may be at a speed of at most about 200 millimeters per second. Moving may be at a speed of at most about 100 millimeters per second. Moving may be at a speed of at most about 50 millimeters per second. Moving may be at a speed of at most about 30 millimeters per second. The first energy beam may have a power density that is lower by at least two times than the second energy beam. The first energy beam may have a power density that is lower by at least five times than the second energy beam. The first energy beam may have a power density that is lower by at least ten times than the second energy beam. The first energy beam may have a power density that is lower by at least 15 times than the second energy beam. The first energy beam may have an exposure time of at least about 1 microsecond to form the first tile and the second tile. The tile may have a fundamental length scale of at least about 200 micrometers. The tile may have a fundamental length scale of at least about 300 micrometers. The tile may have a fundamental length scale of at least about 400 micrometers.

In another aspect, an apparatus for generating a 3D object comprises a controller that is programmed to direct a first energy beam to: (a) irradiate a first portion of a layer of pre-transformed material at a first location to transform the pre-transformed material at the first portion to a first tile of transformed material; (b) translate to a second location at the layer of pre-transformed material; and (c) irradiate a second portion of a layer of pre-transformed material at the second location to transform the pre-transformed material of the second portion to form a second tile of transformed material; wherein the first tile and second tile harden to form at least a portion of the 3D object, wherein the first energy beam has an exposure time of at least about 1 microsecond to form the first tile and the second tile separately, wherein the pre-transformed material comprises a particulate material selected from the group consisting of elemental metal, metal alloy, ceramic, and an allotrope of elemental carbon, wherein the 3D object is suspended anchorlessly in the material bed, and wherein the controller is operatively coupled to the layer of pre-transformed material and to the first energy beam.

In another aspect, a system for generating a 3D object comprises: (a) a layer of pre-transformed material, which pre-transformed material comprises a particulate material selected from the group consisting of elemental metal, metal alloy, ceramic, and an allotrope of elemental carbon; (b) an energy source generating an energy beam that transformed the pre-transformed material into a transformed material; and (c) a controller operatively coupled to the layer of pre-transformed material, energy source, and energy beam, and is programmed to direct the energy beam to: (i) irradiate a first portion of a layer of pre-transformed material at a first location to transform the pre-transformed material at the first portion to a first tile of transformed material; (ii) translate to a second location at the layer of pre-transformed material; and (iii) irradiate a second portion of a layer of pre-transformed material at the second location to transform the pre-transformed material of the second portion to form a second tile of transformed material, wherein the first tile and second tile harden to form at least a portion of the 3D object, and wherein the first energy beam has an exposure time of at least about 1 microsecond to form the first tile and the second tile separately.

In another aspect, a computer software product for generating a 3D object, which computer software product comprises a non-transitory computer-readable medium in which program instructions are stored, which instructions, when read by a computer, cause the computer to perform operations comprising compiling printing instructions that direct (a) a first energy beam to irradiate a first portion of a layer of pre-transformed material at a first location to transform the pre-transformed material at the first portion to a first tile of transformed material; (b) translation of the first energy beam to a second location at the layer of pre-transformed material; and (c) the first energy beam to irradiate a second portion of a layer of pre-transformed material at the second location to transform the pre-transformed material of the second portion to form a second tile of transformed material, wherein the first tile and second tile harden to form at least a portion of the 3D object, wherein the first energy beam has an exposure time of at least about 1 microsecond to form the first tile and the second tile separately, wherein the pre-transformed material comprises a particulate material selected from the group consisting of elemental metal, metal alloy, ceramic, and an allotrope of elemental carbon, and wherein the 3D object is suspended anchorlessly in the material bed.

In another aspect, a method for generating a 3D object comprises: revising a morphology of a first (e.g., desired) model slice to form a second (e.g., revised) model slice, which first model slice is of a model 3D object, which revising is to correct a projected bending deformation during formation of the 3D object in a 3D printing process in accordance with the model 3D object; generating (e.g., compiling) a printing instruction(s) in accordance the second model slice, wherein the printing instruction(s) is for formation of the 3D object in the 3D printing process; and performing the 3D printing process to transform at least a portion of a material bed to form a transformed material according to the printing instruction(s) to generate the 3D object, which 3D object is substantially identical to the model 3D object, and which 3D object is formed of one or more materials selected from the group consisting of an elemental metal, metal alloy, ceramic, and an allotrope of elemental carbon. The bending deformation may comprise warping, arching, curving, or twisting. Revising may use data comprising (i) anticipated stress built in the 3D object, (ii) anticipated deformation of the 3D object, and/or (iii) temperature depletion, during the 3D printing process. The morphology can comprise a length of the slice circumference, shape of the slice circumference, volume of the slice, or surface of the slice. The material bed may comprise a particulate material selected from the group consisting of elemental metal, metal alloy, ceramic, and an allotrope of elemental carbon. Transform may comprise melting. The melting can be complete melting. The 3D printing process may comprise selective laser melting. The transformed material may harden into a hardened material as part of the 3D object. The revising may take into account a manner in which the transformed material hardens as a function of a density of a particulate material within the material bed. The 3D object can be suspended anchorlessly in the material bed during the 3D printing process. Substantially may comprise a deviation. The deviation can be from the model 3D object by at most about the sum of 100 micrometers and 1/1000 of a fundamental length scale of the model 3D object. The deviation can be from the model 3D object by at most about the sum of 25 micrometers and 1/2500 of a fundamental length scale of the model 3D object.

In another aspect, an apparatus for generating a 3D object comprises a controller that is programmed to direct (a) a first processor to revise of a morphology of a first (e.g., desired) model slice to a second (e.g., revised) model slice to correct projected bending deformation during a 3D printing process, which first model slice is of a model 3D object, which revise is to correct a projected bending deformation during a 3D printing process; (b) a second processor to generate (e.g., compile) a printing instruction(s) that comprises the second model slice, wherein the printing instruction(s) is for the formation of the 3D object in the 3D printing process; and (c) a first energy beam to transform at least a portion of a material bed to form a transformed material according to the printing instruction(s) to generate the 3D object, which 3D object is substantially identical to the model 3D object, which 3D object is formed of one or more materials selected from the group consisting of an elemental metal, metal alloy, ceramic, and an allotrope of elemental carbon, wherein the controller is operatively coupled to the first processor, second processor, and energy beam. The first processor and the second processor can be the same processor. The first processor and the second processor can be different. The apparatus may further comprise a second energy beam that transforms a pre-transformed material to a transformed material. The controller can be operatively coupled to the second energy beam, and direct the second energy beam to transform of at least a portion of a material bed to form a transformed material according to the printing instruction(s) to generate the 3D object in the 3D printing process. The morphology can comprise a length of the slice circumference, shape of the slice circumference, volume of the slice, or surface of the slice

In another aspect, a system for generating a 3D object comprises: (a) a material bed comprising a particulate material selected from the group consisting of elemental metal, metal alloy, ceramic, and an allotrope of elemental carbon; (b) a first energy source generating a first energy beam that transforms a pre-transformed material to a transformed material; (c) a first processor; (d) a second processor; and (e) a controller that is operatively coupled to the material bed, energy source, energy beam, first processor, and second processor, and is programmed to direct (i) the first processor to revise of a morphology of a first (e.g., desired) model slice to a second (e.g., revised) model slice to correct a projected bending deformation during a 3D printing process, which first model slice is of a model 3D object, which revise is to correct a projected bending deformation during a 3D printing process; (ii) the second processor to generate (e.g., compile) a printing instruction(s) that comprise the second model slice, wherein the printing instruction is for the 3D printing process; and (iii) the energy beam to transform of at least a portion of a material bed to form a transformed material according to the printing instruction(s) to generate the 3D object in the 3D printing process, which 3D object is substantially identical to the model 3D object, and which 3D object is formed of one or more materials selected from the group consisting of an elemental metal, metal alloy, ceramic, and an allotrope of elemental carbon. The first processor and the second processor can be the same processor. The first processor and the second processor can be different. The system may further comprise a second energy beam that transforms a pre-transformed material to a transformed material. The controller can be operatively coupled to the second energy beam, and direct the second energy beam to transform of at least a portion of a material bed to form a transformed material according to the printing instruction to generate the 3D object. The second energy beam can be generated by the first energy source. The second energy beam can be generated by a second energy source that is different from the first energy source. The morphology can comprise a length of the slice circumference, shape of the slice circumference, volume of the slice, or surface of the slice

In another aspect, a computer software product for generating a 3D object, which computer software product comprises a non-transitory computer-readable medium in which program instructions are stored, which instructions, when read by a computer, cause the computer to perform operations comprising: (a) revising a morphology of a first (e.g., desired) model slice to form a second (e.g., revised) model slice, which first slice is of a model 3D object, which revising is to correct a projected bending deformation during a 3D printing process; and (b) generating (e.g., compiling) a printing instruction(s) using the second model slice, wherein the printing instruction(s) comprises instruction(s) to transform at least a portion of a material bed to form a transformed material to generate the 3D object in the 3D printing process, which 3D object is substantially identical to the model 3D object, and which 3D object is formed of one or more materials selected from the group consisting of elemental metal, metal alloy, ceramic, and an allotrope of elemental carbon. The morphology may comprise a length of the slice circumference, shape of the slice circumference, volume of the slice, or surface of the slice.

In another aspect, a method for generating a 3D object comprises: revising a morphology of a first (e.g., desired) model slice to form a second (e.g., revised) model slice, which first model slice is of a model 3D object; generating (e.g., compiling) a printing instruction(s) that comprises the second model slice; and transforming at least a portion of a material bed to form a transformed material with an open loop control and according to the printing instruction(s) to form the 3D object in the 3D printing process, which 3D object is substantially identical to the model 3D object, which 3D object is formed of one or more materials selected from the group consisting of an elemental metal, metal alloy, ceramic, and an allotrope of elemental carbon. Transforming may further be performed with a closed loop control. The closed loop control comprises feedback or feed-forward control. The open loop control can comprise empirical data. The empirical data can be of at least one characteristic structure that is comprised in the model 3D object. The open loop control can comprise a theoretical model. The theoretical model can comprise heat flow. The printing instruction(s) may exclude an iterative 3D printing process based on the printed 3D object or on a portion thereof. The iterative process can comprise the formed 3D object by the 3D printing process. The material bed can comprise a particulate material selected from the group consisting of elemental metal, metal alloy, ceramic, and an allotrope of elemental carbon. The transforming can comprise melting. The melting may be complete melting. The 3D printing process can comprise selective laser melting. The 3D object can be suspended anchorlessly in the material bed during the 3D printing process. Substantially can comprise a deviation. The deviation can be from the model 3D object by at most about the sum of 100 micrometers and 1/1000 of a fundamental length scale of the model 3D object. The deviation can be from the model 3D object by at most about the sum of 25 micrometers and 1/2500 of a fundamental length scale of the model 3D object. The morphology can comprise a length of the slice circumference, shape of the slice circumference, volume of the slice, or surface of the slice.

In another aspect, an apparatus for generating a 3D object comprises a controller that is controlled by open loop control and is programmed to direct (a) a first processor to revise of a morphology of a first (e.g., desired) model slice to a second (e.g., revised) model slice, which first model slice is of a model 3D object; (b) a second processor to generate (e.g., compile) a printing instruction(s) that comprises the revised model slice, wherein the printing instruction(s) is for the 3D printing process; and (c) a first energy beam to transform at least a portion of a material bed to form a transformed material according to the printing instruction(s) and generate the 3D object in the 3D printing process, which 3D object is substantially identical to the model 3D object, wherein the 3D object is formed of one or more materials selected from the group consisting of an elemental metal, metal alloy, ceramic, and an allotrope of elemental carbon, wherein the controller is operatively coupled to the first processor, second processor, and energy beam. The controller can be further controlled by closed loop control. The closed loop control can comprise feedback control. The closed loop control can comprise feed-forward control. The first processor and the second processor can be the same processor. The first processor and the second processor can be different. The apparatus may further comprise a second energy beam that transforms a pre-transformed material to a transformed material. The controller may be operatively coupled to the second energy beam. The controller may direct the second energy beam to transform of at least a portion of a material bed to form a transformed material according to the 3D printing instruction to generate the 3D object. The morphology can comprise a length of the slice circumference, shape of the slice circumference, volume of the slice, or surface of the slice.

In another aspect, a system for generating a 3D object comprises: (a) a material bed comprising a particulate material selected from the group consisting of an elemental metal, metal alloy, ceramic, and an allotrope of elemental carbon; (b) a first energy source generating a first energy beam that transforms the particulate material to a transformed material; (c) a first processor; (d) a second processor; and (e) a controller that is controlled by open loop control, is operatively coupled to the material bed, energy source, energy beam, first processor, and second processor, and is programmed to direct (i) the first processor to revise of a morphology of a first (e.g., desired) model slice to a second (e.g., revised) model slice, which first model slice is of a model 3D object; (ii) the second processor to compile a 3D printing instruction(s) that comprise the second model slice, wherein the printing instruction is for the 3D printing process; and (iii) the energy beam to transform at least a portion of a material bed to form a transformed material according to the 3D printing instruction(s) to generate the 3D object, and which 3D object is substantially identical to the desired 3D object. The controller may be further controlled by closed loop control. The closed loop control can comprise feedback control. The closed loop control can comprise feed-forward control. The first processor and the second processor can be the same processor. The first processor and the second processor may be different. The system may further comprise a second energy beam that transforms the particulate material to a transformed material, wherein the controller is operatively coupled to the second energy beam, and direct the second energy beam to transform at least a portion of a material bed to form a transformed material according to the 3D printing instruction(s) to generate the 3D object. The second energy beam can be generated by the first energy source. The second energy beam can be generated by a second energy source that is different from the first energy source. The morphology can comprise a length of the slice circumference, shape of the slice circumference, volume of the slice, or surface of the slice.

In another aspect, a computer software product for generating a 3D object, which computer software product comprises a non-transitory computer-readable medium in which program instructions are stored, which instructions, when read by a computer, cause the computer to perform operations comprising: (a) revising a morphology of a first (e.g., desired) model slice to form a second (e.g., revised) model slice, which first model slice is of a model 3D object; and (b) generating (e.g., compiling) a printing instruction(s) using an open loop control and the second model slice, wherein the printing instruction(s) comprises instruction to transform at least a portion of a material bed to a transformed material to generate the 3D object, which 3D object is substantially identical to the model 3D object, and which 3D object is formed of a material selected from the group consisting of elemental metal, metal alloy, ceramic, and an allotrope of elemental carbon. The morphology can comprise a length of the slice circumference, shape of the slice circumference, volume of the slice, or surface of the slice.

In another aspect, a method for generating a 3D object comprises printing the 3D object using an open loop control module, which open loop control comprises: projecting (e.g, estimating) one or more errors (e.g., projected deformations) formed during a 3D printing process of a model (e.g., desired) 3D object using a first printing instruction (e.g., a first set of printing instructions), which one or more errors comprise bending deformation; altering the first printing instruction to generate a second printing instruction (e.g., second set of printing instructions); and using the second printing instruction for the printing of the 3D object using a 3D printing process, which generated 3D object is substantially identical to the model 3D object, which generated 3D object is formed of one or more materials selected from the group consisting of an elemental metal, metal alloy, ceramic, and an allotrope of elemental carbon. Bending may comprise warping, arching, curving, or twisting. Warping can be positive warping. The 3D printing can comprise using a material bed disposed on a platform, and wherein the positive warping is in the direction away from the platform. Projecting (e.g., estimating) can comprise a multiplicity of modules. Projecting can comprise a theoretical model of forming the 3D object by the 3D printing. The theoretical model can comprise alteration of stress or temperature in the 3D object during its formation (e.g., by the 3D printing process). The theoretical model can comprise alteration of stress and temperature in the 3D object during its formation. The projecting can comprise a multiplicity of modules based on a theoretical model of forming the 3D object by the 3D printing process. The altering can comprise correcting the projected one or more errors though the generation of the second printing instruction. The second printing instruction may reduce the degree of the one or more errors in the generated 3D object (e.g., by the 3D printing process). The second printing instruction comprises deforming the model 3D object. The printing may further comprises a closed loop control. The closed loop control can comprise feedback or feed-forward control. The open loop control can comprise empirical data. The empirical data can be of the characteristic structure. The open loop control can comprise a theoretical model. The theoretical model can comprise heat flow. The theoretical model can be of the model 3D object. The printing instruction may exclude an iterative process. The iterative process can comprise the formed 3D object by the 3D printing. The 3D printing can comprise a material bed. The material bed can comprise a particulate material comprising elemental metal, metal alloy, ceramic, and an allotrope of elemental carbon. The 3D printing process can comprise melting at least a portion of the material bed. The 3D printing process can comprise completely melting at least a portion of the material bed. The 3D printing process can comprise selective laser melting. The (e.g., forming) 3D object can be suspended anchorlessly in the material bed during the 3D printing process. Substantially can comprise a deviation. Substantially can comprise a deviation. The deviation can be from the desired 3D object by at most about the sum of 100 micrometers and 1/1000 of a fundamental length scale of the model 3D object. The deviation can be from the desired 3D object by at most about the sum of 25 micrometers and 1/2500 of a fundamental length scale of the model 3D object.

In another aspect, an apparatus for generating a 3D object comprises a controller that is controlled by open loop control and is programmed to direct (a) a first processor to project (e.g., estimate) one or more errors (e.g., projected deformations) formed during a 3D printing process of a model (e.g., desired) 3D object using a first printing instruction (e.g., a first set of printing instructions), which one or more errors comprise bending deformation; (b) a second processor to alter the first printing instruction and generate a second printing instruction (e.g., second set of printing instructions); and (c) a first energy beam to transform at least a portion of a material bed to form a transformed material according to the second printing instruction, which transformed material forms at least a portion of the generated 3D object, which generated 3D object is substantially identical to the model 3D object, which material bed is of a material selected from the group consisting of an elemental metal, metal alloy, ceramic, and an allotrope of elemental carbon. The material bed can be of a particulate material selected from the group consisting of an elemental metal, metal alloy, ceramic, and an allotrope of elemental carbon. The controller may be further controlled by closed loop control. The closed loop control can comprise feedback control. The closed loop control can comprise feed-forward control. The first processor and the second processor may be the same processor. The first processor and the second processor may be different. The apparatus can further comprise a second energy beam that transforms a pre-transformed material to a transformed material. The controller can be operatively coupled to the second energy beam, and direct the second energy beam to transform of at least a portion of a material bed to form a transformed material according to the second printing instruction to generate the 3D object.

In another aspect, a system for generating a 3D object comprises: (a) a material bed formed of a particulate material selected from the group consisting of an elemental metal, metal alloy, ceramic, and an allotrope of elemental carbon; (b) a first energy source generating a first energy beam that transforms the particulate material to a transformed material; (c) a first processor; (d) a second processor; and (e) a controller that is controlled by open loop control, is operatively coupled to the material bed, energy source, energy beam, first processor, and second processor, and is programmed to direct: (i) the first processor to project (e.g., estimate) one or more errors formed during a 3D printing process of a model (e.g., desired) 3D object using a first printing instruction (e.g., a first set of printing instructions), which one or more errors (e.g., projected deformations) comprise bending deformation (e.g., during and/or following the formation of the 3D object in the 3D printing process); (ii) the second processor to alter the first printing instruction to generate a second printing instruction (e.g., second set of printing instructions); and (iii) the energy beam to transform of at least a portion of a material bed to a transformed material according to the second printing instruction, which generated 3D object is substantially identical to the model 3D object. The controller may be further controlled by closed loop control. The closed loop control can comprise feedback control. The closed loop control can comprise feed-forward control. The first processor and the second processor may be the same processor. The first processor and the second processor may be different. The system may further comprise a second energy beam that transforms a particulate material to a transformed material. The controller may be operatively coupled to the second energy beam, and direct the second energy beam to transform of at least a portion of the material bed to a transformed material according to the second printing instruction to generate the 3D object. The second energy beam may be generated by the first energy source. The second energy beam may be generated by a second energy source that is different from the first energy source.

In another aspect, a computer software product for generating a 3D object, which computer software product comprises a non-transitory computer-readable medium in which program instructions are stored, which instructions, when read by a computer, cause the computer to perform operations comprising (a) projecting (e.g., estimating) one or more errors (e.g., deformations) formed during a 3D printing process of a model (e.g., desired) 3D object using a first printing instruction (e.g., first set of printing instructions), which one or more errors comprise bending; and (b) altering the first printing instruction to generate a second printing instruction (e.g., second set of printing instructions) that is used to generate the 3D object that is substantially identical to the model 3D object, which generated 3D object is formed of one or more materials selected from the group consisting of elemental metal, metal alloy, ceramic, and an allotrope of elemental carbon.

In another aspect, a 3D object comprises at least one layer of material (e.g., hardened material) comprising successive melt pools of the material, wherein the layer of material is (e.g., substantially, or noticeably) different from a corresponding cross section of a model of the 3D object. The material may comprise elemental metal, metal alloy, ceramics, or elemental carbon. The layer of (hardened) material may be indicated by a microstructure of the material. The 3D object may be generated by at least one 3D printing method (e.g., additive manufacturing). The additive manufacturing method may comprise selective laser melting (SLM), selective laser sintering (SLS), direct metal laser sintering (DMLS), or fused deposition modeling (FDM). The additive manufacturing method can comprise selective laser melting. The layer of material can comprise successive arrangement of melt pools. The layer of (hardened) material can comprise crystals. The crystal can comprise single crystals. The layer of material can comprise dendrites. The melt pool can comprise a crystal. The melt pool can comprise a dendrite. Each of the successive melt pools may be a discrete melt pool.

In another aspect, a 3D object comprises a layer of hardened (e.g., solid) material generated by at least one additive manufacturing method, wherein the layer of hardened material is different from a corresponding cross section of a model of the 3D object. The material disclosed herein can comprise elemental metal, metal alloy, ceramics, or elemental carbon. The layer of hardened material within the 3D object described herein can be indicated by the microstructure of the material.

In another aspect, a system for forming a closed 3D structure comprises: (a) a powder bed formed of a first particulate material selected from the group consisting of elemental metal, metal alloy, ceramic, and an allotrope of elemental carbon; (b) a first energy source that generates a first energy beam, which first energy beam transforms at least a first portion of the powder bed to form a transformed material as part of the closed 3D structure; and (c) a controller operatively coupled to the powder bed, and the first energy source and is programmed to direct a first energy beam to transform at least a first portion of a powder bed to form a first 3D object and a second portion of a material bed to form a second 3D object, wherein the second 3D object is enclosed within the first 3D object, wherein the second 3D object is devoid of auxiliary support and is anchorlessly suspended in the material bed during its formation. The first energy source may further generate a second energy beam, which second energy beam transforms at least a second portion of the powder bed to form a transformed material as part of the 3D object. The controller may be further operatively coupled to the second energy beam.

The term “operatively coupled” or “operatively connected” refers to a first mechanism that is coupled (or connected) to a second mechanism to allow (e.g., facilitate) the intended operation of the second and/or first mechanism.

In another aspect, a method for forming nested 3D objects, comprises transforming at least a first portion of a powder bed to form a first 3D object and a second portion of a powder bed to form a second 3D object, wherein the second 3D object is enclosed within the first 3D object, wherein the second 3D object is devoid of auxiliary support and is anchorlessly suspended in the powder bed during its formation and wherein the powder bed is formed of a particulate material selected from the group consisting of elemental metal, metal alloy, ceramics, and an allotrope of elemental carbon. The powder bed can be disposed on a platform. The first 3D object can be anchored to the platform. The first 3D object can be suspended anchorlessly in the powder bed during its formation. The second 3D object can be fully enclosed within the first 3D object. Transforming can comprise a first energy beam. Transforming can comprise a first energy beam and a second energy beam. Both the first and second energy beams can be focused. Both the first and second energy beams can be de-focused. The first energy beam can be focused and the second energy beam can be non-focused. The first energy beam can be faster than the second energy beam. The first energy beam may have a greater power per unit area than the second energy beam. Greater may be by at least half an order of magnitude. Greater may be by at least an order of magnitude. Transforming can comprise using a first energy beam having a power per unit area of at least about 100 watts per millimeter square. The method may further comprise open loop control. The method may further comprise closed loop control. The control may be of at least one characteristics of the energy beam. The control may be real time control (e.g., during the formation of at least a portion of the 3D object). The method may further comprise using a layer dispensing mechanism to dispense a layer of pre-transformed material to form at least a portion of the powder bed. The layer dispensing mechanism may comprise a non-contact layer dispensing mechanism part (e.g., a non-contact powder removal mechanism). The non-contact powder removal mechanism may be a part of a non-contact recoater. The non-contact powder removal mechanism may not contact the exposed surface of the material bed during its operation. The method may further comprise removing heat (e.g., from the material bed) using a cooling member.

In another aspect, a 3D object comprises at least one layer of hardened material comprising successive melt pools of the material, wherein the layer of hardened material comprises a path of deposited material comprising successive segments of parallel lines, wherein at least one first pair of the successive segments of parallel lines within the layer of material vary by a factor from at least one second pair of the successive segments of parallel lines within the layer of material.

In another aspect, a 3D object comprises a layer of hardened material generated by at least one additive manufacturing method, wherein the layer of hardened material can comprise a path of deposited material comprising successive segments of parallel lines, wherein at least one first pair of the successive segments of parallel lines in the layer of hardened material may vary by a factor, from at least one second pair of the successive segments of parallel lines within the layer of hardened material. The factor can comprise the distance between the pair. The path can be indicated by the grain structure of the material within the 3D objects. The path can be indicated by a microstructure of the 3D objects. The melt pools within the 3D objects described herein can indicate the path. The path can be indicated by a crystal structure of the material within the 3D objects.

In another aspect, a 3D object comprises at least one layer of hardened material comprising successive melt pools of the material, wherein the layer of hardened material comprises a path of material, wherein the path of material comprises a segment wherein the microstructure of the material varies as a function of the structure. In another aspect, a 3D object comprises at least one layer of hardened material comprising successive melt pools of the material, wherein the layer of hardened material comprises a path of material, wherein the path of material comprises a segment wherein the microstructure of the material varies as a function of the structure.

The material within the layer of hardened material can be solid. The microstructure of the 3D object can comprise smaller melt pools at the edges of the 3D object as compared to the bulk of the 3D object. The microstructure can comprise different (e.g., larger) melt pools at the edges of the 3D object as compared to the bulk of the 3D object. Different can be different in size, in shape (e.g., crystal structure, or metallurgical structure). Different in size can be smaller or larger. The difference in size may refer to the fundamental length scale (abbreviated herein as “FLS”) of the features within the melt pool (e.g., metallurgical structures and/or crystals). The FLS can be a diameter, spherical equivalent diameter, length, width, height, or diameter of a bounding circle. The microstructure can comprise varied (e.g., smaller) melt pools at the kinks of the 3D object as compared to the bulk of the 3D object. The microstructure can comprise varied (e.g., larger) melt pools at the kinks of the 3D object as compared to the bulk of the 3D object. The microstructure can comprise melt pools that are more spaced apart at the edge of the 3D object as compared to the bulk of the 3D object. The microstructure can comprise melt pools that are more spaced apart at the kink of the 3D object as compared to the bulk of the 3D object.

In another aspect, a 3D object comprises at least one layer of hardened material comprising successive melt pools of the material, wherein the layer of hardened material comprises a first tile of material and a second tile of material, wherein the first tile and the second tile are spaced apart by a first distance (e.g., a gap), wherein the first tile comprises a first set of line segments of material, wherein the second tile comprises a second set of line segments of material, wherein the first tile differs from the second tile by at least one factor.

In another aspect, a 3D object comprises a layer of hardened material generated by at least one additive manufacturing method, wherein the layer of hardened material can comprise a first tile of material and a second tile of material, wherein the first tile and the second tile are spaced apart by a first distance, wherein the first tile can comprise a first set of line segments of material, wherein the second tile can comprise a second set of line segments of material. The first tile may differ from the second tile by at least one factor. The tile of material may be indicated by the microstructure of the material within the 3D object. The at least one factor can comprise the spacing (e.g., gap) between lines in the set of line segments. The at least one factor can comprise the angle between lines in the set of line segments. The lines in the set of line segments can be parallel. The at least one factor can comprise the angle formed by a plane perpendicular to the layer of material and a line in the set of line segments. The at least one factor can comprise the width of lines in the set of line segments. The at least one factor can comprise the uniformity of lines in the set of line segments. The at least one factor can comprise the crystal structure of the material within the tile.

In another aspect, a 3D object comprises more than one layer of hardened material comprising successive melt pools of the material, wherein a microstructure of the more than one layer indicates that the 3D object was printed at an angle that minimizes the amount of suspended area in at least one of the more than one layer.

In another aspect, a 3D object comprises more than one layer of material generated by at least one additive manufacturing method, wherein a microstructure of the more than one hardened layer indicates that the 3D object was printed at an angle that minimizes the amount of suspended area in a layer within the 3D object.

In another aspect, a 3D object comprises at least one layer of (hardened) material comprising successive melt pools of the material, wherein the layer comprises a path of material, wherein the path follows a direction in the object that is susceptible to deformation. In another aspect, a 3D object comprises a layer of (hardened) material generated by at least one additive manufacturing method, wherein the layer can comprise a path of material, wherein the path follows a direction in the 3D object that is susceptible to deformation. The deformation can comprise warping (e.g., positive warping). Positive warping can be warping in the direction away from the building platform. The objects described herein may be devoid of (i) auxiliary support and (ii) auxiliary support mark. A plane N is a layering plane of the more than one layer (of hardened material). The 3D object may comprise two auxiliary support marks that are spaced apart by at least 40.5 millimeters, wherein the acute angle between the shortest straight line between the two auxiliary support marks and the direction of normal to the plane N is from about 45 degrees to about 90 degrees, from about 35 degrees to about 90 degrees, or from about 30 degrees to about 90 degrees. Points X and Y are points residing on the surface of the 3D object, wherein X is spaced apart from Y by at least about 2 millimeters or more. The sphere of radius XY that is centered at Y and intersects the 3D object (e.g., at point X) may lack auxiliary support marks. The acute angle between the shortest straight line XY and the direction of normal to the plane N may be from about 45 degrees to about 90 degrees, from about 35 degrees to about 90 degrees, or from about 30 degrees to about 90 degrees.

In another aspect, a first 3D object comprises two or more layers of hardened material comprising successive melt pools of the material, forming two or more steps, wherein a portion of the surface of the first 3D object incorporates a stratum that contacts at least portion of the two or more steps.

In another aspect, a 3D object comprises two or more layers of (hardened) material generated by at least one additive manufacturing method, forming two or more steps, wherein a portion of the surface of the 3D object incorporates a stratum (e.g., hardened stratum) situated on at least portion of the two or more steps. The stratum may level out the surface of the two or more steps. The stratum may include steps. The stratum may include steps of varied height. The two or more steps may include steps of substantially identical height.

In another aspect, a first 3D object comprises two or more layers of hardened material comprising successive melt pools of the hardened material, wherein the two or more layers comprise two or more substantially parallel layering planes, wherein a portion of the surface of the first 3D object incorporates a stratum, wherein the stratum comprises a layering plane that is not parallel to the two or more layering planes.

In another aspect, a first 3D object comprises two or more layers of hardened material generated by at least one additive manufacturing method, wherein the two or more hardened layers comprise two or more substantially parallel layering planes respectively, wherein a portion of the surface of the first 3D object incorporates a stratum, wherein the stratum can comprise a layering plane that is not parallel to the two or more layering planes. The stratum may comprise a corrugation. The stratum may comprise a corrugated surface. The thickness of the stratum can be heterogeneous. The thickness of the stratum may vary linearly. The thickness of the stratum may vary in a series (e.g., a series as disclosed herein). The thickness of the stratum may vary as a function of the relative position of the two or more layers. The thickness of the stratum may be thicker in a position situated adjacent to an earlier formed layer of the two or more layers. The thickness of the stratum may be thicker in a position situated adjacent to a layer that is closer or equal to a first formed layer of the first 3D object. The thickness of the stratum may be substantially homogenous. The portion of the surface of a second 3D object that is devoid of the stratum may comprise a rougher portion of the surface as compared to the first 3D object.

In another aspect, a first 3D object comprises at least one layer of hardened material comprising successive melt pools of the hardened material, wherein the layer comprises an edge area of the 3D object and a bulk area of the 3D object, wherein an average first distance between centers of a first set of successive microstructures of the hardened material in the edge area is longer than a second average distance between centers of a second set of successive microstructures of the hardened material at the bulk area.

In another aspect, a first 3D object comprises a layer of hardened material generated by at least one additive manufacturing method, wherein the hardened layer can comprise an edge area of the 3D object and a bulk area of the 3D object, wherein an average first distance between centers of a first set of successive microstructures of the hardened material in the edge area is longer than a second average distance between centers of a first set of successive microstructures of the material at the bulk area. The set of successive microstructures can be within a line of microstructures. The successive microstructures can be within adjacent lines of microstructures. The successive microstructures can be within different lines of microstructures.

In another aspect, a first 3D object comprises successive melt pools of at least one hardened material, wherein the first 3D object comprises a first material structure of the hardened material and a second material structure of the hardened material, wherein the second material structure is arranged in one or more positions within the first 3D object, wherein the positions are spaced apart by a first distance, wherein the first material occupies the first distance. The at least one material can consist of (e.g., substantially) one material type.

In another aspect, a first 3D object comprises successive melt pools of at least one hardened material, wherein the first 3D object comprises a first material structure of the hardened material and a second material structure of the hardened material, wherein the second material structure is arranged in one or more wires within the first 3D object.

In another aspect provided herein is a first 3D object generated by at least one additive manufacturing method comprising a hardened material, wherein the first 3D object comprises a first material structure of the hardened material and a second material structure of the hardened material, wherein the second material structure is arranged in one or more wires within the first 3D object. The first material structure can comprise the bulk of the first 3D object. In some examples, the second material structure does not comprise the bulk of the first 3D object. The first 3D structure can comprise an enhanced rigidity as compared to a second 3D object that is devoid of a second material structure. The first material structure may differ from the second material structure by its microstructure. The first material structure may differ from the second material structure by its grain structure. The first material structure may differ from the second material structure by its crystal structure, or by its metallurgical structure. The first material structure may differ from the second material structure by the FLS of its melt pools. The FLS may be a diameter, spherical equivalent diameter, length, width, or diameter of a bounding sphere. The wires are parallel. The one or more wires may be arranged at an angle with respect to a layering plane within the first 3D object. The angle may be the acute angle alpha. The one or more wires may be arranged substantially parallel to a layering plane within the first 3D object. The one or more wires may be arranged substantially parallel to the building platform, or perpendicular to the direction of the gravitational field. The one or more wires may be arranged substantially perpendicular to a layering plane within the first 3D object. The one or more wires may be slanted with respect to a layering plane within the first 3D object (or with respect to the building platform, or the plane perpendicular to the gravitational field direction). The one or more wires within a layer of material in the 3D object may have a length of at most the length of the layer of material. The one or more lines within the 3D object may have a length of at most the height of the first 3D object. The one or more wires have a cross section of a FLS of at least 20 micrometers. The one or more wires have a cross section of a FLS of at most 40 micrometers.

In another aspect, a first 3D object comprises successive melt pools of at least one material generated by at least one additive manufacturing method comprising a) a first material structure situated in a first hardened layer; b) a second material structure situated in a second hardened layer; and c) a third material structure traversing at least part of both the first layer and the second layer. The third material structure can comprise a spot. The spot can be a clump. The spot can be a sphere. The third material structure can comprise a wire. The third material structure can comprise a surface. The third material structure can comprise a surface. The first 3D object can comprise a lower degree of deformation compared to a second 3D object that does not comprise a third hardened material that transverses at least part of the first and second layer. The deformation can comprise warping. The first material structure, second material structure, and/or third material structure may correspond to one material type (e.g., one material formula).

In another aspect, a method for generating a 3D object comprises: (a) depositing a layer of pre-transformed material (e.g., powder) in an enclosure; (b) providing a first energy to a portion of the layer of pre-transformed material according to a first path; (c) transforming at least a section of the portion of the layer of pre-transformed material to form a transformed material by utilizing the first energy; and (d) allowing the transformed material to harden into a hardened material that forms at least a portion of a 3D object through energy depletion; and wherein the providing energy in operation (b) is performed in a manner that will compensate for a difference in an energy depletion rate from the transformed material or from the hardened material within the layer of pre-transformed material. Transform may comprise fuse. Fuse may comprise melt or sinter. The hardened material may comprise solid material. The hardened material may comprise fused material that subsequently solidified. The hardened material may comprise a dense material (e.g., of at least about 2 gr/cm³). The deposited pre-transformed material may comprise a powder material. The deposited pre-transformed material may comprise an elemental metal, metal alloy, ceramics, or elemental carbon. The first energy may be provided by a first energy source and the second energy may be provided by a second energy source. The first energy and the second energy may be provided by the same energy source. The energy depletion may comprise heat depletion. The energy depletion may comprise cooling. The first path may be predetermined. The providing a first energy may can comprise providing energy at a varied rate. The providing a first energy may comprise providing energy at a varied rate depending on the position of the generated hardened material within the 3D object. The providing a first energy may comprise providing energy at a varied FLS depending on the position of the generated hardened material within the 3D object. The providing a first energy may comprise providing energy at a varied intensity depending on the position of the generated hardened material within the 3D object. The first path may follow a direction that is susceptible to deformation. The first path can comprise successive lines. The successive lines may be spaced by a first distance. The first distance may vary depending on the position of the generated hardened material within the 3D object. In some examples, an angle between successive lines is varied depending on the position of the generated hardened material within the 3D object. The first path can be separated into at least two path tiles that are spaced by a first distance (e.g., a gap). The direction of the path that hatches the tiles (e.g., of at least two tiles) can be the same. The direction of the path that hatches of the tiles (e.g., of at least two tiles) can be different. A method described herein may further comprise after operation (a) and before operation (b) providing a second energy to a portion of the layer of pre-transformed material according to a second path, wherein the second energy is able to heat the pre-transformed material but not able to transform the pre-transformed material. The second path can be different than the first path. The second path can be identical to the first path but for an angular deviation. The second path can overlap the first path. The pre-transformed material can be a powder material. The second path can be a predetermined second path.

In another aspect, a method for generating a 3D object comprises: (a) depositing a layer of pre-transformed material (e.g., before transformation, such as powder material) in an enclosure; (b) providing a first energy to a portion of the layer of pre-transformed material according to a first path; (c) transforming at least a section of the portion of the layer of pre-transformed material to form a transformed material by utilizing the first energy; and (d) allowing the transformed material to harden into a hardened material that forms at least a portion of a 3D object though energy depletion; and wherein the providing energy is performed in a manner that will allow a reduced amount of energy to concentrate at an edge of the 3D object. The energy depletion can comprise heat depletion. The energy depletion can comprise cooling. The method may reduce the amount of deformation (e.g., bending) of the 3D object, as compared to a method for generating a hardened material by additive manufacturing, that does not reduce the amount of energy concentrated at an edge of the 3D object. The method may reduce the amount of balling of the hardened material, as compared to a method for forming a 3D object by additive manufacturing that does not reduce the amount of energy concentrated at an edge of the 3D object. The first path can comprise a first segment that corresponds to an edge of the 3D object and a second segment that corresponds to a portion of the 3D object that is distant from the edge. The path lines in the first segment can be more spaced apart as compared to the path lines in the second segment. The path lines in the first segment can be more spaciously separated as compared to the path lines in the second segment. The operation of providing a first energy (e.g., beam) can comprise energy that is less dense in the first segment as compared to the second segment. The first energy can comprise energy provided by an energy source. The FLS of a cross section of an energy beam generated by the energy source and projected on the exposed surface of the layer of pre-transformed material can be reduced in the first segment as compared to the second segment. The time exerted for the transforming can be reduced in the first segment as compared to the second segment.

In another aspect, a method for generating a 3D object comprises: (a) depositing a layer of pre-transformed material (e.g., powder) in an enclosure; (b) providing energy (e.g., beam) to a portion of the layer of material according to a path, wherein the path deviates at least in part from a cross section of a desired 3D object; (c) transforming at least a section of the portion of the layer of material to form a transformed material by utilizing the energy; (d) allowing the transformed material to harden into a hardened material; and (e) optionally repeating operations (a) to (d) to generate a generated 3D object, wherein the generated 3D object substantially corresponds to the desired 3D object. Deviates may comprise a deviation between different cross sections of the desired 3D object. The deviation may comprise a deviation within the cross section of a desired 3D object. The path can comprise a path section that is larger than a corresponding path section in the cross section of the desired 3D object. Larger may be larger within the plane of the cross section (e.g., horizontal plane). Larger may be larger outside the plane of the cross section. The path may comprise a path section that is smaller than a corresponding path section in the cross section of the desired 3D object.

In another aspect, a method for generating a 3D object comprises: a) depositing a layer of pre-transformed material (e.g., powder) in an enclosure; b) providing energy (e.g., beam) to a portion of the layer of pre-transformed material according to a first path, wherein the first path can comprise successive segments of lines, wherein at least one first pair of the successive segments of lines varies in at least one factor from at least one second pair of the successive segments of lines; c) transforming at least a section of the portion of the layer of pre-transformed material to form a transformed material by utilizing the energy; and d) allowing the transformed material to harden into a hardened material that forms at least a portion of a first 3D object. The successive segments may be parallel. The factor may comprise a distance between the pair of successive segments. The factor may comprise an angle formed by a pair of successive segments. The generated first 3D object may comprise a lesser degree of deformation as compared to a second 3D object formed by additive manufacturing using a second path wherein the successive segments of lines within the second path do not vary in the at least one factor.

In another aspect, a method for generating a 3D object comprises: (a) depositing a layer of pre-transformed material (e.g., powder) in an enclosure; (b) providing energy (e.g., beam) to a portion of the layer of material according to a path, wherein the energy can comprise an energy variation; (c) transforming at least a section of the portion of the layer of pre-transformed material to form a transformed material by utilizing the energy; and (d) allowing the transformed material to harden into a hardened material that forms at least a portion of a generated 3D object, wherein the energy variation depends on the corresponding position of the path within the generated 3D object. The layer of pre-transformed material prior to transformation (e.g., of at least a portion of the layer) may comprise a powder material. The energy variation may generate a hardened material comprising a lesser degree of deformation as compared to a hardened material produced without energy variation. The method may further comprise repeating operations (a) to (d) to generate the generated 3D object.

In another aspect, a method for generating a 3D object comprises: (a) depositing a layer of pre-transformed material (e.g., powder) in an enclosure; (b) providing a first energy (e.g., beam) to a portion of the layer of material according to a first path, wherein the first energy is insufficient to transform the material; and providing a second energy (e.g., beam) to the portion of the layer of material according to a second path, wherein the second energy is sufficient to transform the material; (c) transforming at least a section of the portion of the layer of material to form a transformed material by utilizing the second energy; and (d) allowing the transformed material to harden into a hardened material that forms at least a portion of a generated first 3D object. The hardened material can be a tile. The generated first 3D object can comprise a lesser degree of deformation as compared to a second 3D object generated by an additive manufacturing method that omits operation (b). The layer of pre-transformed material may comprise the first path and the second path. The operation of providing the first energy and the providing the first energy may overlap in time. The operation of providing the first energy and the providing the first energy may occur simultaneously. The operation of providing the first energy and the providing the first energy can occur sequentially. The first path and the second path can comprise an overlapping path section. The first path and the second path may substantially overlap. The first path and the second path may be distinct.

In another aspect, a method for generating a 3D object comprises: (a) depositing a layer of pre-transformed material (e.g., powder) in an enclosure; (b) providing energy (e.g., beam) to a first portion of the layer of material according to a path, wherein the path is at least a portion of a 3D model of the 3D object, wherein the 3D model is tilted to minimize at least one area of a hanging plane section of the 3D object; (c) transforming at least a first section of the layer of pre-transformed material to form a first section of transformed material by utilizing the provided energy; and (d) allowing the transformed material to harden into a hardened material that forms at least a portion of a generated 3D object. The at least one area of a hanging plane section (e.g., 3D plane) of the 3D object can comprise the area of all hanging plane sections of the 3D object. The hanging (e.g., 3D) plane section may be substantially parallel to the build platform, to the top surface of the material bed, and/or to the plane normal to the direction of the field of gravity. The hanging (e.g., 3D) plane section may form an acute angle alpha with the (i) build platform, (ii) top surface of the material bed, and/or (iii) plane normal to the direction of the field of gravity.

In another aspect, a method for generating a 3D object comprises: (a) depositing a layer of pre-transformed material (e.g., powder) in an enclosure; (b) providing energy (e.g., beam) to a portion of the layer of pre-transformed material according to a path; (c) transforming at least a first section of the layer of pre-transformed material to form a transformed material by utilizing the provided energy; and (d) allowing the transformed material to harden into a hardened material that forms at least a portion of a 3D object, wherein the path follows a direction of the hardened material that is susceptible to deformation. The hardened material described herein can have a lower degree of deformation as compared to a hardened material printed by an additive manufacturing method where the path does not follow a direction that is susceptible to the deformation (e.g., bending).

In another aspect, a method for generating a 3D object by layer tiling comprises: (a) depositing a layer of pre-transformed material (e.g., powder) in an enclosure; (b) providing a first energy (e.g., beam) to a first portion of the layer of pre-transformed material along a path of a first tile at a first location, wherein the path of the first tile is a portion of a path-set corresponding to a layer of the 3D object; (c) transforming at least a first section of the layer of pre-transformed material to form a first section of transformed material by utilizing the first energy that travels along the path of the first tile; (d) providing a second energy to a second portion of the layer of pre-transformed material according to a path of a second tile that is part of the path set, wherein the path of the second tile is in a second location, wherein the first location and the second location are separated by a first distance; (e) transforming at least a second section of the layer of material to form a second section of transformed material by utilizing the second energy that travels along the path of the second tile; and (f) allowing the first section of transformed material and the second section of transformed material to harden into a first hardened material tile and a second hardened material tile respectively, which form at least a portion of a generated first 3D object. The path set may reside within the layer of pre-transformed material. The generated first 3D object can comprise a lesser degree of deformation as compared to a second 3D object generated by an additive manufacturing method using the path that corresponds to a layer of pre-transformed material, without dividing it into at least a path of a first tile and a path of a second tile. The lesser degree of deformation may be due to one or more factors comprising the positions of the location. The lesser degree of deformation may be due to one or more factors comprising the density of the path of the tile. The path of the tile may be less dense at a position corresponding to an edge of the 3D object, as compared to a position corresponding to an area farther from an edge of the 3D object. The first energy may be provided by a first energy source and the second energy is provided by a second energy source. The first energy and the second energy may be provided by the same energy source. In some embodiments, a separation of the path corresponding to the layer of material into the path of the first tile and the path of the second tile may afford reducing energy density on edge of the generated 3D object. The reducing energy density on edge may occur at least during the transforming. The reducing energy density on edge may occur at least during the operation (f) of “allowing to harden.” The lesser degree of deformation may be due to one or more factors comprising the size of the tile. The size of the tile can comprise the size of the path of the tile. The size of the tile can comprise the size of the path of the first tile, the size of the path of the second tile, or size of both the path of the first tile and the path of the second tile. The size of the tile can comprise the size of the hardened material tile. The size of the tile can comprise the size of the first hardened material tile, the size of the second hardened material tile, or size of both the first hardened material tile and the second hardened material tile.

In another aspect, a method for generating a second 3D object comprises: (a) situating a first 3D object in an enclosure, wherein the 3D object has a top uneven surface that is formed by two or more layers of hardened material; depositing a layer of pre-transformed material (e.g., powder) in the enclosure, wherein the layer of pre-transformed material covers the uneven surface; and (b) forming a hardened material from at least a portion of the layer of pre-transformed material, wherein the hardened material covers at least a portion of the uneven surface to form a second 3D object, wherein the top surface of the hardened material is more even (e.g., flatter) than the uneven surface. The uneven surface may comprise a staggered surface. The uneven surface may comprise a stepped surface. The second 3D object may have a greater resemblance to a desired 3D object, as compared to the first 3D object.

In another aspect, a method for generating a 3D object comprises: (a) situating a first 3D object in an enclosure, wherein the 3D object has a top surface comprising a first set of steps, wherein the first set of steps forms an acute angle theta with the substrate above which the first three dimensional object is situated; (b) depositing a layer of material (e.g., powder) in the enclosure, wherein the layer of material covers the first set of steps; and (c) forming a hardened material from at least a portion of the layer of material, wherein the hardened material covers at least a portion of the first set of steps, wherein the hardened material comprises a second set of steps that form an acute angle phi with the substrate; and wherein phi is smaller than theta. The second 3D structure may comprise a surface that is smoother than the corresponding surface in the first 3D structure. The second 3D structure can comprise a surface that is more leveled (e.g., flatter) than the corresponding surface in the first 3D structure. The surface can comprise the second set of steps. The second 3D structure may correspond to a desired 3D structure. The first 3D structure may deviate from a desired 3D structure.

In another aspect, a method for generating a 3D object comprises: (a) depositing a first layer of pre-transformed material (e.g., powder) in an enclosure; (b) forming a first hardened material from at least a portion of the first layer of pre-transformed material; (c) depositing a second layer of pre-transformed material in the enclosure; (d) forming a second hardened material from at least a portion of the second layer of material, wherein the first hardened material is substantially parallel to the second hardened material; (e) depositing a third layer of pre-transformed material in the enclosure to cover the first hardened material and the second hardened material; and (f) forming a third hardened material from the pre-transformed material in the enclosure, wherein the third hardened material contacts at least a portion of both the first hardened material and the second hardened material, wherein the third hardened material is not parallel to the first hardened material, wherein a first 3D object comprises the hardened material. The first hardened material can be situated below the second hardened material. The first 3D object can comprise a smoother surface, as compared to a second 3D object generated without operations (e) to (f). A top of the first 3D object can comprise the third hardened material. The thickness of the third hardened material may be constant. The thickness of the third hardened material may vary. The third hardened material may be thicker towards the bottom of the first 3D object.

In another aspect, a method for generating a 3D object comprises: (a) depositing a layer of pre-transformed material (e.g., powder) in an enclosure; (b) providing a first energy (e.g., beam) to a portion of the layer of material according to a first path set comprising first disconnected paths; (c) transforming at least a section of the pre-transformed material within the first path set to form a first transformed material set by utilizing the first energy; (d) allowing the first transformed material set to harden into a first hardened material set that forms at least a portion of a 3D object; (e) providing a second energy to a portion of the layer of pre-transformed material according to a second path set comprising second disconnected paths, wherein the second path set is situated within at least one gap between the first disconnected paths sections; (f) transforming at least a section of the pre-transformed material within the second path set to form a second transformed material set by utilizing the second energy (e.g., beam); and (g) allowing the second transformed material set to harden into a second hardened material set that forms at least a portion of a 3D object. The gap can comprise a hole. The gap can comprise a line section. The gap can be a hole. The second hardened material can comprise lines. The lines can comprise parallel lines. The lines may be situated at an angle with respect to the layering plane of the first hardened material. The lines can be situated substantially perpendicular to the layering plane of the first hardened material. The lines may be situated within the layering plane of the first hardened material. The first hardened material set and the second hardened material set differ in their material structure. The first energy and the second energy comprise substantially the same energy. The first energy and the second energy differ by at least one quality (e.g., characteristics of the energy beam). The quality can comprise the energy density. The quality can comprise the FLS of the energy projected onto the layer of material. The quality can comprise the time during which the energy is projected on to the layer of material. The quality can comprise the rate at which the energy is projected on to the layer of material. The quality may comprise the intensity pattern by which the energy can be projected on to the layer of material. The pattern can comprise oscillation in energy intensity and/or cross section on the exposed surface of the layer of pre-transformed material. The first energy and the second energy can derive from the same energy source. The first energy and the second energy can derive from different energy sources. The first path set and the second path set can comprise an overlapping path section. The first path set and the second path set may be distinct. The first transformed material can comprise energy depletion though the layer of material. The first transformed material can comprise energy depletion though the first hardened material. The second hardened material can nest within the first hardened material. The first hardened material can comprise the bulk of material within the 3D object. At times, the second hardened material does not form the bulk of the 3D object. The second hardened material can reinforce the structure formed by the first hardened material. The second hardened material can reinforce the 3D object.

In another aspect, a method for generating a 3D object comprises: (a) depositing a layer of pre-transformed material (e.g., powder) in a material bed situated within an enclosure; (b) providing a first energy (e.g., beam) to a portion of the layer of pre-transformed material according to a first path; (c) transforming at least a section of the portion of the layer of pre-transformed material to form a transformed material by utilizing the energy; and (d) allowing the transformed material to harden into a hardened material that forms at least a portion of the 3D object through energy depletion; and wherein the providing energy in operation (b) is dependent on the density of material. The operations of providing energy in operation (b) may dependent on the density of pre-transformed material within the layer of pre-transformed material. The operations of providing energy in b) may dependent on the density of pre-transformed material within the material bed. The operation of providing energy in b) may further depend on the density of pre-transformed material situated beneath the layer of pre-transformed material. The operation of providing energy in operation (b) may further depend on the density of pre-transformed material situated directly beneath the layer of pre-transformed material. The operation of providing energy in operation (b) may depend on the density of pre-transformed material within the material bed. The layer of pre-transformed material can comprise a powder material. The material can comprise elemental metal, metal alloy, elemental carbon, or ceramics. The density of the powder material can be from 40 percent material to 80 percent material. The percent may be a weight-by-weight or a volume-by-volume percent.

In another aspect, a method for generating a 3D object comprises: (a) depositing a first layer of pre-transformed material (e.g., powder) in an enclosure; (b) hardening portion of the first layer of material to form a first hardened material; (c) depositing a second layer of pre-transformed material in an enclosure; (d) hardening portion of the second layer of pre-transformed material to form a second hardened material; (e) depositing a third layer of pre-transformed material in an enclosure; and (f) hardening portion of the third layer of material to form a third hardened material, wherein the third hardened material traverses at least a portion of the first hardened material and at least a portion of the second hardened material; and wherein the hardened material forms at least a portion of a generated first 3D object.

In another aspect, a method for generating a 3D object comprises: (a) depositing a first layer of pre-transformed material (e.g., powder) in an enclosure; (b) providing an energy (e.g., beam) to the first layer of material; (c) transforming at least a section of the first layer of pre-transformed material to form a first transformed material; (d) hardening the first transformed material into a first hardened material; (e) depositing a second layer of pre-transformed material in an enclosure; (f) providing the energy to the second layer of material; (g) transforming at least a section of the second layer of material to form a second transformed material; (h) hardening the second transformed material into a second hardened material; (i) depositing a third layer of pre-transformed material in an enclosure; (j) providing the energy to the third layer of pre-transformed material; (k) transforming at least a section of the third layer of pre-transformed material to form a third transformed material; and (l) hardening the third transformed material into a third hardened material, wherein the third hardened material traverses at least a portion of the first hardened material and at least a portion of the second hardened material, wherein the hardened material forms at least a portion of a generated first 3D object. The first hardened material can include disconnected tiles. The second hardened material can include disconnected tiles. The first hardened material can connect to the second hardened material in one or more positions. The third hardened material can include a spot. The spot may be a clump. The spot may comprise a sphere. The third hardened material can comprise a wire. The third hardened material can comprise a surface. The third hardened material can comprise a plane.

In another aspect, a system for generating a 3D object comprises: an enclosure for accommodating a layer of pre-transformed material (e.g., powder); a first energy (e.g., beam) that transforms the pre-transformed material to form a transformed material, wherein the transformed material hardens to form at least a portion of a 3D object; and a controller that directs the first energy to at least a portion of the layer of pre-transformed material according to a first path, wherein the controller controls the energy along the first path to compensate for a difference in an energy depletion rate from at least one area of the transformed material or from at least one area of the hardened material within the layer of material.

In another aspect, a system for generating a 3D object comprises: an enclosure for accommodating a layer of pre-transformed material (e.g., powder); a first energy (e.g., beam) that transforms the material to a transformed material, wherein the transformed material hardens to form at least a portion of a 3D object; and a controller that directs the first energy to at least a portion of the layer of material according to a path, wherein the controller controls the energy along the path to allow a reduced amount of energy to concentrate at an edge of the 3D object.

In another aspect, a system for generating a 3D object comprises: an enclosure for accommodating a layer of pre-transformed material (e.g., powder); a first energy (e.g., beam) that transforms the pre-transformed material to a transformed material, wherein the transformed material hardens to form at least a portion of a 3D object; and a controller that directs the first energy to at least a portion of the layer of material according to a first path, wherein the first path deviates at least in part from a cross section of a desired 3D object; and wherein the generated 3D object substantially corresponds to the desired 3D object. The desired 3D object can comprise a model of a 3D object. The model can comprise vector-based graphics. The model can comprise computer-aided design, electronic design automation, mechanical design automation, or computer aided drafting.

In another aspect, a system for generating a 3D object comprises: an enclosure for accommodating a layer of pre-transformed material (e.g., powder); a first energy (e.g., beam) that transforms the material to form a transformed material, wherein the transformed material hardens to form at least a portion of a first 3D object; and a controller that directs the first energy to at least a portion of the layer of pre-transformed material according to a first path, wherein the first path can comprise successive segments of lines (e.g., hatch lines), wherein at least one first pair of the successive segments of lines vary in at least one factor from at least one second pair of the successive segments of lines. The successive segments can be parallel. The factor can be a distance between the pair of successive segments. The factor is an angle formed by a pair of successive segments. The generated first 3D object can comprise a lesser degree of deformation as compared to a second 3D object generated by an additive manufacturing method that uses a path wherein the successive segments of lines do not vary in the at least one factor.

In another aspect, a system for generating a 3D object comprises: an enclosure for accommodating a layer of pre-transformed material (e.g., powder), wherein the material can comprise elemental metal, metal alloy, ceramics, or elemental carbon; a first energy beam that transforms the pre-transformed material to form a transformed material, wherein the transformed material hardens to form at least a portion of a generated first 3D object; a controller that directs the first energy beam to at least a portion of the layer of pre-transformed material according to a first path; and wherein an energy of the energy beam can comprise energy variation depending on the position of the corresponding path within the first 3D object. The first 3D object can comprise a lesser degree of deformation as compared to a second 3D object generated by an additive manufacturing method without the energy variation.

In another aspect, a system for generating a 3D object comprises: an enclosure for accommodating a layer of pre-transformed material (e.g., powder); a first energy (e.g., beam) that transforms the material to form a transformed material, wherein the transformed material hardens to form at least a portion of a generated 3D object; a controller that directs the first energy to at least a portion of the layer of material according to a first path, wherein the first path is at least a portion of a 3D model of the generated 3D object; and wherein the 3D model is tilted to minimize at least one area of a hanging plane section within the 3D object.

In another aspect, a system for generating a 3D object comprises: an enclosure for accommodating a layer of pre-transformed material (e.g., powder); a first energy (e.g., beam) that transforms the material to form a transformed material, wherein the transformed hardens to form at least a portion of a generated 3D object; and a controller that directs the first energy to at least a portion of the layer of material according to a first path, wherein the first path follows a direction of the hardened material that is susceptible to deformation.

In another aspect, a system for generating a 3D object comprises: an enclosure for accommodating a layer of pre-transformed material (e.g., powder); a first energy (e.g., radiation) that heats the material to form a heated material, wherein the first energy does not transform the material; a second energy (e.g., beam) that transforms the material to form a transformed material, wherein the transformed material hardens to form at least a portion of a generated first 3D object; and a controller that directs the first energy to a portion of the layer of pre-transformed material according to a first path, and that directs the second energy to a portion of the layer of pre-transformed material according to a second path, wherein the first path and the second path span substantially the same area within the layer of pre-transformed material. The first 3D object can comprise a lesser degree of deformation as compared to a second 3D object that is generated by a method of additive manufacturing that omits the first energy. In some examples, the portion of the layer can be smaller than the layer of pre-transformed material. The systems described herein may further comprise a first energy source that supplies the first energy, and a second energy source that supplies the second energy. The systems described herein may further comprise an energy source that supplies both the first energy and the second energy. The energy may be an energy beam.

In another aspect provided herein is an enclosure for accommodating a layer of pre-transformed material (e.g., powder); a first energy (e.g., beam) that transforms the material to form a first transformed material, wherein the first transformed material hardens to form a first hardened material tile that is a portion of a generated first 3D object; and a second energy capable of transforming the pre-transformed material to form a second transformed material, wherein the second transformed material hardens to form a second hardened material tile that is a portion of the generated first 3D object; a controller that directs the first energy to a portion of the layer of pre-transformed material along a first path-tile within a path-set corresponding to the layer of pre-transformed material, and that directs the second energy to a portion of the layer of pre-transformed material along a second path-tile within the path-set, wherein the first path-tile is separated by a first distance from the second path-tile, wherein the first path-tile corresponds to the first hardened material tile; and wherein the second path-tile corresponds to the second hardened material tile. The systems described herein may further comprise a first energy source that supplies the first energy, and a second energy source that supplies the second energy. The systems described herein may further comprise an energy source that supplies both the first energy and the second energy. The path set can comprise the first path-tile and the second path-tile. The path set may correspond to the layer of pre-transformed material. The generated first 3D object can comprise a lesser degree of deformation as compared to a second 3D object generated by an additive manufacturing method that uses a path of a layer of material that is not a path set.

In another aspect, a system for generating a 3D object comprises: an enclosure accommodating both a first 3D object and a pre-transformed material (e.g., in a material bed), wherein a top surface of the first 3D object comprises a first set of steps; a substrate situated within the enclosure, wherein the first 3D object is situated adjacent to the substrate; an energy that transforms the pre-transformed material to form a transformed material; a controller that directs the energy to follow a first path thereby transforming a portion of the material in the enclosure to form the transformed material, wherein the transformed material hardens into a hardened material, wherein the hardened material comprises a second set of steps situated adjacent to the first set of steps, wherein the first set of steps forms an acute angle theta with the substrate; and wherein the second set of steps forms an acute angle phi with the substrate, and wherein phi is smaller than theta.

In another aspect, a system for generating a 3D object comprises: an enclosure accommodating a first 3D object and a pre-transformed material (e.g., in a material bed), wherein the 3D object comprises a slanted uneven surface (e.g., formed by two or more layers of hardened material); an energy that transforms the pre-transformed material to form a transformed material; a controller that directs the energy to follow a first path thereby transforming a portion of the pre-transformed material in the enclosure into a transformed material, wherein the transformed material hardens into a first hardened material, wherein the first hardened material is situated adjacent to the uneven surface; and wherein the top surface of the first hardened material is more even than the uneven surface.

In another aspect, a system for generating a 3D object comprises: an enclosure for accommodating at least three layers of pre-transformed material (e.g., powder); an energy (e.g., beam) that transforms the pre-transformed material to form a transformed material, wherein the transformed material is hardens to form at least a portion of a generated 3D object; and a controller that directs the energy to follow a first path, second path, and third path, wherein the controller directs the energy to follow the first path and thereby transform the pre-transformed material of a first layer to form a first transformed material that is later on hardened to a first hardened material, wherein the controller directs the energy to follow the second path and thereby transform the pre-transformed material of the second layer to form a second transformed material that is later on hardened to a second hardened material, wherein the second hardened material is substantially parallel to the first hardened material, wherein the controller directs the energy to follow the third path and thereby transform the pre-transformed material of the third layer to form a third transformed material that is later on hardened to a third hardened material, wherein the third hardened material is not parallel to the second hardened material. The third hardened material may cover at least a portion of a surface of the 3D object. The surface may be a top surface, wherein the top is relative to a substrate above which the 3D object is generated. The thickness of the third hardened material may be constant. The thickness of the third hardened material may vary. The thickness of the third hardened material may vary linearly. The third hardened material may be thicker in a direction closer to the substrate above which the 3D object is generated. The energy may be an energy beam. The energy may be radiative energy.

In another aspect, a system for generating a 3D object comprises: an enclosure for accommodating a layer of pre-transformed material (e.g., powder); a first energy (e.g., beam) that transforms a first portion of the pre-transformed material to form a first set of transformed material, wherein the first set of transformed material hardens to form a first set of hardened material as part of a generated 3D object; a second energy (e.g., beam) that transforms a second portion of the pre-transformed material to form a second set of transformed material, wherein the second set of transformed material hardens to form a second set of hardened material as part of the generated 3D object; and a controller that directs the first energy to the first portion of the layer of pre-transformed material according to a first path set comprising a first set of disconnected paths, and that directs the second energy to the second portion of the layer of pre-transformed material according to a second path set comprising a second set of disconnected paths.

In another aspect, a system for generating a 3D object comprises: an enclosure for accommodating a layer of pre-transformed material (e.g., powder) within a material bed; an energy (e.g., beam) that transforms the pre-transformed material to form a transformed material, wherein the transformed material hardens to form a hardened material that is at least a portion of a generated 3D object; and a controller that directs the energy to a portion of the layer of pre-transformed material according to at least one instruction (e.g., direction), wherein the at least one instruction depends on the density of the pre-transformed material in the material bed. The at least one instruction may depend on the density of the pre-transformed material within the layer of pre-transformed material. The at least one instruction may depend on the density of the pre-transformed material that is situated beneath the layer of pre-transformed material. The at least one instruction may depend on the density of the pre-transformed material that is situated directly beneath the layer of pre-transformed material. The at least one instruction may depend on the density of the pre-transformed material within the material bed. The layer of pre-transformed material can comprise a powder material. The material can comprise elemental metal, metal alloy, elemental carbon, or ceramics. The elemental carbon can be an allotrope of elemental carbon. The density of the powder material may be from 40 percent material to 80 percent material. The percent may be weight-per-weight or volume-per-volume. The instruction may comprise a direction.

In another aspect, a 3D object formed by a 3D printing process, comprises: a layered structure comprising solidified melt pools of a material arranged in at least one layer, wherein the at least one layer comprises a first section and a second section that is separated from the first section by a gap, wherein the first section comprises a first set of successively solidified melt pools of a first material, wherein the second section comprises a second set of successively solidified melt pools of a second material, wherein the gap comprises a third material, wherein the at least two of the first material, second material, and third material are (e.g., substantially) identical (e.g., in type), and wherein the gap comprises a microstructure that distinguishes the gap from the first section and second section. The wherein the at least two of the first material, second material, and third material are (e.g., substantially) identical. The 3D object can have an Ra value of at most 250 micrometers. The first section and the second section can comprise hatch lines. The first section and the second section may each exclude a rim hatching. The first section may be disposed on at least one additional layer (e.g., a previously formed layer) of hardened material. The second section may not form on at least one previously formed layer of hardened material. The third hardened material may be in contact with the additional layer of hardened material. The gap can be in contact with the additional layer. The additional layer of hardened material can comprise a ledge that is disposed at a gap end. At least two of the first material, second material, and third material may be different. The first material, second material, and third material may be (e.g., substantially) identical (e.g., in type). At least two of the first material, second material, and third material may differ in at least one material property. At least two of the first material, second material, and third material may be (e.g., substantially) identical in at least one material property. The material property may comprise material phase, crystal structure, melt pool form, distribution of material phases within a melt pool, or material type. The gap can include a third material. The third material may cover an exposed portion of at least one of the first section and the second section. The material may be a hardened (e.g., solid) material. The third material may form a layer of material that is in contact with at least a portion of an exposed surface of the first section and/or the second section. The first section can be disposed at an end of the second section. The first section can be disposed within the second section. The first section can be at least partially surrounded by the second section. The gap can be smaller in a cross section than the first section or second section The gap can be smaller in cross section than the first section and the second section. The first section can be a portion of a post. The second section can be at least a portion of a suspended structure. The second section can be substantially planar. The second set of successively solidified melt pools may form a layering plane. The layering plane may indicate that the second section was fabricated at an angle of about 45°, 35°, 30°, 25°, or less from a building platform. The second set of successively solidified melt pools can form a layering plane. The layering plane may indicate that the second section was fabricated substantially parallel to the building platform. The second section may be a wire or a plane. A greater of a width and length of the second section can be at least about 2 centimeters (cm). A greater of a width and length of the second section can be at least about 10 cm. A greater of a width and length of the second section can be at least about 50 cm. The 3D object can be devoid of auxiliary feature (e.g., auxiliary support). The 3D object can be devoid of auxiliary feature or mark of auxiliary support feature.

In another aspect, a 3D object formed by a 3D printing process comprises: a layered structure comprising successively solidified melt pools of a material arranged in at least one layer, wherein the layer comprises a first section and a second section that borders the first section, wherein the first section comprises a first set of successively solidified melt pools that comprises an edge melt pool having microstructure characteristic of an isotherm boundary, which edge melt pool is situated at an edge of the first set that contacts the second set. The first section can comprise microstructures whose crystallinity (e.g., gradually) changes among the melt pools in the second section. The first section can comprise microstructures whose size (e.g., gradually) changes. The first section can comprise dendrites whose size (e.g., gradually) changes.

In another aspect, a 3D object formed by a 3D printing process comprises: a layered structure comprising successively solidified melt pools of a material arranged in at least one layer, wherein the at least one layer comprises a first section and a second section that is adjacent to the first section, wherein the first section comprises a first set of successively solidified melt pools that comprises a first border melt pool and a first set of interior melt pools, wherein the second section comprises a second set of successively solidified melt pools that comprises a second border melt pool and a second set of interior melt pools, wherein the first border melt pool is adjacent to the second border melt pool, wherein the first set of interior melt pools and the second set of interior melt pools comprise a first microstructure characteristics, and wherein the second border melt pool comprises a second microstructure characteristics that is different from the first microstructure characteristics. The first border melt pool may comprise a second microstructure characteristics that is different from the first microstructure characteristics. The second microstructure characteristic can be typical of adhering to a microstructure that is colder by at least about 70° C. The first microstructure characteristic can be typical of adhering to a microstructure that is colder by about 70° C. or less (e.g., less than about 70° C.). A microstructure of the first set of interior melt pools can be (e.g., substantially) identical to a microstructure of the second set of interior melt pools. The second border melt pool may have a microstructure characteristic of abrupt temperature change. The first microstructure characteristic can be typical of a temperature change milder as compared to the temperature change that is typical to the second microstructure characteristic.

In another aspect, a method for generating a 3D object by layer tiling comprises: (a) depositing a layer of powder material in an enclosure adjacent to a first layer of hardened material; (b) heating a first portion of the first layer of hardened material to form a first heated portion, wherein the heating does not (e.g., substantially) transform the material of the first heated portion; (c) transforming a first portion of the powder material to form a first transformed material that is disposed within the first heated portion, wherein the first transformed material hardens into a first hardened material; (d) heating a second portion of the first layer of hardened material to form a second heated portion, wherein the heating does not substantially transform the material of the second heated portion; and (e) transforming a second portion of the powder material to form a second transformed material that is disposed within the second heated portion, wherein the second transformed material hardens into a second hardened material, and wherein the first hardened material and the second hardened material form at least a portion of the second layer of hardened material as part of a first generated 3D object. The 3D object can have an Ra value of at most 250 micrometers. A surface area of the first hardened material or second hardened material can be at least 25 millimeter squared (mm²). A surface area of the first hardened material or second hardened material can be at most 25 mm². The first hardened material can touch the second hardened material. The first hardened material can overlap the second hardened material. The first hardened material can be separate from the second hardened material by a gap. The first section and the second section may comprise hatch lines, wherein the first section and the second section each exclude a rim hatch. The first and/or second section may comprise a rim. The rim may comprise one or more hath lines. The first and/or second section may comprise a multiplicity of rims. The second layer can be disposed adjacent to the first layer. The second layer may contact the first layer. The second layer may adhere to the first layer. The second layer can be disposed on the first layer. The first generated 3D object may comprise a lesser degree of deformation as compared to a second generated 3D object in which the second layer is deposited without tiling. The first generated 3D object may comprise a lesser degree of deformation as compared to a second generated 3D object in which the second layer is deposited without heating. The first generated 3D object may comprise a lesser degree of deformation as compared to a second generated 3D object in which the second layer is deposited without tiling and heating. The deformation may comprise bending (e.g., warping, arching, curving, or twisting), balling, cracking, or dislocating. For example, the deformation may comprise warping. The method may further comprise after operation (e): (0 heating a third portion of the first layer of hardened material to form a third heated portion, wherein the heating does not substantially transform the material of the third heated portion; and (g) transforming a third portion of the powder material to form a third transformed material that is disposed within the third heated portion, wherein the third transformed material hardens into a third hardened material. The third hardened material may not directly contact the first hardened material or the second hardened material. The third hardened material can be included within the second layer of hardened material. The first hardened, second hardened, and third hardened material may form a pattern that may be different from a straight line. The first heated portion, second heated portion, and third heated portion form a pattern that may be different from a straight line. The method may further comprise repeating operations (b) to (e) to substantially cover the second layer of hardened material except for at least one of the gap.

In another aspect, a method for generating a 3D object by welding comprises: (a) providing a powder bed comprising powder material in an enclosure; (b) transforming a first portion of the powder material into a first transformed material that hardens into a first hardened material; (c) transforming a second portion of the powder material into a second transformed material that hardens into a second hardened material that is separated from the first hardened material by a gap; and (d) transforming a third portion of the powder material into a third transformed material that is disposed in the gap and connects the first hardened material and the second hardened material, which third transformed material hardens into a third hardened material, wherein the first hardened material, the second hardened material, and the third hardened material are comprised in a layer of hardened material that is at least a portion of the 3D object. Transforming the third portion of powder material may comprise gradually transforming. The third portion of powder material may be transformed with (e.g., gradually) reduced energy. The energy may comprise thermal (e.g., heat) energy. The energy may comprise an energy beam. The energy beam may comprise an electromagnetic or electron beam. The energy beam may comprise a laser beam. Gradually may comprise linearly reduced heat energy. Gradually may comprise exponentially reduced heat energy. Exponentially may comprise a natural exponent. The 3D object may have a Ra value of at most 250 μm. The first portion and the second portion may comprise a hatch line, wherein the first section and the second section each exclude a rim hatch line. The method may further comprise after (c) and before (d), dispensing a layer of powder material in the powder bed. The method may further comprise leveling the powder material in the powder bed. The leveling may exclude contacting the exposed surface of the powder bed. The first hardened material may be disposed on at least one previously formed layer of hardened material. The second hardened material may be suspended (e.g., anchorlessly) in the powder bed. The at least one previously formed layer of hardened material may be suspended in the powder bed. The first hardened material and the second hardened material may be disposed on at least one previously formed layer of hardened material. The 3D object may be devoid of auxiliary support feature.

In another aspect, a method for generating a 3D object by layer tiling comprises: (a) depositing a layer of powder material in an enclosure adjacent to a first layer of hardened material; (b) transforming a first portion of the powder material along a first path to form a first transformed material that is disposed on the first layer, wherein the first transformed material hardens into a first tile of hardened material; (c) transforming a second portion of the powder material along a second path to form a second transformed material that is disposed on the first layer adjacent to the first tile, wherein the second transformed material hardens into a second tile of hardened material, wherein the second path starts from a position that is distant from the first tile, and progresses towards the first tile. The first path may start from a position that is adjacent to the second tile and progresses towards a position away from the position adjacent to the second tile. Adjacent may comprise immediately adjacent. Adjacent may comprise bordering. Adjacent may comprise contacting. The first path may comprise a single path. The second path may comprise a single path. The second path may comprise multiple path vectors (e.g., hatch lines). The first path may comprise multiple path vectors (e.g., hatch lines). The multiple path vectors can be formed sequentially. The multiple path vectors can be formed in parallel.

In another aspect, a system for generating a 3D object by layer tiling comprises: an enclosure for accommodating a layer of material comprising powder material; an energy source that is configured to provide an energy beam capable of heating at least a portion of the first layer of hardened material; and a controller in communication with the energy source, wherein the controller: (a) directs the energy beam to transform a first portion of the powder material into a first transformed material that hardens into a first hardened material; (c) directs the energy beam to transform a second portion of the powder material into a second transformed material that hardens into a second hardened material that is separated from the first hardened material by a gap; and (d) directs the energy beam to transform a third portion of the powder material into a third transformed material that is disposed in the gap and connects the first hardened material and the second hardened material, which third transformed material hardens into a third hardened material, wherein the first hardened material, the second hardened material, and the third hardened material are comprised in a layer of hardened material that is at least a portion of the 3D object.

In another aspect, a system for generating a 3D object by layer tiling comprises: an enclosure for accommodating a powder bed comprising a powder material, which powder bed comprises a first layer of hardened material; a first energy source that is configured to provide a first energy beam that heats at least a portion of the first layer of hardened material; a second energy source that is configured to provide a second energy beam that transforms at least a portion of the powder material; and a controller in communication with the first energy source and with the second energy source, wherein the controller: (a) directs the first energy beam to heat a first portion of the first layer of hardened material to form a first heated portion, wherein the heating does not substantially transform the material of the first heated portion; (b) directs the second energy beam to transform a first portion of the powder material to form a first transformed material that is disposed within the first heated portion, wherein the first transformed material hardens into a first hardened material; (c) directs the first energy beam to heat a second portion of the first layer of hardened material to form a second heated portion, wherein the heating does not (e.g., substantially) transform the material of the second heated portion; (e) directs the second energy beam to transform a second portion of the powder material to form a second transformed material that is disposed within the second heated portion, wherein the second transformed material hardens into a second hardened material, and wherein the first hardened material and the second hardened material form at least a portion of the second layer of hardened material as part of a first generated 3D object.

In another aspect, a system for generating a 3D object by layer tiling comprises: an enclosure for accommodating a powder bed comprising a powder material, which powder bed comprises a first layer of hardened material; an energy source that is configured to provide a first energy beam that heats at least a portion of the first layer of hardened material; and a controller in communication with the energy source, wherein the controller: (a) directs the energy beam along a first path to transform a first portion of the powder material to form a first transformed material that is disposed on the first layer, wherein the first transformed material hardens into a first tile of hardened material; (b) directs the energy beam along a second path to transform a second portion of the powder material to form a second transformed material that is disposed on the first layer adjacent to the first tile of hardened material, wherein the second transformed material hardens into a second tile of hardened material, wherein the second path starts from a position that is distant from the first tile, and progresses towards the first tile, and wherein the first tile of hardened material and the second tile of hardened material form at least a portion of the second layer of hardened material as part of a first generated 3D object.

In another aspect, an apparatus for generating a 3D object comprises a controller that is programmed to: (a) direct a powder dispenser to generate a powder bed comprising a powder material, wherein the controller is operatively coupled to the powder dispenser; and (b) direct an energy source to project an energy beam onto the powder bed and: (i) transform a first portion of the powder material into a first transformed material that hardens into a first hardened; (ii) transform a second portion of the powder material into a second transformed material that hardens into a second hardened material that is separated from the first hardened material by a gap; and (iii) transform a third portion of the powder material into a third transformed material that is disposed in the gap and connects the first hardened material and the second hardened material, which third transformed material hardens into a third hardened material, wherein the first hardened material, the second hardened material, and the third hardened material are comprised in a layer of hardened material that is at least a portion of the 3D object, and wherein the controller is operatively coupled to the energy source.

In another aspect, an apparatus for generating a 3D object comprises a controller that is programmed to: (a) direct a powder dispenser to generate a powder bed comprising powder material and a first layer of hardened material, wherein the controller is operatively coupled to the powder dispenser; and (b) direct an energy source to project an energy beam onto the powder bed and: (i) heat a first portion of the first layer of hardened material to form a first heated portion, wherein the heat does not (e.g., substantially) transform the material of the first heated portion; (ii) transform a first portion of the powder bed to form a first transformed material that is disposed within the first heated portion, wherein the first transformed material hardens into a first hardened material; (iii) heat a second portion of the first layer of hardened material to form a second heated portion, wherein the heat does not (e.g., substantially) transform the material of the second heated portion; and (iv) transform a second portion of the powder material to form a second transformed material that is disposed within the second heated portion, wherein the second transformed material hardens into a second hardened material, wherein the first hardened material and the second hardened material form at least a portion of the second layer of hardened material as part of a first generated 3D object, wherein the controller is operatively coupled to the energy source.

In another aspect, an apparatus for generating a 3D object comprises a controller that is programmed to: (a) direct a powder dispenser to generate a powder bed comprising powder material and a first layer of hardened material, wherein the controller is operatively coupled to the powder dispenser; and (b) direct an energy source to project an energy beam onto the powder bed along a first path to transform a first portion of the powder bed to form a first transformed material that is disposed on the first layer, wherein the first transformed material hardens into a first tile of hardened material; direct the energy beam onto the powder bed along a second path to transform a second portion of the powder material to form a second transformed material, wherein the second transformed material hardens into a second hardened material that is disposed on the first layer adjacent to the first tile of hardened material, wherein the second path starts from a position that is distant from the first tile, and progresses towards the first tile, and wherein the first tile of hardened material and the second tile of hardened material form at least a portion of the second layer of hardened material as part of a first generated 3D object.

Another aspect of the present disclosure provides systems, apparatuses, controllers, and/or non-transitory computer-readable medium (e.g., software) that implement any of the methods disclosed herein.

In another aspect, an apparatus for printing one or more 3D objects comprises a controller that is programmed to direct a mechanism used in a 3D printing methodology to implement (e.g., effectuate) any of the method disclosed herein, wherein the controller is operatively coupled to the mechanism.

In another aspect, a computer software product, comprising a non-transitory computer-readable medium in which program instructions are stored, which instructions, when read by a computer, cause the computer to direct a mechanism used in the 3D printing process to implement (e.g., effectuate) any of the method disclosed herein, wherein the non-transitory computer-readable medium is operatively coupled to the mechanism.

Another aspect of the present disclosure provides a non-transitory computer-readable medium comprising machine-executable code that, upon execution by one or more computer processors, implements any of the methods disclosed herein.

Another aspect of the present disclosure provides a computer system comprising one or more computer processors and a non-transitory computer-readable medium coupled thereto. The non-transitory computer-readable medium comprises machine-executable code that, upon execution by the one or more computer processors, implements any of the methods disclosed herein.

Additional aspects and advantages of the present disclosure will become readily apparent to those skilled in this art from the following detailed description, wherein only illustrative embodiments of the present disclosure are shown and described. As will be realized, the present disclosure is capable of other and different embodiments, and its several details are capable of modifications in various obvious respects, all without departing from the disclosure. Accordingly, the drawings and description are to be regarded as illustrative in nature, and not as restrictive.

### INCORPORATION BY REFERENCE

All publications, patents, and patent applications mentioned in this specification are herein incorporated by reference to the same extent as if each individual publication, patent, or patent application was specifically and individually indicated to be incorporated by reference.

### BRIEF DESCRIPTION OF DRAWINGS

The novel features of the invention are set forth with particularity in the appended claims. A better understanding of the features and advantages of the present invention will be obtained by reference to the following detailed description that sets forth illustrative embodiments, in which the principles of the invention are utilized, and the accompanying drawings or figures (also “Fig.” and “Figs.” herein), of which:

FIG. 1 schematically illustrates a vertical cross section of a three-dimensional (3D) printing system and its components;

FIG. 2 schematically illustrates a horizontal cross section of a path configuration of the present disclosure;

FIGS. 3A-3D schematically illustrate a horizontal cross section of various path configurations disclosed herein;

FIGS. 4A-4B schematically illustrate a horizontal cross section of various path variations disclosed herein;

FIGS. 5A-5B schematically illustrate a horizontal cross section of various path segments (e.g., tiles) within a set of path segments;

FIGS. 6A-6C schematically illustrate various cross sections of at least a portion of a 3D object;

FIGS. 7A-7B schematically illustrate examples of cross sections of an object comprising two layers;

FIGS. 8A and 8B illustrate vertical cross sections of a 3D object of the present disclosure; FIG. 8C schematically illustrates various 3D objects above respective planes;

FIGS. 9A-9B schematically illustrate vertical side cross sections of a portion of the enclosure of the present disclosure;

FIG. 10 schematically illustrates a computer control system that is programmed or otherwise configured to facilitate the formation of a 3D object;

FIGS. 11A-11B schematically illustrate a vertical cross sectional side view of various layer structures;

FIGS. 12A-12C schematically illustrate a vertical cross section of various stages in a 3D printing process described herein;

FIGS. 13A-13E schematically illustrate a vertical cross section of various stages in a 3D printing process described herein;

FIGS. 14A-14C schematically illustrate a vertical cross section of various stages in a 3D printing process described herein;

FIGS. 15A-15B schematically illustrate cross sections of various 3D objects;

FIGS. 16A-16D schematically illustrate a vertical cross section of various stages in a 3D printing process described herein;

FIGS. 17A-17D schematically illustrate a vertical cross section of various stages in a 3D printing process described herein;

FIGS. 18A-18C schematically illustrate a vertical cross section of various stages in a 3D printing process described herein;

FIGS. 19A-19B schematically illustrate a vertical cross section of various stages in a 3D printing process described herein;

FIGS. 20A-20D schematically illustrate cross sections of various stages in 3D printing processes and their possible outcomes;

FIG. 21 schematically illustrates a flow diagram of a 3D printing process;

FIGS. 22A-22B schematically illustrate a vertical cross section of various stages in a 3D printing process described herein;

FIGS. 23A-23G schematically illustrate a vertical cross section of various stages in 3D printing processes and their possible outcomes, and FIG. 23H illustrates a vertical cross section of a 3D object and a schematic representation of a 3D object;

FIGS. 24A-24B schematically illustrate a vertical cross section of various stages in 3D printing processes and their possible outcomes, and FIG. 24C illustrate a vertical cross section of a 3D object;

FIGS. 25A-25C schematically illustrate a vertical cross section of various stages in 3D printing processes, FIG. 25D illustrate a vertical cross section of a 3D object, and FIG. 25E illustrate a to view of a 3D object;

FIGS. 26A-26I schematically illustrate top views of various stages in 3D printing processes described herein;

FIGS. 27A-27D schematically illustrate top views of various stages in a 3D printing processes described herein;

FIGS. 28A-28F schematically illustrate top views of various stages in 3D printing processes described herein;

FIG. 29 schematically illustrates a vertical cross section of various 3D objects;

FIGS. 30A-30B schematically illustrate various stages in energy beam forming processes described herein;

FIGS. 31A-31B schematically illustrate 3D printing processes and their possible outcomes;

FIG. 32 schematically illustrates various stages in the formation of a 3D object;

FIGS. 33A-33C schematically illustrate a 3D printing process;

FIGS. 34A-34B illustrate a 3D object formed by a method described herein;

FIGS. 35A-35B illustrate a 3D objects formed by the methods described herein;

FIG. 36 schematically illustrates various 3D objects and portions thereof;

FIG. 37 shows various 3D objects; and

FIG. 38 schematically illustrates various paths.

The figures and components therein may not be drawn to scale. Various components of the figures described herein may not be drawn to scale.

### DETAILED DESCRIPTION

While various embodiments of the invention have been shown and described herein, it will be obvious to those skilled in the art that such embodiments are provided by way of example only. Numerous variations, changes, and substitutions may occur to those skilled in the art without departing from the invention. It should be understood that various alternatives to the embodiments of the invention described herein might be employed.

Terms such as “a”, “an” and “the” are not intended to refer to only a singular entity, but include the general class of which a specific example may be used for illustration. The terminology herein is used to describe specific embodiments of the invention(s), but their usage does not delimit the invention(s).

When ranges are mentioned, the ranges are meant to be inclusive, unless otherwise specified. For example, a range between value 1 and value 2 is meant to be inclusive and include value 1 and value 2. The inclusive range will span any value from about value 1 to about value 2. The term “adjacent” or “adjacent to,” as used herein, includes ‘next to’, ‘adjoining’, ‘in contact with’, and ‘in proximity to.’

The term “anchorlessly,” as used herein, generally refers to without or in the absence of an anchor. In some examples, an object is suspended in a powder bed anchorlessly without attachment to a support. For example, the object floats in the powder bed.

The present disclosure provides three-dimensional (3D) printing apparatuses, systems, and methods for forming a 3D object. For example, a 3D object may be formed by sequential addition of material or joining of material to form a structure in a controlled manner (e.g., under manual or automated control). In a 3D printing process, the deposited material may be fused, (e.g., sintered or melted), bound or otherwise connected to form at least a portion of the desired 3D object. Fusing, binding or otherwise connecting the material is collectively referred to herein as “transforming” the material. Fusing the material may refer to melting, smelting, or sintering a pre-transformed material. Pre-transformed material, as understood herein, is a material before it has been transformed during the 3D printing process. The transformation can be effectuated by utilizing an energy beam and/or flux. The pre-transformed material may be a material that was, or was not, transformed prior to its use in a 3D printing process.

A liquefied state refers to a state in which at least a portion of a transformed material is in a liquid state. A liquidus state refers to a state in which an entire transformed material is in a liquid state. The apparatuses, methods, software, and/or systems provided herein are not limited to the generation of a single 3D object, but are may be utilized to generate one or more 3D objects simultaneously (e.g., in parallel) or separately (e.g., sequentially).

3D printing methodologies can comprise extrusion, wire, granular, laminated, light polymerization, or power bed and inkjet head 3D printing. Extrusion 3D printing can comprise robo-casting, fused deposition modeling (FDM) or fused filament fabrication (FFF). Wire 3D printing can comprise electron beam freeform fabrication (EBF3). Granular 3D printing can comprise direct metal laser sintering (DMLS), electron beam melting (EBM), selective laser melting (SLM), selective heat sintering (SHS), or selective laser sintering (SLS). Power bed and inkjet head 3D printing can comprise plaster-based 3D printing (PP). Laminated 3D printing can comprise laminated object manufacturing (LOM). Light polymerized 3D printing can comprise stereo-lithography (SLA), digital light processing (DLP), or laminated object manufacturing (LOM). 3D printing methodologies can comprise Direct Material Deposition (DMD). The Direct Material Deposition may comprise, Laser Metal Deposition (LMD, also known as, Laser deposition welding).

3D printing methodologies may differ from methods traditionally used in semiconductor device fabrication (e.g., vapor deposition, etching, annealing, masking, or molecular beam epitaxy). In some instances, 3D printing may further comprise one or more printing methodologies that are traditionally used in semiconductor device fabrication. 3D printing methodologies can differ from vapor deposition methods such as chemical vapor deposition, physical vapor deposition, or electrochemical deposition. In some instances, 3D printing may further include vapor deposition methods.

The FLS of the printed 3D object or a portion thereof can be at least about 50 micrometers (μm), 80 μm, 100 μm, 120 μm, 150 μm, 170 μm, 200 μm, 230 μm, 250 μm, 270 μm, 300 μm, 400 μm, 500 μm, 600 μm, 700 μm, 800 μm, 1 mm, 1.5 mm, 2 mm, 3 mm, 5 mm, 1 cm, 1.5 cm, 2 cm, 10 cm, 20 cm, 30 cm, 40 cm, 50 cm, 60 cm, 70 cm, 80 cm, 90 cm, 1 m, 2 m, 3 m, 4 m, 5 m, 10 m, 50 m, 80 m, or 100 m. The FLS of the printed 3D object or a portion thereof can be at most about 150 μm, 170 μm, 200 μm, 230 μm, 250 μm, 270 μm, 300 μm, 400 μm, 500 μm, 600 μm, 700 μm, 800 μm, 1 mm, 1.5 mm, 2 mm, 3 mm, 5 mm, 1 cm, 1.5 cm, 2 cm, 10 cm, 20 cm, 30 cm, 40 cm, 50 cm, 60 cm, 70 cm, 80 cm, 90 cm, 1 m, 2 m, 3 m, 4 m, 5 m, 10 m, 50 m, 80 m, 100 m, 500 m, or 1000 m. The FLS of the printed 3D object or a portion thereof can any value between the aforementioned values (e.g., from about 50 μm to about 1000 m, from about 500 μm to about 100 m, from about 50 μm to about 50 cm, or from about 50 cm to about 1000 m). In some cases, the FLS of the printed 3D object or a portion thereof may be in between any of the afore-mentioned FLS values. The portion of the 3D object may be a heated portion or disposed portion (e.g., tile).

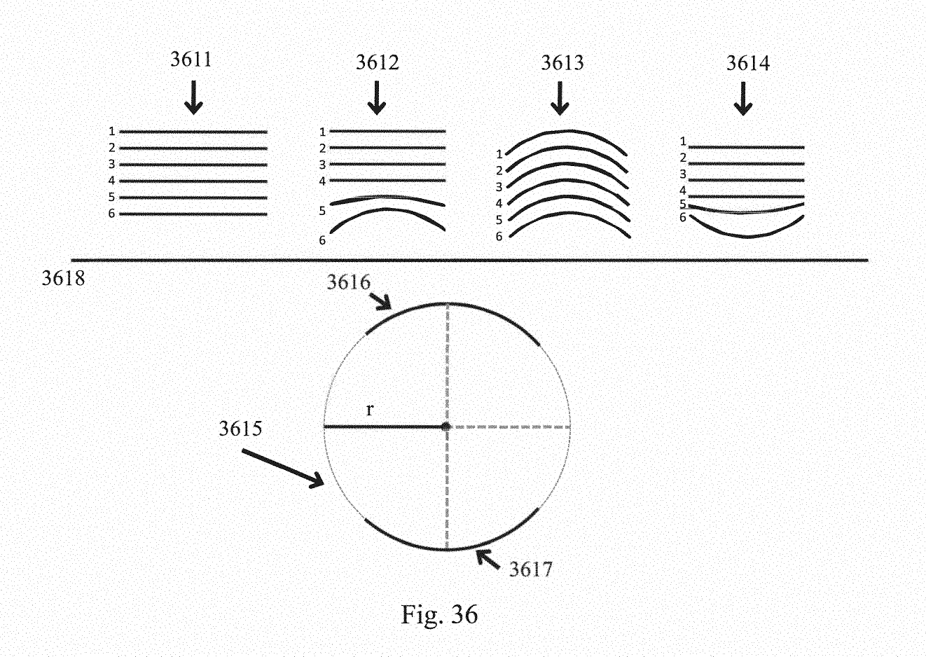

The layer of pre-transformed material (e.g., powder) may be of a predetermined height (thickness). The layer of pre-transformed material can comprise the material prior to its transformation in the 3D printing process. The layer of pre-transformed material may have an upper surface that is substantially flat, leveled, or smooth. In some instances, the layer of pre-transformed material may have an upper surface that is not flat, leveled, or smooth. The layer of pre-transformed material may have an upper surface that is corrugated or uneven. The layer of pre-transformed material may have an average or mean (e.g., predetermined) height. The height of the layer of pre-transformed material (e.g., powder) may be at least about 5 micrometers (μm), 10 μm, 20 μm, 30 μm, 40 μm, 50 μm, 60 μm, 70 μm, 80 μm, 90 μm, 100 μm, 200 μm, 300 μm, 400 μm, 500 μm, 600 μm, 700 μm, 800 μm, 900 μm, 1 mm, 2 mm, 3 mm, 4 mm, 5 mm, 6 mm, 7 mm, 8 mm, 9 mm, 10 mm, 20 mm, 30 mm, 40 mm, 50 mm, 60 mm, 70 mm, 80 mm, 90 mm, 100 mm, 200 mm, 300 mm, 400 mm, 500 mm, 600 mm, 700 mm, 800 mm, 900 mm, or 1000 mm. The height of the layer of pre-transformed material may be at most about 5 micrometers (μm), 10 μm, 20 μm, 30 μm, 40 μm, 50 μm, 60 μm, 70 μm, 80 μm, 90 μm, 100 μm, 200 μm, 300 μm, 400 μm, 500 μm, 600 μm, 700 μm, 800 μm, 900 μm, 1 mm, 2 mm, 3 mm, 4 mm, 5 mm, 6 mm, 7 mm, 8 mm, 9 mm, 10 mm, 20 mm, 30 mm, 40 mm, 50 mm, 60 mm, 70 mm, 80 mm, 90 mm, 100 mm, 200 mm, 300 mm, 400 mm, 500 mm, 600 mm, 700 mm, 800 mm, 900 mm, or 1000 mm. The height of the layer of pre-transformed material may be any number between the afore-mentioned heights (e.g., from about 5 μm to about 1000 mm, from about 5 μm to about 1 mm, from about 25 μm to about 1 mm, or from about 1 mm to about 1000 mm). The “height” of the layer of material (e.g., powder) may at times be referred to as the “thickness” of the layer of material. In some instances, the layer of hardened material may be a sheet of metal. The layer of hardened material may be fabricated using a 3D manufacturing methodology. Occasionally, the first layer of hardened material may be thicker than a subsequent layer of hardened material. The first layer of hardened material may be at least about 1.1 times, 1.2 times, 1.4 times, 1.6 times, 1.8 times, 2 times, 4 times, 6 times, 8 times, 10 times, 20 times, 30 times, 50 times, 100 times, 500 times, 1000 times, or thicker (higher) than the average (or mean) thickness of a subsequent layer of hardened material, the average thickens of an average subsequent layer of hardened material, or the average thickness of any of the subsequent layers of hardened material. FIG. 36 shows an example of a schematic cross section in a 3D object 3611 comprised of layers of hardened material numbered 1 to 6, with 6 being the first layer (e.g., bottom skin layer). In some instances, layer #1 can be thicker than any of the layers #2 to #6. In some instances, layer #1 can be thicker than an average thickens of layers #2 to #6. The very first layer of hardened material formed in the material bed by 3D printing may be referred herein as the “bottom skin” layer.

In some instances, one or more intervening layers separate adjacent components from one another. For example, the one or more intervening layers can have a thickness of at most about 10 micrometers (“microns”), 1 micron, 500 nanometers (“nm”), 100 nm, 50 nm, 10 nm, or 1 nm. For example, the one or more intervening layers can have a thickness of at least about 10 micrometers (“microns”), 1 micron, 500 nanometers (“nm”), 100 nm, 50 nm, 10 nm, or 1 nm. In an example, a first layer is adjacent to a second layer when the first layer is in direct contact with the second layer. In another example, a first layer is adjacent to a second layer when the first layer is separated from the second layer by a third layer. In some instances, adjacent to may be ‘above’ or ‘below.’ Below can be in the direction of the gravitational force or towards the platform. Above can be in the direction opposite to the gravitational force or away from the platform.

The deposited pre-transformed material within the enclosure can be a liquid material or a solid material. The deposited pre-transformed material within the enclosure can be in the form of a powder, wires, sheets, or droplets. The material (e.g., pre-transformed, transformed, and/or hardened) may comprise elemental metal, metal alloy, ceramics, or an allotrope of elemental carbon. The allotrope of elemental carbon may comprise amorphous carbon, graphite, graphene, diamond, or fullerene. The fullerene may be selected from the group consisting of a spherical, elliptical, linear, and tubular fullerene. The fullerene may comprise a buckyball, or a carbon nanotube. The ceramic material may comprise cement. The ceramic material may comprise alumina, zirconia, or carbide (e.g., silicon carbide, or tungsten carbide). The ceramic material may include high performance material (HPM). The ceramic material may include a nitride (e.g., boron nitride or aluminum nitride). The material may comprise sand, glass, or stone. In some embodiments, the material may comprise an organic material, for example, a polymer or a resin (e.g., 114 W resin). The organic material may comprise a hydrocarbon. The polymer may comprise styrene or nylon (e.g., nylon 11). The polymer may comprise a thermoplast. The organic material may comprise carbon and hydrogen atoms. The organic material may comprise carbon and oxygen atoms. The organic material may comprise carbon and nitrogen atoms. The organic material may comprise carbon and sulfur atoms. In some embodiments, the material may exclude an organic material. The material may comprise a solid or a liquid. In some embodiments, the material may comprise a silicon-based material, for example, silicon based polymer or a resin. The material may comprise an organosilicon-based material. The material may comprise silicon and hydrogen atoms. The material may comprise silicon and carbon atoms. In some embodiments, the material may exclude a silicon-based material. The powder material may be coated by a coating (e.g., organic coating such as the organic material (e.g., plastic coating)). The material may be devoid of organic material. The liquid material may be compartmentalized into reactors, vesicles, or droplets. The compartmentalized material may be compartmentalized in one or more layers. The material may be a composite material comprising a secondary material. The secondary material can be a reinforcing material (e.g., a material that forms a fiber). The reinforcing material may comprise a carbon fiber, Kevlar®, Twaron®, ultra-high-molecular-weight polyethylene, or glass fiber. The material can comprise powder (e.g., granular material) and/or wires. The bound material can comprise chemical bonding Transforming can comprise chemical bonding. Chemical bonding can comprise covalent bonding. The pre-transformed material may be pulverous. The printed 3D object can be made of a single material (e.g., single material type) or multiple materials (e.g., multiple material types). Sometimes one portion of the 3D object and/or of the material bed may comprise one material, and another portion may comprise a second material different from the first material. The material may be a single material type (e.g., a single alloy or a single elemental metal). The material may comprise one or more material types. For example, the material may comprise two alloys, an alloy and an elemental metal, an alloy and a ceramic, or an alloy and an elemental carbon. The material may comprise an alloy and alloying elements (e.g., for inoculation). The material may comprise blends of material types. The material may comprise blends with elemental metal or with metal alloy. The material may comprise blends excluding (e.g., without) elemental metal or including (e.g., with) metal alloy. The material may comprise a stainless steel. The material may comprise a titanium alloy, aluminum alloy, and/or nickel alloy.

In some cases, a layer within the 3D object comprises a single type of material. In some examples, a layer of the 3D object may comprise a single elemental metal type, or a single alloy type. In some examples, a layer within the 3D object may comprise several types of material (e.g., an elemental metal and an alloy, an alloy and a ceramic, an alloy and an elemental carbon). In certain embodiments each type of material comprises only a single member of that type. For example: a single member of elemental metal (e.g., iron), a single member of metal alloy (e.g., stainless steel), a single member of ceramic material (e.g., silicon carbide or tungsten carbide), or a single member of elemental carbon (e.g., graphite). In some cases, a layer of the 3D object comprises more than one type of material. In some cases, a layer of the 3D object comprises more than one member of a material type.

In some examples the material bed, platform, or both material bed and platform comprise a material type which constituents (e.g., atoms) readily lose their outer shell electrons, resulting in a free flowing cloud of electrons within their otherwise solid arrangement. In some examples the powder, the base, or both the powder and the base comprise a material characterized in having high electrical conductivity, low electrical resistivity, high thermal conductivity, or high density. The high electrical conductivity can be at least about 1*10⁵ Siemens per meter (S/m), 5*10⁵ S/m, 1*10⁶ S/m, 5*10⁶ S/m, 1*10⁷ S/m, 5*10⁷ S/m, or 1*10⁸ S/m. The symbol “*” designates the mathematical operation “times.” The high electrical conductivity can be between any of the aforementioned electrical conductivity values (e.g., from about 1*10⁵ S/m to about 1*10⁸ S/m). The thermal conductivity, electrical resistivity, electrical conductivity, and/or density can be measured at ambient temperature (e.g., at room temperature (R.T.), or 20° C.). The low electrical resistivity may be at most about 1*10⁻⁵ ohm times meter (Ω*m), 5*10⁻⁶ Ω*m, 1*10⁻⁶ Ω*m, 5*10⁻⁷ Ω*m, 1*10⁻⁷ Ω*m, 5*10⁻⁸ or 1*10⁻⁸ Ω*m. The low electrical resistivity can be between any of the aforementioned values (e.g., from about 1×10⁻⁵ Ω*m to about 1×10⁻⁸ Ω*m). The high thermal conductivity may be at least about 10 Watts per meter times degrees Kelvin (W/mK), 15 W/mK, 20 W/mK, 35 W/mK, 50 W/mK, 100 W/mK, 150 W/mK, 200 W/mK, 205 W/mK, 300 W/mK, 350 W/mK, 400 W/mK, 450 W/mK, 500 W/mK, 550 W/mK, 600 W/mK, 700 W/mK, 800 W/mK, 900 W/mK, or 1000 W/mK. The high thermal conductivity can be between any of the aforementioned thermal conductivity values (e.g., from about 20 W/mK to about 1000 W/mK). The high density may be at least about 1.5 grams per cubic centimeter (g/cm³), 1.7 g/cm³, 2 g/cm³, 2.5 g/cm³, 2.7 g/cm³, 3 g/cm³, 4 g/cm³, 5 g/cm³, 6 g/cm³, 7 g/cm³, 8 g/cm³, 9 g/cm³, 10 g/cm³, 11 g/cm³, 12 g/cm³, 13 g/cm³, 14 g/cm³, 15 g/cm³, 16 g/cm³, 17 g/cm³, 18 g/cm³, 19 g/cm³, 20 g/cm³, or 25 g/cm³. The high density can be any value between the afore mentioned values (e.g., from about 1 g/cm³ to about 25 g/cm³).

The elemental metal can be an alkali metal, an alkaline earth metal, a transition metal, a rare earth element metal, or another metal. The alkali metal can be Lithium, Sodium, Potassium, Rubidium, Cesium, or Francium. The alkali earth metal can be Beryllium, Magnesium, Calcium, Strontium, Barium, or Radium. The transition metal can be Scandium, Titanium, Vanadium, Chromium, Manganese, Iron, Cobalt, Nickel, Copper, Zinc, Yttrium, Zirconium, Platinum, Gold, Rutherfordium, Dubnium, Seaborgium, Bohrium, Hassium, Meitnerium, Ununbium, Niobium, Iridium, Molybdenum, Technetium, Ruthenium, Rhodium, Palladium, Silver, Cadmium, Hafnium, Tantalum, Tungsten, Rhenium or Osmium. The transition metal can be mercury. The rare earth metal can be a lanthanide or an actinide. The antinode metal can be Lanthanum, Cerium, Praseodymium, Neodymium, Promethium, Samarium, Europium, Gadolinium, Terbium, Dysprosium, Holmium, Erbium, Thulium, Ytterbium, or Lutetium. The actinide metal can be Actinium, Thorium, Protactinium, Uranium, Neptunium, Plutonium, Americium, Curium, Berkelium, Californium, Einsteinium, Fermium, Mendelevium, Nobelium, or Lawrencium. The other metal can be Aluminum, Gallium, Indium, Tin, Thallium, Lead, or Bismuth. The material may comprise a precious metal. The precious metal may comprise gold, silver, palladium, ruthenium, rhodium, osmium, iridium, or platinum. The material may comprise at least about 40%, 50%, 60%, 70%, 80%, 90%, 95%, 97%, 98%, 99%, 99.5% or more precious metal. The powder material may comprise at most about 40%, 50%, 60%, 70%, 80%, 90%, 95%, 97%, 98%, 99%, 99.5% or less precious metal. The material may comprise precious metal with any value in between the afore-mentioned values. The material may comprise at least a minimal percentage of precious metal according to the laws in the particular jurisdiction.

The metal alloy can comprise iron based alloy, nickel based alloy, cobalt based allow, chrome based alloy, cobalt chrome based alloy, titanium based alloy, magnesium based alloy, or copper based alloy. The alloy may comprise an oxidation or corrosion resistant alloy. The alloy may comprise a super alloy (e.g., Inconel). The super alloy may comprise Inconel 600, 617, 625, 690, 718 or X-750. The alloy may comprise an alloy used for aerospace applications, automotive application, surgical application, or implant applications. The metal may include a metal used for aerospace applications, automotive application, surgical application, or implant applications. The super alloy may comprise IN 738 LC, IN 939, Rene 80, IN 6203 (e.g., IN 6203 DS), PWA 1483 (e.g., PWA 1483 SX), or Alloy 247.

The material (e.g., alloy or elemental) may comprise a material used for applications in industries comprising aerospace (e.g., aerospace super alloys), jet engine, missile, automotive, marine, locomotive, satellite, defense, oil & gas, energy generation, semiconductor, fashion, construction, agriculture, printing, or medical. The material may comprise an alloy used for products comprising, devices, medical devices (human & veterinary), machinery, cell phones, semiconductor equipment, generators, engines, pistons, electronics (e.g., circuits), electronic equipment, agriculture equipment, motor, gear, transmission, communication equipment, computing equipment (e.g., laptop, cell phone, i-pad), air conditioning, generators, furniture, musical equipment, art, jewelry, cooking equipment, or sport gear. The material may comprise an alloy used for products for human or veterinary applications comprising implants, or prosthetics. The metal alloy may comprise an alloy used for applications in the fields comprising human or veterinary surgery, implants (e.g., dental), or prosthetics.

The alloy may include a high-performance alloy. The alloy may include an alloy exhibiting at least one of excellent mechanical strength, resistance to thermal creep deformation, good surface stability, resistance to corrosion, and resistance to oxidation. The alloy may include a face-centered cubic austenitic crystal structure. The alloy may comprise Hastelloy, Inconel, Waspaloy, Rene alloy (e.g., Rene-80, Rene-77, Rene-220, or Rene-41), Haynes alloy, Incoloy, MP98T, TMS alloy, MTEK (e.g., MTEK grade MAR-M-247, MAR-M-509, MAR-M-R41, or MAR-M-X-45), or CMSX (e.g., CMSX-3, or CMSX-4). The alloy can be a single crystal alloy.

In some instances, the iron-based alloy can comprise Elinvar, Fernico, Ferroalloys, Invar, Iron hydride, Kovar, Spiegeleisen, Staballoy (stainless steel), or Steel. In some instances, the metal alloy is steel. The Ferroalloy may comprise Ferroboron, Ferrocerium, Ferrochrome, Ferromagnesium, Ferromanganese, Ferromolybdenum, Ferronickel, Ferrophosphorus, Ferrosilicon, Ferrotitanium, Ferrouranium, or Ferrovanadium. The iron-based alloy may include cast iron or pig iron. The steel may include Bulat steel, Chromoly, Crucible steel, Damascus steel, Hadfield steel, High speed steel, HSLA steel, Maraging steel, Reynolds 531, Silicon steel, Spring steel, Stainless steel, Tool steel, Weathering steel, or Wootz steel. The high-speed steel may include Mushet steel. The stainless steel may include AL-6XN, Alloy 20, celestrium, marine grade stainless, Martensitic stainless steel, surgical stainless steel, or Zeron 100. The tool steel may include Silver steel. The steel may comprise stainless steel, Nickel steel, Nickel-chromium steel, Molybdenum steel, Chromium steel, Chromium-vanadium steel, Tungsten steel, Nickel-chromium-molybdenum steel or Silicon-manganese steel. The steel may be comprised of any Society of Automotive Engineers (SAE) grade such as 440F, 410, 312, 430, 440A, 440B, 440C, 304, 305, 304L, 304L, 301, 304LN, 301LN, 2304, 316, 316L, 316LN, 316, 316LN, 316L, 316L, 316, 317L, 2205, 409, 904L, 321, 254SMO, 316Ti, 321H or 304H. The steel may comprise stainless steel of at least one crystalline structure selected from the group consisting of austenitic, superaustenitic, ferritic, martensitic, duplex and precipitation-hardening martensitic. Duplex stainless steel may be lean duplex, standard duplex, super duplex or hyper duplex. The stainless steel may comprise surgical grade stainless steel (e.g., austenitic 316, martensitic 420 or martensitic 440). The austenitic 316 stainless steel may include 316L or 316LVM. The steel may include 17-4 Precipitation Hardening steel (also known as type 630 is a chromium-copper precipitation hardening stainless steel; 17-4PH steel). The stainless steel may comprise 360L stainless steel.

The titanium-based alloys may include alpha alloys, near alpha alloys, alpha and beta alloys, or beta alloys. The titanium alloy may comprise grade 1, 2, 2H, 3, 4, 5, 6, 7, 7H, 8, 9, 10, 11, 12, 13, 14, 15, 16, 16H, 17, 18, 19, 20, 21, 2, 23, 24, 25, 26, 26H, 27, 28, 29, 30, 31, 32, 33, 34, 35, 36, 37, 38 or higher. In some instances the titanium base alloy includes TiAl₆V₄ or TiAl₆Nb₇.

The Nickel based alloy may include Alnico, Alumel, Chromel, Cupronickel, Ferronickel, German silver, Hastelloy, Inconel, Monel metal, Nichrome, Nickel-carbon, Nicrosil, Nisil, Nitinol, or Magnetically “soft” alloys. The magnetically “soft” alloys may comprise Mu-metal, Permalloy, Supermalloy, or Brass. The Brass may include nickel hydride, stainless or coin silver. The cobalt alloy may include Megallium, Stellite (e. g. Talonite), Ultimet, or Vitallium. The chromium alloy may include chromium hydroxide, or Nichrome.

The aluminum-based alloy may include AA-8000, Al—Li (aluminum-lithium), Alnico, Duralumin, Hiduminium, Kryron Magnalium, Nambe, Scandium-aluminum, or, Y alloy. The magnesium alloy may be Elektron, Magnox or T—Mg—Al—Zn (Bergman phase) alloy. At times, the material excludes at least one aluminum-based alloy (e.g., AlSi₁₀Mg).

The copper based alloy may comprise Arsenical copper, Beryllium copper, Billon, Brass, Bronze, Constantan, Copper hydride, Copper-tungsten, Corinthian bronze, Cunife, Cupronickel, Cymbal alloys, Devarda's alloy, Electrum, Hepatizon, Heusler alloy, Manganin, Molybdochalkos, Nickel silver, Nordic gold, Shakudo or Tumbaga. The Brass may include Calamine brass, Chinese silver, Dutch metal, Gilding metal, Muntz metal, Pinchbeck, Prince's metal, or Tombac. The Bronze may include Aluminum bronze, Arsenical bronze, Bell metal, Florentine bronze, Guanin, Gunmetal, Glucydur, Phosphor bronze, Ormolu or Speculum metal. The elemental carbon may comprise graphite, Graphene, diamond, amorphous carbon, carbon fiber, carbon nanotube, or fullerene.

The powder material (also referred to herein as a “pulverous material”) may comprise a solid comprising fine particles. The powder may be a granular material. The powder can be composed of individual particles. At least some of the particles can be spherical, oval, prismatic, cubic, or irregularly shaped. At least some of the particles can have a fundamental length scale (e.g., diameter, spherical equivalent diameter, length, width, or diameter of a bounding sphere). The fundamental length scale (abbreviated herein as “FLS”) of at least some of the particles can be from about 1 nanometers (nm) to about 1000 micrometers (microns), 500 microns, 400 microns, 300 microns, 200 microns, 100 microns, 50 microns, 40 microns, 30 microns, 20 microns, 10 microns, 1 micron, 500 nm, 400 nm, 300 nm, 200 nm, 100 nm, 50 nm, 40 nm, 30 nm, 20 nm, 10 nm, or 5 nm. At least some of the particles can have a FLS of at least about 1000 micrometers (microns), 500 microns, 400 microns, 300 microns, 200 microns, 100 microns, 50 microns, 40 microns, 30 microns, 20 microns, 10 microns, 1 micron, 500 nm, 400 nm, 300 nm, 200 nm, 100 nm, 50 nm, 40 nm, 30 nm, 20 nm, 10 nm, 5 nanometers (nm) or more. At least some of the particles can have a FLS of at most about 1000 micrometers (microns), 500 microns, 400 microns, 300 microns, 200 microns, 100 microns, 50 microns, 40 microns, 30 microns, 20 microns, 10 microns, 1 micron, 500 nm, 400 nm, 300 nm, 200 nm, 100 nm, 50 nm, 40 nm, 30 nm, 20 nm, 10 nm, 5 nm or less. In some cases, at least some of the powder particles may have a FLS in between any of the afore-mentioned FLSs.

The powder can be composed of a homogenously shaped particle mixture such that all of the particles have substantially the same shape and FLS magnitude within at most about 1%, 5%, 8%, 10%, 15%, 20%, 25%, 30%, 35%, 40%, 50%, 60%, 70%, or less distribution of FLS. In some cases, the powder can be a heterogeneous mixture such that the particles have variable shape and/or FLS magnitude. In some examples, at least about 30%, 40%, 50%, 60%, or 70% (by weight) of the particles within the powder material have a largest FLS that is smaller than the median largest FLS of the powder material. In some examples, at least about 30%, 40%, 50%, 60%, or 70% (by weight) of the particles within the powder material have a largest FLS that is smaller than the mean largest FLS of the powder material.

In some examples, the size of the largest FLS of the transformed material (e.g., height) is greater than the average largest FLS of the powder material by at least about 1.1 times, 1.2 times, 1.4 times, 1.6 times, 1.8 times, 2 times, 4 times, 6 times, 8 times, or 10 times. In some examples, the size of the largest FLS of the transformed material is greater than the median largest FLS of the powder material by at most about 1.1 times, 1.2 times, 1.4 times, 1.6 times, 1.8 times, 2 times, 4 times, 6 times, 8 times, or 10 times. The powder material can have a median largest FLS that is at least about 1 μm, 5 μm, 10 μm, 20 μm, 30 μm, 40 μm, 50 μm, 100 μm, or 200 μm. The powder material can have a median largest FLS that is at most about 1 μm, 5 μm, 10 μm, 20 μm, 30 μm, 40 μm, 50 μm, 100 μm, or 200 μm. In some cases, the powder particles may have a FLS in between any of the FLS listed above (e.g., from about 1 μm to about 200 μm, from about 1 μm to about 50 μm, or from about 5 μm to about 40 μm).

The methods for generating a 3D object described herein may comprise: a) depositing a layer of pre-transformed material in an enclosure; b) providing energy (e.g., using an energy beam) to a portion of the layer of material according to a path; c) transforming at least a section of the portion of the layer of pre-transformed material to form a transformed material by utilizing the energy (e.g., radiative energy); d) allowing the transformed material to harden into a hardened material; and e) optionally repeating operations a) to d) to generate the 3D object. The enclosure may comprise a building platform (e.g., a substrate and/or base). The enclosure may comprise a container. The 3D object may be printed adjacent to (e.g., above) the building platform. The pre-transformed material may be deposited in the enclosure by a material dispensing system to form a layer of pre-transformed material within the enclosure. The deposited material may be leveled by a leveling mechanism. The leveling mechanism may comprise a leveling operation where the leveling mechanism does not contact the exposed surface of the material (e.g., powder) bed. The material (e.g., powder) dispensing system may comprise one or more dispensers. The material dispensing system may comprise at least one material (e.g., bulk) reservoir. The material may be deposited by a layer dispensing mechanism (e.g., recoater). The layer dispensing mechanism may level the dispensed material without contacting the powder bed (e.g., the top surface of the powder bed). The layer dispensing mechanism may include any layer dispensing mechanism and/or a powder dispenser used in 3D printing such as, for example, the ones disclosed in application number PCT/US15/36802 titled “APPARATUSES, SYSTEMS AND METHODS FOR 3D PRINTING” that was filed on Jun. 19, 2015, or in Provisional Patent Application Ser. No. 62/317,070 filed on Apr. 1, 2016, titled “APPARATUSES, SYSTEMS AND METHODS FOR EFFICIENT THREE-DIMENSIONAL PRINTING,” each of which is entirely incorporated herein by reference.

The layer dispensing mechanism may include components comprising a material dispensing mechanism, material leveling mechanism, material removal mechanism, or any combination thereof. The layer dispensing mechanism and any of its components may be any layer dispensing mechanism (e.g., used in 3D printing) such as, for example, the one described in patent application serial number PCT/US15/36802, or in Provisional Patent Application Ser. No. 62/317,070, each of which is entirely incorporated herein by reference.

In some embodiments, the formation of the 3D object includes transforming (e.g., fusing, binding or connecting) the pre-transformed material (e.g., powder material) using an energy beam. The energy beam may be projected on to a particular area of the material bed, thus causing the pre-transformed material to transform. The energy beam may cause at least a portion of the pre-transformed material to transform from its present state of matter to a different state of matter. For example, the pre-transformed material may transform at least in part (e.g., completely) from a solid to a liquid state. The energy beam may cause at least a portion of the pre-transformed material to chemically transform. For example, the energy beam may cause chemical bonds to form or break. The chemical transformation may be an isomeric transformation. The transformation may comprise a magnetic transformation or an electronic transformation. The transformation may comprise coagulation of the material, cohesion of the material, or accumulation of the material.

The methods described herein may further comprise repeating the operations of material deposition and material transformation operations to produce a 3D object (or a portion thereof) by at least one 3D printing (e.g., additive manufacturing) method. For example, the methods described herein may further comprise repeating the operations of depositing a layer of pre-transformed material and transforming at least a portion of the material to connect to the previously formed 3D object portion (i.e., repeating the printing cycle), thus forming at least a portion of a 3D object. The transforming operation may comprise utilizing an energy beam to transform the material. In some instances, the energy beam is utilized to transform at least a portion of the material bed (e.g., utilizing any of the methods described herein).

In an aspect provided herein is a method for generating a 3D object comprising: a) depositing a layer of pre-transformed material in an enclosure; b) providing a first energy to a portion of the layer of pre-transformed material according to a first path; c) transforming at least a section of the portion of the layer of pre-transformed material to form a transformed material by utilizing the first energy; d) allowing the transformed material to harden into a hardened material that forms at least a portion of a 3D object (e.g., through energy depletion). The first energy provided to the portion of the layer of pre-transformed material may transform the material. The transformed material may subsequently harden into a hardened material. Some of the provided energy (e.g., heat) may be depleted from the transformed material or from the hardened material. The manner of energy depletion may depend on the structure of the transformed (e.g., and/or of the hardened material). The structure may comprise the geometry, FLS (e.g., width, length, or height), or volume. The manner may comprise the rate (flux) of energy depletion, or the direction of energy depletion. The manner may include flux of energy depleted per unit volume of transformed (e.g., and/or hardened material). The manner of energy depletion may depend on the nature of the material (e.g., type or types of material in the pre-transformed, transformed and/or hardened material). The manner of energy depletion may depend on proximity to previously hardened material (e.g., a previous layer of hardened material). For example, the transformed material may attach to a hardened material (e.g., transformed material that was previously hardened), and deplete though the hardened material. The transformed material may attach to a second transformed material and deplete though the second transformed material. Energy depletion may comprise depletion though the pre-transformed material, depletion though the transformed material, and/or depletion through the hardened material. Depletion of energy may comprise cooling. Various sections of the transformed and/or hardened material may have different energy depletion rates. Various sections of the transformed and/or hardened material may have different hindrance (e.g., resistance) to the energy depletion. The factors that affect the degree of hindrance (e.g., resistance) to energy depletion may include the factors that affect the depletion energy, as mentioned herein. The manner of transforming the pre-transformed material may affect the rate of energy depletion, or conversely the hindrance (e.g., resistance) to energy depletion. The manner of transforming the pre-transformed material may include various characteristics of the energy beam which comprises the transforming energy. These energy beam characteristics may include the path by which the transforming energy beam travels along the layer of pre-transformed material within the material bed. These energy beam characteristics may include the intensity of the energy beam, FLS of the energy beam (e.g., cross section thereof), energy flux of the energy beam. In some methods disclosed herein, the operation of providing energy (e.g., providing a first energy to a portion of the layer of material (e.g., powder) according to a first path) may be performed in a manner that will compensate for a difference in the energy depletion rate from the transformed material or from the hardened material within the layer of material (e.g., powder). Hardened material may comprise material that has been fused, melted, connected or bound, and that subsequently hardened (e.g., solidified). Fused may comprise melted or sintered. The hardened material may comprise a solid, semi solid, or gel material. The hardened material may comprise a solid material. The hardened material may comprise a fused material that subsequently solidified. The hardened material may comprise a dense material. The hardened material may comprise a porous material. Hardened may be solidified. Hardened may comprise at least one solidified material. The deposited pre-transformed material in the material bed may comprise a powder material.

The transformed material may be allowed to deplete the energy (e.g., cool) prior to, during, and/or subsequent to the deposition of a subsequent layer of pre-transformed material. The transformed material may be allowed to deplete the energy prior to, during, and/or subsequent to the transformation of a subsequent layer of pre-transformed material. The pre-transformed material before, during, and/or after transformation may be cooled. The energy depletion (e.g., cooling) may comprise using a cooling mechanism (e.g., a heat sink) or cooled gas. The cooling gas may flow across the layer of pre-transformed material (e.g., above the exposed surface of the material bed) before, during, and/or after transforming at least a portion of the material bed. The transformed material within each layer of pre-transformed material in the material bed may be allowed to deplete the energy at the same rate. The transformed material within each layer of pre-transformed material in the material bed may be allowed to deplete the energy at a varied rate.

In another aspect, a method for generating a 3D object comprises: a) depositing a layer of pre-transformed material in a material bed situated within an enclosure to form a material bed; b) providing a first energy (e.g., beam) to a portion of the material bed (e.g., a portion of the layer of pre-transformed material) according to a first path; c) transforming at least a section of the material bed to form a transformed material by utilizing the energy (e.g., beam); d) allowing the transformed material to harden into a hardened material that forms at least a portion of a 3D object through energy depletion (e.g., cooling); and wherein the providing energy in b) is dependent on the density of material. The operation of providing energy in b) may dependent on the density of material within the material bed (e.g. the layer of pre-transformed material). The layer of pre-transformed material can comprise a powder material. The operation of providing energy in b) may further depend on the density of material situated beneath the layer of pre-transformed material, beneath the transformed material, and/or beneath the hardened material. The operation of providing energy in b) may further depend on the density of material situated directly beneath the layer of pre-transformed material, beneath the transformed material, and/or beneath the hardened material. The material situated beneath the layer of pre-transformed material, beneath the transformed material, and/or beneath the hardened material may be a remainder of the material (e.g., powder material) that did not transform to form at least a portion of the 3D object, the transformed material, or the hardened material (herein, the “remainder”).

In some examples, the remainder does not comprise a continuous structure extending over at least about 1 millimeter (mm), 2 mm, 3 mm, 5 mm, 6 mm, 7 mm, 8 mm, 9 mm, or 10 mm. In some examples, the remainder does not comprise a continuous structure extending over at most about 1 millimeter (mm), 2 mm, 3 mm, 5 mm, 6 mm, 7 mm, 8 mm, 9 mm, 10 mm, or the FLS of the material bed. In some examples, the remainder does not comprise a continuous structure extending over any value between the afore-mentioned continuous structure values (e.g., from about 1 mm to the FLS of the material bed, from about 2 mm to abut the FLS of the material bed, from about 3 mm to the FLS of the material bed, from about 5 mm to the FLS of the material bed, from about 10 mm to abut the FLS of the material bed, or from about 15 mm to the FLS of the material bed). In some examples, the material situated beneath the layer of pre-transformed material, beneath the transformed material, and/or beneath the hardened material may be the remainder that was not transformed. The material situated beneath the layer of pre-transformed material, beneath the transformed material, and/or beneath the hardened material may be a powder material. Beneath may be directly beneath or indirectly beneath. Indirectly beneath may include additional layers of material.

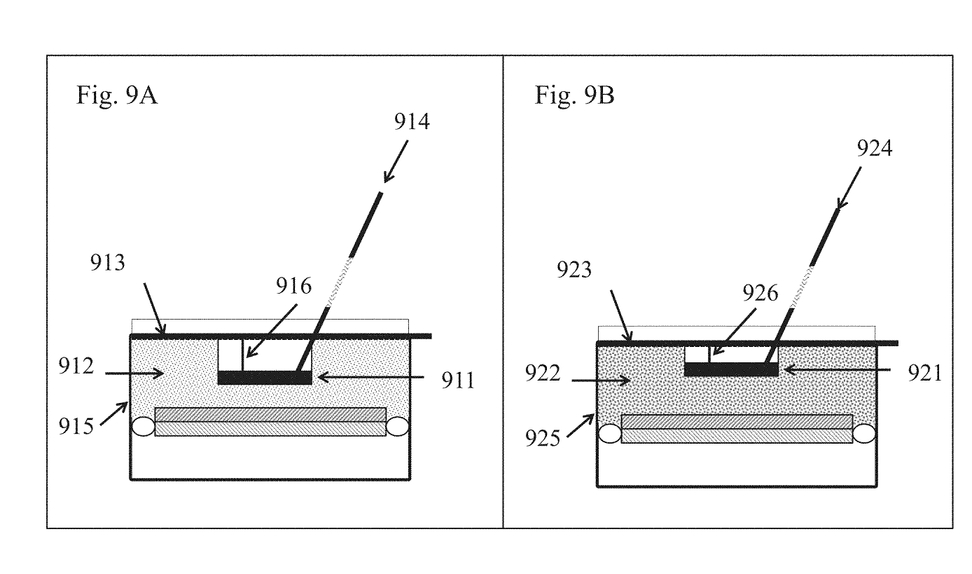

The operation of providing energy in b) may depend on the density of pre-transformed material within the material bed. The density of the pre-transformed material may be at least about 20%, 30%, 40%, 50%, 60%, 70%, 80%, or 90 percent (%) material. The density of the pre-transformed material (e.g., powder) may be at most about 20%, 30%, 40%, 50%, 60%, 70%, 80%, or 90 percent (%) material. The density of the pre-transformed material may be any value between the afore-mentioned percentages of pre-transformed material (e.g., the percent may be from about 40% to about 80%, from about 50% to about 70%, from about 30% to about 60%, or from about 40% to about 70% material). The percent may be a weight-by-weight or a volume-by-volume percent. In some instances, the layer of pre-transformed material forms an average top surface, and the transformed material form a gap (e.g., vertical gap) having a first height from that top surface. In some instances, the transformed material sinks into a position having a first height relative to that top surface. The sunken position may be within the layer of pre-transformed material (e.g., powder in the powder bed), or at least partially within a previously deposited layer of pre-transformed material. The first height may depend on the density of the material within the pre-transformed material layer. The first height may depend on the characteristics of the energy or the characteristics of the energy beam as described herein. The first height may depend on the density of the pre-transformed material within the pre-transformed material layer. The methods described herein may compensate for the formation of the first height (e.g., compensate for the sinking). FIGS. 9A-9B schematically illustrate differences in the first height on transforming a pre-transformed material (e.g., powder). For example, FIG. 9A shows a relatively loose powder 912 in a powder bed 915. Upon transformation of the loose powder material 912 into a transformed material 911, a void having a relatively large first height 916 is formed with respect to the average top layer surface 913. FIG. 9B shows a relatively dense powder 922 in a powder bed 925. Upon transformation of the dense powder material 922 into a transformed material 921, a void having a relatively small first height 926 has been formed with respect to the average top layer surface 923.

The transforming energy (e.g., the first energy) may be provided by an energy source. The transforming energy may comprise an energy beam. The energy source can produce an energy beam. The energy beam may include a radiation comprising electromagnetic, electron, positron, proton, plasma, or ionic radiation. The electromagnetic beam may comprise microwave, infrared, ultraviolet, or visible radiation. The ion beam may include a charged particle beam. The ion beam may include a cation, or an anion. The electromagnetic beam may comprise a laser beam. The laser may comprise a fiber, or a solid-state laser beam. The energy source may include a laser. The energy source may include an electron gun. The energy depletion may comprise heat depletion. The energy depletion may comprise cooling. The energy may comprise an energy flux (e.g., energy beam. E.g., radiated energy). The energy may comprise an energy beam. The energy may be the transforming energy. The energy may be a warming energy that is not able to transform the deposited pre-transformed material (e.g., in the material bed). The warming energy may be able to raise the temperature of the deposited pre-transformed material. The energy beam may comprise energy provided at a (e.g., substantially) constant or varied energy beam characteristics. The energy beam may comprise energy provided at (e.g., substantially) constant or varied energy beam characteristics, depending on the position of the generated hardened material within the 3D object. The varied energy beam characteristics may comprise energy flux, rate, intensity, wavelength, amplitude, power, cross-section, or time exerted for the energy process (e.g., transforming or heating). The energy beam cross-section may be the average (or mean) FLS of the cross section of the energy beam on the layer of material (e.g., powder). The FLS may be a diameter, a spherical equivalent diameter, a length, a height, a width, or diameter of a bounding circle. The FLS may be the larger of a length, a height, and a width of a 3D form. The FLS may be the larger of a length and a width of a substantially two dimensional (2D) form (e.g., wire, or 3D surface).

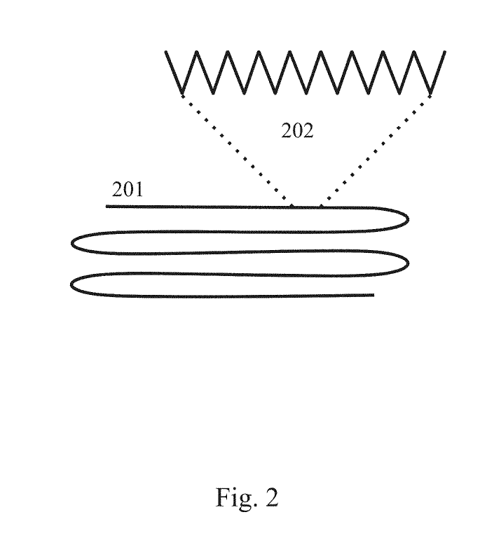

The path of the energy beam (e.g., the first path) may follow a direction that is susceptible to deformation (e.g., when forming a transformed and/or hardened material). The deformation may comprise bending (e.g., warping, curving, or twisting). The deformation may include geometric distortion. The deformation may include internal deformation. Internal may be within the 3D object or a portion thereof. The deformation may include a change in the material properties. The deformation may be disruptive (e.g., for the intended purpose of the 3D object). The deformation may comprise a geometric deformation. The deformation may comprise inconsistent material properties. The deformation may occur before, during, and/or after hardening of the transformed material. The deformation may comprise balling. The path of the energy beam (e.g., the first path) may follow a direction that is susceptible to deviation from a plane, for example, from the plane of the deposited pre-transformed material. The path of the energy beam may be a vector. The path of the energy beam may comprise a raster, a vector, or any combination thereof. Deviation may comprise deviation from a structural dimension or from desired material characteristics. The path of the energy beam may comprise an oscillating pattern. The path of the energy beam may comprise a zigzag, wave (e.g., curved, triangular, or square), or curve pattern. The curved wave may comprise a sine or cosine wave. The path of the energy beam may comprise a sub-pattern. The path of the energy beam may comprise an oscillating (e.g., zigzag), wave (e.g., curved, triangular, or square), and/or curved sub-pattern. The curved wave may comprise a sine or cosine wave. FIG. 2 shows an example of a path 201 of an energy beam comprising a zigzag sub-pattern (e.g., 202 shown as a blow up of a portion of the path 201). The sub-path of the energy beam may comprise a wave (e.g., sine or cosine wave) pattern. The sub-path may be a small path that forms the large path. The sub-path may be a component (e.g., a portion) of the large path. The path that the energy beam follows (e.g., the first path) may be a predetermined path. A model may predetermine the path by utilizing a controller or an individual. The controller may comprise a processor. The processor may comprise a computer, computer program, drawing or drawing data, statue or statue data, or by any combination thereof.

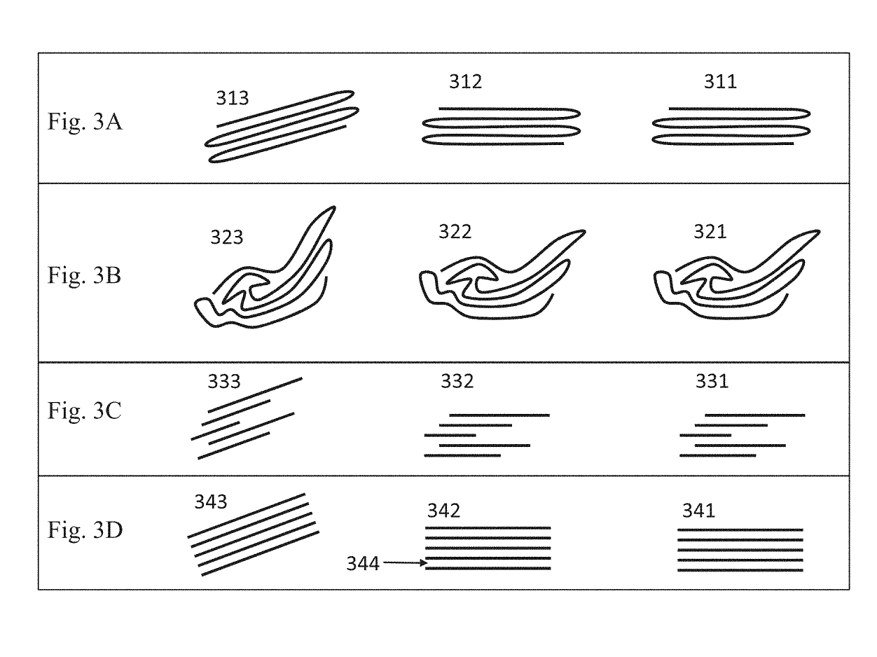

The path can comprise successive lines. The successive lines may touch each other. The successive lines may overlap each other in at least one point. The successive lines may substantially overlap each other. The successive lines may be spaced by a first distance (e.g., hatch spacing). FIG. 3 shows an example of a path 342 that includes five hatches wherein each two immediately adjacent hatches are separated by a spacing distance (e.g., 344). The first distance may vary depending on the position of the generated hardened material within the 3D object. The hatch spacing may be at least 10 mm, 9 mm, 8 mm, 7 mm, 6 mm, 5 mm, 4 mm, 3 mm, 2 mm, 1 mm, 500 micrometers (μm), 400 μm, 300 μm, 200 μm, 100 μm, 90 μm, 80 μm, 70 μm, 60 μm, 50 μm, 40 μm, 30 μm, 20 μm, 10 μm, 5 μm, or 1 μm. The hatch spacing may be at most 10 mm, 9 mm, 8 mm, 7 mm, 6 mm, 5 mm, 4 mm, 3 mm, 2 mm, 1 mm, 500 micrometers (μm), 400 μm, 300 μm, 200 μm, 100 μm, 90 μm, 80 μm, 70 μm, 60 μm, 50 μm, 40 μm, 30 μm, 20 μm, 10 μm, 5 μm, or 1 μm. The hatch spacing may any value between the afore-mentioned first distance values (e.g., from about 1 μm to about 10 mm, or from about 1 μm to about 50 μm). In some examples, an angle between successive lines is varied depending on the position of the generated hardened material within the 3D object. The acute angle between successive lines may be at most 5°, 10°, 15°, 20°, 30°, 40°, 50°, 60°, 70°, 80°, or 85 degrees)(°. The acute angle between successive lines may be at least 5°, 10°, 15°, 20°, 30°, 40°, 50°, 60°, 70°, 80°, or 85°. The acute angle between successive lines may be any angle value between the afore-mentioned acute angle values (e.g., from about 5° to about 85°, or from about 40° to about 80°). The angle can be a planar angle or a compound angle.

In another aspect, a method for generating a 3D object comprises: a) depositing a layer of a first pre-transformed material in an enclosure to form a material bed; b) providing a first energy to a first portion of the layer of the material bed according to a first path set comprising a first set of disconnected paths; c) transforming at least a section of the material bed within the first path set to form a first transformed material tile set by utilizing the first energy; d) allowing the first transformed material tile set to harden into a first hardened material tile set that forms at least a portion of the 3D object; e) providing a second energy to a second portion of the material bed according to a second path set comprising second set of disconnected paths, wherein the second path set is situated within at least one gap between the first set of disconnected paths sections; f) transforming the second portion of the material bed within the second path set to form a second transformed material tile set by utilizing the second energy; and g) allowing the second transformed material tile set to harden into a second hardened material tile set that forms at least a portion of a 3D object. The path set may comprise line sections (e.g., hatches). The line sections (e.g., hatch lines) may be parallel line sections. The parallel line sections of the first set and of the second set may be of the same angle. The parallel line sections of the first set and of the second set may be of a varied angle. An angle Gamma may be formed between the parallel line sections of the first set and of the parallel line sections of the second set. Gamma may be different than 0°, 180°, or 360°. Gamma may be between 0° and 180° excluding 0° and 180°. Gamma may be between 180° and 360° degrees excluding 180° and 360°. The gap can comprise a hole. The gap can comprise a line section. The gap can be a hole or a line section. The line sections may be situated at an angle with respect to the layering plane of the first hardened material. The lines can be situated substantially perpendicular to the layering plane of the first hardened material. The lines may be situated within the layering plane of the first hardened material. The first hardened material tile set and the second hardened material tile set may differ in their material structure. The first energy and the second energy may comprise substantially the same energy (e.g., beam). The first energy and the second energy may differ by at least one energy (e.g., beam) characteristics. The energy (e.g., beam) characteristics can comprise the energy density, the rate at which the energy travels along the path, the FLS of the energy projection on the layer of the material. The first energy may comprise a first energy beam. The second energy may comprise a second energy beam. The energy beam may have any of the energy characteristics disclosed herein. The first energy beam, second energy beam, or both, may have varied energy beam characteristics. The energy beam characteristics may vary as disclosed herein. For example, the energy beam may vary in the FLS of the energy beam that is projected onto the layer of pre-transformed material (e.g., powder) within the material bed, the time during which the energy beam is projected on to the layer of material, the rate at which the energy is projected on to the layer of material, the pattern by which the energy can be projected on to the layer of material. The FLS of the energy beam may be altered by a focus-shifting device, by a mask (e.g., a diffractive mask, or a refractive phase mask), or by any combination thereof. The FLS of the energy beam may be altered by a tube lens, by a micro lens, or any combination thereof. The pattern can comprise oscillation in energy intensity, frequency, wavelength, power, or amplitude. The first energy and the second energy can derive from the same energy source. The first energy and the second energy can derive from different energy sources. The first path set and the second path set can comprise an overlapping path section. The first path set and the second path set may be distinct. The first transformed material can comprise energy depletion though the layer of pre-transformed material (e.g., powder) within the material bed. The first transformed material can comprise energy depletion though the layer of pre-transformed material. The first transformed material can comprise energy depletion though the layer of pre-transformed powder material. The first transformed material can comprise energy depletion though the first hardened material. The second hardened material can nest within the first hardened material. At least one section of the second hardened material can nest within at least one section of the first hardened material. The first hardened material can comprise the bulk of material within the 3D object. At times, the second hardened material does not form the bulk of the 3D object. The bulk may comprise the majority of hardened material within the 3D object. The bulk may comprise at least 95%, 90%, 85%, 80%, 75%, 70%, 65%, 60%, 55%, or 50% of the 3D object. The bulk may comprise at most 95%, 90%, 85%, 80%, 75%, 70%, 65%, 60%, 55%, or 50% of the 3D object. The bulk may comprise any percentages between the afore-mentioned percentages. The percentages may be weight-by-weight percentages. The percentages may be volume-by-volume percentages. The second hardened material can reinforce the structure formed by the first hardened material. The second hardened material can reinforce the 3D object. The second hardened material may vary by at least one material characteristic from the first hardened material. The material characteristics may comprise crystal structure, microstructure, grain structure, melt pool structure, metallurgical structure (e.g., dendrite structure or cell structure), metallurgical composition, crystal composition, or material density.

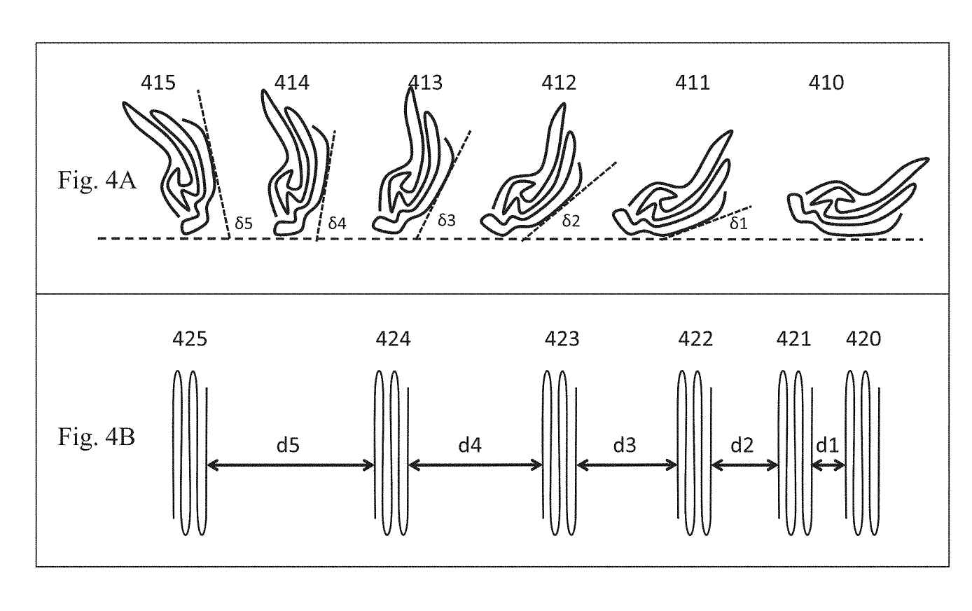

The 3D object may comprise a plane like structure (referred to herein as “planar object,” “three dimensional plane,” or “3D plane”). The 3D plane may have a relatively small width as opposed to a relatively large surface area. The 3D plane may have a relatively small height as opposed to a relatively width by length area. For example, the 3D plane may have a small height relative to a large horizontal plane. FIG. 4B shows an example of a 3D plane that is planar (e.g., flat). The 3D plane may be planar, curved, or assume an amorphous 3D shape. The 3D plane may be a strip, a blade, or a ledge. The 3D plane may comprise a curvature. The 3D plane may be curved. The 3D plane may be planar (e.g., flat). The 3D plane may have a shape of a curving scarf. The term “3D plane” is understood herein to be a generic (e.g., curved) 3D surface. For example, the 3D plane may be a curved 3D surface.

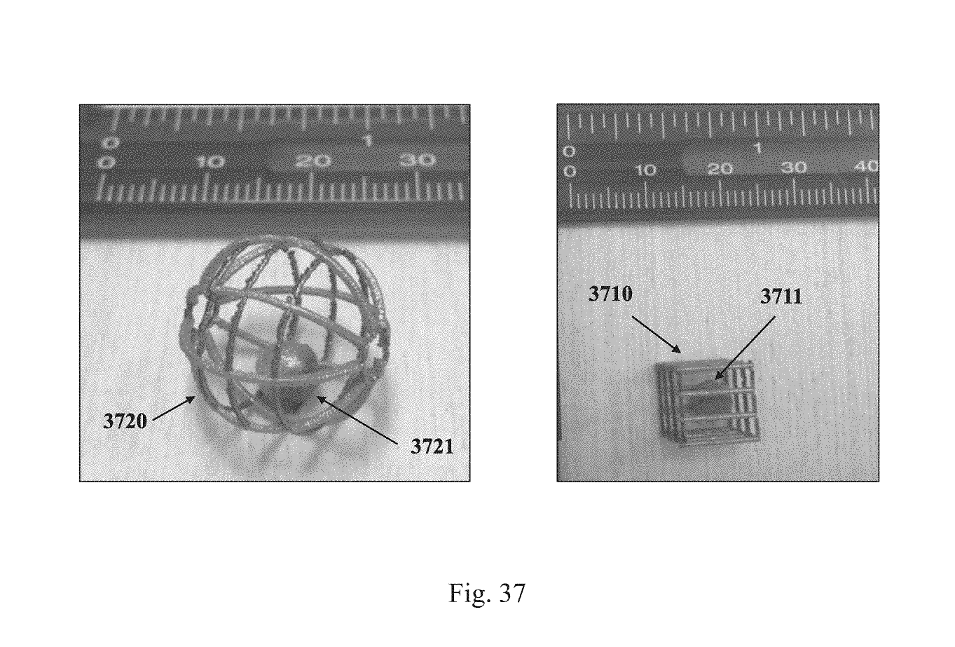

The desired 3D object may comprise a multiplicity of 3D object of which a first 3D object is nested within a second 3D object. The first 3D object may be an internal 3D object. The second 3D object may be an external 3D object. The external 3D object may comprise a cavity that accommodates the internal 3D object at least in part (e.g., entirely). The internal 3D object may contact the external 3D object. In some embodiments, the internal 3D object connects to (e.g., anchor to, cling to, or attach to) the external 3D object. The nested (e.g., internal) 3D object may be enclosed within a second (e.g., external) 3D object at least in part (e.g., fully enclosed). The enclosed 3D object (or enclosed portion thereof) may freely float anchorlessly within the external 3D object. The enclosed 3D object may itself comprise a nested 3D object. The external 3D object may itself be enclosed within a 3D object at least in part. The external and/or internal 3D object may comprise a wire. The external and/or internal 3D object may comprise a 3D plane. FIG. 37 shows an example of a cubical external 3D object 3710 that is comprised of wires, and encloses a second globular 3D object 3711 that is fully enclosed within the external 3D object 3710. FIG. 37 shows an example of a globular external 3D object 3720 that is comprised of wires, and encloses a second globular 3D object 3721 that is fully enclosed within the external 3D object 3720. The internal globular objects shown in the example of FIG. 37 (e.g., 3711 and 3721) float freely and anchorlessly within their respective external 3D objects (e.g., 3710 and 3720 respectively). In some embodiments, the external 3D object is anchored to the enclosure (e.g., platform) during its formation. In some embodiments, the external 3D object not anchored to the enclosure (e.g., platform) during its formation. The external 3D object may comprise, or be devoid of auxiliary support. The internal 3D object may be devoid of auxiliary support. At times, the internal 3D object is enclosed at least in part within the first 3D object. The portion of the 3D object that is enclosed within the first 3D object may be devoid of auxiliary support. The portion of the 3D object that external to the first 3D object may comprise auxiliary support.

The energy beam may follow a path. The path may correspond to a slice of the desired 3D object. The path may travel in at least a portion of a layer of pre-transformed material. The energy beam that follows the path may form a transformed material from at least a portion of the material bed. The layer of pre-transformed material may harden into a layer of hardened material. The path of the energy beam in a subsequent layer (e.g., in a second, third, and/or forth, etc. layer) may follow the same path that the energy beam passed in a previous layer (e.g., of pre-transformed material, and/or to form the layer of hardened material). Layer one may be the first printed layer (i.e., the “bottom skin” layer), any other layer designated as “layer one.” The paths of the energy beam in layer one and in a subsequent layer thereof may coincide, as viewed from above or from below the (e.g., average or mean) layering plane. The paths of the energy beam in layer one and in a subsequent layer thereof may coincide, as viewed from the normal to the (e.g., average or mean) layering plane. The paths of layer one and of the subsequent layer may be transposed relative to each other (e.g., as viewed from above, below, and/or normal to the (e.g., average or mean) layering plane). The transposition may be a vertical and/or horizontal transposition. At times, only a section of a plane of transformed (e.g., and subsequently hardened) material within the at least a portion of the 3D object may be transposed. The path transpositions in the successive layers may follow a pattern. The pattern may be a linear pattern. The pattern may be a non-linear pattern. In comparison with a 3D object produced without transposition of successive paths (e.g., with coinciding paths of each successively transformed layer in the at least a portion of the 3D object), the 3D object formed using any of the path transposition methods described herein may comprise at least one surface that is more leveled, smoother, with a lower degree of roughness, flatter, with a lower degree of warpage, with a lower degree of bending, with a larger radius of curvature, with a reduced degree of deformation, or any combination thereof. In comparison with a 3D object produced without transposition of the successive paths, the formation of valleys (e.g., rows of valleys) or ridges (e.g., rows of ridges) in at least one surface of the 3D object (or a portion thereof) are substantially reduced (e.g., or prevented) in the 3D object formed with path transposition. The at least one surface may be a top, bottom or side surface with respect to the building direction of the 3D object. In comparison to a 3D object produced without transposition of the successive paths, the 3D object formed using path transposition may comprise of at least one surface with lower degree of roughness, with lower Ra value, with lower degree of deviation from ideal flatness (e.g., molecular or atomic flatness), with smaller number of depressions per unit area, with smaller number of protrusions per unit area, or any combination thereof. In comparison to an object produced without transposition of the successive paths, the object formed using path transposition may be a denser object (3D object or a portion thereof), a less brittle object, an object with a lower percentage of holes, or any combination thereof. The path of the energy beam in a subsequent layer (e.g., in a second, third, fourth etc. layer) may follow a different path that the energy-beam in the first layer (e.g., bottom skin layer). The surface may comprise smoothing features that form an easily cleaned surface. The smoothing features may comprise lotus effect surface features or shark skin features. The surface may comprise scales or protrusions that allow the surface of the 3D object to remain clean (e.g., from debris, dust, and/or liquid).

A transforming path may be a path in which an energy (e.g., energy beam) travels to form a transformed material from at least a portion of the material bed. The transforming path can comprise a first segment that corresponds to the selected position of the 3D object and a second segment that corresponds to a portion of the 3D object that is distant from the selected position. The path lines in the first segment can differ in at least one path characteristics as compared to the path lines in the second segment. The path may comprise hatch lines. The hatch lines may be parallel hatch lines. At least two of the hatch lines (e.g., in a tile) may be parallel hatch lines. The path characteristics may comprise hatch line thickness, line spacing, or quantity of hatch lines per area. The path may comprise a contour. The path may be devoid of a contour. The path may comprise path sections. A path section may comprise a contour. A path section may be devoid of a contour. The existence or absence of the contour may depend on the position of the hardened material generated by the energy projected according to the path section within the 3D object. The formed contour (e.g., wire) may vary in its FLS, resolution, and/or length. The contour may be formed prior to hatching, after hatching, or during hatching of the internal tile area (e.g., the area of the tile that is not a rim). At times, the contour hatch line may smooth edges in a path segment (e.g., tile), or maintain their sharpness. The direction of the tile lines within the path segments can be the same in a layer of deposited pre-transformed material (e.g., powder material). The direction of the hatch lines within the path segments within a layer of deposited pre-transformed material (e.g., powder material) can be different. The (e.g., average) FLS of the contour (e.g., wire) may be larger than the (e.g., average) FLS of the hatch lines within the contour (e.g., tile interior). The (e.g., average) FLS of the contour (e.g., wire) may be smaller than the (e.g., average) FLS of the hatch lines within the contour.

At times, generating the 3D object comprises forming tiles. Tiles may be an area that is filled by a path including one or more hatch lines. FIGS. 3A-3D show example of tiles. For example, FIG. 3A shows an example of a tile 311 formed by a winding path line. For example, FIG. 3B shows an example of a tile 323 formed by a winding path line. For example, FIG. 3C shows an example of a tile 332 formed by multiple hatch lines that comprise a disconnected path. An energy beam may follow the tile path (e.g., path forming the tile). The energy beam may be a heating and/or transforming energy beam. In some instances, formation of a tile comprises transforming a pre-transformed material within the material bed. In some instances, formation of a tile comprises transforming a pre-transformed material within a first layer of hardened material (e.g., previously formed layer of hardened material or metal sheet). The first layer of hardened material may be the layer on which the transformed material tile is deposited. The formation of the transformed material tile can comprise transforming the pre-transformed material within the material bed and the hardened material within the first layer. For example, the transforming can comprise transforming any material (e.g., pre-transformed, or hardened) substantially within a horizontal cross section of the tile. At times, transforming the hardened material of a previous layer may comprise transforming a height of the first layer (e.g., bottom skin layer) that comprises a portion of the first layer height, or substantially the entire first layer height. At times, transforming the material of the first layer comprises transforming a height that is at least about 10%, 20%, 30%, 40%, 50%, 60%, 70%, 80%, 90%, or 100% of the first layer height. Transforming the material of the first layer can comprise transforming a height that is at most about 100%, 80%, 70%, 60%, 50%, 40%, 30%, 20%, 10%, or 5% of the first layer height. Transforming the material of the first layer may comprise transforming a height that corresponds to any percentage between the above-mentioned percentages (e.g., from about 5% to about 100%, from about 5% to about 50%, or from about 50% to about 100%). The first layer can be the first layer of hardened material and/or of pre-transformed material.

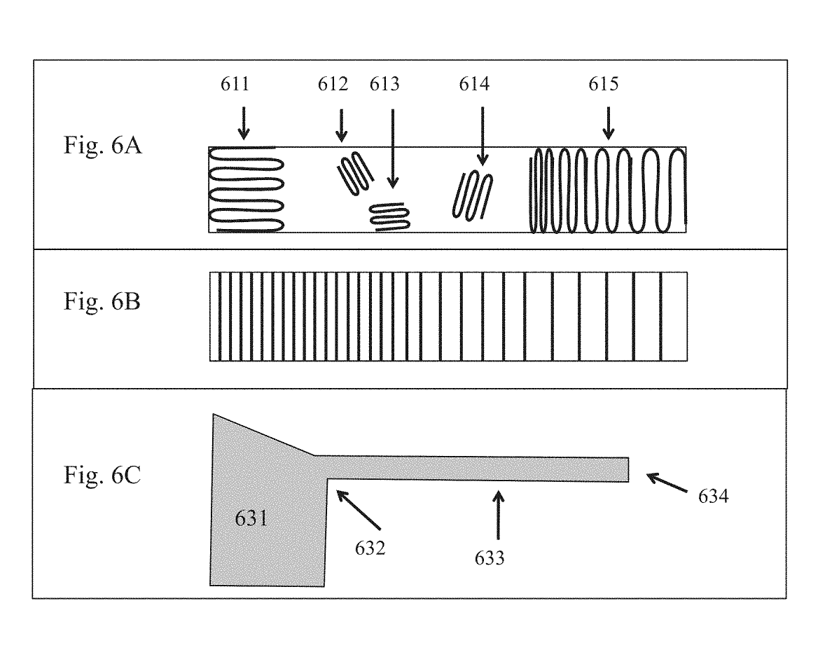

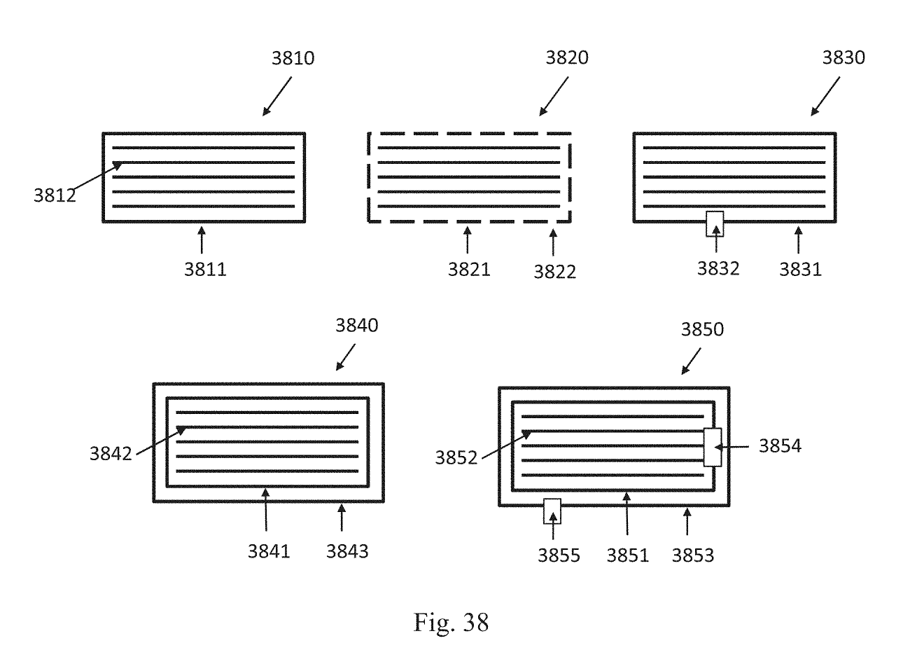

The path can be separated into at least two path tiles that are spaced by a first distance. The first distance may be larger than the FLS of a cross section of the energy beam. Each tile-path (e.g., FIG. 3A, 313) may comprise a hatch line. The path may comprise a hatch line. For example, FIG. 3A shows two tile-paths 311 and 312, each comprising its own respective hatch line, which hatch lines of the two tiles are separated by a hatch line spacing distance. Hatch lines may be parallel lines; for example, closely spaced parallel lines. FIG. 3D shows an example of parallel hatch lines within a tile 341. In some embodiments, the tile excludes a rim hatching (e.g., frame, or outline). FIG. 3D shows an example of parallel hatch lines within tile 332 that excludes a rim hatch line. In some embodiments, the rim is continuous. In some embodiments, the rim is discontinuous. The rim may comprise one or more gaps. The rim may be a discontinuous or a continuous rim. FIG. 38 shows examples of various tiles (e.g., 3810, 3820, and 3830), which comprise a rim. Tile 3810 shows an example of a tile having internal hatch lines (e.g., 3812) and a closed rim 3811. Tile 3820 shows an example of a tile having internal hatch lines and a dashed rim 3821 having a multiplicity of discontinuity positions (e.g., 3822). Tile 3830 shows an example of a tile having internal hatch lines and a rim 3831 having a small number of discontinuity positions (e.g., 3832). In some embodiments, multiple rim hatch lines may surround the interior hatch lines. At least one of the plurality of rim hatch lines may be continuous. At least one of the plurality of rim hatch lines may be discontinuous. Tile 3840 shows an example of a tile having internal hatch lines (e.g., 3842) and a plurality continuous rims 3841 and 3843. Tile 3850 shows an example of a tile having internal hatch lines (e.g., 3852) and a plurality discontinuous rims 3851 and 3853 having areas of discontinuity 3854 and 3855 respectively. The discontinuity positions may be at most about 50%, 40%, 30%, 20%, 10%, 5%, 1% of the tile circumference. The rim may be at least about 50%, 60%, 70%, 80%, 90%, 95%, 99%, or the entire tile circumference. In some embodiments, the tiles include a rim hatching. Examples for parallel hatch lines can be seen in FIGS. 3C (e.g., in tiles 331-333) and 3D (e.g., in tiles 341-343). The parallel hatch lines within a tile may vary in quantity, thickness, spacing, or in any combination thereof. The gap between at least two hatch lines may be substantially identical. The gap between at least two hatch lines may be different. Difference or similarity may include different or similarity in length, width, and/or volume of the gap respectively. The gaps between various (e.g., adjacent) hatch lines may be (e.g., substantially) identical. Various gaps between (e.g., adjacent) hatch lines may be different. FIGS. 6A-6C schematically show examples of various cross sections of at least a portion of a 3D object. FIG. 6A schematically shows an example of a horizontal cross section of a set of path segments within the ledge 633 of the 3D object; FIG. 6B schematically shows an example of a horizontal cross section of a path lines within the ledge 633 of the 3D object; FIG. 6C schematically shows a vertical side cross section of a 3D object; FIG. 6B shows an example of hatch lines within a tile, which vary in relative distance (e.g., gap) of the parallel hatch lines. The hatch lines (e.g., in a tile) may comprise parallel or crossing hatch lines. The hatch lines may comprise contoured hatch line(s). FIG. 6B shows an example of hatch lines within a rectangle having a contour line (e.g., a continuous rim). FIGS. 3A-3D show examples of hatch lines that do not have (e.g., are devoid of) a contoured path (e.g., a rim). The tile may comprise a contour-path (or a contour hatch line) around the tile. The direction of the path that hatches a plurality of tiles can be (e.g., substantially) the same in at least two tiles of the plurality of tiles. The direction of the path that fills up the tiles in a plurality of tiles can be different in at least two tiles within the plurality of tiles. The direction of the path that hatches each of the tiles can be different. For example, FIG. 3A shows two path tiles 311 and 313, having different relative directions (i.e., form an angle). The hatch lines may be varied. The hatch lines may be adaptive (e.g., before and/or during the 3D printing process). The variation and/or adaptivity of hatch line(s) may depend on the selected position within the transformed material, within the hardened material, and/or within the 3D object. The variation and/or adaptivity of the hatch line(s) may depend on the depletion of energy in the selected position, resistance to energy depletion in the selected position, and/or susceptibility to deformation of a selected position.

The methods described herein may further comprise after depositing a layer of pre-transformed material in the enclosure (e.g., operation a), and before providing the transforming energy (e.g., the first energy) to a portion of the material bed according to a first path (e.g., operation b)): providing at least a second energy (e.g., energy beam) to a portion of the layer of material according to a second path, wherein the second energy elevates the temperature (e.g., heats or warms) the material, but does not transform the material. The path of the heating energy (e.g., second energy) can be different than the path of the transforming energy (e.g., first energy). The path of the heating energy can be (e.g., substantially) identical to the path of the transforming energy. The path of the heating energy can be (e.g., substantially) identical to the path of the transforming energy, except for an angular deviation. The path of the heating energy can be (e.g., substantially) identical to the path of the transforming energy, except for a vertical or a horizontal deviation. The path of the heating energy can be (e.g., substantially) identical to the path of the transforming energy. The path of the heating energy may overlap the path of the transforming energy. The heating energy and the transforming energy can derive from the same energy source. The heating energy and the transforming energy can derive from different energy sources. The heating energy may be provided in a single path (e.g., the second path), or in 2, 3, 4, 5, 6, 7, 8, 9, 10, 15, or more paths. The heating energy may follow (e.g., repeat) the heating path at least 1, 2, 3, 4, 5, 6, 7, 8, 9, 10, or 15 times. The heating energy may follow the heating path at most 1, 2, 3, 4, 5, 6, 7, 8, 9, 10, or 15 times. The heating energy may follow the heating path any number of times between the afore-mentioned number of times. The heating energy may follow (e.g., repeat) the heating path a multiplicity of times. The heating energy may maintain a selected area of the material bed hot (e.g., at an elevated temperature) for a (e.g., predetermined) time span. The time span may be at least about 2 milliseconds (μsec), 4 μsec, 6 μsec, 8 μsec, 10 μsec, 12 μsec, 14 μsec, 16 μsec, 18 μsec, or 20 μsec. The time span may be at most 2 milliseconds (μsec), 4 μsec, 6 μsec, 8 μsec, 10 μsec, 12 μsec, 14 μsec, 16 μsec, 18 μsec, or 20 μsec. The time span may be any time interval between the afore-mentioned times. The heating energy may comprise an energy beam. The energy beam may vary by at least one of energy beam characteristics (e.g., as disclosed herein). The variation of energy beam characteristics may be within one path as the energy beam hatches a tile (e.g., excluding path repetition). The energy beam characteristics may (e.g., substantially) not vary within one path as the energy beam hatches a tile (e.g., excluding path repetition). The variation of energy beam characteristics may vary between repetitions as the energy beam hatches a tile a plurality of times (i.e., two or more times). The variation of energy beam characteristics may be among the repetitions as the energy beam hatches a tile a plurality of times, and/or within each repetition. Providing at least a second energy (e.g., energy beam) may comprise providing at least a 2^{nd} 3^{rd} 4^{th} 5^{th} 6^{th} 7^{th} 8^{th} 9^{th} 10^{th}, 11^{th}, or 12^{th} energy (e.g., energy beam). The plurality of energies (e.g., energy beams) may be identical or different. The plurality of energies (e.g., energy beams) may be at times (e.g., substantially) identical and at times different. The energy beam characteristics may comprise the energy beam flux, energy density, power per unit area, wavelength, amplitude, power, travel rate, travel time, traveling path, focus, defocus, FLS of the cross-section, or pulsing frequency (if any).

Providing both the heating energy and transforming energy may overlap in time. Providing both the heating energy and transforming energy may occur (e.g., substantially) simultaneously. Providing both the heating energy and transforming energy can occur shifted in time. Providing both the heating energy and transforming energy can occur sequentially. The path of the heating energy and the path of the transforming energy can comprise an overlapping path section. The path of the heating energy and the path of the transforming energy may (e.g., substantially) overlap. The path of the heating energy and the path of the transforming energy may be distinct. The path of the heating energy and the path of the transforming energy may be not overlap.

The energy may be provided in a manner that will allow a reduced amount of energy to concentrate at a selected position of the generated (e.g., formed) 3D object (or portion thereof). The selected position may comprise an edge, a kink, a crossing, an interior, or a surface. The methods, systems, software, and/or apparatuses described herein may facilitate reduction of the degree of deformation. For example, facilitate reduction of the amount of bending (e.g., warping, curving, or twisting), balling, cracking, dislocating, shrinking, or any combination thereof, as compared to a method for generating a 3D object by 3D printing (e.g., additive manufacturing) that does not reduce the amount of energy concentrated at the selected position of the generated 3D object. The methods described herein may facilitate increasing (e.g., result in increasing) the radius of curvature of a plane within the generated 3D object, as compared to a method for generating a 3D object by a 3D printing method that does not reduce the amount of energy concentrated at the selected position of the generated 3D object. The methods described herein may reduce the amount of balling of the hardened material, as compared to a method for generating a 3D object by a 3D printing method that does not reduce the amount of energy concentrated at the selected position of the generated 3D object.

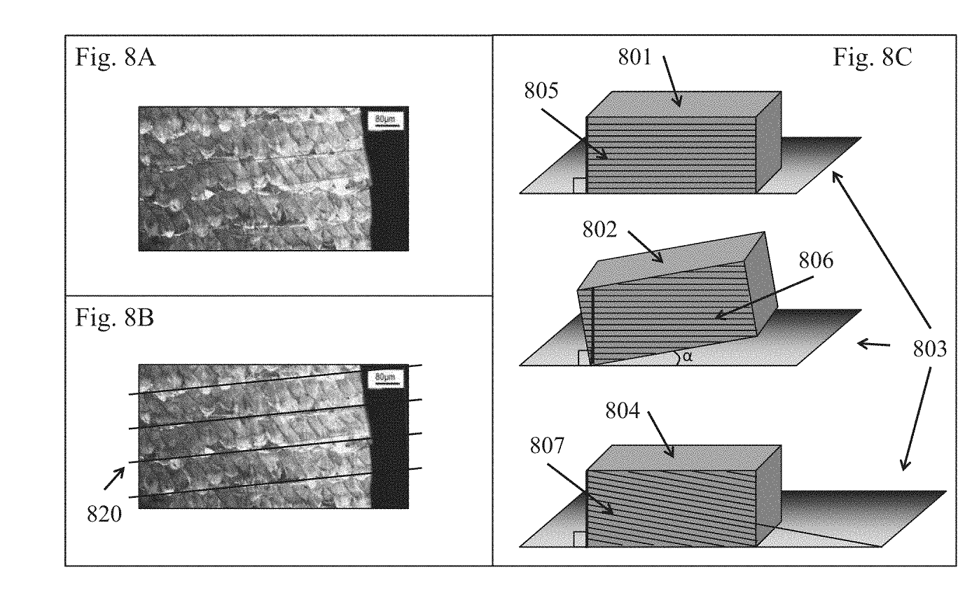

In some methods provided herein, the generated 3D object is printed as a tilted 3D object with respect to its natural position. In some methods provided herein, at least a portion of the 3D object is printed as a tilted part of the 3D object. Tilted may be with respect to the natural position of the desired 3D object. The natural position may be with respect to gravity (e.g., a stable position), with respect to everyday position of the desired object as intended (e.g., for its use), or with respect to a 3D model of the desired 3D object. Tilted may be with respect to a model of the desired 3D object. The model of the 3D object may be any model described herein. In some instances, instructions may be given to the energy (e.g., energy beam) to transform the material within the material bed according to a path. The instructions may correspond to the desired 3D object that has been tilted from its natural position. The methods disclosed herein comprise printing a desired 3D object that has been tilted from its natural position. The methods disclosed herein comprise printing a tilted desired 3D object with respect to its natural position (e.g., during the 3D printing process). The methods disclosed herein comprise printing a desired 3D object while it is tilted with respect to its natural position during the 3D printing process. FIG. 8C, 801 shows an example of a 3D object placed in its natural position with respect to the field of gravity, and rests on a plane 803 that is normal to the field of gravity. The object 801 was printed in this position, as illustrated by the parallel layering planes (e.g., as seen in the example of a vertical cross section 805 of a layering plane). FIG. 8C, 802 shows an example of the desired 3D object (e.g., 801) that was printed as a 3D object 802 that was tilted by an angle alpha (a) with respect to the plane 803 (e.g., platform and/or a plane perpendicular to the direction of the gravitational field). The object 802 was printed in this position (e.g., during the 3D printing), as illustrated by the parallel layering planes (e.g., an example of a vertical cross section 806 of a layering plane). When the 3D object is subsequently retrieved (e.g., after the 3D printing), it can be placed in its natural position, and (e.g., substantially) correspond to the desired 3D object. The microstructure of the 3D object may reveal its tilt angle from the natural position during the 3D printing process. The microstructure of the 3D object may reveal that it was printed in as a tilted 3D object (e.g., during the 3D printing). FIG. 8C, 804 shows an example of a 3D object placed in its natural position with respect to the field of gravity, and rests on a plane 803. The object 804 was printed in a tilted position, as illustrated by the parallel layering planes (e.g., vertical cross section 807 of a layering plane). FIGS. 8A and 8B show examples of a vertical cross sections of a 3D object. The lines in FIG. 8B (e.g., 820) illustrate average layering planes. The 3D object can be printed as a tilted 3D object (or part thereof) forming an acute angle alpha with (i) the plane normal to the field of gravity, (ii) the plane of natural position of the desired 3D object, and/or (iii) the platform (e.g., building platform). The acute angle alpha may be at least about 0 degrees (°), 0.5°, 1°, 1.5°, 2°, 2.5°, 3°, 3.5°, 4°, 4.5°, 5°, 5.5°, 6°, 6.5°, 7°, 7.5°, 8°, 8.5°, 9°, 9.5°, 10°, 11°, 12°, 13°, 14°, 15°, 20°, 25°, 30°, 35°, 40°, or 45°. The acute angle alpha may be at most about 0.5°, 1°, 1.5°, 2°, 2.5°, 3°, 3.5°, 4°, 4.5°, 5°, 5.5°, 6°, 6.5°, 7°, 7.5°, 8°, 8.5°, 9°, 9.5°, 10°, 11°, 12°, 13°, 14°, 15°, 20°, 25°, 30°, 35°, 40°, or 45°. The acute angle alpha may be any value between the afore-mentioned alpha values (e.g., from about 0° to about 45°, from about 0° to about 30°, or from about 0° to about 5°).

In some embodiments, at least a portion of the generated 3D model is tilted to minimize at least one area of a hanging structural section. At least a portion of the generated 3D model is tilted to minimize the surface area of a layer of hardened material (e.g., that is a hanging structure). A hanging structural section (e.g., of the 3D object) may comprise a 3D plane, a wire, or an amorphous structure. The hanging structural section may comprise a section below which there is no supporting structure. The supporting structure may comprise a previously hardened powder material sections, auxiliary support structure, the building platform, or any other added supportive structure (e.g., a mold). Minimizing the hanging structure section of the 3D object may comprise minimizing the horizontal cross section, lateral cross section, cross section parallel to the layering plane of material within the enclosure, cross section parallel to the platform (e.g., substrate and/or base), cross section parallel to the plane normal to the gravitational field, volume of the hanging structural sections, or any combination thereof. The at least one area of a hanging structural section of the 3D object can comprise the area of all hanging structural sections (e.g., planes) of the 3D object.

The wire may have an aspect ratio of a width to length (i.e., width:length) of at least about 1:10, 1:20, 1:30, 1:40, 1:50, 1:100, 1:500, or 1:1000. The wire may have an aspect ratio of a width to length of at most about 1:5000, 1:1000, 1:500, 1:100, 1:50, 1:40, 1:30, 1:20, or 1:10. The wire may have an aspect ratio of a width to length of any value between the aforementioned values (e.g., from about 1:10 to about 1:5000, from about 1:10 to about 1:500, or from about 1:10 to about 1:1000).

The 3D plane may have an aspect ratio of a width to length (i.e., width:length) of at least about 1:1, 1:2, 1:3, 1:4, 1:5, 1:6, 1:7, 1:8, or 1:9. The plane may have an aspect ratio of a width to length of at most about 1:9, 1:8, 1:7, 1:6, 1:5, 1:4, 1:3, 1:2, or 1:1. The wire may have an aspect ratio of a width to length of any value between the aforementioned values (e.g., from about 1:1 to about 1:9, from about 1:1 to about 1:5, or from about 1:1 to about 1:3).

The cross section of the tile may be at least about 4 mm², 9 mm², 16 mm², 15 mm², 20 mm², 25 mm², 30 mm², 36 mm², 40 mm², 49 mm², 50 mm², 60 mm², 64 mm², 70 mm², 81 mm², 100 mm², 121 mm, or 144 mm². The cross section of the tile may be at most about 4 mm², 9 mm², 16 mm², 15 mm², 20 mm², 25 mm², 30 mm², 36 mm², 40 mm², 49 mm², 50 mm², 60 mm², 64 mm², 70 mm², 81 mm², 100 mm², 121 mm, or 144 mm². The cross section of the tile may be any value between the afore-mentioned values (e.g., from about 4 mm² to about 144 mm², from about 16 mm² to about 49 mm², from about 4 mm², or 49 mm², or from about 49 mm², or 144 mm²). The cross section may be a vertical or a horizontal cross section. The FLS of the tile may be a square root of any of the above-mentioned tile cross section values.

The radius of curvature, “r,” of a curve at a point can be a measure of the radius of the circular arc (e.g., FIG. 36, 3616) which best approximates the curve at that point. The radius of curvature can be the inverse of the curvature. In the case of a 3D curve (also herein a “space curve”), the radius of curvature may be the length of the curvature vector. The curvature vector can comprise of a curvature (e.g., the inverse of the radius of curvature) having a particular direction. For example, the particular direction can be the direction towards the platform (e.g., designated herein as negative curvature), or away from the platform (e.g., designated herein as positive curvature). For example, the particular direction can be the direction towards the direction of the gravitational field (e.g., designated herein as negative curvature), or opposite to the direction of the gravitational field (e.g., designated herein as positive curvature). A curve (also herein a “curved line”) can be an object similar to a line that is not required to be straight. A straight line can be a special case of curved line wherein the curvature is (e.g., substantially) zero. A line of substantially zero curvature has a (e.g., substantially) infinite radius of curvature. A curve can be in two dimensions (e.g., vertical cross section of a plane), or in three-dimension (e.g., curvature of a plane). The curve may represent a cross section of a curved plane. A straight line may represent a cross section of a flat (e.g., planar) plane.

The one or more layers within the 3D object may be (e.g., substantially) flat. The one or more layers within the 3D object may be one or more layers of hardened material. The substantially flat one or more layers may each have a large radius of curvature. The one or more layers may have a radius of curvature of at least about 0.1 centimeter (cm), 0.2 cm, 0.3 cm, 0.4 cm, 0.5 cm, 0.6 cm, 0.7 cm, 0.8 cm, 0.9 cm, 1 cm, 5 cm, 10 cm, 20 cm, 30 cm, 40 cm, 50 cm, 60 cm, 70 cm, 80 cm, 90 cm, 1 meter (m), 1.5 m, 2 m, 2.5 m, 3 m, 3.5 m, 4 m, 4.5 m, 5 m, 10 m, 15 m, 20 m, 25 m, 30 m, 50 m, 100 m, or 200 m. The one or more layers may have a radius of curvature of at most about 0.1 centimeter (cm), 0.2 cm, 0.3 cm, 0.4 cm, 0.5 cm, 0.6 cm, 0.7 cm, 0.8 cm, 0.9 cm, 1 cm, 5 cm, 10 cm, 20 cm, 30 cm, 40 cm, 50 cm, 60 cm, 70 cm, 80 cm, 90 cm, 1 meter (m), 1.5 m, 2 m, 2.5 m, 3 m, 3.5 m, 4 m, 4.5 m, 5 m, 10 m, 15 m, 20 m, 25 m, 30 m, 50 m, 100 m, or 200 m. The one or more layers may have a radius of curvature between any of the afore-mentioned values of the radius of curvature (e.g., from about 0.1 cm to about 200 m, from about 0.1 cm to about 5 cm, from about 5 cm to about 50 cm, from about 50 cm to about 100 m, from about 50 cm to about 200 m, from about 50 cm to about 1 m, or from about 1 m to about 200 m). In some examples, the one or more layers may be included in a planar section of the 3D object, or may be a planar 3D object. An (e.g., average or mean) planar layer may have an infinite radius of curvature.

The path of the energy (e.g., energy beam) may follow a direction that is susceptible to deformation, which direction is of the 3D object (e.g., the forming hardened material). The deformation may comprise bending (e.g., warping, curving, or twisting), shrinking, cracking, or dislocating. The hardened material can have a lower degree of deformation as compared to a hardened material printed by a 3D printing methodology (e.g., additive manufacturing) where the path does not follow a direction in the 3D object that is susceptible to deformation. In some instances, the path is the path of the transforming energy. In some instances, the path is the path of the heating energy. In some instances, the path both is the path of the transforming energy and the path of the heating energy.

The path that the energy (e.g., energy beam) travels within a layer of pre-transformed material (e.g., deposited material. E.g., powder material) may comprise multiple sections. The sections may be tiles. The path may be divided into a multiplicity of paths. The path may be divided into a set of paths (i.e., a path set). For example, the energy path may comprise a first tile at a first location within the layer of (e.g., pre-transformed) material, and a second tile at a second location within the layer of (e.g., pre-transformed) material. A path set forming a multiplicity of tiles may be traveled by a single energy (e.g., single energy beam), or a multiplicity of energies (e.g., multiplicity of energy beams). A path set forming a multiplicity of tiles may be traveled by a corresponding multiplicity of energies (e.g., multiplicity of energy beams). For example, a first tile may be formed by a first energy, and a second tile may be formed by a second energy. For example, a first tile may be formed by a first energy beam, and a second tile may be formed by a second energy beam. The first and second energies may be (e.g., substantially) identical. The first and second energy beams may be different. The energy beam (e.g., first, second or both) may vary by at least one energy beam characteristics (e.g., as disclosed herein). The first and second tile locations may touch (e.g., contact) each other in at least one point (e.g., one tile-rim). The first and second tile locations may overlap each other in at least one point (e.g., in at least one tile-rim). The first and second tile locations may substantially overlap each other. The first and second tile locations may be spaced apart by a first distance (e.g., a gap). The gap may be at least about 10 mm, 9 mm, 8 mm, 7 mm, 6 mm, 5 mm, 4 mm, 3 mm, 2 mm, 1 mm, 500 micrometers (μm), 400 μm, 300 μm, 250 μm, 200 μm, 150 μm, 100 μm, 90 μm, 80 μm, 70 μm, 60 μm, 50 μm, 40 μm, 30 μm, 20 μm, 10 μm, 5 μm, or 1 μm. The gap may be at most about 10 mm, 9 mm, 8 mm, 7 mm, 6 mm, 5 mm, 4 mm, 3 mm, 2 mm, 1 mm, 500 micrometers (μm), 400 μm, 300 μm, 250 μm, 200 μm, 150 μm, 100 μm, 90 μm, 80 μm, 70 μm, 60 μm, 50 μm, 40 μm, 30 μm, 20 μm, 10 μm, 5 μm, or 1 μm. The gap may be any value between the afore-mentioned first distance values (e.g., from about 1 μm to about 10 mm, from about 1 μm to about 20 μm, from about 10 μm to about 100 μm, from about 50 μm to about 300 μm, from about 200 μm to about 1 mm, or from about 1 mm to about 10 mm). The first and second tile locations may be adjacent. The first and second tile locations may overlap at least in part. The first and second tile locations may completely overlap. A first tile may be completely overlapped by a second tile, and vice versa. The generated 3D object using a path sectioning (e.g., tiling) method described herein can comprise a lesser degree of deformation as compared to a 3D object that is generated by a 3D printing methodology (e.g., additive manufacturing) using a path corresponding to a layer of hardened material that was not divided, sectioned, or tiled it into multiple tile paths. The lesser degree of deformation may be due to one or more factors comprising the positions of the tile location within the formed 3D object, or within the (to be formed) layer of hardened material. The lesser degree of deformation of the 3D object may be due to one or more path characteristics (e.g., described herein). Each tile may have its path characteristics (e.g., described herein) which may differ from another tile by at least one path characteristics. The path characteristics corresponding to the tiles formed by a path set may be (e.g., substantially) the same. The path characteristics corresponding to at least two tiles formed by at least a portion of a path set may be (e.g., substantially) the same. The path characteristics corresponding to at least one tile formed by a path set may be different. The path characteristics of the tiles formed by a path set may be different. For example, the path of the tile may be less dense at a position corresponding to an edge of the generated 3D object, as compared to a position corresponding to an area farther from an edge within the generated 3D object. FIG. 6A shows a top view example of a first tile path section 614 in the interior of the forming layer of hardened material, which first tile path is denser than a second tile path tile section 611 at the edge of the forming layer of hardened material. For example, the path of the tile may be less dense at a selected position within the 3D object, as compared to a position corresponding to an area farther away from that selected position within the 3D object. For example, the path of the tile may be less dense at a position corresponding to a kink within the 3D object, as compared to a position corresponding to an area farther from the kink within the 3D object. FIG. 6C shows an example of a side view of a 3D object showing a kink 632, and a position 633 away from the kink. For example, the path of the tile may be less dense at a position corresponding to a hanging structure within the 3D object, as compared to a position corresponding to an area farther from the hanging structure within the 3D object. FIG. 6C shows an example of hanging structure (e.g., comprising 633), and a position 632 away from the hanging structure. For example, the path of the tile may be less dense at a position corresponding to an internal cavity (e.g., the surface of the internal cavity) within the 3D object, as compared to a position corresponding to an area farther from the internal cavity (e.g., the surface of the internal cavity) within the 3D object. The selected position may be any selected position described herein.

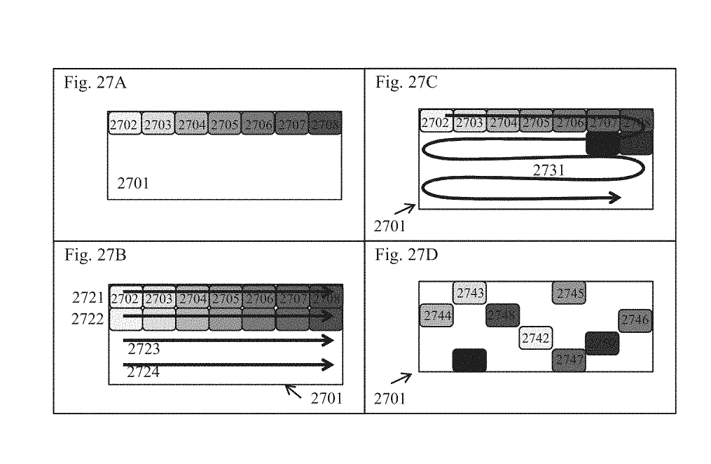

In some embodiments, a separation (e.g., partitioning) of the path corresponding to the (to be formed) layer of hardened material into a path corresponding to the first tile and a path corresponding to (e.g., of) the second tile. The partitioning may reduce the energy density on a selected position (e.g., edge or kink) of the generated 3D object, as compared to a non-partitioned formation of the layer of hardened material. FIG. 6A shows an example of a path set of various tiles 611-615. Reducing the energy density on the selected position within the 3D object may occur at least during the transforming. The energy (e.g., beam) following a tile path may transform the material within the layer of material (e.g., powder) into a transformed material tile. The transformed material tile may be allowed to harden into a hardened tile. The transformed tile may harden into a hardened tile. Reducing the energy density on the selected position may occur at least during the operation of hardening (e.g., when the transformed material hardens). Hardening may comprise allowing to harden. The energy or energies may travel along the path tiles sequentially, randomly, or at an order with respect to a lateral position. For example, the energy may transform a first tile path, and move to the second tile path that is closest to it, and transform the material. For example, the energy may transform a (e.g., pre-transformed) material corresponding to a first tile path, and move to the second tile path that is farthest from it, and transform the material corresponding to the second tile. FIG. 27D shows an example of multiplicity of tiles 2742-2749. The tile closest to 2746 is 2750. The tile that is farthest from 2746 can be 2744. For example, the energy (e.g., beam) may transform a first tile path, and move to the second tile path that is not farthest from it and transform the material. For example, the energy may transform a pre-transformed material that correspond to a first tile path, and move to the second tile path that is not closest to the first tile path, and transform the pre-transformed material that correspond to the second tile path. The order of movement between the tile path sections within the plurality of tile paths (e.g., tile path set) may depend on the depletion of energy from the transformed and/or hardened material. The order of movement between the tile path sections within the plurality of tile paths may depend on the susceptibility to deformation of the transformed or hardened material. Taking the tile paths in FIG. 6A as an example: the energy beam may travel first though the path 611, then to path 612, then to path, 613, then to path 614 and finally to path 615; or the energy beam may travel first though path 611, then to path 614, then to path, 612, then to path 615, and finally to path 613. The sequence of movement of the energy beam though the tiles may comprise a random sequence (e.g., Monte Carlo or quasi Monte Carlo), or quasi-random sequence (e.g., Sobol sequence). The quasi-random sequence may comprise a low discrepancy sequence. The sequence may be followed by a heating energy beam, by a transforming energy beam, or by both the heating energy beam and the transforming energy beam. The energy beams may travel the path(s) before, after, or during the cooling of the material bed (e.g., with a cooling member, such as a heat sink, that is situated adjacent to the material bed).

The lesser degree of deformation may be due to one or more factors comprising the size of the tile. The size (or a FLS) of the tile can (e.g., substantially) comprise the size of the path corresponding to a tile. The size (or a FLS) of the tile can comprise the size of the hardened material tile. The FLS (e.g., height, width, and/or length) of the tile may be at least about 50 mm, 40 mm, 20 mm, 10 mm, 9 mm, 8 mm, 7 mm, 6 mm, 5 mm, 4 mm, 3 mm, 2 mm, 1 mm, 500 micrometers (μm), 400 μm, 300 μm, 200 μm, 100 μm, 90 μm, 80 μm, 70 μm, 60 μm, 50 μm, 40 μm, 30 μm, 20 μm, or 10 μm. The FLS of the tile may be at most about 50 mm, 40 mm, 20 mm, 10 mm, 9 mm, 8 mm, 7 mm, 6 mm, 5 mm, 4 mm, 3 mm, 2 mm, 1 mm, 500 micrometers (μm), 400 μm, 300 μm, 200 μm, 100 μm, 90 μm, 80 μm, 70 μm, 60 μm, 50 μm, 40 μm, 30 μm, 20 μm, or 10 μm. The FLS of the tile may be may any value between the afore-mentioned tile size values (e.g., from about 10 μm to about 50 mm, from about 100 μm to about 50 mm, from about 300 μm to about 500 μm, from about 250 μm to about 700 μm, from about 1 mm to about 10 mm, or from about 2 mm to about 10 mm).

The tiles may (e.g., collectively) form a 3D shape. The 3D shape may form a cuboid (e.g., cube), or a tetrahedron. The tiles may form one or more 3D shapes or 3D planes that completely fill in a volume of space. The tiles may form a closely tied structure. The tile may form a polyhedron. The polyhedron may be a space filling polyhedron. In some examples, all the tiles of the 3D structure may be space filling polyhedrons. The 3D shape may comprise a polyhedron (e.g., primary parallelohedron). The 3D shape may comprise a space-filling polyhedron (e.g., plesiohedron). The polyhedron may be a prism (e.g., hexagonal prism), or octahedron (e.g., truncated octahedron). The 3D shape may comprise a Platonic solid. The tiles may comprise a combination of tetrahedra and octahedra (e.g., that fill a space). The 3D shape may comprise octahedra, truncated octahedron, and cubes, (e.g., combined in the ratio 1:1:3). The 3D shape may comprise tetrahedra and/or truncated tetrahedra. The 3D shape may comprise convex polyhedra (e.g., with regular faces). For example, the 3D shape may comprise a triangular prism, hexagonal prism, cube, truncated octahedron, or gyrobifastigium. The 3D shape may comprise a non-self-intersecting quadrilateral prism. The 3D shape may comprise space-filling polyhedra. The 3D shape may include a pyramid. The 3D shape may exclude a pentagonal pyramid. The 3D shape may comprise 11-hedra, dodecahedra, 13-hedra, 14-hedra, 15-hedra, 16-hedron 17-hedra, 18-hedron, icosahedra, 21-hedra, 22-hedra, 23-hedra, 24-hedron, or 26-hedron. The tile may comprise at least 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, or 40 faces. The 3D shape may comprise at most 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, or 40 faces. The 3D shape may comprise any number of faces between the aforementioned number of faces (e.g., from 4 to 38, from 4 to 20, from 20 to 40, or from 10 to 30 faces). The 3D shape may comprise a non-convex aperiodic polyhedron, convex polyhedron (e.g., Schmitt-Conway bi-prism). The cross-section of the tile (e.g., vertical or horizontal) may be a square, rectangle, triangle, pentagon, hexagon, heptagon, octagon, nonagon, octagon, circle, or icosahedron. The tile may be hollow. The tile may comprise dense material. The tile may comprise porous material. The tile may be filled with transformed (e.g., and subsequently hardened) material. A cross section of the tiles may have a cross section of any of the 3D shapes or 3D planes mentioned herein. The cross section may be horizontal or vertical. The tile may comprise a material with high porosity. The tile may comprise at least about 30%, 40%, 50%, 60%, 70%, 80%, 90% or 95% material. The tile may comprise at most about 100%, 99%, 95%, 90%, 80%, 70%, 60%, or 50% material. The tile may comprise a percentage of material corresponding to any percentage between the aforementioned percentages of material (e.g., the percent may be from 40% to 80%, from 50% to 99%, from 30% to 90%, or from 70% to 100% material). The percentage of material may correspond to the density of the material. The tile may comprise pores. Porosity and/or density can be measured by a direct method, optical method, Computed tomography method (e.g., CT scan, MRI, or Ultrasound), water evaporation method, mercury intrusion porosimetry, and/or a gas expansion method. The tile may comprise an internal structure. The tile may comprise one or more scaffolds. The tile may comprise one or more cavities. The layer of hardened material may comprise a percentage of material corresponding to the abovementioned percentages of material within the tile. At least two of the tiles may have a substantially identical shape and/or cross section. At least two of the tile may have a different shape and/or cross section. The tiles may be of (e.g., substantially) identical shape and/or cross section.

In some embodiments, at least a portion of the layer is heated (e.g., pre-heated) before a transformed material is deposited. The transformed material may be deposited within the heated portion, adjacent to that portion, overlapping that portion, bordering that portion, touching that portion, or any combination thereof. The pre-heating of the at least a portion may be performed using an energy source (e.g., an energy beam). The energy beam may follow a path (e.g., hatch). For example, any hatch pattern and/or design described herein. The energy beam paths that form at least two of the pre-heated portions may be substantially identical. The energy beam paths that form at least two of the pre-heated portions may be different. The energy beam paths that form the pre-heated portions may be substantially identical or different. Examples of paths can be seen in FIGS. 3A-3D.

As compared to a procedure in which the added layer (e.g., second layer) is deposited without using pre-heating (e.g., of tiles or of the entire layer) and/or as compared to a procedure in which layer of transformed material is formed as a continuous layer (e.g., as opposed to tiling): The pre-heating procedure may (i) reduce deformation in the forming 3D object (or a portion thereof) as it hardens, (ii) reduce warping or bending of the formed 3D object, or a portion thereof (e.g., upon subsequent cooling), (iii) reduce stress in the formed layer (e.g., second layer), and/or (iv) form better adhesion of the material of the added layer to the previously formed layer.

In some embodiments, several portions of the layer are pre-heated before a transformed material is deposited within those several portions (e.g., a tiles). The several heated portions of the layer can be adjacent to each other, overlap each other, separated by a gap from each other, or any combination thereof. For example, some of the pre-heated portions can be formed sequentially. At least two of the sequential pre-heated portions (e.g., all the sequential pre-heated portions) may touch each other. At least two of the sequential portions (e.g., all the sequential portions) may overlap. At least two of the sequential portions (e.g., all the sequential portions) may be separated by a gap.

In some examples, the tiles may be deposited on a first layer (e.g., or pre-transformed and/or of transformed material) that was not pre-heated. In some examples, the tiles (e.g., portions of deposited material comprising a transformed material) can be deposited sequentially. At least two of the sequentially deposited tiles (e.g., all the sequential tiles) may touch each other, border each other, and/or overlap each other. The sequentially deposited tiles may touch or overlap each other at least at one of their edges. At least two of the sequentially deposited tiles (e.g., all the sequential portions of material) may overlap. At least two of the sequentially deposited portions (e.g., all the sequential portions) may be separated by a gap. The deposited tiles may be deposited randomly or non-randomly. The deposited tiles may be deposited in a manner that avoids an area of preclusion.

The straight line in which the three or more tiles may be arranges is termed herein an “area of preclusion.” In some embodiments, the area of preclusion may comprise a straight tile between two or more sequentially deposited tiles (e.g., when the two sequentially deposited tiles are in close proximity to each other separated by a gap, border each other, or overlap each other). The methods, systems, and/or apparatuses describe herein may aim to at least form successively (e.g., one after another) disposed tiles in an area that is outside the area of preclusion. In some embodiments, the area of preclusion may include two tiles that are disposed sequentially one next to each other. Next to each other includes directly next to each other. Next to each other comprises next to a tile face, vertex, or edge of the tile. Next to each other may comprise touching a file face, vertex, or edge. Next to each other may comprise having a gap between the two tiles (e.g., any gap value disclosed herein).

The area of preclusion may depend on the temperature at various portions of the first layer, the time elapsed from heating at least one of the three or more prior portions of the first layer, the time elapsed from depositing at least one of the three or more prior tiles of material on the first layer, the temperature at the potential area to be heated, the temperature gradient from at least one of the three or more prior portions or tiles to the potential area to be heated, the temperature at the previously heated three or more portions or tiles, the heat deformation susceptibility of the material that is included in the first and/or second layer, or any combination thereof. The area of preclusion may depend on the physical state of matter within the tile (e.g., liquid, partially liquid, or solid).

In some embodiments, successively heating three or more portions of the first layer in a straight line will cause the first layer to deform (e.g., bend). The deformation may be disruptive (e.g., for the intended purpose of the 3D object). Such straight line may form (e.g., generate, create) a line of weakness in the first layer. In some embodiments, successively heating at least three portions of the first layer in a pattern that differs from a straight line will substantially lessen the degree of deformation of the first layer as compared to a straight line heating pattern. In some embodiments, successively heating at least three portions of the first layer in a pattern that differs from a straight line will substantially not cause the first layer to deform (e.g., bend). In some embodiments, successively heating at least three portions of the first layer in a pattern that differs from a straight line will retard (e.g., prevent) the formation of lines of weakness. In some embodiments, successively depositing three or more tiles of material on the first layer in a straight line will cause the first layer to deform (e.g., bend). In some embodiments, successively depositing at least three tiles of material on the first layer in a pattern that differs from a straight line will substantially lessen the degree of deformation of the first layer as compared to a straight line heating pattern. In some embodiments, successively depositing at least three tiles of material on the first layer in a pattern that differs from a straight line (e.g., single file) will substantially not cause the first layer to deform (e.g., bend). In some embodiments, successively depositing at least three tiles of material on the first layer in a pattern that differs from a straight line will retard (or prevent) the formation of lines of weakness.

The area of preclusion may comprise three or more tiles that are formed sequentially and are arranged on a straight line. The determination of the area of preclusion may comprise characteristics of a gap between at least two tiles (or lack thereof). The gap characteristics may include a FLS of the gap (e.g., height, length, or width), or volume of the gap. The determination of the area of preclusion may comprise characteristics of the first layer of hardened material and any previously formed layers of hardened material, which characteristics may comprise the FLS of these layers (e.g., height, length, width), volume, shape, or material of these layer(s). The determination of the area of preclusion may comprise energy characteristics (e.g., energy distribution such as heat distribution) of the first layer of hardened material and any previously formed layers of hardened material, for example, energy (e.g., heat) depletion characteristics. FIG. 27A shows an example of a first layer of hardened material 2701, on which sequential portions of transformed material are deposited 2702-2708 such that at least one of their edges (e.g., two edges) is touching each other, forming a row comprising single file of deposited portions. The number sequence represents the sequence in which the tiles were deposited, with 2702 being the first tile deposited on layer 2701, and 2708 the last respectively (e.g., 2702, followed by 2703, followed by 2704, . . . followed by 2708). FIG. 27D shows an example of a first layer of hardened material 2701 on which tiles 2742-2750 are disposed in a manner that avoids an area of preclusion, wherein the number sequence characterizes the sequence in which the tiles (i.e., tiles of hardened material) were disposed, with deposited being the first tile disposed on layer 2701, and 2750 the last. The first layer may be of the same, or of a different material as compared to the material of the tiles. The first layer may be of the same, or different material as compared to the material of the welding material. The difference can be in the material type, material characteristics (e.g., microstructure, crystal structure), melting point, rigidity, flexibility, porosity, and/or density. The density of the pre-transformed (e.g., powder) material be at least about 30%, 40%, 50%, 60%, 70%, 80%, 90% or 95% material. The density of the powder material be at most about 100%, 99%, 95%, 90%, 80%, 70%, 60%, or 50% material. The density of the powder material may be any value between the afore-mentioned percentages of material (e.g., the percent may be from 40% to 80%, from 50% to 99%, from 30% to 90%, or from 70% to 100% material).

The heated portions and/or deposited tiles (i.e., tiles of material) may be generated using an energy beam. The energy beam may follow a path. The path may include an internal path within each of the portion(s) (e.g., heated portions and/or deposited tiles). The path may include a path of the portion in the layer (herein designated as “path-of-portions”), which corresponds to the sequence in which the portions (e.g., heated and/or deposited tiles) are generated.

The path-of-portions can be linear, rectilinear, curved, staggered, stochastic, or any combination thereof. The path of portions may follow a sequence assigned to the formation (e.g., heating) of the portions. The sequence may be assigned according to an algorithm. The algorithm may exclude a random number generator. The algorithm may comprise the area of preclusion (e.g., as described herein). FIG. 27B shows an example of a sequence of several paths-of-portions numbered 2721-2724. The direction of the arrows in each of arrows 2721-2724 designates the sequence in which a single file of individual tiles (e.g., 2702-2708) are formed on the layer 2701. For example, the path-of-portions 2721 illustrates that tile 2702 was deposited first, tiles 2703, 2704, 2705, 2706, and 2707 were deposited in sequence one after another, and tile 2708 was deposited last. FIG. 27C shows an example of a path 2731 that designates the sequence in which individual portions (e.g., 2702-2708) are sequentially deposited on the layer 2701. FIG. 27D shows an example of individual portions (e.g., 2702-2708) deposited on the layer 2701 in a manner that excludes an area in the sequence of tile deposition. The sequence of tile deposition may be the path-of-portions. The excluded area may be designated as “area of preclusion.” FIGS. 27A-27D may similarly represent sequence formation of heated portions, in which the tiles are substituted by heated portions.

In some embodiments, the second layer may be divided into portions (e.g., tiles). The layer may be divided into at least about 2, 10, 100, 1000, or 10000 portions. The layer may be divided into at most about 10000, 1000, 100, or 10 portions. The layer may be divided into any number between the aforementioned number of portions (e.g., from about 2 to about 10000, from about 100 to about 1000 portions, or from about 2 to about 100 portions). The portions may be portion of hardened material (also herein used as “tiles,” or “material tiles”).

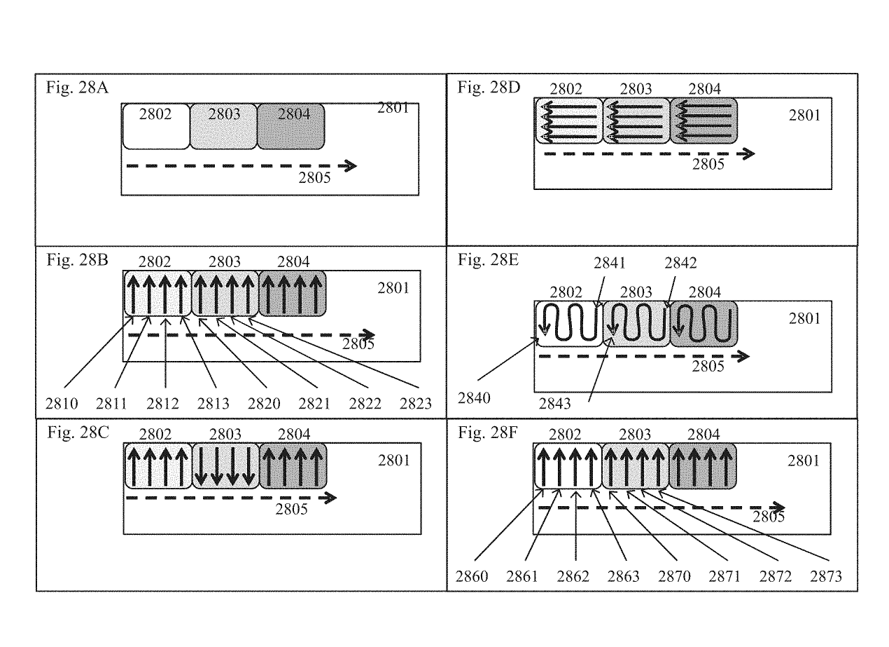

The internal path of one or more portions (e.g., all portions) may follow the direction of the path-of-portion. The internal path of one or more portions (e.g., all portions) may oppose the direction of the path-of-portion. The internal path of one or more portions (e.g., all portions) may be at an angle relative to the path-of-portion. The angle may be an acute angle. The angle may have the value of alpha. The internal path of the portions may be (e.g., substantially) parallel or perpendicular relative to the path-of-portion. The internal path of at least two portions may be different. FIGS. 28A-28F show an examples of the direction of the path-of-portions illustrated by dotted line 2805, and tiles 2802, 2803, and 2804. FIG. 28B shows an example of internal portion path (e.g., hatch lines) designated by arrows (e.g., 2810-2813 and 2820-2823) in the tiles. In the example shown in 28B, the internal portion hatches (e.g., hatch lines) are all perpendicular to the direction of the path-of-portions and point towards the same direction. FIG. 28C shows an example of the direction of the path-of-portions illustrated by dotted line 2805, and internal portion hatches designated by arrows in tiles 2802, 2803, and 2804 respectively. In the example of 28C, the internal portion hatches are perpendicular to the direction of the path-of-portions, and point to opposite directions (e.g., internal hatches in 2802 point in opposite direction to the paths in 2803). FIG. 28D shows an example of the direction of the path-of-portions illustrated by dotted line 2805, and internal portion hatches designated by arrows in tiles 2802, 2803, and 2804 respectively. In the example of 28D, the internal portion hatches are substantially parallel to the direction of the path-of-portions, and point to opposite directions. FIG. 28E shows an example of the direction of the path-of-portions illustrated by dotted line 2805, and internal portion path designated by arrows in tiles 2802, 2803, and 2804 respectively. Hatch lines may be referred herein as hatches.

In some examples, the progression of the internal hatch(es) of one or more portions (e.g., all the portions) follows the progression of the path-of-portions. At times, it may be hard to differentiate between the tiles when inspecting the microstructure of the formed 3D object if the parts are formed in the same velocity, as the paths will form a sequence of substantially homogenous melt pools. At times, it may be possible to differentiate between the tiles when inspecting the microstructure of the formed 3D object, for example, when a second tile is being formed only after a first previous tile has hardened (e.g., cooled or solidified) thus forming an isotherm boundary (also herein isothermal boundary) at the intersecting melt-pool. The progression of the path may correlate to the progression of the energy beam that generates the path. In some examples, the progression direction (e.g., sequence) of the internal hatch lines of one or more portions (e.g., all the portions) opposes the progression direction of the path-of-portions. In some examples, the progression direction (e.g., sequence) of the internal hatch lines of some of the portions follows the progression direction of the path-of-portions, and the progression direction (e.g., sequence) of the internal hatch lines of some of the portions opposes the progression direction of the path-of-portions. In some instances, the progression direction of tile formation may have a microstructure signature. For example, when a second tile is formed only after at least the first formed melt pool of a first previous tile has hardened (e.g., cooled or solidified) thus forming an isotherm boundary at the intersecting melt pool(s) between the first tile and second tile.

The isotherm boundary may comprise characteristic microstructures within a boundary melt pool The characteristic microstructure may comprise microstructure typical of a rapid crystallization process (e.g., as a hot melt pool comes in contact with a cold melt pool). For example, the rapid crystallization process may be characterized by shorter crystals (e.g., smaller dendrites and/or cells). The rapid crystallization process may be characterized by a certain characteristic ratio between various crystal (e.g., metallurgical) forms). FIG. 28B shows an example where the progression direction of the internal tile hatch lines 2810-2813 and 2820-2823 opposes the progression direction of the path-of-portion 2805. In example 28B, tile 2802 was generated by transforming material using an energy beam that follows path 2813, followed by path 2812, followed by path 2811, and ending by path 2810. Tile 2803 was generated by transforming material using the energy beam that follows hatch 2823, followed by hatch 2822, followed by hatch 2821, and ending by hatch 2820. FIG. 28F shows an example where the progression of the internal tile hatch lines 2860-2863 and 2870-2873 follows the progression of the path-of-portion 2805. In FIG. 28E, tile 2802 that was generated by transforming material using an energy beam that follows a path that started at position 2841 and ended at position 2840. Tile 2803 was generated by transforming material using the energy beam that follows path that started at position 2842 and ended at position 2843. FIGS. 28B-28E shows examples where the progression of the internal tile hatch lines 2810-2813 and 2820-2823 opposes the progression of the path-of-portion 2805. Unless there is a time-gap in the formation of the tiles, the tiles may appear as one continuum (e.g., when inspecting their microstructure), for example, provided that the progression of the internal tile paths follows the progression of the path-of-portions and there is no other variation in the process characteristics (e.g., variance in the energy beam characteristics between the formation of different tiles). For example, in FIG. 28F the microstructure may appear as one continuum. In example 28F, tile 2860 was generated by transforming material using an energy beam that follows hatch 2861, followed by hatch 2862, and followed by hatch 2863. Tile 2803 was generated by transforming material using the energy beam that follows hatch 2870, followed by hatch 2871, followed by hatch 2872, and followed by hatch 2873.

In some cases, the portion (e.g., tile portion or heated portion) is generated by simultaneously or sequentially operated energy beams. The sequential paths can be formed using one energy beam or a multiplicity of energy beams. FIG. 28B shows an example of tile 2802 which is formed using sequentially formed hatch lines. FIG. 28D shows an example of tile 2802 which is generated using simultaneously formed hatch lines (e.g., parallel generated energy beams forming the parallel hatch lines).

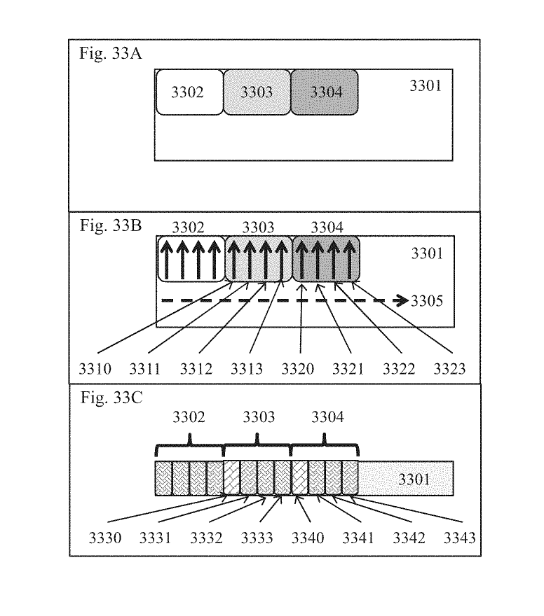

In another aspect disclosed is a 3D object formed by a 3D printing process that comprises a layered structure comprising successive solidified melt pools of a material arranged in at least one layer, wherein the layer comprises a first section (e.g., a first tile) and a second section (e.g., a second tile) that is adjacent to the first section, wherein the first section comprises a first set of successive solidified melt pools that comprises a first border (e.g., rim) melt pool and a first set of interior melt pools, wherein the second section comprises a second set of successive solidified melt pools that comprises a second border melt pool and a second set of interior melt pools, wherein the first border melt pool is adjacent to the second border melt pool, and wherein the first set of interior melt pools and the second set of interior melt pools comprise a first microstructure characteristics; wherein the second border melt pool comprises a second microstructure characteristics that is different from the first microstructure characteristics. The second microstructure characteristic may be of an isothermal boundary. The isothermal boundary microstructure characteristic may be typical to adherence of a newly formed melt pool to a previously formed melt pool that is colder by at least about 50° C., 60° C., 70° C., 80° C., 90° C., 100° C., or 150° C. The isothermal boundary microstructure characteristic may be typical to adherence of a newly formed melt pool to a previously formed melt pool that is colder by at most about 50° C., 60° C., 70° C., 80° C., 90° C., 100° C., or 150° C. The microstructure of the first set of interior melt pools may be substantially identical to a microstructure of the second set of interior melt pools. The second border melt pool may comprise of a microstructure characteristic of abrupt temperature change (e.g., isothermal boundary). The first microstructure characteristic may be typical of a temperature change that is milder as compared to the temperature change that is typical to the second microstructure characteristic. The milder temperature change can be brought about when a melt pool is formed next to previously formed melt pool that was immediately previously formed. The greater temperature change can be brought about when a newly formed melt pool touches a melt pool that was formed a while ago (e.g., not immediately previously formed). A while ago can be previously during the 3D printing process that is not immediately precedent to the formation of the newly formed melt pool. FIG. 33A shows an example of a top view of the 3D object which comprises a layer of hardened material 3301 on which a first tile 3303 and a second tile 3304 (as well as another tile 3302) are formed. The tile 3303 is formed before tile 3304. FIG. 33B shows an example of a top view of a layer of hardened material 3301 on which tiles 3302-3304 were deposited. FIG. 33B shows the path by which the energy beam travels, which energy beam transformed the material that subsequently hardened into tiles 3303 and 3304. The progression of tile formation is illustrated by arrow 3305. In the example shown in FIG. 33B, the energy beam travels in vectorial paths within each tile. For example, tile 3303 is formed by vectorial hatches 3310 to 3313, and tile 3304 is formed by vectorial hatches 3320 to 3323. The energy beam travels first along hatch 3313, then along hatch 3312, then along hatch 3311 and finally along hatch 3310 to create tile 3303. Then the energy beam travels along hatch 3323, followed by hatch 3322, followed by hatch 3321, and ending in hatch 3320 to form tile 3304. Each internal tile path may comprise a melt pool. FIG. 33C shows an example of a vertical cross section of the layer of tiles shown in FIG. 33B as a top view, with FIG. 33C showing an example of the respective corresponding melt pools. For example, melt pool 3330 corresponds to hatch 3310. Melt pool 3331 corresponds to hatch 3311, melt pool 3340 corresponds to hatch 3320, melt pool 3341 corresponds to hatch 3321, etc. Therefore, in the example shown in FIG. 33C, melt pool 3333 was formed, followed by melt pool 3343, followed by melt pool 3342, followed by melt pool 3341, and ending by melt pool 3340. Thus melt pool 3340 contacted melt pool 3333 which was formed a while ago, and was therefore colder as compared to melt pool 3341. This abrupt temperature changes in one side of melt pool 3340 forms a different microstructure (e.g., upon cooling) as compared to the substantially identical microstructures formed in melt pools 3343-3341 (e.g., upon cooling).

In some embodiments, the microstructure of the first set of interior melt pools may form a microstructure series. A first set of melt pools correspond to the melt pool in a first tile. The microstructure series may climax at the second set of interior melt pools. A second set of melt pools correspond to the melt pool in a second tile. The microstructure series may climax at the melt pool preceding the second set of interior melt pools. The microstructure series may comprise an altered crystal structure, metallurgical structure, metallurgical composition, morphology, crystal composition, or material density. The series may be converging or diverging. The series may be a telescopic series. The series may be a linear series, arithmetic series, geometric series, arithmetic-geometric series, exponential series, logarithmic series, or any combination thereof. The logarithmic series may be a common or natural logarithmic series. The exponential series may be a common or natural exponential series.

Some of the portions (e.g., heated portions or tiles) can be separated by a gap, touch each another heated portion, overlap each other, or any combination thereof. The portions may fuse to each other. For example, one portion may be separated from a second portion by a gap, while overlapping a third portion. For example, all the portions may be separated from each other by gaps. At least two gaps may be substantially identical or different. Identical or different can be in FLS. Identical or different can be in length, width, height, volume, or any combination thereof. The transformed material can be deposited as separate deposited patches (e.g., tiles) within the area of each of the heated portions. The process of heating a portion of the layer and depositing a tile of transformed material that subsequently hardens into a hardened material can continue until all the gaps have been substantially filled with transformed material (e.g., except for the edges). Such process may be referred herein as “Pointillism.” Any gaps can be filled by a welding material (e.g., as described herein). For example, filling up the gap to a height level that is below, at, or above the average surface of the second layer (e.g., average height of the gaps within the layer, or average height of the patches of transformed material within the layer). The gap may be filled using any of the gap filling methodologies described herein. For example, the gap may be filled using an energy (e.g., heat energy). For example, the gap may be filled by a transformed material (e.g., molten powder). For example, the amount of energy may gradually decrease as the gap is being filled (e.g., with transformed material). For example, the decrease may follow a series (e.g., any series described herein).

The gap size (e.g., FLS such as height, length, and/or width) may be at least about 30 μm, 35 μm, 40 μm, 50 μm, 60 μm, 70 μm, 80 μm, 90 μm, 100 μm, 120 μm, 150 μm, 170 μm, 200 μm, 220 μm, 250 μm, 270 μm, 300 μm, 400 μm, 500 μm, 600 μm, 800 μm, 1 mm, 5 mm, 10 mm, 30 mm, 35 mm, 40 mm, 50 mm, 60 mm, 70 mm, 80 mm, 90 mm, 100 mm, 120 mm, 150 mm, 170 mm, 200 mm, 220 mm, 250 mm, 270 mm, 300 mm, 400 mm, or 500 mm. The gap size may be at most about 30 μm, 35 μm, 40 μm, 50 μm, 60 μm, 70 μm, 80 μm, 90 μm, 100 μm, 120 μm, 150 μm, 170 μm, 200 μm, 220 μm, 250 μm, 270 μm, 300 μm, 400 μm, 500 μm, 600 μm, 800 μm, 1 mm, 5 mm, 10 mm, 30 mm, 35 mm, 40 mm, 50 mm, 60 mm, 70 mm, 80 mm, 90 mm, 100 mm, 120 mm, 150 mm, 170 mm, 200 mm, 220 mm, 250 mm, 270 mm, 300 mm, 400 mm, or 500 mm. The gap size may be any value between the aforementioned values (e.g., from about 30 μm to about 800 μm, from about 100 μm to about 300 μm, from about 800 μm to about 100 mm, from about 100 mm to about 500 mm). The gap size may be any gap mentioned herein.

The heating can be done by the one or more energy sources. At least two of the energy sources may heat the portions simultaneously, sequentially, or a combination thereof. At least two portions can be heated sequentially. At least two portions can be heated substantially simultaneously. The sequence of heating at least two of the portions may overlap.

In some embodiments, layers (e.g., large layers) can be divided to area portions, patches, or tiles on which transformed material can be deposited. The deposition of the transformed material in at least two of the tiles may be done in sequence, in overlapping sequence, random, parallel, or simultaneously. The deposition of the transformed material to form a multiplicity of tiles may be done in sequence, overlapping sequence, random, parallel, simultaneously, or any combination thereof. In some embodiments, the deposition of transformed material may not be done at random.

In some embodiments, the second heated portion (e.g., area) may be distant from the first heated portion. The heat from the first portion can negligently increase the temperature of the second portion (e.g., before it is heated). Heating the first portion may elevate the temperature of the second portion (e.g., before it is heated) in at most about 0.1%, 0.5%, 1%, 5%, 10%, 15%, or 20%. Heating the first portion may elevate the temperature of the second portion (e.g., before it is heated) by any percentage between the afore mentioned percentages (e.g., from about 0.1% to about 20%, or from about 0.1% to about 10%). The heat from the first portion can negligently alter the dimension of the second portion (e.g., expand in length, width, height, and/or volume). Heating the first portion may alter the form (e.g., dimension) of the second portion (e.g., before it is heated) by at most about 0.1%, 0.5%, 1%, 5%, 10%, 15%, or 20%. Heating the first portion may alter the form of the second portion (e.g., before it is heated) by any percentage between the afore mentioned percentages (e.g., from about 0.1% to about 20%, or from about 0.1% to about 10%).

In some embodiments, no sequence of three tiles of deposited material is disposed in a straight line (e.g., single file). The tree tiles can be deposited sequentially such that the deposition of the first tile is immediately followed by the deposition of the second tile, that is in turn immediately followed by the deposition of the third tile. In some embodiments, at least two of the three tiles are deposited in parallel. In some embodiments, at least two of the three tiles are deposited in an overlapping sequence. An example for an overlapping sequence of deposition can be a first tile that is being deposited on the first layer, and while it is being deposited, the second tile is being its deposition. The first tile can end its deposition before, or during the deposition of the second tile. The numbering of the tile refers to its deposition sequence in time. For example, the term “first” in the “first tile” refers to its deposition sequence in time relative to the second and third tiles. The term “second” in the “second tile” refers to its deposition sequence in time relative to the relative to the first and third tiles. The term “third” in the “third tile” refers to its deposition sequence in time relative to the first and second tiles. In some embodiments, no sequence of three or more tiles of deposited material is deposited in a straight line (e.g., area of preclusion). The three or more tiles can include at least 4, 5, 6, 7, 8, 9, 10, 50, or 100 tiles. The three or more tiles can be any value between the aforementioned values (e.g., from 4 tiles to 100 tiles, from 5 tiles to 10 tiles, from 10 tiles to 100 tiles, or from 7 tiles to 50 tiles). “Between” as understood herein, is meant to be inclusive. The three or more tiles can exclude tiles that reached temperature equilibrium. The three or more tiles can comprise hot tiles. The three or more tiles can comprise tiles that did not completely harden (e.g., solidify). The three or more tiles can exclude tiles that hardened into a hardened (e.g., solid) material. The three or more tiles can include tiles that are disposed on a hot portion of the first layer. The three or more tiles can include tiles that are disposed on a portion of the first layer that did not reach temperature equilibrium. The three or more tiles can exclude tiles that are disposed on a portion of the first layer that is no longer susceptible to deformation (e.g., since it is sufficiently cold and/or is deposited on a portion of the 3D object that is sufficiently sturdy).

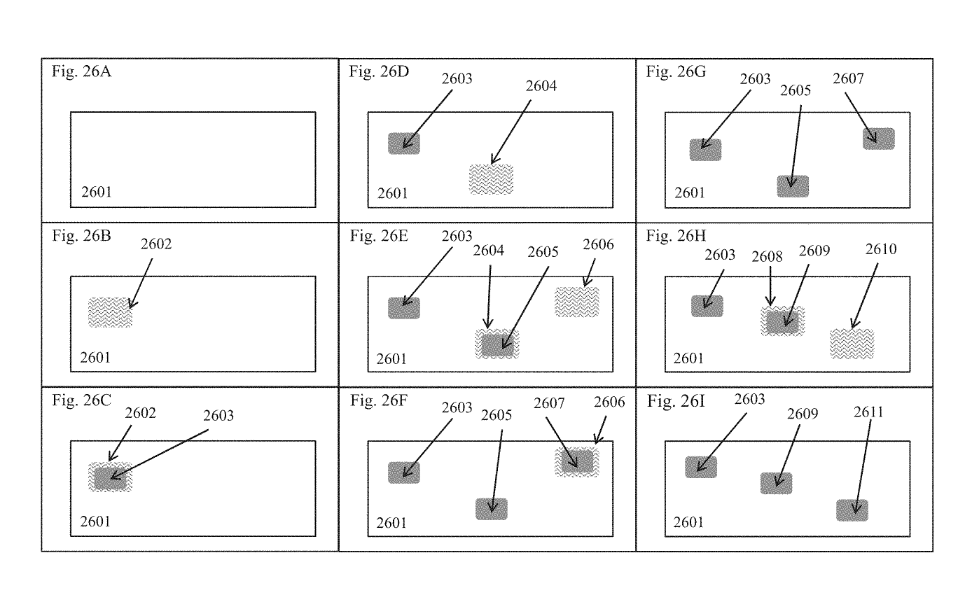

FIGS. 26A-26F schematically show examples of top views of a portion of the Pointillism process. FIG. 26A shows an example of the first layer (e.g., of hardened material) 2601. FIG. 26B shows an example of a portion of the first layer 2601 that that is heated (i.e., 2602). FIG. 26C shows an example of a tile of material 2603 that is deposited within the heated portion 2602. FIG. 26D shows an example of a second heated portion 2604. FIG. 26E shows an example of a second tile of material 2605 that is deposited within the heated portion 2604, and a third heated portion 2606. FIG. 26F shows an example of a third tile of material 2607 within the heated portion 2606. FIG. 26G shows an example of the tree tiles of material 2603, 2605, and 2607 disposed on the first layer 2601, which tiles are not arranged on a straight line. As a comparative example, FIGS. 26H and 26I show examples of alternative continuation operations to the process shown in FIGS. 26A-C, in which the patches or material (e.g., tiles) are deposited in a straight line configuration. FIG. 26I shows an example of three tiles 2603, 2609, and 2611 deposited in a straight line configuration. Such straight line configuration may form a line of weakness, for example, comprising tiles 2603, 2609, and 2611, or adjacent to tiles 2603, 2609, and 2611.

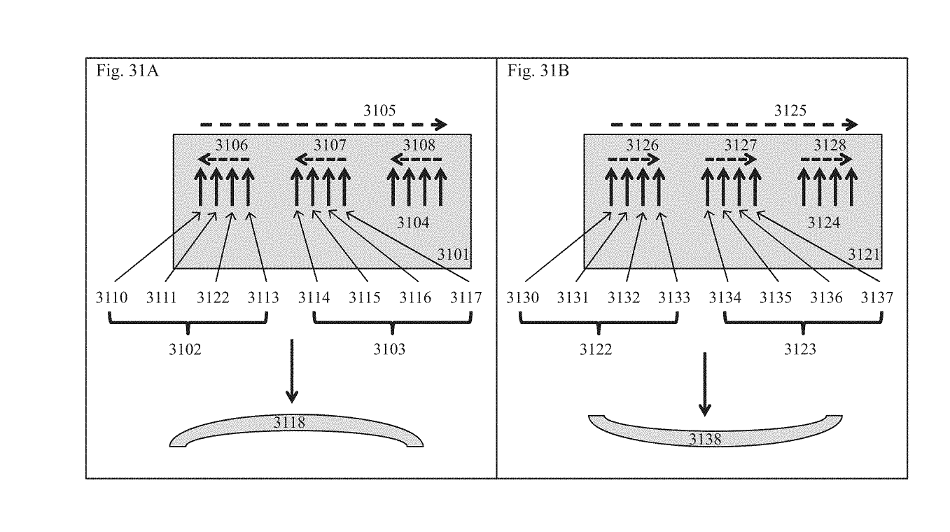

In another aspect disclosed herein is a 3D object comprising a layer of hardened material, wherein the layer of hardened material comprises groups of melt pools. The groups of melt pools can correspond to the tiles (e.g., of the hardened material). The border between one melt pool group to another can be identifiable. The identification comprises material characteristics (e.g., microstructure, crystal structure, or metallurgical structures). The identification comprises melt pool characteristics may be indicative of their formation. For example, the melt pool characteristics can indicate that during the layer formation a hot melt pool contacted a cold melt pool, or a hot melt pool contacted a hot melt pool. Such identification may differentiate between the example in FIG. 31A, in which a hot melt pool created with an energy beam forming the hatch 3114 contacts a cold melt pool that was created with an energy beam forming the hatch 3113, and the example in FIG. 31B, in which a hot melt pool created with an energy beam forming the hatch 3134 contacts a relatively hot melt pool (e.g., recently formed) that was created with an energy beam forming the hatch 3133. In the example shown in FIG. 31A, arrows 3106-3108 represent a top view of the progression of the internal hatches within each of the tiles 3102-3104 respectively, and the arrow 3105 illustrates a top view of the direction in which the path-of-portions progresses. In the example of 31B, arrows 3126-3128 represent a top view of the progression of the internal hatches within each of the tiles 3122-3124 respectively, and the arrow 3125 illustrates a top view of the direction in which the path-of-portions progresses. In example shown in FIG. 31A, side viewed bent layer 3118 corresponds to the top view of layer 3101. In example shown in FIG. 31B, side viewed bent layer 3138 corresponds to the top view of layer shown in 3121.

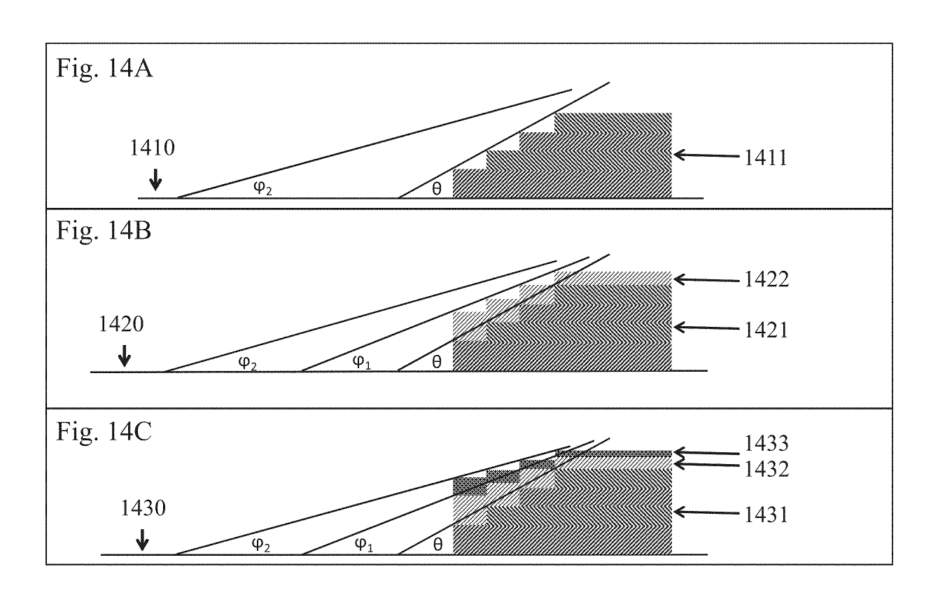

The methods, apparatuses, software, and/or systems disclosed herein may allow the generation of (e.g., upwards facing) one or more surfaces of a 3D object with improved smoothness. In some embodiments, the 3D printing process may be divided into formation of a preliminary 3D object, and smoothing, thickening and/or enlarging one or more surface of the preliminary 3D object. Upward is the direction facing away from the building platform and/or in the direction opposite from the gravitational field direction. An upwards facing surface may include steps due to the discrete layer wise printing of a 3D object, for example, in an additive manufacturing process. These steps may be of the height of the layer thickness or less, and may limit the smoothness of the constructed 3D objects. The methods, apparatuses, software, and/or systems described herein may allow the construction of tilted surfaces that have a lower amount of deviation from the desired smooth surface than the operation height of layer thickness formed by one (or more) added manufacturing method. The methods, apparatuses, software and/or systems described herein may comprise initial generation of steps in an acute angle that is greater than the desired final acute tilt angle. FIG. 14A shows an example of a vertical cross section of a preliminary 3D object 1411, having an initial acute tilt angle theta (0), and a desired (i.e., final) geometry and acute tilt angle phi-two (q) (e.g., as shown in the example of FIG. 14C). The initially generated 3D object (e.g., FIG. 14A, 1411) may be covered with at least one layer of pre-transformed material (e.g., powder) that is transformed and may subsequently harden (e.g., FIG. 14B, 1422), and is designated herein as a “hardened cover,” or a “hardened stratum.” The hardened cover may include new one or more steps. The at least one layer may be one layer or a multiplicity of layers (i.e., a plurality of hardened covers). The multiplicity (e.g., plurality) of hardened covers can be adjacent to each other. Adjacent may comprise on each other, or to the side of each other. The horizontal cross-section of a step (e.g., each step) may be substantially equal to the horizontal cross section of the preliminary 3D object. The vertical cross section of a step (e.g., each step) may have a reduced height as compared to the height of the operations in the preliminary 3D object. In some examples, multiple hardened covers may be applied to the preliminary generated 3D object. The multiple hardened covers can include finer operations (e.g., diminishing steps. E.g., FIG. 14B, 1422, and FIG. 14C, 1433). Diminishing may be in height. Diminishing may be in volume. The final (e.g., average or mean) slope may be the initial slope times a compactization factor to the power of n, where n is the number of times that this process (e.g., covering the preliminary 3D object with a hardened cover) was repeated. The repetition may correspond to the number of hardened covers applied on the preliminary 3D object. The compactization factor may be equal to a subtraction of the powder density from the material density, followed by a division of the subtraction by the material density: {(material-density)−(powder-density)}/(material-density). In some instances, the material density may comprise elemental metal density, metal alloy density, ceramic density, or elemental carbon density. For example, for a powder with a density of ⅔, the compactization factor may be ⅓, resulting in dropping the height (and hence roughness) of the final slope by three-times for every repetition of the process described herein.

In another aspect, a method for generating a 3D object comprises: a) depositing a first layer of pre-transformed material (e.g., powder) in an enclosure; b) forming a first hardened material from at least a portion of the first layer of material; c) depositing a second layer of material in the enclosure; b) forming a second hardened material from at least a portion of the second layer of material; d) depositing a third layer of material in the enclosure to cover the first hardened material and the second hardened material; e) forming a third hardened material from at least a portion of the material in the enclosure, wherein the third hardened material covers at least a portion of the first hardened material and of the second hardened material, wherein the first hardened material, the second hardened material and the third hardened material form at least a portion of a 3D object.

The method can further comprise, after the depositing operation and before the forming step, transforming the material in the enclosure to form a transformed material (e.g., a first, second or third transformed material respectively). The method can further comprise after the depositing operation and before the forming operation (or before the transforming step), providing an energy (e.g., energy beam) to a portion of the layer of material (e.g., powder) according to a path. The energy can be a transforming energy. The energy beam that forms the first, second or third transformed material can be the same or different. The energy beam that forms the first, second or third transformed material can be the same energy beam. The energy beam that forms the first, second or third transformed material can be a first, second or third energy beam respectively. The path that forms the first, second or third transformed material can the same or different. The path that forms the first, second or third transformed material can be a first, second or third path respectively. In some instances, the first transforming energy and the second transforming energy are substantially equal. In some instances, the first transforming energy and the second transforming energy vary. In some instances, at least the first transforming energy and the second transforming are generated by the same energy source. In some instances, the first transforming energy and the second transforming are generated by different energy sources. The third hardened material can be a hardened cover (also referred herein as a hardened stratum). The hardened cover may be the top surface of the 3D object that faces away from the building platform above which at least a portion of the 3D object is generated.

The hardened cover may be made by any material disclosed herein. The hardened cover may comprise a corrosion and/or oxidation deterrent material (e.g., anti-corrosion and/or anti-oxidation material). For example, the material may comprise MCrAlX, where M may comprise iron (Fe), cobalt (Co) or nickel (Ni); X may comprise yttrium (Y), silicon, scandium (Sc), a rare earth element, or hafnium. The hardened cover may comprise a material that is a poor heat conductor (e.g., an insulator). The hardened cover may comprise a thermal barrier. For example, the hardened cover may include zinc oxide (e.g., ZrO₂), Yttrium oxide (e.g., Y₂O₃), calcium oxide, magnesium oxide, or any combination (e.g., complexation) thereof.

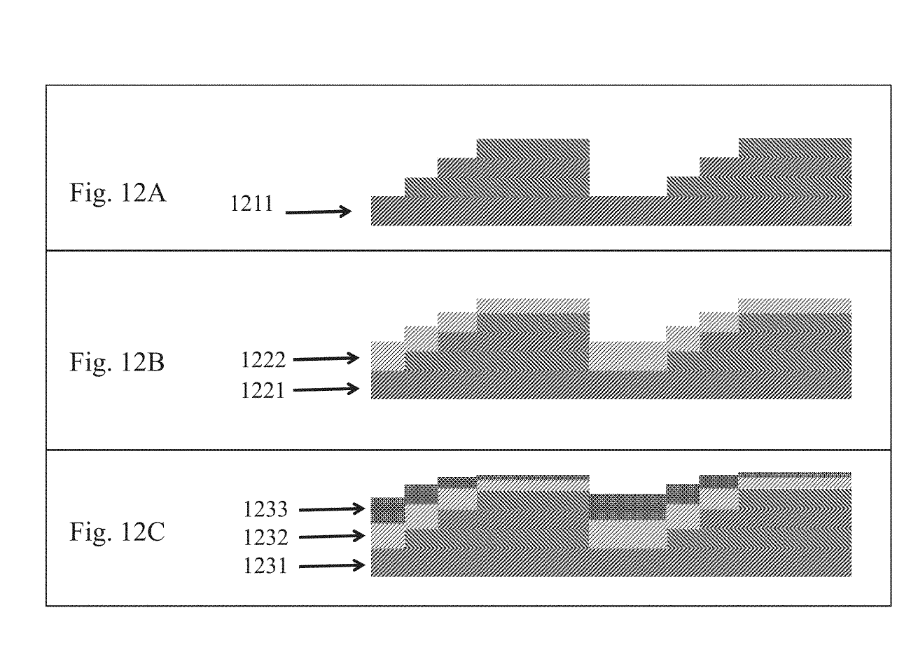

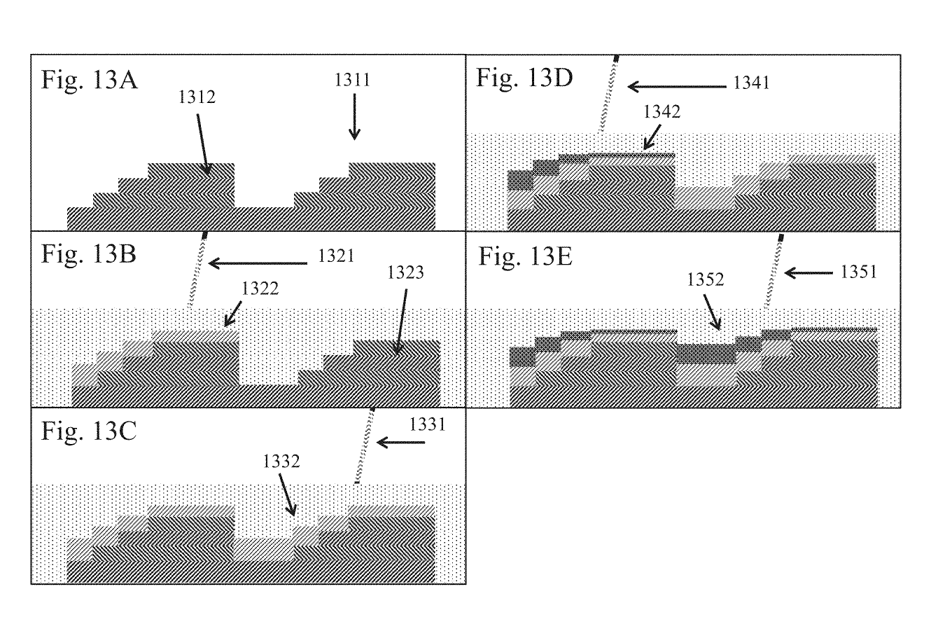

The methods described herein may comprise generating at least a portion of a 3D object by at least one additive manufacturing method, covering the at least a portion of a 3D object by a layer of pre-transformed material (e.g., powder), transforming at least a section of the layer of material into a transformed material that covers at least a portion of the surface of the at least a portion of a 3D object, and allowing the transformed material to harden (e.g., into a hardened cover). The surface may be the top surface of the 3D object that faces away from the building platform (above which at least a portion of the 3D object is generated). FIG. 13B shows an example of a 3D object 1323 whose top surface is partially covered by a hardened cover 1322. The methods described herein may comprise generating a 3D object by an additive manufacturing method, covering 3D object by a layer of material (e.g., powder), transforming a top section of the layer of material into a transformed material that covers at least a portion of the top surface of 3D object, and allowing the transformed material to harden, thus forming a hardened cover. FIGS. 12A-12C and FIGS. 13A-13E show examples of the formation process of a hardened cover on top of the (e.g., initially formed) 3D objects 1211 and 1312 respectively. Each layer of hardened cover may be formed in a single operation or in multiple steps. FIGS. 12A-12C show an example where each layer of hardened cover is formed in a single operation (e.g., in FIG. 12B showing the hardened cover 1222 on a previously formed layer 1221, and FIG. 12C showing the hard cover 1233 on previously formed layer 1231 and 1232). FIGS. 13A-13E illustrate examples where each layer of the hardened cover is formed in two-operations (e.g., FIG. 13B showing the first portion of a hardened cover layer 1322; FIG. 13C showing the second portion of a hardened cover layer 1332; FIG. 13D showing the first portion of a hardened cover layer 1342; and FIG. 13E showing the second portion of a hardened cover layer 1352). The 3D object may comprise one or more layers of hardened cover. The 3D object may comprise at least 1, 2, 3, 4, 5, 6, 7, 8, 9, or 10 layers of hardened cover. The 3D object may comprise at most 1, 2, 3, 4, 5, 6, 7, 8, 9, or 10 layers of hardened cover. The 3D object may comprise a number of hardened cover layers between the afore-mentioned number of hardened cover layers. The hardened cover layers may be of the same material as the 3D object, or of a different material. All the hardened cover layers may be of the same material. At least two of the hardened cover layers may be of a different material. At least two of the hardened cover layers may be of the same material. The material of the hardened cover layers may comprise elemental metal, metal alloy, elemental carbon, ceramic, glass, or organic material (e.g., polymeric material). The generated 3D object may comprise a plurality of hardened cover layers. FIG. 12A depicts a vertical cross section of a 3D object 1211 printed by a 3D printing methodology (e.g., an additive manufacturing process). An example of a first hardened cover is depicted in FIG. 12B, 1222. An example of a second hardened cover is depicted in FIG. 12C, 1233. The hardened cover may be generated after all the cross sections of the 3D object were generated (i.e., printed). The hardened cover may be generated after only a portion of the cross sections of the 3D object were generated (i.e., printed). The hardened cover may be generated as part of the printing process. The hardened cover may be generated subsequent to, or as part of at least one 3D printing method (e.g., additive manufacturing). The hardened cover may be generated subsequent to, or as part of any method for generating 3D object described herein. In some examples, the hardened cover provides a smoother surface of the portion of the first 3D object that it covers, as compared to that portion of the 3D object that does not comprise the hardened cover. The thickness of the hardened cover can be constant. The thickness of the hardened cover can vary. The thickness of the hardened cover can vary linearly. The hardened cover can be thicker in a direction closer to the building platform above which the 3D object is generated. In some embodiments, the 3D object with the hardened cover comprises a top surface that is smoother or more leveled, as compared to a 3D object that is devoid of the hardened cover. At times, the variation in the thickness of the hardened cover is controlled. The top surface of the 3D object may form an acute angle theta (0) with a reference plane. The reference plane can be a plane perpendicular to the direction of the gravitational field. The reference plane may be a plane parallel to the platform. The top surface of the 3D object that is covered with a first layer of hardened cover may form an acute angle phi-one (φ₁) with the reference plane. In some examples theta is larger than phi (i.e., θ>φ). The top surface of the 3D object that is covered with a n^{th} layer of hardened cover may form an acute angle phi-n (φₙ) with the reference plane. In some examples, phi-one is greater than phi-two. In some examples, phi of the n^{th} hardened cover layer is greater than phi of the (n+1)^{th} hardened cover layer, where n is an integer that is greater or equal to 1 (i.e., φₙ>φₙ₊₁). The hardened cover may comprise a varied thickness. When the material in the powder bed is a powder material, the angle phi-n (φₙ) may depend on: θ*{(ρₘₐₜₑᵣᵢₐₗ−ρ_{powder})/ρₘₐₜₑᵣᵢₐₗ}ⁿ, where n is the number of layer, ρₘₐₜₑᵣᵢₐₗ is the density of the material of which the powder is composed, and ρ_{powder} is the density of the powder material in the powder bed. For example, FIG. 14A shows a vertical cross section of a 3D object 1411, which top surface of the 3D object forms an angle theta (θ) with the plane 1410. FIG. 14B shows a first hardened cover 1422 of varied thickness on the 3D object 1421, whose top surface of forms an angle phi-one (φ₁) with the plane 1420. FIG. 14C shows a second hardened cover 1433 of varied thickness on the 3D object 1431 having a first hardened cover 1432, whose top surface of forms an angle phi-two (φ₂) with the plane 1430.

In another aspect, a method for generating a 3D object comprises: a) depositing a first layer of pre-transformed material (e.g., powder) in an enclosure; b) providing a first energy to a portion of the first layer of material according to a first path; c) transforming the portion of the first layer of material (or a section thereof) to form a first transformed material; d) allowing the first transformed material to harden into a first hardened material; e) repeating operations a) to d) to form a second hardened material (with a second layer of material, a second energy and a second path respectively); f) depositing a third layer of material in the enclosure to cover at least a portion of the first hardened material and of the second hardened material; g) providing a third energy to a portion of the third layer of material according to a third path; h) transforming a portion of the material in the enclosure to form a third transformed material, wherein the third transformed material covers at least a portion of a surface of the first hardened material and of the second hardened material; and i) allowing the third transformed material to harden into a third hardened material, wherein the first, second and third hardened material are a portion of the 3D object.

The surface roughness of the 3D object (or a portion thereof) may be measured as the arithmetic average of the roughness profile (hereinafter “Ra”). The hardened cover can have a Ra value of at least about 1000 micrometers (μm), 800 μm, 500 μm, 400 μm, 300 μm, 200 μm, 150 μm, 100 μm, 75 μm, 50 μm, 45 μm, 40 μm, 35 μm, 30 μm, 25 μm, 20 μm, 15 μm, 10 μm, 7 μm, 5 μm, 3 μm, 1 μm, 500 nm, 400 nm, 300 nm, 200 nm, 100 nm, 50 nm, 40 nm, or 30 nm. The hardened cover can have a Ra value of at most about 1000 μm, 800 μm, 500 μm, 400 μm, 300 μm, 200 μm, 150 μm, 100 μm, 75 μm, 50 μm, 45 μm, 40 μm, 35 μm, 30 μm, 25 μm, 20 μm, 15 μm, 10 μm, 7 μm, 5 μm, 3 μm, 1 μm, 500 nm, 400 nm, 300 nm, 200 nm, 100 nm, 50 nm, 40 nm, 30 nm, or 20 nm. The hardened cover can have a Ra value between any of the aforementioned roughness values (e.g., from about 20 nm to about 1000 μm, from about 50 nm to about 500 μm, from about 100 μm nm to about 400 μm). The bottom surface may be rougher than the top surface comprising the hardened cover. Ra may be the Mean Roughness (i.e., Roughness Average Ra). Ra may be the arithmetic average of the absolute values of the roughness profile ordinates. Ra may be the center line average. Ra may provide a general description of the height variations in the surface. The average roughness may be the area between the roughness profile and its mean line. The average roughness may be the integral of the absolute value of the roughness profile height over the evaluation length. Ordinates as understood herein represent the distance from a point to the horizontal (e.g., x-axis) measured parallel to the vertical (e.g., y) axis. The Ra values may be measured by a contact or by a non-contact method. The Ra values may be measured by a roughness tester and/or by a microscopy method (e.g., any microscopy method described herein). The measurements may be conducted at ambient temperatures (e.g., R.T.), melting point temperature (e.g., of the pre-transformed material) or cryogenic temperatures. The roughness may be measured by a contact or by a non-contact method. The roughness measurement may comprise one or more sensors (e.g., optical sensors). The roughness measurement may comprise using a metrological measurement device (e.g., using metrological sensor(s)). The roughness may be measured using an electromagnetic beam (e.g., visible or IR).

The top surface of the 3D object (e.g., as situated during the 3D printing) may be rougher than the bottom surface. At times, the top and bottom surfaces of the generated 3D object may have a substantially similar roughness. The bottom surface of the printed 3D object may have an Ra value that is about 1.1, 1.2, 1.4, 1.5, 1.6, 1.7, 1.8, 1.9, 2, 2.5, 3, 3.5, 4, 4.5, 5, 5.5, 6, 6.5, 7, 7.5, 8, 8.5, 9, 10, 15, 20, 25, 30, 35 or 40 times larger than the Ra value of the top surface. The top surface of the hardened cover may have an Ra value that is about 1.1, 1.2, 1.4, 1.5, 1.6, 1.7, 1.8, 1.9, 2, 2.5, 3, 3.5, 4, 4.5, 5, 5.5, 6, 6.5, 7, 7.5, 8, 8.5, 9, 10, 15, 20, 25, 30, 35 or 40 times larger than the Ra value of the bottom surface.

In another aspect, a 3D object comprises two or more layers of (hardened) material generated by at least one 3D printing method, wherein the two or more layers comprise two or more (e.g., substantially) parallel layering planes respectively, wherein a portion of the surface of the first 3D object incorporates a stratum (e.g., hardened stratum), wherein the stratum can comprise a layering plane that is not parallel to the two or more layering planes. The stratum may be a layer (of hardened material) that covers at least a portion of the surface of the 3D object. The stratum may form a hardened cover. The at least a portion of the surface of the 3D object may be at least a portion of the top surface of the 3D object. Top may be in the direction opposite to the building platform. The stratum may be of the same material of which the 3D object is composed (e.g., the same material as of the two or more layers). The stratum may comprise the same material of which the 3D object is composed (e.g., the same material as of the two or more layers). The stratum may be of a different material of which the 3D object is composed (e.g., the same material as of the two or more layers). The stratum may comprise a different material of which the 3D object is composed (e.g., the same material as of the two or more layers). The stratum may be a lamination layer. The stratum may comprise a corrugation. The stratum may comprise a smooth surface. The stratum may comprise an average surface that is smoother than the average surface of the 3D object. The stratum may comprise a corrugated surface. The stratum may comprise one or more steps. The stratum may comprise one or more steps in at least one of its surface. The stratum may comprise one or more steps in its surface that contacts the 3D object. The stratum may comprise one or more steps in its surface that does not contact the 3D object. The stratum may comprise one or more steps in its surface that contacts the 3D object, and one or more steps in its surface that does not contact the 3D object. The stratum may comprise one or more steps in its surface that contacts the 3D object, and no significant (e.g., apparent) steps in its surface that does not contact the 3D object. The thickness of the stratum can be heterogeneous. The thickness of the stratum may vary linearly. The thickness of the stratum may vary step-wise. The thickness of the stratum may vary as a function of the relative position of the two or more layers. The thickness of the stratum may be thicker in a position situated adjacent to an earlier formed layer of hardened material of the two or more layers of hardened material within the 3D object. The thickness of the stratum may be thicker in a position situated adjacent to a layer of hardened material that is closer or equal to a first formed layer of the generated 3D object. The thickness of the stratum may be substantially homogenous. The portion of the surface of a 3D object that is devoid of the stratum may comprise a rougher portion of the surface as compared to the respective surface portion in the 3D object that comprises the stratum. The stratum may be used to smooth the surface of a 3D object. The stratum disclosed herein may be used to level, smooth, and/or flatten the surface of a 3D object. The stratum may be used to fill up steps, holes, gaps, embossed area, or depressions on the surface of a 3D object. The stratum may be used to mask steps, holes, gaps, embossed area, projections or depressions on the surface of a 3D object. The hardened cover may be smoother than the surface of the 3D object devoid of the hardened cover. The Ra value of the surface of the 3D object devoid of the hardened cover may be at least about 1.5, 2, 3, 4, 5, 6, 7, 8, 9, 10, 15, 20, 30, 40, 50, 60, 70, 80, 90, or 100 times larger than the Ra value of the outer (i.e., external) surface of the hardened cover. The surface of the 3D object devoid of the hardened cover may comprise steps having a step height of at least about 5 μm, 10 μm, 20 μm, 30 μm, 40 μm, 50 μm, 60 μm, 70 μm, 80 μm, 90 μm, or 100 μm. The surface of the 3D object devoid of the hardened cover may comprise steps having a step height of at most 5 μm, 10 μm, 20 μm, 30 μm, 40 μm, 50 μm, 60 μm, 70 μm, 80 μm, 90 μm, or 100 μm. The surface of the 3D object devoid of the hardened cover may comprise steps having a step height of any value between the afore-mentioned values. The average step height of the surface of the 3D object with the hardened cover (i.e., stratum) may be at least 1.5, 2, 3, 4, 5, 6, 7, 8, 9, 10, 15, 20, 30, 40, 50, 60, 70, 80, 90, or 100 times smaller. The average step height of the surface of the 3D object with the hardened cover (i.e., stratum) may be at most 1.5, 2, 3, 4, 5, 6, 7, 8, 9, 10, 15, 20, 30, 40, 50, 60, 70, 80, 90, or 100 times smaller. The average step height of the surface of the 3D object with the hardened cover (i.e., stratum) may be any value between the afore-mentioned values. The outer surface is the surface that points away from the center of the 3D object.

In another aspect, a 3D object comprises two or more layers of material generated by at least one 3D printing method. The two or more layers may form a surface that includes steps. The surface may include corrugations. The surface may be staggered or otherwise uneven. The unevenness of the surface may be due to the two or more layers. The unevenness of the surface may be due to the 3D printing (e.g., additive manufacturing process). The unevenness of the surface may be due to the process by which the 3D object was generated. In some instances, the surface generated by the two or more layers may be covered by a stratum (e.g., hardened stratum). The surface of the 3D object may be smooth and cover the uneven, staggered, stepped, corrugated, and/or jittered surface of the two or more layers. The stratum may cover the surface generated by the two or more steps. The stratum may level out and/or smooth the surface of the two or more steps. The stratum may include steps. The steps of the stratum may be smaller than the steps created by the two or more layers. The stratum may include steps of varied height. The two or more layers may include steps of substantially identical height. The height of the steps of the two or more layers may depend on the thickness of the layer used in the 3D printing process. The height of the steps of the stratum may not depend on the thickness of the layer of hardened material printed in the 3D printing process. In some instances, the height of the steps of the stratum may depend on the thickness of the layer of hardened material printed in the 3D printing process. The steps of the stratum may form an acute angle phi with a reference plane. The steps of the two or more layers may form an acute angle theta with a reference plane. Theta may be larger than phi. The angle phi may depend on the density of the pre-transformed material (e.g., in the material bed) from which the 3D object was generated. For example, the angle phi may depend on the density of the powder from which the 3D object was generated (e.g., density of powder material within a powder bed).

In another aspect, a method for generating a 3D object comprises: a) depositing a first layer of pre-transformed material (e.g., powder) in an enclosure; b) providing a first energy beam to the first layer of pre-transformed material; c) transforming at least a section of the first layer of pre-transformed material to form a first transformed material; d) depositing a second layer of pre-transformed material in an enclosure; e) providing a second energy to the second layer of material; f) transforming at least a section of the second layer of pre-transformed material to form a second transformed material; g) hardening the second transformed material into a second hardened material; h) depositing a third layer of pre-transformed material in an enclosure; i) providing a third energy to the third layer of material; j) transforming at least a section of the third layer of pre-transformed material to form a third transformed material; k) hardening the third transformed material into a third hardened material, wherein the third hardened material traverses at least a portion of the first hardened material and at least a portion of the second hardened material; and wherein the hardened material forms at least a portion of a generated first 3D object. The first, second and third energy beams may be (e.g., substantially) identical. The first, second and third energy beams may be different by at least one energy characteristics. At least two of the first, second and third energy may be (e.g., substantially) identical. At least two of the first, second and third energy beams may be different by at least one energy beam characteristics. The first, second and third energy beams may originate from one energy source. The first, second and third energy (e.g., energy beams) may originate from different energy sources. At least two of the first, second and third energy may originate from the same energy source. At least two of the first, second and third energy may originate from a different energy source.

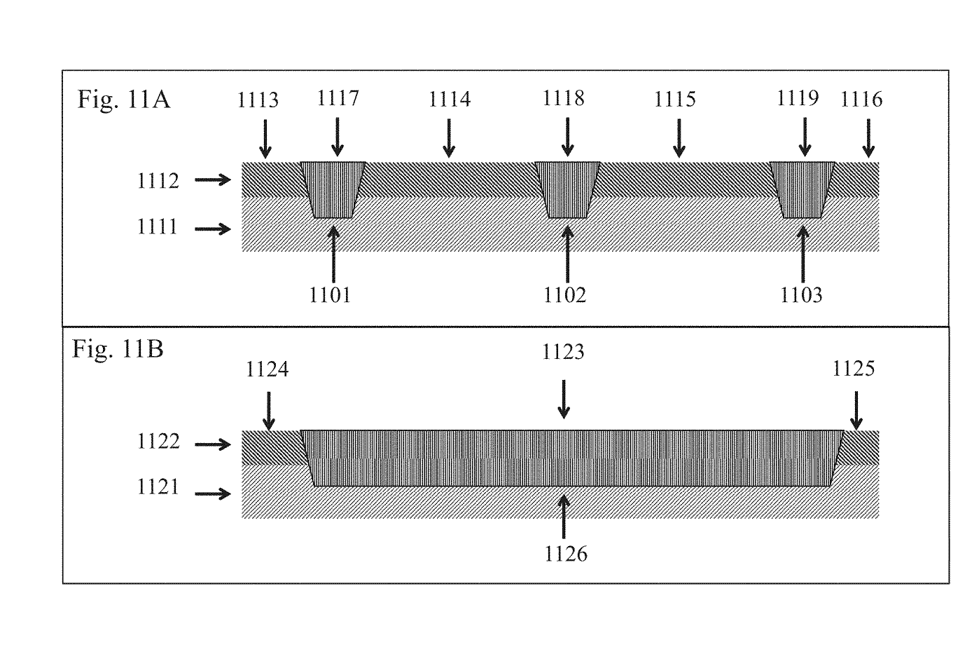

The first layer of hardened material can include disconnected tiles. The second layer of hardened material can include disconnected tiles. FIG. 11A shows a second layer of material (e.g., hardened) comprising disconnected tiles 1113-1116. The first layer of hardened material can include connected tiles (e.g., a single tile). The tiles may be separated from each other by one or more gaps. The first layer of hardened material may comprise one or more crevices, valleys or depressions. FIG. 11A shows a first layer of material (e.g., hardened) comprising depressions 1101-1103. The third material can comprise a welding material. The welding material may fill the gap partially, entirely, or in excess. The third material can form weld pools. The second layer of hardened material can include connected tiles (e.g., though welding by the third material). The first hardened material can connect to the second hardened material in one or more positions. The gap may be filled using an energy (e.g., heat energy). The gap may be filled by a transformed material (e.g., powder), using an energy (e.g., heat energy). The energy (e.g., energy beam) may transform the material to at least fill a portion of the gap. The energy source emitting the energy beam may emit constant or varied amount of energy. The amount of energy may gradually decrease as the gap is being filled (e.g., with transformed material). The decrease rate may follow a series. The series may be converging or diverging. The series may be a telescopic series. The series may comprise a linear series, arithmetic series, geometric series, arithmetic-geometric series, exponential series, or logarithmic series. The logarithmic series may comprise a common or natural logarithmic series. The exponential series may comprise a natural exponential series. The series may comprise a mathematical series. The series may comprise a power series (e.g., a Taylor series). The series may comprise a trigonometric series (e.g., Fourier series). The series may comprise a Laurent or Dirichlet series.

FIG. 11A shows an example of a third layer of material (e.g., hardened) comprising three sections 1117-1119, a first layer 1111 and a second layer 1112. The third hardened material can comprise a surface. The surface may be planar or non-planar. FIG. 11B shows a third layer of material (e.g., hardened) comprising a plane 1123, a first layer 1121 and a second layer 1122. The third hardened material can comprise a plane. The third hardened material may comprise a mesh or intertwining wires. The first, second and third hardened material may be (e.g., substantially) identical or have (e.g., substantially) identical material characteristics. The first, second, and/or third hardened material may be different by at least one material type or material characteristics. At least two of the first, second, and third hardened material may be (e.g., substantially) identical or have (e.g., substantially) identical material characteristics. At least two of the first, second, and third hardened material may be different by at least one material type or material characteristics. The third material may connect, adhere, and/or weld the sections (e.g., tiles) of the second material. The third material may penetrate into the first layer of (hardened) material. The third material may contact, but not penetrate into the first layer of (hardened) material.

The first hardened material and the second hardened material that are connected may deform (e.g., warp or shrink). The first hardened material and the second hardened material that are connected may (e.g., substantially) not deform. The first hardened material and the second hardened material that are connected may minimally deform. The minimal deformation may be a deformation by at least about 0.2%, 0.4%, 0.6%, 0.8%, 1%, 2%, 3%, 4%, 5%, 10%, 15%, 20% of the hardened material as compared to the transformed material. The minimal deformation may be a deformation by at most about 0.2%, 0.4%, 0.6%, 0.8%, 1%, 2%, 3%, 4%, 5%, 10%, 15%, 20% of the hardened material as compared to the transformed material. The minimal deformation may be a deformation by any percentage between the above-mentioned percentages. The percentages may be weight-by-weight, volume-by-volume, vertical-cross-sectional-area by vertical-cross-sectional-area or horizontal-cross-sectional-area by horizontal-cross-sectional-area. In some example, at least one portion of the first hardened material is an anchor to the hardening of the second hardened material. In some examples, at least one portion of the first hardened material anchors the second hardened material. The third material structure can include a spot. The spot may be a clump. The spot may comprise a sphere. The spot may comprise a cone or a conical section. The spot may comprise a cuboid or a cylinder. The spot may comprise an ellipsoid (e.g., a sphere). The spot may comprise a geometrical shape. The third hardened material can comprise a wire. The wire disclosed herein may be a substantially horizontal wire. The wire may be linear or not winding.

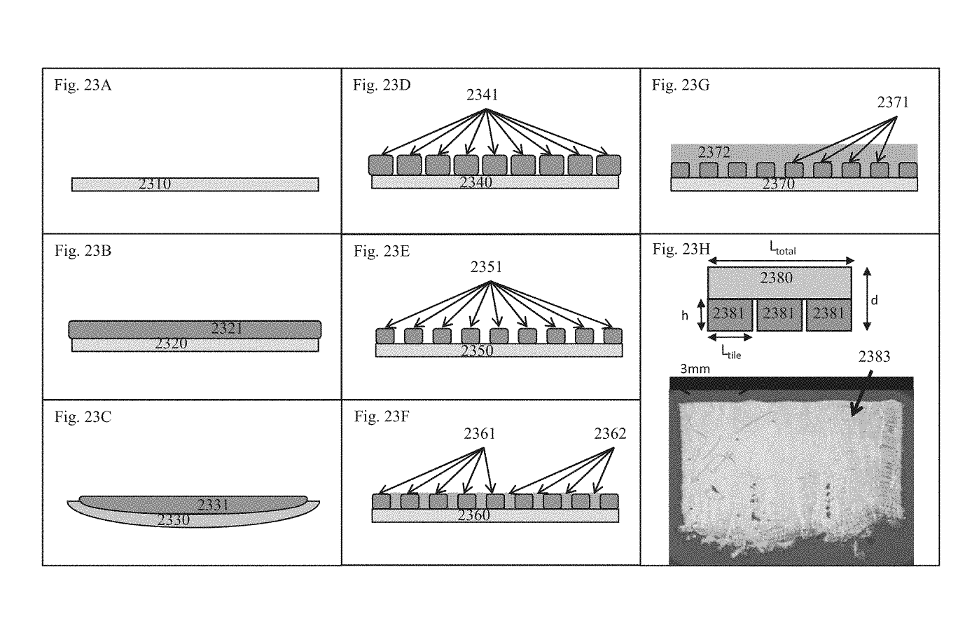

In some embodiments a second layer may be printed on a planar first layer. Upon cooling of the second layer, the formed 3D object may deform. FIGS. 23A-23C show schematically vertical cross section examples of various stages in the formation of a 3D object. FIG. 23A shows an example of first layer of hardened material 2310. FIG. 23B shows an example of a warm second layer of transformed and/or partially hardened material 2321 that is added on a first layer 2320. FIG. 23C shows an example of the second layer 2331 that is added on a first layer 2330 (e.g., as in FIG. 23B) and subsequently hardened (e.g., cooled). In some instances, the hardening of the second layer contracts the volume of the second layer, which causes the hardened 3D object to deform.

In some embodiments, the second layer may be printed as two or more disconnected tiles that may be subsequently welded. The position of the disconnection may be related to the structure (e.g., geometry) of the previously formed portion of the 3D object. The position of the disconnection may be related to the structure of the desired 3D object. The position of the disconnection (e.g., gap) may be related to the particular position in which the gap is created and/or the particular position in which the tiles are deposited. The tiling may reduce the degree of deformation of the generated 3D object. For example, the tiling may reduce the degree of warping of the 3D object (or a portion thereof). The tiles may be subsequently welded (e.g., as disclosed herein). The welding may be below, at, or above the average (or mean) top surface of the tiles. Welding at the average top surface of the tiles is termed herein as “deep welding” (e.g., FIG. 23F). Welding above the average top surface of the tiles is termed herein as “Layered merging,” (e.g., FIG. 23G).

The welding may connect two or more tiles and form one continuous layer of hardened material. The welding may be of a material that is substantially identical, or different, then the material of the tiles. The tiles may be of a material substantially identical, or different, then the material of the first layer (e.g., bottom skin layer). FIGS. 23A, 23D-23G show schematically vertical cross section examples of various stages in the formation of a 3D object. FIG. 23D shows an example of a second layer that is separated into tiles 2341 (e.g., patches) that are just added on a first layer (e.g., of hardened material) 2340 and are still warm. FIG. 23E shows an example of the tiles 2351 of the second layer that was added on a first layer 2350 (e.g., in 23D) and subsequently hardened (e.g., cooled). FIG. 23E shows an example of a cooled construct of the example in FIG. 23D. FIG. 23H shows an example of a vertical cross section in a stainless steel 316L 3D object 2383 (obtained by an optical microscope) that was formed according to the schematics of FIG. 23E, which schematics includes parts 2380 and 2381. In some embodiments, the hardened tiles are sufficiently small to form a negligible deformation of the 3D object (e.g., as they cool down). The tiles can be subsequently welded. FIG. 23F shows a schematic example of welded tiles, in which the welding 2362 does not exceed the height of the tiles 2361. FIG. 23G shows an example of welded tiles in which the welding 2372 exceeds the height of the tiles 2371, and forms a thicker second layer. The dimension (e.g., FLS or volume) of the tile may be larger, equal, or smaller than the dimension of the gap. The dimension may include width, height, length, or volume.

The welding can be performed by adding one or more contact points (e.g., connecting points) to the non-connected area (e.g., gap), or adding an entire layer that will cover the top surface of the hanging structure and the posts, as well as the to-be-welded areas. The welding material may be dense or porous. The welding portion may be dense or porous.

The FLS of the gap may be at least about 40 μm, 50 μm, 60 μm, 70 μm, 80 μm, 90 μm, 100 μm, 50 μm, 60 μm, 70 μm, 80 μm, 90 μm, 100 μm, 500 μm, 700 μm, 1000 μm, 2000 μm, 3000 μm, 4000 μm, or 5000 μm. The FLS of the gap may be at most about 50 μm, 60 μm, 70 μm, 80 μm, 90 μm, 100 μm, 50 μm, 60 μm, 70 μm, 80 μm, 90 μm, 100 μm, 500 μm, 700 μm, 1000 μm, 2000 μm, 3000 μm, 4000 μm, 5000 μm, or 6000 μm. The FLS of the gap may be at any value between the aforementioned values (e.g., from about 40 μm to about 6000 μm, 100 μm to about 3000 μm, or from about 100 μm to about 5000 μm). The height of the gap can be (e.g., substantially) equal to the height of the layer of pre-transformed, transformed, and/or hardened material.

In situations where the layer comprises two or more gaps, at least two of the gaps may be welded simultaneously or sequentially. In situations where the layer comprises two or more gaps, the gaps may be welded simultaneously, sequentially, or any combination thereof. For example, some of the gaps may be welded simultaneously and some of the gaps may be welded sequentially. In some instances, the welding technique may reduce stresses within the formed 3D object.

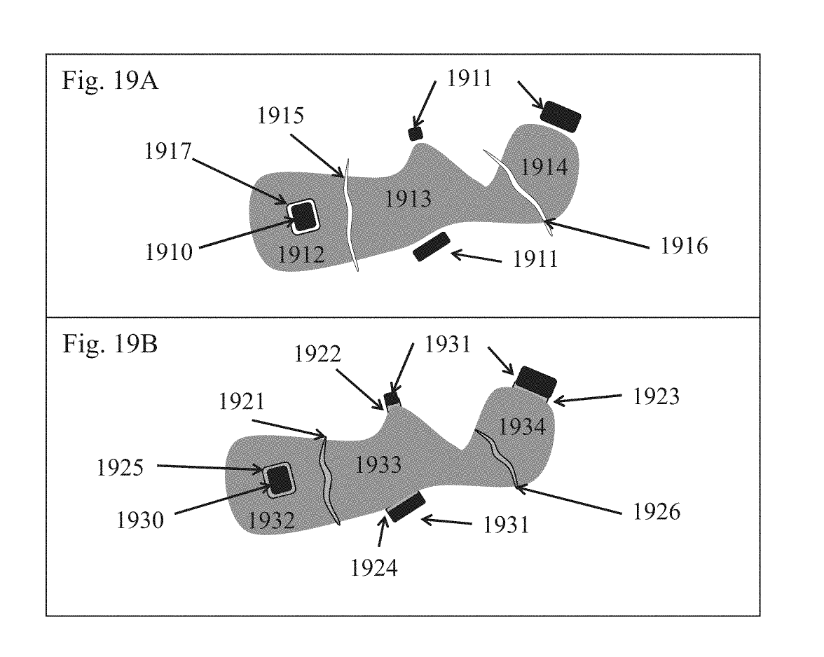

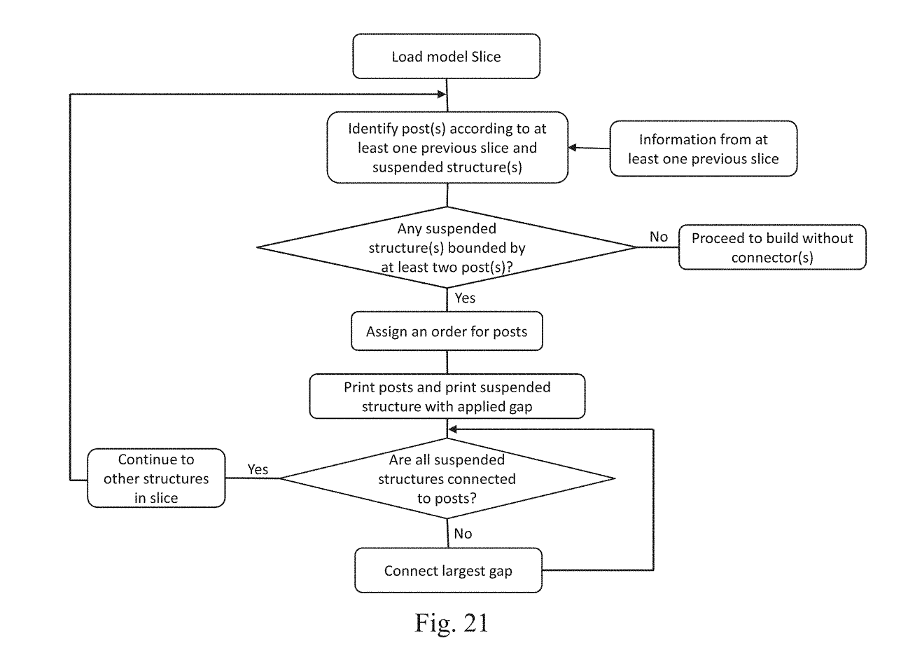

In some examples, the method, systems and/or apparatus may comprise a controller. The controller may comprise a software. In some instances, the software may be separated (e.g., disconnected) from the controller. In some instances, the software may be an integral part of the controller. The software may define a ranking (e.g., order) of welding. The software may identify a first mating surface (e.g., from a first tile) and a second mating surface (e.g., from a second tile) to be connected (e.g., through welding). The mating surfaces are the surface to be connected by welding. The software may generate a sequence of events. The sequence of events may be a logical sequence of events. An algorithm may include the sequence of events. The software may consider process build parameters (e.g., real-time and/or historical). The software may consider thermal analysis of the material bed and/or 3D object (e.g., hardened material of the forming or previously formed 3D object portion). The thermal analysis may consider the material in the material bed and/or hardened material. The thermal analysis may comprise dissipation of heat though the material bed and/or at least a portion of the 3D object. The software may consider thermal simulations (e.g., within the material bed and/or the hardened material). The sequence of events may be represented as a flowchart. The software may generate the flowchart. The flowchart may be a logic flow diagram. The flowchart may be an algorithm. FIG. 21 shows an example of a flowchart. In some embodiments, the welding order may not rely of the size of the portions (e.g., tiles and/or posts) to be welded. The tiles and/or posts may be connected though welding. The hanging structures (e.g., tiles) and/or posts can be directly or indirectly connected though welding. For example, the hanging structures (e.g., tiles) and/or posts can be connected though a single weld pool or through multiple weld pools. The software may receive a model of a desired 3D object. The model may comprise one or more slices (e.g., layer slices). The software (e.g., algorithm) may identify the number and locations of posts and/or hanging structures. The algorithm may take into account at least one previous slice (e.g., in order to determine the posts). The algorithm may determine the existence of one or more hanging structures in a slice of the 3D model. The algorithm may determine whether any hanging structure is bordered by at least two posts. The algorithm may rank the posts. The algorithm will generate directions for incorporation of gaps between the two or more posts and the at least one hanging structure that is bound between the posts. The algorithm may assign an order to the posts. The software may apply gaps to the subject slice (e.g., layer slice). The software may generate directions to print a portion of the posts and hanging structure that corresponds to the subject slice. The gap may be located between the hanging structure and the post. The gap can be located within the hanging structure. For example, the gap can divide a hanging structure into two or more sections. FIG. 19A shows an example of a horizontal cross section, top or bottom view of a layer that includes a hanging structure composed of sections 1912-1914, that is internally separated by gaps 1915 and 1916. The suspended structure is separated from side posts 1911 by gaps. The suspended structure is separated from an internal post 1910 by a gap 1917. FIG. 19B shows a horizontal cross section, top or bottom view example of the structure in 19A, in which the gaps are welded 1921-1926 to form a continuous layer. The software may take into account the applied gaps. The algorithm may assign an order to the gaps. The algorithm may assign a sequence to the gaps. The software may generate directions (e.g., executed by the controller), to weld the gaps in the assigned order (e.g., sequence). The ranking of the gaps may take into account the size (e.g., FLS and/or volume) of the gap (e.g., height, width, length, and/or volume). The ranking may comprise sequence determination, ordering, classifying, grouping, lining up, and/or succession. The ranking of the gaps may take into account the size (e.g., FLS, volume, and/or density) and/or shape of the corresponding posts. The ranking of the gaps may take into account the size and/or shape of the hanging structure(s). The ranking of the gaps may take into account energy depletion from the material deposited in the gap (e.g., welding material), from the adjacent post(s), and/or hanging structure(s). The software may generate a sequence for the welding of the gaps. The controller may identify constraints imposed on the suspended structure by post(s). The controller (e.g., using the software) may generate a welding request. The welding request may be based on the size (e.g., FLS, volume, and/or density) of the gap. The controller may identify in real time any remaining gaps. The controller may be a real-time controller. In real-time may be during the formation of the layer of transformed material or a portion thereof, during formation of at least one melt pool, during the formation of at least two melt pools, and/or during the generation of the 3D object. The controller may direct execution of the welding request. The controller may identify gaps and/or welded gaps. The controller may identify the size and/or density of a gap. Size may comprise FLS, surface area, or volume. The identification may include using the software and/or one or more sensors. The controller may identify a volume of the gap. The controller may direct the sequence of welding. The controller may identify the number and/or positions of post(s). The controller may identify connection positions between one or more posts and one or more suspended plane and/or wire. The controller may control and/or regulate the energy (e.g., energy beam) used in the welding process. The welding process may include one or more energy sources. The energy sources may generate one or more energy. The energy may comprise heat energy. The energy may comprise radiative energy. The energy may comprise an energy beam. The radiative energy may include an energy beam, and/or a dispersed energy (e.g., generated by a radiative heat source such as a radiator, or a lamp).

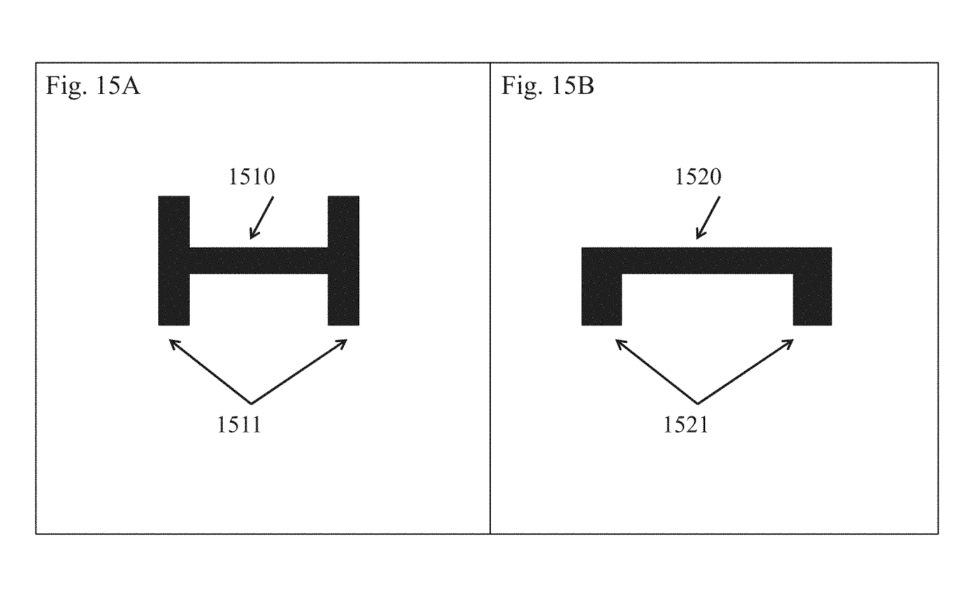

In some instances, a 3D object comprises a hanging 3D plane and/or wire between at least two posts. A post can be a structure that comprises two or more layers of hardened material. A post can comprise multiple layers of hardened material. A post can comprise more layers of hardened material as compared to the number of layers that comprise the suspended structure (e.g., hanging plane and/or wire). A post can be a pillar, column, frame, wall, or another stabilization feature. A post is a portion of the desired 3D object. For example, FIG. 15A shows an example of a horizontal cross section of a 3D object with two posts 1511 and a hanging wire or 3D plane 1510, and FIG. 15B shows an example of a vertical cross section of the posts 1521 and of the wire or 3D plane 1520.

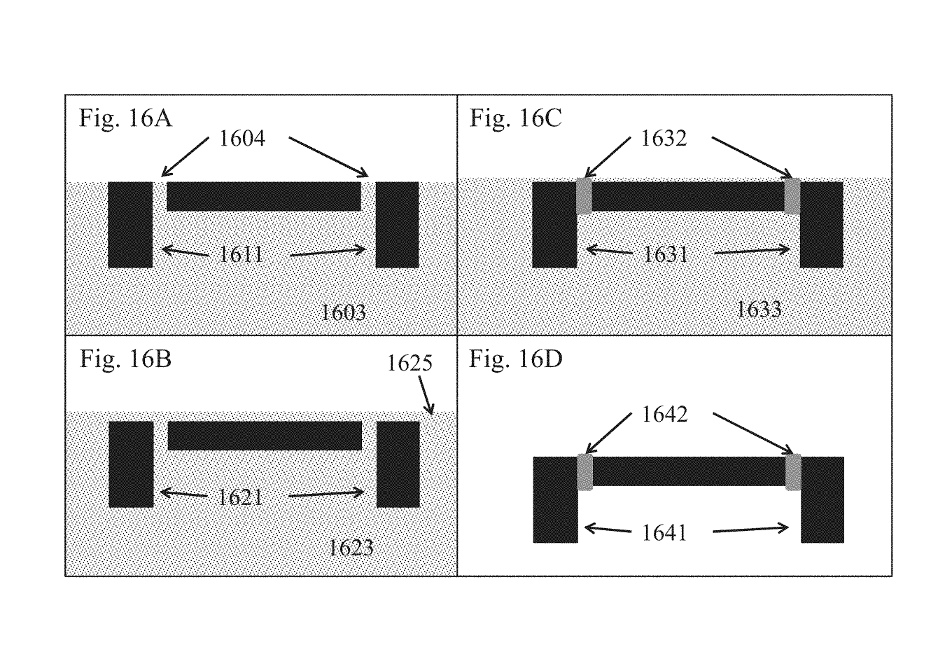

The hanging wire and/or 3D plane may be fabricated in at least two operations that include formation of posts and either wire or 3D plane from the material bed (e.g., by transforming the pre-transformed material into a transformed material that hardens into a hardened material), wherein the wire or 3D plane are separated from the posts by a gap and form at least one tile; followed by a separate operation of connecting the wire or 3D plane to the posts. The connection can be effectuated by causing transformed material to be introduced into the gap. The transformed material can be introduced into the gap, into the gap and its vicinity (e.g., covering a portion of the tile and a portion of the at least one post), or into the gap and covering the tile and posts thus forming an additional layer. FIGS. 16A-16D show examples of operations in the formation of a suspended structure that is connected to two posts. FIG. 16A shows a side view example of two posts 1611 and a hanging tile (e.g., wire/3D plane) 1610 that is fabricated such that the tile (e.g., 1610) is disconnected from the posts 1611 by a gap 1604. In the example shown in FIG. 16A, the tile 1610 is supported by the material (e.g., powder) bed 1603. The tile and/or posts can be suspended anchorlessly in the material bed during formation of the 3D object. During formation of the 3D object may comprise during all operations of forming the 3D object. FIGS. 16A-16C show tiles and posts that are suspended in the material bed anchorlessly (e.g., without auxiliary support). FIG. 16C shows a side view example of subsequent welding 1632 of the disconnected tile 1630 to the posts 1631, which tile, posts and welding are suspended anchorlessly in the material bed 1633. The welding may be accomplished by filling in the gaps between the tiled structure (e.g., wire/3D plane) and the posts. FIG. 16B shows an example where a layer of pre-transformed material was added to the material bed to form a new exposed surface 1625 of the material bed, which material bed comprises posts 1621 and tile 1620 that are suspended anchorlessly in the material bed 1623. Voids formed while fabricating the posts (e.g., FIG. 16A, 1611) and the disconnected tile (e.g., FIG. 16A, 1610) may be subsequently filled with pre-transformed material to allow their mutual connection (e.g., welding). FIG. 16D shows an example of a structure comprising two posts 1641, and a hanging structure that includes welding 1642 and tile 1640.

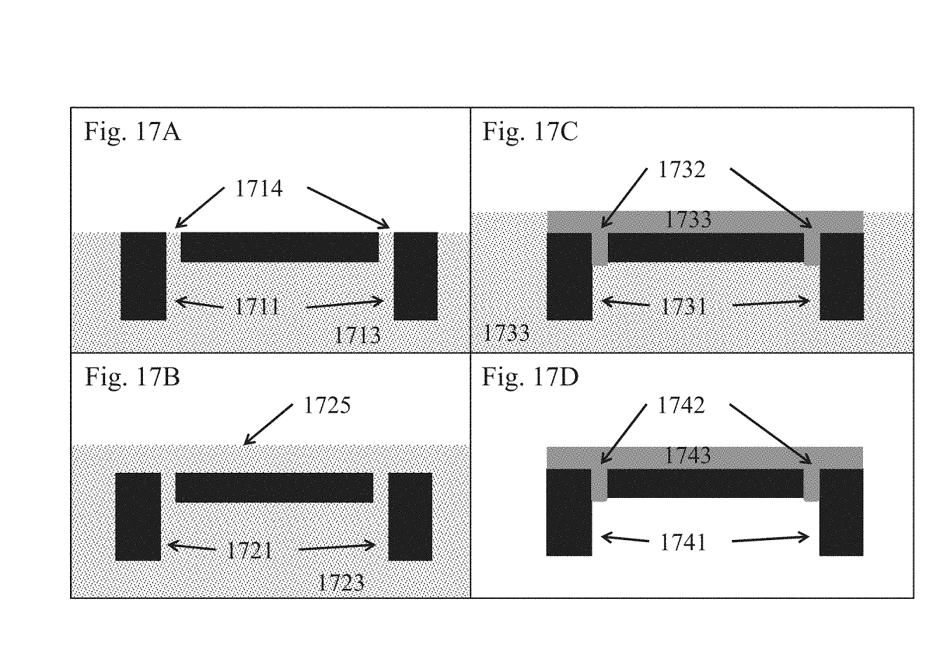

FIGS. 17A-17D show various side view examples of operations in the formation of a hanging structure (e.g., tile) supported by two posts to form a 3D object, which suspended structure, posts and 3D object are floating anchorlessly in the material bed during formation of the 3D object. FIG. 17A shows an example of two posts 1711 and a hanging tile 1710 that is fabricated as a disconnected tile from the posts. In the example of FIG. 17A, the tile 1710 is supported (e.g., only) by the powder bed 1713. FIG. 17C shows an example of a subsequent welding 1732 of the disconnected tile 1730 to posts 1731 though the formation of a second layer 1733. The welding may be accomplished by adding sufficient pre-transformed material to the material bed to both fill any gaps between the tiled structure (e.g., wire/3D plane) and the posts, and allow the formation of an additional layer. FIG. 17B shows an example where any voids formed while fabricating the three structures (e.g., 1711 and 1710 in FIG. 17A), were filled with pre-transformed material in excess to allow the formation of a subsequent layer of pre-transformed material comprising an exposed surface of the material bed 1725, wherein the material bed 1723 comprises posts 1721 and tile 1720. FIG. 17C shows an example where the layer of pre-transformed material is transformed in part to form a layer of transformed material 1733 and welding portions 1732 that connect the posts 1731 to the tile 1730 to form a 3D object, which 3D object is suspended anchorlessly in the material bed 1733. As a consequence, a structure comprising posts and at least one suspended tile (e.g., wire and/or 3D plane) can be formed as an anchorless structure that (e.g., substantially) corresponds to the desired 3D object. FIG. 17D shows an example of a structure comprising two posts 1741, and a hanging structure 1740 that includes welding 1742, tile 1740 and an additional layer 1743 (e.g., substantially) devoid of pre-transformed material (e.g., after its retrieval from the material bed). The retrieval from the material bed can be at the end of the 3D printing.

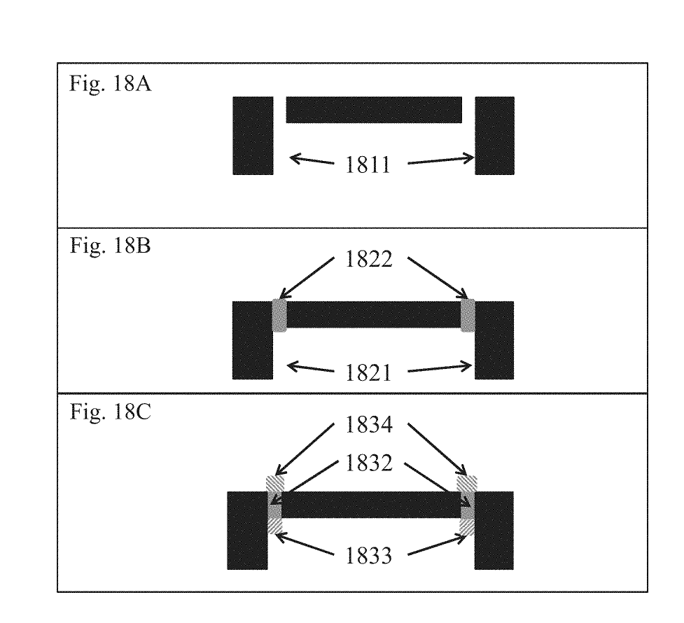

FIGS. 18A-18C show examples of various operations in the formation of a 3D object from posts and a hanging structure (e.g., tile). FIG. 18A show formation of posts 1811 and a hanging structure 1810. The posts and hanging structure may be formed in a material bed such that they are suspended anchorlessly in the material bed during their (e.g., entire) formation. FIG. 18B shows an example where the posts 1821 are connected to the hanging structure (e.g. tile) 1820 with a material (e.g., welding material) 1822 to form a 3D object. The 3D object may be suspended anchorlessly in the material bed during its (e.g., entire) generation.

The welding material may fill the gap between the posts and the at least one hanging structure (e.g., tile. E.g., wire or 3D plane). The welding material may just fill in the gap. The welding material may fill the gap in excess (e.g., spill out of the gap vertically and/or horizontally). The welding material may cover at least a portion of the suspended posts and/or tile. In some embodiments, a support (e.g., supporting structure) can be pre-fabricated as part of the posts or in addition to the posts. FIG. 18C shows a side view example of supporting structures 1833, posts 1831, and a hanging structure 1830 (e.g., wire or 3D plane), welding material 1831, and sealing structures 1834. The supporting structures can be formed prior to, during, or subsequent to the fabrication of the posts. For example, the supporting structures can be formed during (e.g., as part of) the fabrication of the posts 1831. The supporting structure may be fabricated separately from the posts. The supporting structures may be fabricated from a material that is (e.g., substantially) identical, or different from the material of the posts, and/or of the hanging structure (e.g., tile, E.g., wire or 3D plane). The supporting structure may support the welding material (e.g., during and/or subsequent to its formation). The supporting structure may prevent leakage of the welding material. The supporting structure may confine the welding material to the gap. In some embodiments, a sealing structure may be added to the welding material. FIG. 18C shows an example of a sealing structure 1834. The sealing structure may be formed subsequent to welding the posts to the suspended structure. The sealing structure may be formed from a different material than the welding material, the posts, and/or the suspended structure. The sealing structure may cover the gap. In some embodiments, the sealing structure will have substantially the same cross section of the gap. The sealing structure may cover the gap and at least a portion of the suspended structure and/or the posts. The sealing structure may cover the posts and suspended structure and form a subsequent layer.

The hanging structure may comprise a single tile, or be broken into a plurality of tiles. The posts can be internal or external with respect to the hanging structure. FIGS. 19A-19B show example of operations in the formation of a hanging structure that is connected to posts, that can be viewed from the top or bottom, or be a horizontal cross sections. FIG. 19A shows an example of external posts 1911, internal post 1910, and suspended tiles 1912-1914, which are disconnected from the posts and from each other by gaps 1915-1917 respectively. FIG. 19B shows an example of external posts 1931, internal post 1930, and hanging tiles 1932-1934. FIG. 19B shows an example of tiles 1932-1934 connected to posts 1931 and 1930 by welding 1922-1925 respectively, tile 1933 is connected to tile 1932 via welding 1921, and tile 1933 is connected to tile 1934 via welding 1926 thus collectively forming a 3D object that includes tiles 1932-1934 as a single hanging structure that is connected to posts 1911 and 1912. The hanging tiles are hanging structure (e.g., wire or 3D plane). The 3D object and any of its components may be suspended in the material bed anchorlessly during the (e.g., entire) 3D printing (e.g., comprising the welding).

In some embodiments the hanging structure is connected to one post. The one post can be situated at the edge of the hanging structure (e.g., to form a ledge or a wire that is connected to a post at one end). The one post can be situated within the interior of the hanging structure (e.g., forming a mushroom like configuration). The one post can be situated at the center of the hanging structure, or at a position that is different from the center of the hanging structure. The one post can be situated at the exterior of the hanging structure (e.g., forming a mushroom like configuration). The one post can be situated at the center of the hanging structure, or at a position that is different from the center of the hanging structure.

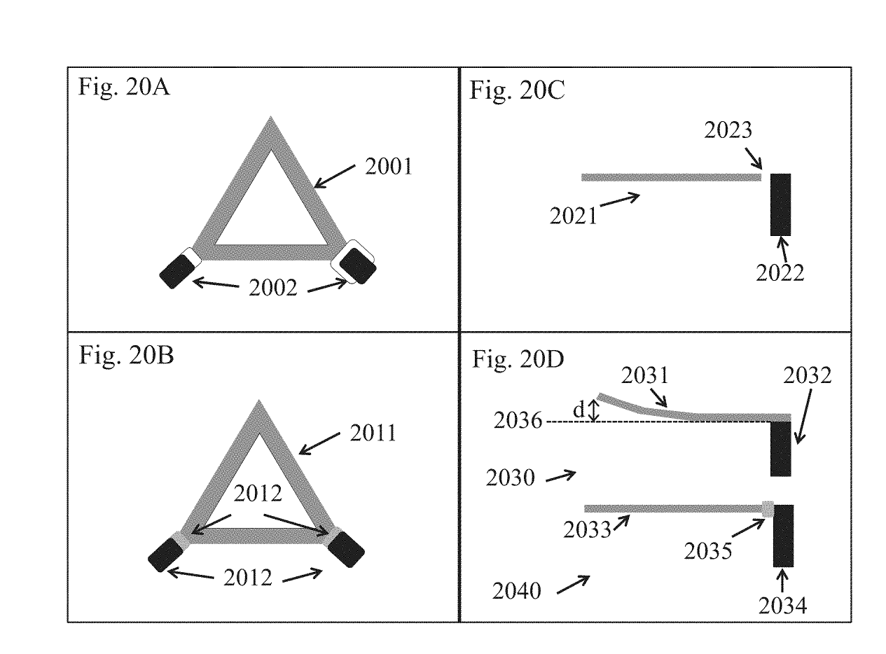

In some embodiments, the hanging structure may be connected by two or more posts, and include a significant portion that is not connected to the posts and is free hanging. FIG. 20D shows an example of side views of two 3D objects 2040 and 2030 in which the suspended structure 2033 is supported by post 2034, which hanging structure includes a significant portion that is freely hanging (e.g., without auxiliary or other support). The 3D object whose side view is 2040 can have a top view depicted in FIG. 20B. In some embodiments, welding the hanging structure (e.g., 2012) to the post (e.g., 2012) can circumvent deformation in the resulting 3D object. FIG. 20D shows examples of side views of two 3D objects 2030 and 2040 respectively as a comparison. The hanging structure 2031 was fabricated directly on the post 2032, resulting in the deformation (e.g., upward curling) of the hanging structure 2031 from its desired plane 2036 by a vertical distance “d” as the 3D object 2030 cooled down. FIG. 20C shows an example of a side view of the precursor parts for object 2040, in which the hanging structure 2021 was fabricated as a disconnected portion from the post 2022 that is separated from the post by a gap 2023, which at least the hanging structure 2021 was suspended anchorlessly in the material bed. FIG. 20A shows a top, bottom, or horizontal cross sectional view of the precursor parts for object 2040, in which the hanging structure 2001 was fabricated as a disconnected portion from the post 2002 that is separated from the post by a gap, which at least the hanging structure 2001 was suspended anchorlessly in the material bed. In some embodiments, also the post 2002 is suspended anchorlessly in the material bed during the (e.g., entire) formation of the 3D object. Such planar object may not be possible without this (or similar) methodology, as they otherwise deform and/or deflect from their desired (e.g., intended) planar surface. FIG. 20D shows an example of a side view of a 3D object 2030 which was fabricated as a connected piece. In object 2030, there was no gap between the suspended portion and the post 2032, as the 3D object (comprising the hanging portion-post) was fabricated as a single entity 2031, which upon hardening (e.g., cooling) contracted, deformed, and deflected from the desired plane 2036 by a distance “d”.

The posts may or may not be suspended anchorlessly in the material bed during the formation of the 3D object. The hanging structure (e.g., tile) may be suspended anchorlessly in the material bed during the (e.g., entire) formation of the 3D object.

The formation of the welded structures may utilize a layer deposition mechanism (e.g., a recoater). The layer deposition mechanism may add pre-transformed material to the material bed and level (e.g., planarize and/or flatten) the exposed surface of the material bed. The leveling of the material bed may include an operation in which the layer deposition mechanism levels the exposed surface of the material bed without contracting the material bed. The leveling may comprise using a material removal mechanism, leveling mechanism, or layer dispensing mechanism (e.g., recoater) that does not contact the material bed (e.g., top surface of the material bed). Examples of a material removal mechanism, leveling mechanism, and layer dispensing mechanism may be found in application number PCT/US15/36802 that is incorporated herein by reference. The non-contact recoater may add a layer of pre-transformed material to areas (e.g., portions) of the material bed that are deficient in pre-transformed material (e.g., to form a planar exposed layer of the material bed. E.g., FIG. 16A, 1604, or FIG. 17A, 1714). FIG. 16B and FIG. 17B show examples of a layer deposition mechanism that adds pre-transformed-material to material-beds 1603 and 1713 respectively to form a leveled top surface of the material beds. The non-contact recoater can level the material bed above, at, or below an average top surface that includes the hanging structure and posts. The non-contact recoater can level the material bed at an average top surface that includes the hanging structure and the posts (e.g., FIG. 16B, 1625). The non-contact recoater can level the material bed above the average top surface that includes the hanging (e.g., suspended) structure and the posts (e.g., FIG. 17B, 1725).

In some embodiments, the recoater may simultaneously remove pre-transformed material from the material bed (e.g., from the exposed surface of the material bed) and dispense pre-transformed material into the enclosure (e.g., the material bed). The exposed surface of the material bed may be the top surface of the material bed.

In some examples, the hanging structure may be generated from one or more posts towards a position away from the one or more posts. In some embodiments, the entire (e.g., growing) hanging structure is kept at an elevated temperature. The elevated temperature can be just below the transformation temperature of the material of which it is composed. In some embodiments, a position adjacent to the growing end of the growing hanging structure is kept hot. The growing hanging structure (e.g., in its entirety, close to its growth position, or at its growth position) is kept at elevated temperature (e.g., using injected energy). The energy may include a heat energy. The energy may include an energy beam (e.g., as disclosed herein) and/or dispersed energy. The radiative heat may be projected by a heating member comprising a lamp, a strip heater (e.g., mica strip heater, or any combination thereof), a heating rod (e.g., quartz rod), or a radiator (e.g., a panel radiator). The heating member may comprise an inductance heater. The heating member may comprise a resistor (e.g., variable resistor). The resistor may comprise a varistor or rheostat. A multiplicity of resistors may be configured in series, parallel, or any combination thereof.

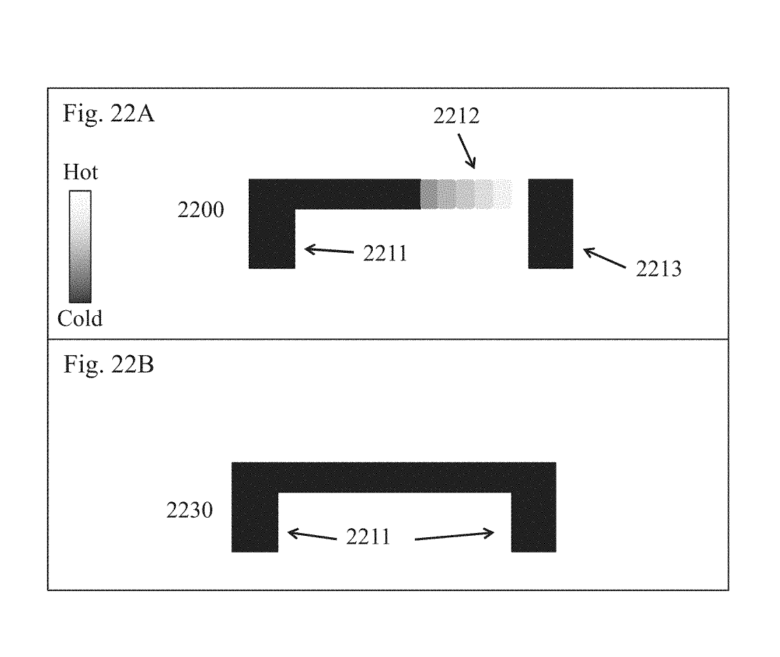

FIG. 22A shows an example of a side view or a vertical cross section of a hanging structure 2210 that is connected to a post 2211. The suspended structure is sequentially growing towards post 2213 as illustrated in the growing sections 2212. The desired 3D object is depicted in FIG. 22B. The black portion of the 3D object designates hardened (e.g., cold) material. The gray portions in 2212 designate heated portions as depicted by the Hot-Cold bar in FIG. 22A. Such methodology may reduce the degree of deformation of the hanging structure.

The generated 3D object may comprise successive regions of hardened material indicative of at least one 3D printing process. For example, the generated 3D object may include successive regions of hardened material indicative of at least one additive manufacturing process. For example, the generated 3D object may include rows of hardened (e.g., solidified) material indicative of at least one additive manufacturing process. The regions may be material grains or melt pools. A cross section (e.g., horizontal and/or vertical cross section) of the printed 3D object may reveal a microstructure or a structure indicative of a material transformation (e.g., fusion, bonding or connection of material). A cross section (e.g., horizontal and/or vertical cross section) of the printed 3D object may reveal a microstructure or a structure indicative of a material transformation (e.g., fusion, bonding or connection of material) and subsequent hardening. The regions of hardened (e.g., solidified) material within the printed 3D object may comprise successive features that originated from a fused, sintered, melted, bound, or otherwise connected material (i.e., transformed material). The microstructure or material grain structure may arise due to the solidification of fused, sintered or melted powder material that is typical to and/or indicative of the 3D printing method. For example, a cross section may reveal a microstructure resembling ripples or waves that are indicative of melt pools, which melt pools may be formed during the 3D printing process. The repetitive structures may reveal the orientation at which the part is printed. The cross section may reveal a substantially repeating micro or material grain structure. The microstructure or grain structure may comprise substantially repetitive variations in material composition, grain orientation, material density, degree of compound segregation or of element segregation to grain boundaries, material phase, metallurgical phase, crystal phase, crystal structure, material porosity or any combination thereof. The repetition may not be exact repetition. The repetition may be sufficient indicative to one versed in the art. The microstructure or material grain structure may comprise substantially repetitive solidification of melt pools.

The hardened material may comprise melt pools (or material grains) that are of an average FLS of at least about 0.5 nm, 1 nm, 5 nm, 10 nm, 20 nm, 30 nm, 40 nm, 50 nm, 60 nm, 70 nm, 80 nm, 90 nm, 100 nm, 150 nm, 200 nm, 250 nm, 300 nm, 350 nm, 400 nm, 450 nm, 500 nm, 1000 nm, 5 μm, 10 μm, 15 μm, 20 μm, 25 μm, 30 μm, 35 μm, 40 μm, 50 μm, 60 μm, 70 μm, 80 μm, 90 μm, 100 μm, 120 μm, 150 μm, 170 μm, 200 μm, 220 μm, 250 μm, 270 μm, 300 μm, 400 μm, or 500 μm. The hardened material may comprise melt pools (or material grains) that are of an average FLS of at most about 0.5 nm, 1 nm, 5 nm, 10 nm, 20 nm, 30 nm, 40 nm, 50 nm, 60 nm, 70 nm, 80 nm, 90 nm, 100 nm, 150 nm, 200 nm, 250 nm, 300 nm, 350 nm, 400 nm, 450 nm, 500 nm, 1000 nm, 5 μm, 10 μm, 15 μm, 20 μm, 25 μm, 30 μm, 35 μm, 40 μm, 50 μm, 60 μm, 70 μm, 80 μm, 90 μm, 100 μm, 120 μm, 150 μm, 170 μm, 200 μm, 220 μm, 250 μm, 270 μm, 300 μm, 400 μm, or 500 μm. The hardened material may comprise melt pools or grains that are of an average FLS of any value between the afore-mentioned FLSs (e.g., from about 0.5 nm to about 500 μm).

The microstructure of the hardened material may comprise dendrites that are of an average length of at least about 20 μm, 25 μm, 30 μm, 35 μm, 40 μm, 50 μm, 60 μm, 70 μm, 80 μm, 90 μm, 100 μm, 120 μm, 150 μm, 170 μm, 200 μm, 220 μm, 250 μm, 270 μm, 300 μm, 400 μm, or 500 μm. The hardened material may comprise dendrites that are of an average length of at most about 20 μm, 25 μm, 30 μm, 35 μm, 40 μm, 50 μm, 60 μm, 70 μm, 80 μm, 90 μm, 100 μm, 120 μm, 150 μm, 170 μm, 200 μm, 220 μm, 250 μm, 270 μm, 300 μm, 400 μm, or 500 μm. The microstructure of the hardened material may comprise dendrites that are of an average length of any value between the afore-mentioned average lengths (e.g., from about 20 μm to about 500 μm). The microstructure of the hardened material may comprise cells that are of an average width of at least about 0.25 μm, 0.5 μm, 0.75 μm 1 μm, 2 μm, 3 μm, 4 μm, 5 μm, 6 μm, 7 μm, 8 μm, 9 μm, 10 μm, 15 μm, 20 μm, 25 μm, 30 μm, 35 μm, 40 μm, or 50 μm. The hardened material may comprise cells that are of an average length of at most about 0.25 μm, 0.5 μm, 0.75 μm 1 μm, 2 μm, 3 μm, 4 μm, 5 μm, 6 μm, 7 μm, 8 μm, 9 μm, 10 μm, 15 μm, 20 μm, 25 μm, 30 μm, 35 μm, 40 μm, or 50 μm. The microstructure of the hardened material may comprise cells that are of an average width of any value between the afore-mentioned average lengths (e.g., from about 20 μm to about 500 μm).

In some examples, the density distribution of the material within a layer of hardened material in the 3D object is (e.g., substantially) homogenous. In some examples, the density distribution of the material within a layer of hardened material in the 3D object is heterogeneous.

In some examples, the average FLS of the melt pools or grains is largest in the first layer of hardened material of the printed 3D object (e.g., bottom skin layer), and shrinks as the number of the layer of hardened material of the printed 3D object increases. The first layer may be the layer hardened first (e.g., the bottom skin layer). A layer of hardened material within the 3D object that has a higher number (higher that one) designates a layer that has been formed after the formation of the first layer (e.g., after the formation of the bottom skin layer). The average FLS of the melt pools or material grains in one layer of hardened material within the 3D object may be at least about 1.1, 1.2, 1.4, 1.5, 1.6, 1.7, 1.8, 1.9, 2, 2.5, 3, 3.5, 4, 4.5, 5, 5.5, 6, 6.5, 7, 7.5, 8, 8.5, 9, 10, 15, 20, 25, 30, 35, 40, 50, or 70 times larger than in a subsequent layer. The average FLS of the melt pools or material grains in one layer of hardened material within the 3D object may be at most about 1.5, 1.6, 1.7, 1.8, 1.9, 2, 2.5, 3, 3.5, 4, 4.5, 5, 5.5, 6, 6.5, 7, 7.5, 8, 8.5, 9, 10, 15, 20, 25, 30, 35, 40, 50, or 70 times larger than in a subsequent layer. The ratio of the melt pools or grains (material grains) in the one-layer relative to a subsequent layer may be any number between the afore-mentioned values. The one layer may be the bottom skin layer. The one layer may be the first, second, third, fourth, fifth, sixth, seventh, eighths, ninth, tenth, or eleventh layer. The subsequent layer may be directly subsequent or not directly subsequent. For example, the subsequent layer may be the second layer. The subsequent layer may be the second, third, fourth, fifth, sixth, seventh, eighths, ninth, tenth, eleventh, or twelfth layer. For example, the number of layer may refer to the number of deposited material that is transformed to form at least a portion of the 3D object by at least one additive manufacturing process (e.g., selective laser melting), and subsequently hardened into a hardened material.

In some examples, the average FLS (e.g., length and/or width) of the dendrites is largest in the first layer, and shrinks as the number of layer increases. For example, the FLS (e.g., length and/or width) of the dendrites in one layer may be at least about 1.1, 1.2, 1.4, 1.5, 1.6, 1.7, 1.8, 1.9, 2, 2.5, 3, 3.5, 4, 4.5, 5, 5.5, 6, 6.5, 7, 7.5, 8, 8.5, 9, 10, 15, 20, 25, 30, 35, 40, 50, or 70 times larger than the respective FLS (e.g., length and/or width) of the dendrites in a subsequent layer. The FLS (e.g., length and/or width) of the dendrites in one layer may be at most about 1.5, 1.6, 1.7, 1.8, 1.9, 2, 2.5, 3, 3.5, 4, 4.5, 5, 5.5, 6, 6.5, 7, 7.5, 8, 8.5, 9, 10, 15, 20, 25, 30, 35, 40, 50, or 70 times larger than the respective FLS (e.g., length and/or width) of the dendrites in the subsequent layer. The FLS (e.g., length and/or width) of the dendrites in one-layer relative to the length of the dendrites in a subsequent layer may be any number between the afore-mentioned values.

In some examples, the average FLS (e.g., length and/or width) of the cells is largest in the first layer, and shrinks as the number of layer increases. For example, the FLS (e.g., length and/or width) of the cells in one layer may be at least about 1.1, 1.2, 1.4, 1.5, 1.6, 1.7, 1.8, 1.9, 2, 2.5, 3, 3.5, 4, 4.5, 5, 5.5, 6, 6.5, 7, 7.5, 8, 8.5, 9, 10, 15, 20, 25, 30, 35, 40, 50, or 70 times larger than the respective FLS (e.g., length and/or width) of the cells in a subsequent layer. The FLS (e.g., length and/or width) of the cells in one layer may be at most about 1.5, 1.6, 1.7, 1.8, 1.9, 2, 2.5, 3, 3.5, 4, 4.5, 5, 5.5, 6, 6.5, 7, 7.5, 8, 8.5, 9, 10, 15, 20, 25, 30, 35, 40, 50, or 70 times larger than the respective FLS (e.g., length and/or width) of the cells in the subsequent layer. The FLS (e.g., length and/or width) of the cells in one-layer relative to the length of the cells in a subsequent layer may be any number between the afore-mentioned values.

The generated 3D object may comprise a surface in which the crystals have a greater average FLS (e.g., length and/or width) than the crystals in its interior. For example, the generated 3D object may comprise a surface in which the crystals are longer and/or wider than the crystals in its interior. The crystals can be single crystals. In some examples, the average length and/or width of the crystals are largest in the first layer (e.g., bottom skin), and shrinks as the number of layer increases. In some examples, the average FLS (e.g., length and/or width) of the crystals is largest at a surface of the 3D object, and shrinks as the number of layer increases towards the interior of the generated 3D object. For example, the average FLS (e.g., length and/or width) of the crystals in the surface may be at least about 1.1, 1.2, 1.4, 1.5, 1.6, 1.7, 1.8, 1.9, 2, 2.5, 3, 3.5, 4, 4.5, 5, 5.5, 6, 6.5, 7, 7.5, 8, 8.5, 9, 10, 15, 20, 25, 30, 35, 40, 50, or 70 times the respective average FLS (e.g., length and/or width) of the crystals in the interior. For example, the average FLS (e.g., length and/or width) of the crystals in the surface may be at most about 1.1, 1.2, 1.4, 1.5, 1.6, 1.7, 1.8, 1.9, 2, 2.5, 3, 3.5, 4, 4.5, 5, 5.5, 6, 6.5, 7, 7.5, 8, 8.5, 9, 10, 15, 20, 25, 30, 35, 40, 50, or 70 times the respective average FLS (e.g., length and/or width) of the crystals in the interior. The average FLS (e.g., length and/or width) of the crystals in the surface relative to the average FLS (e.g., length and/or width) of the crystals in the interior of the generated 3D object may be any number between the afore-mentioned values. The crystals may be single crystals.

The regions of hardened material may be indicative of the direction in which the 3D object was generated (i.e., printed). The regions of hardened material may be indicative of horizontal formation of the printed 3D object. The regions of hardened material may be indicative of formation of the printed 3D object at an angle that is 45 degrees or more from the field of gravity (or from a vector parallel to the field of gravity).

The microstructure of a formed layer may be unaltered during the printing process. In some examples, the microstructure of a formed layer may be changed during the printing process. For example, some microstructures may merge and form larger microstructures. For example, the melt pools in a particular layer (e.g., bottom skin layer) may merge and form larger melt pools.

The material grains and/or melt pools may comprise various (e.g., metallurgical) morphologies including, for example, cells and/or dendrites. The grain structure (e.g., material grains) and/or melt pools may be formed upon depleting energy from the transformed material. The material grains and/or melt pools may be formed upon hardening of the transformed material. The material grains and/or melt pools may comprise columnar grains or axial grains. The material grains and/or melt pools may comprise dendrites. The dendrites may be epitaxial dendrites. The dendrites may be non-epitaxial dendrites. The dendritic structures can grow by a process that comprises nucleation. The dendritic structures can grow by a process that comprises growth mechanism. The dendritic structures (e.g., dendrites) can growth by a process that comprises nucleation and growth mechanism.

In another aspect, a 3D object comprises a layer of (hardened) material generated by at least one 3D printing method (e.g., additive manufacturing), wherein the layer can comprise a path of deposited material comprising successive segments of lines, wherein at least one first pair of the successive segments of lines in the layer of material vary by a factor, from at least one second pair of the successive segments of parallel lines within the layer. The lines can be wires. The lines may be parallel. The lines may be non-parallel. The lines in the first pair of successive segments of lines may be parallel. The lines in the second pair of successive segments of lines may be non-parallel. The lines in at least one pair of successive segments of lines may be parallel. The lines in at least one pair of successive segments of lines may be non-parallel. The factor can comprise the distance between the pair of the successive segments of lines. The distance between the pair of the successive segments of lines may be at least 10 mm, 9 mm, 8 mm, 7 mm, 6 mm, 5 mm, 4 mm, 3 mm, 2 mm, 1 mm, 500 micrometers (μm), 400 μm, 300 μm, 200 μm, 100 μm, 90 μm, 80 μm, 70 μm, 60 μm, 50 μm, 40 μm, 30 μm, 20 μm, 10 μm, 5 μm, or 1 μm. The distance between the pair of the successive segments of lines may be at most 10 mm, 9 mm, 8 mm, 7 mm, 6 mm, 5 mm, 4 mm, 3 mm, 2 mm, 1 mm, 500 micrometers (μm), 400 μm, 300 μm, 200 μm, 100 μm, 90 μm, 80 μm, 70 μm, 60 μm, 50 μm, 40 μm, 30 μm, 20 μm, 10 μm, 5 μm, or 1 μm. The distance between the pair of the successive segments of lines may be may any value between the afore-mentioned distances. The factor can comprise the angle between the pair of successive segments of lines (e.g., parallel lines). The acute angle between the pair of successive segments of lines (e.g., parallel lines) may be at most about 5°, 10°, 15°, 20°, 30°, 40°, 50°, 60°, 70°, 80° or 85°. The acute angle between the pair of successive segments of lines (e.g., parallel lines) may be at least about 5°, 10°, 15°, 20°, 30°, 40°, 50°, 60°, 70°, 80° or 85°. The acute angle between the pair of successive segments of lines (e.g., parallel lines) may be any angle value between the afore-mentioned acute angle values.

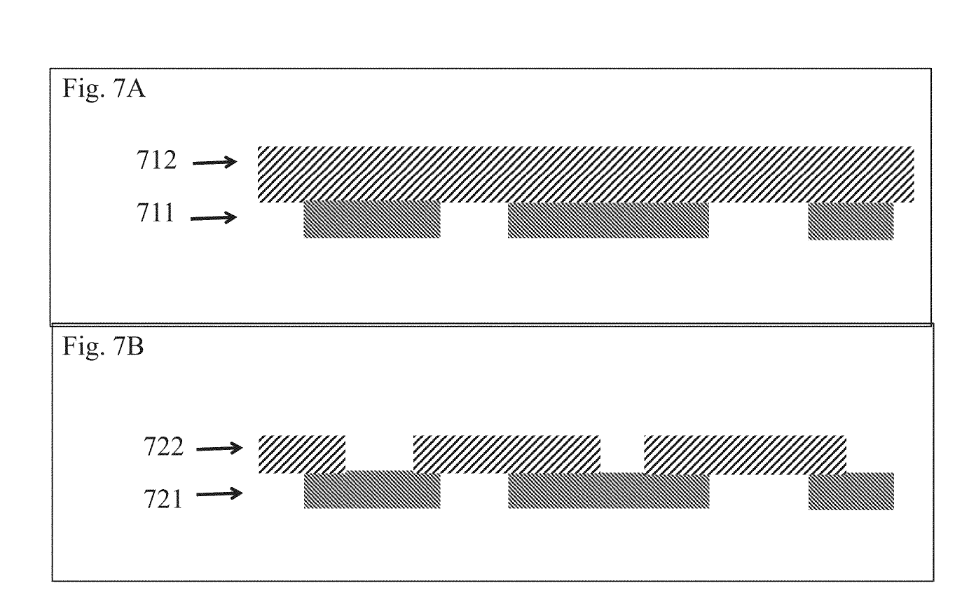

Another aspect of the present disclosure provides a 3D object comprising a first layer of hardened material comprising first spaced apart successive segments (e.g., tiles) of lines (e.g., wires) formed by at least one 3D printing method (e.g., additive manufacturing) conducted in a first average plane; and a second layer of hardened material adjacent to the first layer of material indicative of an 3D printing method conducted in a second average plane; and wherein the second layer of material connect the first spaced apart successive segments of material to form at least a part of the 3D object. The spaced apart material (e.g., tiles) may be separated by a gap. In some examples, the second layer comprises a single segment. In some instances, the second layer comprises a second set of spaced apart successive segments. Examples of cross sections of the 3D object can be seen in FIGS. 7A-B. Examples of cross sections of the spaced apart material (spaced apart objects) are provided in 711 and 721. The second connecting layer can be continuous or discontinuous. An example of a cross section of the second connecting layer that is continuous is provided in 712. An example of a cross section of the second connecting layer that is discontinuous is provided in 722. FIGS. 7A-7B show schematic examples of a vertical cross section of a 3D object comprising two layers: FIG. 7A schematically illustrates a cross section of a second continuous layer, and FIG. 7B schematically illustrates a cross section of a second discontinuous layer. The discontinuous layer may comprise at least two tiles of hardened material that are separated by a gap. The average acute angle between the direction normal to the field of gravity and the first average plane (e.g., during its formation) or the second average plane (e.g., during its formation) may be alpha (e.g., as mentioned herein). At times, the angle alpha of the first average plane (e.g., during its formation) or the second average plane (e.g., during its formation) is measured relative to the plane parallel to the average top leveled surface of the layer of material (e.g., powder), relative to the average plane of the top surface of the building platform facing the deposited material, and/or relative to a plane normal the direction of the field of gravity. The formed layer (e.g., plane) may be substantially parallel to the building platform.

In another aspect, a 3D object generated by at least one 3D printing method comprises a first material structure situated in a first layer, a second material structure situated in a second layer, and a third material structure traversing at least a portion of both the first layer and the second layer. The first material structure can include disconnected tiles. The second material structure can include disconnected tiles. The first material structure can include connected tiles. The second material structure can include connected tiles. The first material structure can connect to the second material structure in one or more positions. In some examples, at least one portion of the first material structure anchors the second material structure. The third material structure can include a spot. The spot may be a clump. The spot may comprise a sphere. The spot may comprise a cone or a conical section. The spot may comprise a cuboid or a cylinder. The spot may comprise an ellipsoid (e.g., a sphere). The spot may comprise a geometrical shape. The third material structure can comprise a wire. The wire may be formed with its long section substantially parallel to the building platform. The long section of the wire may form a plane. The plane may be (e.g., substantially) parallel to the building platform. The plane may be (e.g., substantially) perpendicular to the building platform. The average acute angle between the direction normal to the field of gravity and the length of the wire (e.g., during its formation), or the average plane formed by the wire length may be alpha. At times, the angle alpha of the wire length or the average plane formed by the wire plane (e.g., during its formation) is measured relative to the plane parallel to the average top leveled surface of the layer of material (e.g., powder), relative to the average plane of the top surface of the building platform (e.g., the container, the substrate or the base facing the deposited material), and/or relative to a plane normal the direction of the field of gravity.

The wire may be linear or (e.g., substantially) not winding. The third material structure can comprise a surface. The surface may be planar or non-planar. The third material structure can comprise a plane (e.g., 3D plane). The third material structure may comprise a mesh or intertwining wires. The first, second and third material structure can include substantially the same material. At least one of the materials comprising the first, second or third material structures includes a different material. At least two of the first, second or third material structures include substantially the same material. The first, second and third material structure can include substantially the same microstructure or microstructure characteristics. At least one of the materials comprising the first, second or third material structures includes different microstructure or microstructure characteristics. At least two of the first, second or third material structures include substantially the same microstructure or microstructure characteristics.

In another aspect, a 3D object comprises a layer of hardened material generated by at least one additive manufacturing method disclosed herein, wherein the layer can comprise a path of material, wherein the path of material can comprise a segment wherein the microstructure of the material varies as a function of the structure. The path of material may comprise a wire. The variation may be a variation in the size of the microstructure. The variation may be a variation in the distance between successive microstructures. The variation may be a variation in the density of the microstructures. The variation may be a variation in the type of metallurgical structure, or type of crystal structure. The variation may be a variation in the metallurgical phase, or crystal phase within the microstructure. The variation may be a variation in the direction of growth of the metallurgical structure, or of the crystal structure within the microstructure. The variation may be the types of metallurgical structure (e.g., metallurgical morphology) or crystal structure within the microstructures. The variation may be the number of types of metallurgical structure or crystal structure within the microstructures. The microstructure of the objects described herein can comprise smaller microstructures at a selected position in the 3D object as compared to the bulk of the 3D object. The microstructure of the 3D objects described herein can comprise larger microstructures at a selected position in the 3D object as compared to the bulk of the 3D object. The selected position may comprise an edge, a kink, a crossing, an interior, or a surface. For example, the microstructures of the 3D objects described herein can comprise a smaller microstructure at the edges of the 3D objects as compared to the bulk of the 3D objects. The microstructures can comprise larger microstructure at the edges of the 3D objects as compared to the bulk of the 3D objects. The microstructures can comprise smaller microstructure at the kinks of the 3D objects as compared to the bulk of the 3D objects. The microstructure can comprise a larger microstructure at the kinks of the 3D objects as compared to the bulk of the 3D objects. The microstructures can comprise microstructures that are more spaced apart at the edge of the 3D objects as compared to the bulk of the 3D objects. The microstructures can comprise microstructures that are more spaced apart at the kink of the 3D objects as compared to the bulk of the 3D objects.

In another aspect, a 3D objects comprises a layer of hardened material generated by at least one 3D printing method, wherein the layer of hardened material can comprise a first tile of hardened material and a second tile of hardened material, wherein the first tile and the second tile are spaced apart by a first distance (e.g., a gap), wherein the first tile can comprise a first set of line segments of hardened material, wherein the second tile can comprise a second set of line segments of material. The first distance (e.g., the gap) may be at least about 10 mm, 9 mm, 8 mm, 7 mm, 6 mm, 5 mm, 4 mm, 3 mm, 2 mm, 1 mm, 500 micrometers (μm), 400 μm, 300 μm, 200 μm, 100 μm, 90 μm, 80 μm, 70 μm, 60 μm, 50 μm, 40 μm, 30 μm, 20 μm, 10 μm, 5 μm, or 1 μm. The first distance (e.g., the gap) may be at most 10 mm, 9 mm, 8 mm, 7 mm, 6 mm, 5 mm, 4 mm, 3 mm, 2 mm, 1 mm, 500 micrometers (μm), 400 μm, 300 μm, 200 μm, 100 μm, 90 μm, 80 μm, 70 μm, 60 μm, 50 μm, 40 μm, 30 μm, 20 μm, 10 μm, 5 μm, or 1 μm. The first distance (e.g., the gap) may be any value between the afore-mentioned distances. The first tile may differ from the second tile by at least one factor. The tile of hardened material may be indicated by the microstructure of the material within the 3D objects described herein (e.g., within a layer of the 3D objects). The at least one factor can comprise the spacing between lines in the set of line segments, or the angle between lines in the set of line segments. The lines may be wires. The lines in the set of line segments can be parallel. The lines in the set of line segments can be non-parallel. The lines in at least one set of line segments can be non-parallel. The lines in at least one set of line segments can be parallel. The at least one factor can comprise the angle formed by a plane perpendicular to the layer of material and a line in the set of line segments. The acute angle formed by a plane perpendicular to the layer of material and a line in the set of line segments may be at most about 5°, 10°, 15°, 20°, 30°, 40°, 50°, 60°, 70°, 80° or 85°. The acute angle formed by a plane perpendicular to the layer of material and a line in the set of line segments may be at least about 5°, 10°, 15°, 20°, 30°, 40°, 50°, 60°, 70°, 80° or 85°. The acute angle formed by a plane perpendicular to the layer of material and a line in the set of line segments may be any angle value between the afore-mentioned acute angle values. The at least one factor can comprise (i) the FLS of a cross section of lines (e.g., wires) in the set of line segments, (ii) the uniformity of lines in the set of line segments, or (iii) the crystal structure of the material within the tile. The line may have FLS (e.g., a diameter, a width or a height) of at least about 5 nanometers (nm), 10 nm, 50 nm, 100 nm, 200 nm, 300 nm, 400 nm, 500 nm, 600 nm, 700 nm, 800 nm, 900 nm, 1 micrometer (μm), 3 μm, 10 μm, 20 μm, 30 μm, 100 μm, or 300 μm. The line may have FLS (e.g., a diameter, a width or a height) of at most about 50 nm, 100 nm, 200 nm, 300 nm, 400 nm, 500 nm, 600 nm, 700 nm, 800 nm, 900 nm, 1 micrometer (μm), 3 μm, 10 μm, 20 μm, 30 μm, 100 μm, or 300 μm. The line may have FLS of any value between the aforementioned values.

In another aspect, a 3D object comprises more than one layer of (hardened) material generated by at least one additive manufacturing method, wherein a microstructure of the more than one layer indicates that the 3D object was printed at an angle (e.g., alpha) that minimizes the amount of suspended (e.g., anchorlessly) area in a layer within the 3D object. The acute angle alpha may be with the plane normal to the field of gravity, the plane of natural position of the desired 3D object, or the intended printing plane by a 3D model. The acute angle alpha may have any value disclosed herein for alpha. The suspended area may be a suspended portion of the 3D object. The suspended area may be a hanging portion of the 3D object. Suspended may be anchorlessly suspended in the material bed during formation of the 3D object (or a portion thereof). The suspended area may be any of the suspended and/or hanging areas disclosed herein. The material within the layer of hardened material may support the hanging area (e.g., be a post). The suspended area may be supported by the pre-transformed material in the material bed. The suspended area may be devoid of auxiliary support. The hanging area may be devoid of auxiliary support. The suspended and/or hanging area may have one or more auxiliary supports. The suspended and/or hanging area may comprise a wire or a 3D plane that is connected to the 3D object at one or more points or at one or more ends. The suspended area may comprise a wire or a 3D plane that is connected to the 3D object at one point or at one of its ends. The suspended and/or hanging area may comprise a shelf, a ledge, a projection, a berm, a projection, a branch, an extension, a wing, a plane, or a reef. The suspended and/or hanging area may comprise a wire or a 3D plane that is connected to the 3D object at two points or at two of its ends. The suspended area may comprise a bridge, a platform, a connecting plane, a chain, or a link. The suspended area may hang, protrude, or dangle from the 3D object.

In some examples, a desired 3D object model is used in compiling instructions for 3D printing of the desired 3D object. The 3D object may have a natural position in everyday usage. For example, a natural position with respect to gravity (e.g., a stable position), with respects to its intended use in the art, or with respect to a model of the desired 3D object. The instructions for 3D printing of the desired 3D object may print it according to, or deviated from, the natural position of the 3D object. Such instructions may comprise instructing the energy beam, inter alia, what section of a layer of material to transform into a transformed material (e.g., that subsequently hardens into a hardened material). The instructions may be given on a layer-by-layer basis. The layer-by-layer instructions may comprise forming suspended and/or hanging areas. The instructions for 3D printing of the desired 3D object may follow a position that is different from the natural position of the 3D object. In that different position, the area of any formed suspended and/or hanging areas may remain the same, increase, or decrease. In the 3D objects described herein, the different position may be chosen in a manner that minimizes the suspended area (e.g., the horizontal cross section) in the generated 3D object, in the hardened material, and/or in the transformed material.

In another aspect, a 3D object comprises a layer of (hardened) material generated by at least one 3D printing method, wherein the layer can comprise a selected area of the 3D object and a bulk area of the 3D object, wherein a first distance (e.g., average distance) between centers of a first set of successive microstructures (e.g., melt pools) of the material in the selected area is different than a second distance (e.g., average distance) between centers of a second set of successive microstructures of the material at the bulk area. Different may be larger. Different may be smaller. The smaller or larger difference may depend on the material of the 3D object and/or the 3D printing method. The smaller or larger difference may depend on the selected area. The smaller or larger difference may depend on the depletion of energy from the selected area. The smaller or larger difference may depend on the depletion of energy from the selected area as compared to the depletion of energy (e.g., cooling) from the bulk. The selected area may comprise a surface, an edge, a kink, a crossing, a wire, or a 3D plane. In some examples, the selected area is an edge. In some examples, the selected area is a kink. The successive melt pools can be within a line (e.g., wire) of melt pools. The set of successive microstructures can be within adjacent lines of melt pools. The set of successive microstructures can be within different lines of melt pools. The microstructures can be any microstructures described herein.

In another aspect, a 3D object generated by at least one 3D printing method comprises a material, wherein the 3D object can comprise a first material structure of the material and a second material structure of the material. The second material structure may be arranged in one or more wires within the 3D object. The second material structure may be arranged in one or more clusters (e.g., tiles) within the 3D object. The first material structure and the second material structure may be interlaced. In some embodiments, at least a portion of the first material structure interlaces the second material structure. In some embodiments, at least a portion of the first material structure is entwined with the second material structure. In some embodiments, at least a portion of the first material structure is interlaced, interweaved, alternated, entwined, braided, weaved, and/or is mixed with the second material structure. The second material structure may be situated at multiple positions within the first material structure. The multiple positions may be random or ordered. The multiple positions may be patterned. The pattern may comprise crisscross, zigzag, parallel, twisted, bended, waggling, waving, oscillating, or irregular lines (e.g., the wires). The pattern may comprise a mesh, a braid, a tangled arrangement, a network, or an intertwined arrangement of lines (e.g., the wires). The pattern may comprise separated wires or clusters. The pattern may comprise touching wires or clusters. The pattern may be linear or non-linear. The pattern may comprise lines of various widths. The pattern may comprise microstructures of various widths. The wires or clusters may comprise a variation. The wires or clusters within the 3D object may vary. The variation may be in the microstructures, crystal structures, or metallurgical structures. The variation may be in the width or length of the wires. The variation may be in relative angles of the wires. The variation may be in the distance between the wires and/or clusters. The variation may be in the FLS of the clusters and/or wires. The variation may depend on their position (e.g., relative position) within the 3D object. The variation may depend on their position within the 3D object with respect to a selected position and/or selected area. The selected position and/or selected area may be any selected position or area disclosed herein (e.g., edge, king, crossing, rim, ledge, or bridge). The variation may be in a FLS of the microstructures. The variation may follow a mathematical series. The variation may follow a power series (e.g., a Taylor series). The power series may be a geometric series. The pattern may follow a logarithmic series. The pattern may follow a trigonometric series (e.g., Fourier series). The pattern may follow a Laurent or Dirichlet series. The series may comprise a converging or diverging series. The series may comprise a telescopic series. The series may comprise a linear series, arithmetic series, geometric series, arithmetic-geometric series, exponential series, logarithmic series, or any combination thereof. The logarithmic series may comprise a common or natural logarithmic series. The exponential series may comprise a natural exponential series. The first material structure and the second material structure may be composed of an identical material type. The material type may have one or more material structures. For example, the material type may have one or more crystal structures, one or more metallurgical structures (e.g., morphologies), and/or one or more microstructures. The first material structure can comprise the bulk of the 3D object. In some examples, the second material structure does not comprise the bulk of the first 3D object. The 3D structure can comprise an enhanced rigidity as compared to a 3D structure that is devoid of a second material structure. The 3D structure can comprise an enhanced rigidity as compared to a 3D structure that is composed of a single material structure. The first material structure may differ from the second material structure by its microstructure (e.g., material grain or melt pool). The first material structure may differ from the second material structure by the FLS of its microstructure (e.g., grain or melt pools). The first material structure may differ from the second material structure by its crystal structure. The material structure may differ from the second material structure by the FLS of its melt pools. The lines may comprise parallel lines. The lines may comprise non-parallel lines. The lines can be parallel. The lines can be non-parallel. The lines can be wires. The one or more wires can be arranged at an angle with respect to a layering plane within the 3D object. The acute angle between the one or more wires and the layering plane may be at most about 1°, 5°, 10°, 15°, 20°, 30°, 40°, 50°, 60°, 70°, 80° or 85°. The acute angle between the one or more wires and the layering plane may be at least about 1°, 5°, 10°, 15°, 20°, 30°, 40°, 50°, 60°, 70°, 80° or 85°. The acute angle between the one or more wires and the layering plane may be any angle value between the afore-mentioned acute angle values. The 3D object may comprise layers of hardened material, each of which defines a layering plane. The layering planes may be parallel. The one or more wires can be arranged parallel to a layering plane within the 3D object. The one or more wires can be arranged perpendicular to a layering plane within the 3D object. The one or more wires can be slanted with respect to a layering plane within the 3D object. The one or more wires within a layer of material in the 3D object can comprise a length of at most the length of the layer of material. The one or more wires within the 3D object can comprise a length of at most the height of the 3D object. The one or more wires may have a cross section of a FLS of at least 20 micrometers. The one or more wires can have a cross section of a FLS of at most 40 micrometers. The one or more wires can have a cross section of a FLS (e.g., a diameter, a width or a height) of at least about 5 nanometers (nm), 10 nm, 50 nm, 100 nm, 200 nm, 300 nm, 400 nm, 500 nm, 600 nm, 700 nm, 800 nm, 900 nm, 1 micrometer (μm), 3 μm, 10 μm, 20 μm, 30 μm, 100 μm, or 300 μm. The one or more wires can have a cross section of a FLS (e.g., a diameter, a width or a height) of at most about 50 nm, 100 nm, 200 nm, 300 nm, 400 nm, 500 nm, 600 nm, 700 nm, 800 nm, 900 nm, 1 micrometer (μm), 3 μm, 10 μm, 20 μm, 30 μm, 100 μm, or 300 μm. The one or more wires can have a cross section of a FLS (e.g., a diameter, a width or a height) of any value between the afore-mentioned FLS values.

In another aspect, a 3D object comprises a layer of (hardened) material generated by at least one additive manufacturing method, wherein the layer can comprise a path (e.g., a line or a wire) of material, wherein the path follows a direction in the 3D object that is susceptible to deformation. Deformation may comprise bending (e.g., warping, curving, arching, and/or twisting). For example, a direction susceptible to deformation may be the long axis of an elongated rectangle. In some objects disclosed herein, the layer can comprise a path that follows a direction perpendicular to the direction susceptible to deformation. In some objects disclosed herein, the layer can comprise a path that follows a direction at an angle to the direction susceptible to deformation, wherein the angle is between 0° and 90° (e.g., excluding 0° and 90°). The direction of the path may depend on the nature of the deformation and the type of material, which may be comprised within the 3D object.

The methods, apparatuses and/or systems described herein may comprise a 3D printing process (e.g., added manufacturing) including at least one modification. The modification may include changes to the (e.g., a conventional) 3D printing process, 3D model of the desired 3D object, and/or addition to the 3D printing process. The modification may include changes to the 3D printing instructions, or addition to the 3D printing instructions (e.g., relying on a modified 3D model of the desired 3D object). The printing instructions may include instruction given to the radiated energy (e.g., energy beam). The instructions can be given to a controller that controls and/or regulates the radiated energy and/or energy source. The modification can be in the energy power, frequency, duty cycle, and/or any other modulation parameter. The modification can include process modification. The modification can include a correction (e.g., a geometrical correction) to a model of a desired 3D object. The geometric correction may comprise duplicating a path in a model of the 3D object with a vertical, lateral, or angular (e.g., planer or compound angle) change in position. For example, FIG. 4A shows an example of a duplication of a path that includes angular (rotational) variation of the path (e.g., rotational variation of a path), and FIG. 4B shows an example of duplication of a path to form a multiplicity of paths by lateral translations of the path (e.g., translational variation of a path). The distanced between at least two of the duplicated paths (e.g., the gap) may be identical or different. The distanced between the duplicated paths (e.g., the gap) may be identical or different. The different distances (e.g., gaps) may constitute a series (e.g., of growing distances). The gap may differ in its length, width, and/or volume. FIG. 4B shows an example of paths 420-425 that are separated by distances d1-d5, which all of which are different. The geometric correction may comprise expanding a path in a model of the 3D object in a vertical, lateral, or angular (e.g., planer or compound angle) position. Angular relocation may comprise rotation. The geometric correction may comprise shrinking a path in a model of the 3D object in a vertical, lateral, or angular (e.g., planer or compound angle) position. The modification can include a variation in a characteristic of the energy (e.g., energy beam) using in the 3D printing process, a variation in the path that the energy travels on (or within) a layer of material (in a material bed) to be transformed and form the 3D object. The layer of material can be a layer of powder material. The modification may depend on a selected position within the generated 3D object, such as an edge, a kink, a suspended structure, a bridge, a lower surface, or any combination thereof. The modification may depend on a hindrance for (e.g., resistance to) energy depletion within the 3D object as it is being generated, or a hindrance for (e.g., resistance to) energy depletion in the surrounding pre-transformed material (e.g., powder material). The modification may depend on a degree of packing of the pre-transformed material within a material bed (e.g., a powder material within a powder bed). For example, the modification may depend on the density of the powder material within a powder bed. The powder material may be unused, recycled, new, or aged.

The methods, apparatuses, software, and systems described herein may comprise corrective deformation of a 3D model of the desired 3D structure, that substantially result in the desired 3D structure. The corrective deformation may take into account features comprising stress within the forming structure, deformation of transformed material as it hardens to form at least a portion of the 3D object, the manner of temperature depletion during the printing process, the manner of deformation of the transformed material as a function of the density of the pre-transformed material within the material bed (e.g., powder material within a powder bed). The modification may comprise alteration of a path of a cross section (or portion thereof) in the 3D model that is used in the 3D printing instructions. The alteration of the path may comprise alteration of the path filling at least a portion of the cross section (e.g., hatches). The alteration of the hatches may comprise alteration of the direction of hatches, the density of the hatch lines, the length of the hatch lines, and/or the shape of the hatch lines. The modification may comprise alteration of the thickness of the transformed material. The modification may comprise varying at least a portion of a cross-section of the 3D model (e.g., that is used in the 3D printing instructions) by an angle, and/or inflicting to at least a portion of a cross section, a radius of curvature. The angle can be planer or compound angle. The radius of curvature arose from a bending of at least a portion of the cross section of a 3D model. FIG. 36 shows an example of a vertical cross section of a layered object showing layer #6 of 3612 having a curvature, which curvature has a radius of curvature.

The path of the transforming energy (e.g., first energy) may deviate at least in part from a cross section of a desired 3D object. In some instances, the generated 3D object (e.g., substantially) corresponds to the desired 3D object. In some instances, the transforming energy beam follows a path that differs from a cross section of a model of the desired 3D object (e.g., a deviated path), to form a transformed material. When that transformed material hardens, the hardened transformed material may (e.g., substantially) correspond to the respective cross section of a model of the desired 3D object. In some instances, when that transformed material hardens, the hardened material may not correspond to the respective cross section of a model of the desired 3D object. In some instances, when that transformed material hardens, the hardened transformed material may not correspond to the respective cross section of a model of the desired 3D object, however the accumulated transformed material (e.g., accumulated as it forms a plurality of layers of hardened material) may (e.g., substantially) correspond to the desired 3D object. In some instances, when that transformed material hardens, the accumulated hardened material that forms the generated 3D object (e.g., over several 3D printing cycles) substantially corresponds to the desired 3D object. The deviation from the path may comprise a deviation between different cross-sections of the desired 3D object. The deviation may comprise a deviation within a cross-section of the desired 3D object. The path can comprise a path section that is larger than a corresponding path section in the cross section of the desired 3D object. Larger may be larger within the plane of the cross section (e.g., horizontally larger) and/or outside the plane of the cross section (e.g., vertically larger). The path may comprise a path section that is smaller than a respective path section in the cross section of a model of the desired 3D object. Smaller may be within the plane of the cross section (e.g., horizontally smaller) and/or outside the plane of the cross section (e.g., vertically smaller).

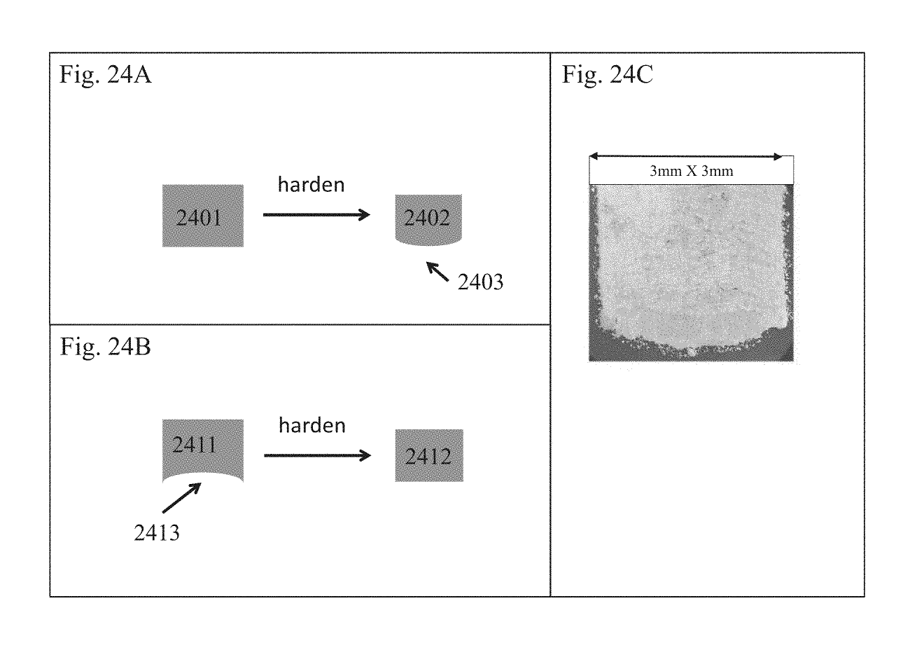

In some embodiments, the tile comprising a transformed material may deform upon hardening (e.g., cooling). The deformation of the tile can be anticipated. Sometimes, the tile may be generated such that the tile comprising the transformed material may deviate from its intended structure, which tile may subsequently harden into a hardened material that assumes the intended structure. The intended structure may be devoid of deformation, or may have a (substantially) reduced amount of deformation. Such corrective deviation from the intended structure of the tile is termed herein as “geometric correction.” FIG. 24A depicts an example of a tile 2401 formed of a transformed material that hardened into a hardened tile 2402, which hardened material comprises a deformation 2403. FIG. 24C shows an example of a vertical cross-section of a 3D object (stainless steel 316L) comprising the deformed tile 2402. FIG. 24B depicts an example of a tile 2411 formed of a transformed material as a deformed tile comprising deformation 2413, which tile hardens into a tile comprising hardened material 2412 that (e.g., substantially) assume the desired structure that is (e.g., substantially) devoid of deformation.

Sometimes, a newly formed layer of material (e.g., comprising transformed material) may reduce in volume during its hardening (e.g., by cooling). Such reduction in volume (e.g., shrinkage) may cause a deformation in the desired 3D object. The deformation may include cracks, and/or tears in the newly formed layer and/or in other (e.g., adjacent) layers. The deformation may include geometric deformation of the 3D object or at least a portion thereof. The newly formed layer can be a portion of a 3D object that comprises a 3D plane or a wire. The 3D printed plane (e.g., 3D plane) or the wire may be (e.g., substantially) parallel to the building platform. An angle may be formed between the 3D printed object and the platform. The angle may be measured relative to the layering plane of (e.g., within) the 3D object (e.g., 3D plane and/or wire). The acute angle between the 3D object and the platform may be any of the acute angle alpha values mentioned herein. The platform (e.g., building platform) may include the base, substrate, or bottom of the enclosure. The building platform may be a carrier plate.

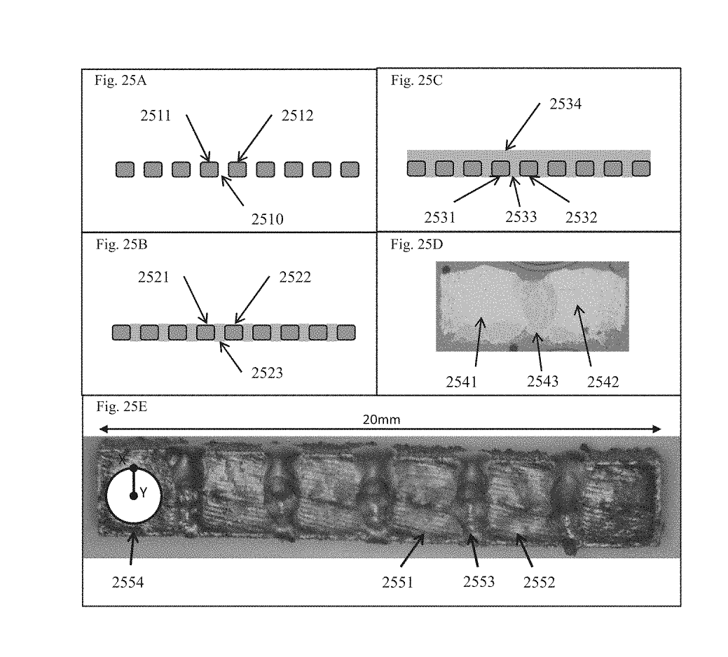

In some embodiments, a layer of hardened material may be composed of individual tiles of hardened material. In some embodiments, two or more tiles are included in the layer of hardened material. The tiles may be separated by a gap. FIG. 25A shows an example of a layer of hardened material that includes a multiplicity of tiles (e.g., 2511 and 2512) separated by at least one gap (e.g., 2510). The at least one gap can comprise a multiplicity of gaps. The tiles may be disposed on a layer of hardened material or on a layer of pre-transformed material. The tiles may be subsequently bound by a binding material (e.g., disposed in the gap). The binding material may be a welding material. The bonding (e.g., of the tiles) may comprise adding a pre-transformed material (e.g., powder) to the material bed. The binding may comprise leveling the pre-transformed material that is added to the material bed. The leveling may comprise flattening, or planarizing. Planarizing and/or leveling may comprise forming a (e.g., substantially) planar exposed surface of the material bed. The adding and/or leveling of material may comprise the layer dispensing mechanism (e.g., recoater). The recoater may comprise the non-contact recoater. The non-contact recoater may level the exposed surface of the material bed without contacting the exposed surface of the material bed. The tiles may be subsequently connected by a connecting (e.g., welding and/or binding) material (e.g., disposed in the gap). The connecting material may form an adhesion between the tiles (e.g., though the gap). The connecting, binding, and/or welding material may form a hardened material (e.g., as it cools and/or cures). The hardened material may be flexible or rigid. The hardened material may be a solid material. The hardened material may have (e.g., substantially) similar, or different, heat distribution properties as compared to the heat distribution properties of the material of the tiles. The tiles may be welded subsequent to their final formation (e.g., hardening). The welding may (e.g., substantially) fill the gap. FIG. 25B shows an example of a layer of hardened material that includes a multiplicity of tiles (e.g., 2521 and 2522) separated by at least one gap (e.g., a plurality of gaps) that is filled by a material 2523 (e.g., welding material) that connects the tiles 2521 and 2522 (e.g., to form a layer). FIG. 25E shows a top view example of a stainless steel 316L 3D object (obtained by optical microscopy) that includes tiles 2551 and 2552 which are welded by the welding portion 2553. The example in FIG. 25E corresponds to the schematics of FIG. 25B in some ways (e.g., tiles being connected by a welding material). FIG. 25D shows an example of a stainless steel 316L 3D object (obtained by optical microscopy) that includes tiles 2541 and 2542 that are welded by a portion 2543, wherein the welded portion can be identified according to its different microstructure. FIGS. 25E and 25D correspond to the same scale bar depicted in FIG. 25E. The welding material may spill out of the gap. The welding material may partially fill the gap. The welding may fill the gap in access and form an additional layer of (hardened) material on the tiles. FIG. 25C shows an example of a layer of hardened material that includes a multiplicity of tiles (e.g., 2531 and 2532) separated by at least one gap (e.g., a multiplicity of gaps) that is filled with a material 2533 that forms a second layer 2544 that covers the tiles. The welding material may be of substantially the same material as the tiles. The welding material may be different from the material that forms the tiles. The tiles may be formed of (e.g., substantially) a single material type. At least two of the tiles may be formed of (e.g., substantially) the same material. At least two of the tiles may be formed of different materials. A series of tiles may be composed of a gradient (e.g., opposing gradient) of two or more materials. The gradient may be a designed gradient. The gradient of material may form a functionally graded material layer. The gradient of material may facilitate the generation of functionally graded 3D object. The tiles may constitute a series. At least two of the tiles may be of (e.g., substantially) identical shape, FLS (e.g., length, width, or height), volume, or any combination thereof Δt least two of the tiles may be of different shape, length, width, height, volume, or any combination thereof. The tiles may be of substantially identical shape, FLS (e.g., length, width, or height), volume, or any combination thereof. The tiles may be of different shape, FLS (e.g., length, width, or height), volume, or any combination thereof Δt least two of the tiles may be separated by a gap. In some instances, the usage of tiles that are subsequently connected (e.g., through welding) generates a layer of hardened material that comprises a substantially flat (e.g., planar) layer that is substantially perpendicular to the platform. In some instances, the generated layer of hardened material that comprises tiles is formed without the usage of auxiliary support. In some instances, the generated layer of hardened material (e.g., that comprises tiles) is formed without the usage of auxiliary support on the portion of the layer that forms a hanging structure. The hanging structure may be (e.g., substantially) parallel to the platform and/or plane normal to the direction of the field of gravity. The hanging structure may form an acute angle alpha with the platform, and/or plane normal to the direction of the field of gravity. The hanging structure may be (e.g., substantially) perpendicular to the direction of the gravitational filed. In some instances, the 3D object generated by tiling is devoid of at least one auxiliary support or auxiliary support mark indicative of a prior presence of at least one auxiliary support. In some instances, the order of welding may or may not take into account the size of the portions (e.g., tiles), heating of the welding areas, heating of the tiles, heating of the material bed, and/or heating of the forming 3D object. Heating may comprise the temperature and/or temperature gradient. In some instances, the gaps may be welded sequentially. In some instances, the gaps may be welded in a single operation (e.g., one sweep of the energy beam across the material bed). The welding may comprise adding pre-transformed material to the material bed. The welding may comprise leveling the material bed (e.g., using the non-contact recoater).

In an aspect provided herein is a 3D object comprising a layer of hardened material generated by at least one additive manufacturing method described herein, wherein the layer of material (e.g., hardened) is different from a corresponding cross section of a model of the 3D object. For example, the generated layers differ from the proposed slices. The layer of material within a 3D object can be indicated by the microstructure of the material. The 3D model may comprise a generated, ordered, provided, or replicated 3D model. The model may be generated, ordered, provided, or replicated by a customer, individual, manufacturer, engineer, artist, human, computer, or software. The software can be neural network software. The model can be generated by a 3D modeling program (e.g., SolidWorks®, Google SketchUp®, SolidEdge®, Engineer®, Auto-CAD®, or I-Deas®). In some cases, the model can be generated from a provided sketch, image, or 3D object.

The layer of transformed material may differ from a respective cross section (e.g., slice) of a model of the 3D object. The difference may be in the area of the transformed material layer as compared to a respective cross section of a model of the 3D object. For example, the area of the transformed material layer may be smaller than the respective cross section of a model of the 3D object. The area of the transformed material layer may be larger than the respective cross section of a model (e.g., model slice) of the 3D object. The area of the transformed material layer may be a portion of the respective cross section of a model of the 3D object. The area of the respective cross section of a model of the 3D object may be divided between at least two different layers of transformed material. The area of the transformed material layer may be larger than the respective cross section of a model of the 3D object, and may shrink to form a hardened material that is substantially identical to the respective cross section of a model of the 3D object. The area of the transformed material layer may be different than the respective cross section of a model of the 3D object, and may deform to form a hardened material that is substantially identical to the respective cross section of a model of the 3D object. The layer of hardened material may differ from a respective cross section (e.g., slice) of a model of the 3D object. The layer of hardened material may be (e.g., substantially) the same as a respective cross section (e.g., slice) of a model of the 3D object. The area of the transformed material layer may be different than the respective cross section of a model of the 3D object, and may deform to form a hardened material within the generated 3D object, wherein the generated 3D object may be substantially identical to the respective cross section of a model of the 3D object. The area of the transformed material layer may be different than the respective cross section of a model of the 3D object, and may form a hardened material within the generated 3D object, wherein the generated 3D object may be (e.g., substantially) identical to the respective cross section of a model of the 3D object. The layer of hardened material may differ from a respective cross section of a model of the 3D object. The difference may be in the area of the hardened material layer as compared to a respective cross section of a model of the 3D object. For example, the area of the hardened material layer may be smaller than the respective cross section of a model of the 3D object. The area of the hardened material layer may be larger than the respective cross section of a model of the 3D object. The area of the hardened material layer may be a portion of the respective cross section of a model of the 3D object. The area of the respective cross section of a model of the 3D object may be divided between at least two different layers of hardened material. The area of the hardened material layer may be different than the respective cross section of a model of the 3D object, and the generated 3D object may be substantially identical to the respective cross section of a model of the 3D object.

In one example, the cross section of a model of the 3D object is divided into a first and a second area. The energy beam may be directed to (i) transform the first area from at least a first portion of a first layer of pre transformed material in the material bed, and (ii) transform the second area from at least a second portion of a second layer of pre transformed material in the material bed. The first transformed and the second transformed area may subsequently harden to form at least a portion of the 3D object. The 3D object may be substantially identical to the model of the 3D object, since upon energy depletion and hardening, the generated 3D object may assume the shape of the model of the 3D object. The deformations of the 3D object (or a portion thereof) may be predicted. For example, the deformations of the transformed material upon energy depletion and hardening may be predicted. The prediction may be used to form the desired 3D object (e.g., even though the cross sections of the transformed material do not correspond to a cross-sections of the model of the desired 3D object).

The material microstructure of the 3D object may reveal the manner in which the 3D object was generated. The material microstructure in a hardened material layer within the 3D object may reveal the manner in which the 3D object was generated. The microstructure of the material in a hardened material layer within the 3D object may reveal the manner in which the layer within the 3D object was generated. The microstructure may comprise the grain-structure, or the melt-pool structure. For example, the path in which the energy traveled and transformed the pre-transformed material to form the hardened material within the printed 3D object may be indicated by the microstructure of the material within the 3D object.

The term “auxiliary support,” as used herein, generally refers to at least one feature that is a part of a printed 3D object, but not part of the desired, intended, designed, ordered, and/or final 3D object. Auxiliary support may provide structural support during and/or subsequent to the formation of the 3D object. The auxiliary support may be anchored to the enclosure. For example, an auxiliary support may be anchored to the platform (e.g., building platform), to the side walls of the material bed, to a wall of the enclosure, to an object (e.g., stationary or semi-stationary) within the enclosure, or any combination thereof. The auxiliary support may be the platform (e.g., the base, the substrate, or the bottom of the enclosure). The auxiliary support may enable the removal or energy from the 3D object (e.g., or a portion thereof) that is being formed. The removal of energy (e.g., heat) may be during and/or after the formation of the 3D object. Examples of auxiliary support comprise a fin (e.g., heat fin), anchor, handle, pillar, column, frame, footing, wall, platform, or another stabilization feature. In some instances, the auxiliary support may be mounted, clamped, or situated on the platform. The auxiliary support can be anchored to the building platform, to the sides (e.g., walls) of the building platform, to the enclosure, to an object (stationary or semi-stationary) within the enclosure, or any combination thereof.

In some examples, the generated 3D object can be printed without auxiliary support. In some examples, overhanging feature of the generated 3D object can be printed without (e.g., without any) auxiliary support. The generated object can be devoid of auxiliary supports. The generated object may be suspended (e.g., float anchorlessly) in the material bed (e.g., powder bed). The generated 3D object may be suspended in the layer of pre-transformed material (e.g., powder material). The pre-transformed material (e.g., powder material) can offer support to the printed 3D object (or the object during its generation). Sometimes, the generated 3D object may comprise one or more auxiliary supports. The auxiliary support may be suspended in the pre-transformed material (e.g., powder material). The auxiliary support may provide weights or stabilizers. The auxiliary support can be suspended in the material bed within the layer of pre-transformed material in which the 3D object (or a portion thereof) has been formed. The auxiliary support (e.g., one or more auxiliary supports) can be suspended in the pre-transformed material within a layer of pre-transformed material other than the one in which the 3D object (or a portion thereof) has been formed (e.g., a previously deposited layer of (e.g., powder) material). The auxiliary support may touch the platform. The auxiliary support may be suspended in the material bed (e.g., powder material) and not touch the platform. The auxiliary support may be anchored to the platform. The distance between any two auxiliary supports can be at least about 1 millimeter, 1.3 millimeters (mm), 1.5 mm, 1.8 mm, 1.9 mm, 2.0 mm, 2.2 mm, 2.4 mm, 2.5 mm, 2.6 mm, 2.7 mm, 3 mm, 4 mm, 5 mm, 10 mm, 11 mm, 15 mm, 20 mm, 30 mm, 40 mm, 41 mm, or 45 mm. The distance between any two auxiliary supports can be at most 1 millimeter, 1.3 mm, 1.5 mm, 1.8 mm, 1.9 mm, 2.0 mm, 2.2 mm, 2.4 mm, 2.5 mm, 2.6 mm, 2.7 mm, 3 mm, 4 mm, 5 mm, 10 mm, 11 mm, 15 mm, 20 mm, 30 mm, 40 mm, 41 mm, or 45 mm. The distance between any two auxiliary supports can be any value in between the afore-mentioned distances (e.g., from about 1 mm to about 45 mm, from about 1 mm to about 11 mm, from about 2.2 mm to about 15 mm, or from about 10 mm to about 45 mm). The distance may be the shortest distance between any two auxiliary supports.

In some examples, the diminished number of auxiliary supports or lack of auxiliary support, may facilitate a 3D printing process that requires a smaller amount of material, produces a smaller amount of material waste, and/or requires smaller energy as compared to commercially available 3D printing processes. The reduced number of auxiliary supports can be smaller by at least about 1.1, 1.3, 1.5, 2, 3, 4, 5, 6, 7, 8, 9, or 10 as compared to conventional 3D printing. The smaller amount may be smaller by any value between the aforesaid values (e.g., from about 1.1 to about 10, or from about 1.5 to about 5) as compared to conventional 3D printing.

In some embodiments, the printed 3D object may be devoid of auxiliary support mark(s). The printed 3D object may comprise a reduced amount of auxiliary supports. The printed 3D object may be devoid of mark(s) arising from an auxiliary structure (including a base structure) that was removed (e.g., subsequent to the generation of the 3D object). The printed 3D object may comprise a single auxiliary support mark. The single auxiliary support may be a platform, or mold (or mould). The single auxiliary support may be adhered to the platform, or mold. The printed 3D object may comprise two or more auxiliary support marks. In some instances, the printed 3D object may comprise mark(s) belonging to one or more auxiliary structures that were previously part of (or attached to) the printed 3D object, and were later on removed. The printed 3D object may comprise two or more marks belonging to previously present auxiliary features. The printed 3D object may be devoid of mark(s) pertaining to a previously present auxiliary support. The mark(s) may comprise variation in grain orientation, variation in material density, variation in the degree of compound segregation to grain boundaries, variation in material porosity, variation in the degree of element segregation to grain boundaries, variation in material phase, variation in metallurgical phase, variation in crystal phase, or variation in crystal structure. For example, that variation (e.g., the mark) may not have been created by the geometry of the printed 3D object alone, and may thus be indicative of a prior existing auxiliary support (e.g., that has subsequently been removed or mostly removed). The variation may be forced by the geometry of the support. In some instances, the 3D structure of the printed object may be forced by the auxiliary support (e.g., by a mold). A mark may be a point of discontinuity that is not explained by the geometry of a printed 3D object devoid of auxiliary support(s). The point of discontinuity may indicate a cutting of a microstructure. For example, cutting of a melt pool. For example, when only a portion of a melt pool is detectable, it indicates that the melt pool was cut subsequent to its formation.

The printed 3D object may comprise spaced apart auxiliary supports. The spaced apart distance may be the shortest distance between the auxiliary supports. In some instances, the spaced apart distance designates the radius of a sphere or of a circle within which there are no auxiliary supports. The sphere may intersect the 3D object forming a circular or an elliptical cross section. For example, X and Y may be two points on the surface of a printed 3D object. The sphere or circle may have a radius XY. FIG. 25E shows and example of a 3D object that comprises an intersecting circle having a radius XY. The shortest distance between points X and Y can be at least about 0.5 millimeters (mm), 1 mm, 1.5 mm, 2 mm, 2.5 mm, 3 mm, 3.5 mm, 4 mm, 4.5 mm, 5 mm, 5.5 mm, 6 mm, 6.5 mm, 7 mm, 7.5 mm, 8 mm, 8.5 mm, 9 mm, 9.5 mm, 10 mm, 10.5 mm, 11 mm, 11.5 mm, 12 mm, 12.5 mm, 13 mm, 13.5 mm, 14 mm, 14.5 mm, 15 mm, 15.5 mm, 16 mm, 20 mm, 20.5 mm, 21 mm, 25 mm, 30 mm, 30.5 mm, 31 mm, 35 mm, 40 mm, 40.5 mm, 41 mm, 45 mm, 50 mm, 80 mm, 100 mm, 200 mm 300 mm, or 500 mm. The shortest distance between points X and Y can be at most about 0.5 mm, 1 mm, 1.5 mm, 2 mm, 2.5 mm, 3 mm, 3.5 mm, 4 mm, 4.5 mm, 5 mm, 5.5 mm, 6 mm, 6.5 mm, 7 mm, 7.5 mm, 8 mm, 8.5 mm, 9 mm, 9.5 mm, 10 mm, 10.5 mm, 11 mm, 11.5 mm, 12 mm, 12.5 mm, 13 mm, 13.5 mm, 14 mm, 14.5 mm, 15 mm, 15.5 mm, 16 mm, 20 mm, 20.5 mm, 21 mm, 25 mm, 30 mm, 30.5 mm, 31 mm, 35 mm, 40 mm, 40.5 mm, 41 mm, 45 mm, 50 mm, 80 mm, 100 mm, 200 mm 300 mm, or 500 mm. The shortest distance between points X and Y can be any value between the afore-mentioned XY distance values. The term “between” as mentioned herein, is meant to be inclusive, unless otherwise specified. The shortest distance between points X and Y can be any value between the above shortest distance values between X and Y (e.g., from about 0.5 mm to about 500 mm, from about 2 mm to about 500 mm, from about 5 mm to about 500 mm, from about 11 mm to about 500 mm, or from about 20 mm to about 500 mm). The shortest straight line XY can form an angle alpha relative to (i) the direction normal to the field of gravity, (ii) the platform, (iii) an average top surface of the layer of (hardened) material, (iv) a plane parallel to the average top leveled surface of the layer of pre-transformed material (e.g., powder) in the material bed, (v) a plane parallel to the average plane of the top surface of the platform facing the deposited material and/or (vi) the normal to a plane parallel to the top surface of the building platform facing the deposited material. A circle of radius XY that is centered at Y (e.g., FIG. 25E, 2554) may lack auxiliary support marks. For example, an acute angle between the straight line XY and a plane normal to the direction of the field of gravity may be from about 0° to about 45°, from about 0° to about 30°, or from about 0° to about 20°. The acute angle between the straight line XY and the plane normal to the direction of the field of gravity may be alpha. When the angle between the straight line XY and the plane normal to the direction of the field of gravity is greater than 90°, one can consider the complementary acute angle. The remainder may not comprise a continuous structure (e.g., as disclosed herein).

In some embodiments, the 3D objects described herein may be devoid of auxiliary support marks. In some embodiments, the 3D objects described herein may comprise auxiliary support marks. The 3D objects described herein may comprise two auxiliary support marks that are spaced apart by at least about 40.5 mm, wherein the acute angle between the shortest straight line between the two auxiliary support marks and the direction of normal to the plane N is from about 45° to about 90°, from about 0° to about 30°, or from about 0° to about 20°. Points X and Y may be points residing on the surface of the 3D object, wherein X is spaced apart from Y by at least about 40.5 mm. The sphere of radius XY that is centered at Y may lack auxiliary support mark. A plane N may be a layering plane of the more than one layer that form the 3D object. The acute angle between the shortest straight line XY and the direction of normal to the plane N may be from about 45° to about 90°, from about 0° to about 30°, or from about 0° to about 20°. The acute angle between the shortest straight line XY and the direction of normal to the plane N may be an angle that is 90° minus the acute angle alpha. Surface comprising XY may be substantially planar (e.g., flat). The surface comprising XY may be curved. The radius of curvature of the surface comprising XY may be at least about 0.1 centimeter (cm), 0.2 cm, 0.3 cm, 0.4 cm, 0.5 cm, 0.6 cm, 0.7 cm, 0.8 cm, 0.9 cm, 1 cm, 5 cm, 10 cm, 20 cm, 30 cm, 40 cm, 50 cm, 60 cm, 70 cm, 80 cm, 90 cm, 1 meter (m), 1.5 m, 2 m, 2.5 m, 3 m, 3.5 m, 4 m, 4.5 m, 5 m, 10 m, 15 m, 20 m, 25 m, 30 m, 50 m, or 100 m. The radius of curvature of the surface comprising XY may have a value between any of the afore-mentioned values of curvature radii (e.g., from about 5 cm to about 100 cm, from about 5 cm to about 100 m, from about 20 cm to about 100 m).

The straight line XY, or the surface having a FLS (e.g., radius) of XY may be substantially planar (e.g., flat). For example, the (e.g., substantially) planar surface may have a large radius of curvature. The straight line XY, or the surface of a FLS XY may have a radius of curvature of at least about 0.1 centimeter (cm), 0.2 cm, 0.3 cm, 0.4 cm, 0.5 cm, 0.6 cm, 0.7 cm, 0.8 cm, 0.9 cm, 1 cm, 5 cm, 10 cm, 20 cm, 30 cm, 40 cm, 50 cm, 60 cm, 70 cm, 80 cm, 90 cm, 1 meter (m), 1.5 m, 2 m, 2.5 m, 3 m, 3.5 m, 4 m, 4.5 m, 5 m, 10 m, 15 m, 20 m, 25 m, 30 m, 50 m, or 100 m. The straight line XY, or the surface having a FLS XY may have a radius of curvature between any of the afore-mentioned values of curvature (e.g., from about 5 cm to about 100 cm, from about 5 cm to about 100 m, from about 20 cm to about 100 m). The radius of curvature of the straight line XY may be normal to the length of the line XY. The curvature of the straight line XY may be the curvature along its length.

FIG. 36 shows examples of a vertical cross section of various 3D objects comprising layers having various radii of curvature. For example, object 3613 is composed of layers that are all negatively warped. The radius of curvature of the layers composing object 3613 may correspond to segment 3616 on a circle with a radius r. For example, object 3612 comprises some layers that are negatively warped (e.g., layer 5 and 6). The radius of curvature of layer 6 of object 3612 may correspond to segment 3616 on a circle with a radius r. For example, object 3614 comprises some layers that are positively warped (e.g., layer 5 and 6). The radius of curvature of layer 6 of object 3614 may correspond to segment 3617 on a circle with a radius r. For example, object 3611 is composed of layers that are all planar (i.e., having a radius of curvature equal to infinity). The positive or negative warp can be measured with respect to a building platform (e.g., FIG. 36, 3618). Planar layers have a radius of curvature equal to infinity.

The generated 3D object can have various surface roughness profiles, which may be suitable for various applications. The surface roughness may be the deviations in the direction of the normal vector of a real surface from its ideal form. The generated 3D object can have a Ra value of as disclosed herein.

The generated 3D object (e.g., the hardened cover) may be substantially smooth. The generated 3D object may have a deviation from an ideal planar surface (e.g., atomically flat or molecularly flat) of at most about 1.5 nanometers (nm), 2 nm, 3 nm, 4 nm, 5 nm, 10 nm, 15 nm, 20 nm, 25 nm, 30 nm, 35 nm, 100 nm, 300 nm, 500 nm, 1 micrometer (μm), 1.5 μm, 2 μm, 3 μm, 4 μm, 5 μm, 10 μm, 15 μm, 20 μm, 25 μm, 30 μm, 35 μm, 100 μm, 300 μm, 500 μm, or less. The generated 3D object may have a deviation from an ideal planar surface of at least about 1.5 nanometers (nm), 2 nm, 3 nm, 4 nm, 5 nm, 10 nm, 15 nm, 20 nm, 25 nm, 30 nm, 35 nm, 100 nm, 300 nm, 500 nm, 1 micrometer (μm), 1.5 μm, 2 μm, 3 μm, 4 μm, 5 μm, 10 μm, 15 μm, 20 μm, 25 μm, 30 μm, 35 μm, 100 μm, 300 μm, 500 μm, or more. The generated 3D object may have a deviation from an ideal planar surface between any of the afore-mentioned deviation values. The generated 3D object may comprise a pore. The generated 3D object may comprise pores. The pores may be of an average FLS (diameter or diameter equivalent in case the pores are not spherical) of at most about 1.5 nanometers (nm), 2 nm, 3 nm, 4 nm, 5 nm, 10 nm, 15 nm, 20 nm, 25 nm, 30 nm 35 nm, 100 nm, 300 nm, 500 nm, 1 micrometer (μm), 1.5 μm, 2 μm, 3 μm, 4 μm, 5 μm, 10 μm, 15 μm, 20 μm, 25 μm, 30 μm, 35 μm, 100 μm, 300 μm, or 500 μm. The pores may be of an average FLS of at least about 1.5 nanometers (nm), 2 nm, 3 nm, 4 nm, 5 nm, 10 nm, 15 nm, 20 nm, 25 nm, 30 nm, 35 nm, 100 nm, 300 nm, 500 nm, 1 micrometer (μm), 1.5 μm, 2 μm, 3 μm, 4 μm, 5 μm, 10 μm, 15 μm, 20 μm, 25 μm, 30 μm, 35 μm, 100 μm, 300 μm, or 500 μm. The pores may be of an average FLS between any of the afore-mentioned FLS values (e.g., from about 1 nm to about 500 μm, or from about 20 μm, to about 300 μm). The 3D object (or at least a layer thereof) may have a porosity of at most about 0.05 percent (%), 0.1% 0.2%, 0.3%, 0.4%, 0.5%, 0.6%, 0.7%, 0.8%, 0.9%, 1%, 2%, 3%, 4%, 5%, 6%, 7%, 8%, 9%, 10%, 20%, 30%, 40%, 50%, 60%, 70%, or 80%. The 3D object (or at least a layer thereof) may have a porosity of at least about 0.05%, 0.1%, 0.2%, 0.3%, 0.4%, 0.5%, 0.6%, 0.7%, 0.8%, 0.9%, 1%, 2%, 3%, 4%, 5%, 6%, 7%, 8%, 9%, 10%, 20%, 30%, 40%, 50%, 60%, 70%, or 80%. The 3D object (or at least a layer thereof) may have porosity between any of the afore-mentioned porosity percentages (e.g., from about 0.05% to about 80%, from about 0.05% to about 40%, from about 10% to about 40%, or from about 40% to about 90%). In some instances, a pore may traverse the generated 3D object. For example, the pore may start at a face of the 3D object and end at the opposing face of the 3D object. The pore may comprise a passageway extending from one face of the 3D object and ending on the opposing face of that 3D object. In some instances, the pore may not traverse the generated 3D object. The pore may form a cavity in the generated 3D object. The pore may form a cavity on a face of the generated 3D object. For example, pore may start on a face of the plane and not extend to the opposing face of that 3D object.

The formed plane may comprise a protrusion. The protrusion can be a grain, a bulge, a bump, a ridge, or an elevation. The generated 3D object may comprise protrusions. The protrusions may be of an average FLS of at most about 1.5 nanometers (nm), 2 nm, 3 nm, 4 nm, 5 nm, 10 nm, 15 nm, 20 nm, 25 nm, 30 nm, 35 nm, 100 nm, 300 nm, 500 nm, 1 micrometer (μm), 1.5 μm, 2 μm, 3 μm, 4 μm, 5 μm, 10 μm, 15 μm, 20 μm, 25 μm, 30 μm, 35 μm, 100 μm, 300 μm, 500 μm, or less. The protrusions may be of an average FLS of at least about 1.5 nanometers (nm), 2 nm, 3 nm, 4 nm, 5 nm, 10 nm, 15 nm, 20 nm, 25 nm, 30 nm, 35 nm, 100 nm, 300 nm, 500 nm, 1 micrometer (μm), 1.5 μm, 2 μm, 3 μm, 4 μm, 5 μm, 10 μm, 15 μm, 20 μm, 25 μm, 30 μm, 35 μm, 100 μm, 300 μm, 500 μm, or more. The protrusions may be of an average FLS between any of the afore-mentioned FLS values. The protrusions may constitute at most about 0.05%, 0.1%, 0.2%, 0.3%, 0.4%, 0.5%, 0.6%, 0.7%, 0.8%, 0.9%, 1%, 2%, 3%, 4%, 5%, 10%, 20%, 30%, 40%, or 50% of the area of the generated 3D object. The protrusions may constitute at least about 0.05%, 0.1%, 0.2%, 0.3%, 0.4%, 0.5%, 0.6%, 0.7%, 0.8%, 0.9%, 1%, 2%, 3%, 4%, 5%, 10%, 20%, 30%, 40%, or 50% of the area of the 3D object. The protrusions may constitute a percentage of an area of the 3D object that is between the afore-mentioned percentages of 3D object area. The protrusion may reside on any surface of the 3D object. For example, the protrusions may reside on an external surface of a 3D object. The protrusions may reside on an internal surface (e.g., a cavity) of a 3D object. At times, the average size of the protrusions and/or of the holes may determine the resolution of the printed (e.g., generated) 3D object. The resolution of the printed 3D object may be at least about 1 micrometer, 1.3 micrometers (μm), 1.5 μm, 1.8 μm, 1.9 μm, 2.0 μm, 2.2 μm, 2.4 μm, 2.5 μm, 2.6 μm, 2.7 μm, 3 μm, 4 μm, 5 μm, 10 μm, 20 μm, 30 μm, 40 μm, 50 μm, 60 μm, 70 μm, 80 μm, 90 μm, 100 μm, 200 μm, or more. The resolution of the printed 3D object may be at most about 1 micrometer, 1.3 micrometers (μm), 1.5 μm, 1.8 μm, 1.9 μm, 2.0 μm, 2.2 μm, 2.4 μm, 2.5 μm, 2.6 μm, 2.7 μm, 3 μm, 4 μm, 5 μm, 10 μm, 20 μm, 30 μm, 40 μm, 50 μm, 60 μm, 70 μm, 80 μm, 90 μm, 100 μm, 200 μm, or less. The resolution of the printed 3D object may be any value between the above mentioned resolution values. At times, the 3D object may have a material density of at least about 99.9%, 99.8%, 99.7%, 99.6%, 99.5%, 99.4%, 99.3%, 99.2% 99.1%, 99%, 98%, 96%, 95%, 94%, 93%, 92%, 91%, 90%, 8%, or 70%. At times, the 3D object may have a material density of at most about 99.5%, 99%, 98%, 96%, 95%, 94%, 93%, 92%, 91%, 90%, 8%, or 70%. At times, the 3D object may have a material density between the afore-mentioned material densities. The resolution of the 3D object may be at least about 100 dots per inch (dpi), 300 dpi, 600 dpi, 1200 dpi, 2400 dpi, 3600 dpi, or 4800 dpi. The resolution of the 3D object may be at most about 100 dpi, 300 dpi, 600 dpi, 1200 dpi, 2400 dpi, 3600 dpi, or 4800 dip. The resolution of the 3D object may be any value between the aforementioned values (e.g., from 100 dpi to 4800 dpi, from 300 dpi to 2400 dpi, or from 600 dpi to 4800 dpi). The height uniformity (e.g., deviation from average surface height) of a planar surface of the 3D object may be at least about 100 μm, 90 μm, 80 μm, 70 μm, 60 μm, 50 μm, 40 μm, 30 μm, 20 μm, 10 μm, or 5 μm. The height uniformity of the planar surface may be at most about 100 μm, 90 μm, 80, 70 μm, 60 μm, 50 μm, 40 μm, 30 μm, 20 μm, 10 μm, or 5 μm. The height uniformity of the planar surface of the 3D object may be any value between the afore-mentioned height deviation values (e.g., from about 100 μm to about 5 μm, from about 50 μm to about 5 μm, from about 30 μm to about 5 μm, or from about 20 μm to about 5 μm). The height uniformity may comprise high precision uniformity.

The 3D object (e.g., solidified material) that is generated can have an average deviation value from the intended dimensions (e.g., of a desired 3D object) of at most about 0.5 microns (μm), 1 μm, 3 μm, 10 μm, 30 μm, 100 μm, 300 μm or less. The deviation can be any value between the aforementioned values. The average deviation can be from about 0.5 μm to about 300 μm, from about 10 μm to about 50 μm, from about 15 μm to about 85 μm, from about 5 μm to about 45 μm, or from about 15 μm to about 35 μm. The 3D object can have a deviation from the intended dimensions in a specific direction, according to the formula Dv+L/K_{dv}, wherein Dv is a deviation value, L is the length of the 3D object in a specific direction, and K_{dv} is a constant. Dv can have a value of at most about 300 μm, 200 μm, 100 μm, 50 μm, 40 μm, 30 μm, 20 μm, 10 μm, 5 μm, 1 μm, or 0.5 μm. Dv can have a value of at least about 0.5 μm, 1 μm, 3 μm, 5 μm, 10 μm, 20 μm, 30 μm, 50 μm, 70 μm, 100 μm, 300 μm or less. Dv can have any value between the aforementioned values. For example, Dv can have a value that is from about 0.5 μm to about 300 μm, from about 10 μm to about 50 μm, from about 15 μm to about 85 μm, from about 5 μm to about 45 μm, or from about 15 μm to about 35 μm. K_{dv} can have a value of at most about 3000, 2500, 2000, 1500, 1000, or 500. K_{dv} can have a value of at least about 500, 1000, 1500, 2000, 2500, or 3000. K_{dv} can have any value between the aforementioned values. For example, K_{dv} can have a value that is from about 3000 to about 500, from about 1000 to about 2500, from about 500 to about 2000, from about 1000 to about 3000, or from about 1000 to about 2500.

The generated 3D object (i.e., the printed 3D object) may not require further processing following its generation by a method described herein. The printed 3D object may require reduced amount of processing after its generation by a method described herein. For example, the printed 3D object may not require removal of auxiliary support (e.g., since the printed 3D object was generated as a 3D object devoid of auxiliary support). The printed 3D object may not require smoothing, flattening, polishing, or leveling. The printed 3D object may not require further machining In some examples, the printed 3D object may require one or more treatment operations following its generation (e.g., post generation treatment, or post printing treatment). The further treatment step(s) may comprise surface scraping, machining, polishing, grinding, blasting (e.g., sand blasting, bead blasting, shot blasting, or dry ice blasting), annealing, or chemical treatment. The further treatment may comprise physical or chemical treatment. The further treatment step(s) may comprise electrochemical treatment, ablating, polishing (e.g., electro polishing), pickling, grinding, honing, or lapping. In some examples, the printed 3D object may require a single operation (e.g., of sand blasting) following its formation. The printed 3D object may require an operation of sand blasting following its formation. Polishing may comprise electro polishing (e.g., electrochemical polishing or electrolytic polishing). The further treatment may comprise the use of abrasive(s). The blasting may comprise sand blasting or soda blasting. The chemical treatment may comprise use or an agent. The agent may comprise an acid, a base, or an organic compound. The further treatment step(s) may comprise adding at least one added layer (e.g., cover layer). The added layer may comprise lamination. The added layer may be of an organic or inorganic material. The added layer may comprise elemental metal, metal alloy, ceramic, or elemental carbon. The added layer may comprise at least one material that composes the printed 3D object. When the printed 3D object undergoes further treatment, the bottom most surface layer of the treated object may be different than the original bottom most surface layer that was formed by the 3D printing (e.g., the bottom skin layer).

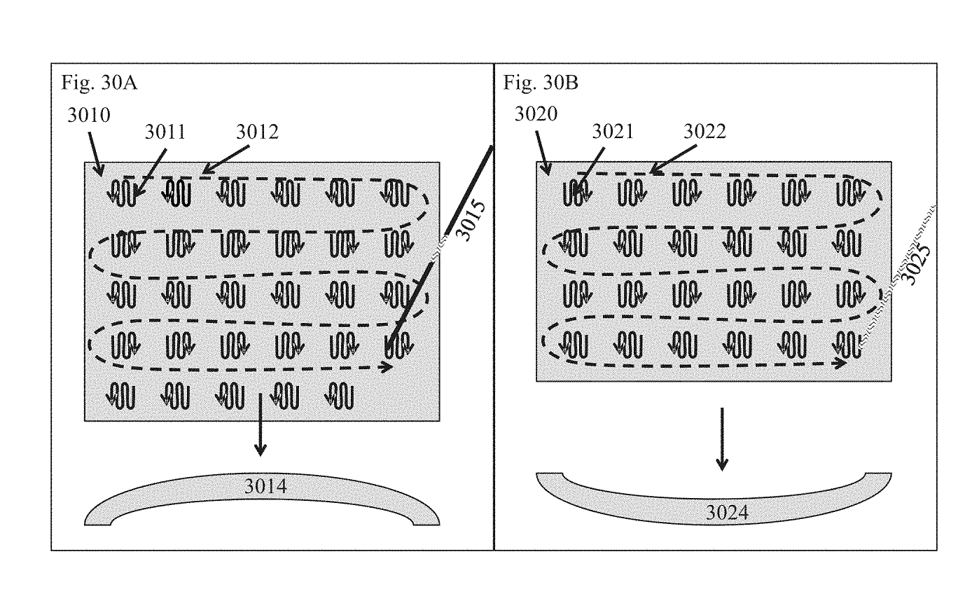

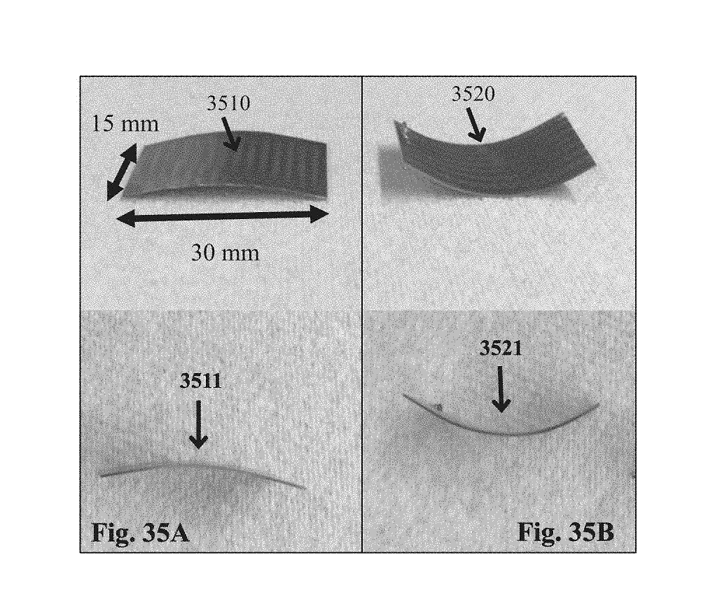

Sometimes the sequence of forming the internal portion paths with respect to the direction of internal portion formation (e.g., path-of-portions) may generate concave, convex, rippled, or 3D shape (or a portion thereof, e.g., A layer). The 3D shape (also herein “3D object”) may comprise a first layer and a second layer. In some embodiments, the first layer comprises a plane of material (e.g., 3D plane). The plane of material (e.g., 3D plane) can be generated by a 3D printing methodology (e.g., additive material methodology). The plane of material can be a metal sheet. The internal hatches may correspond to the heated portions, portions of deposited material (e.g., tiles), or any combination thereof. In some embodiments, the shape of the 3D object (e.g., 3D plane (e.g., metal sheet), or wire) is manipulated using generating heated portions, disposed portions of material (tiles), or any combination thereof. FIG. 30A shows an example of a top view of a planar surface 3010 (e.g., metal sheet) that underwent treatment comprising heating portions of the surface (e.g., 3011), wherein the progression of the hatch within the heated portion is in a direction opposite to the progression of the path-of-portions. Such treatment resulted in FIG. 30A, in a negatively warped object 3014. FIG. 35A shows an example of a negatively warped object prepared by the methods described herein, with the side view of object 3510 shown in 3511. FIG. 30B shows an example of a top view of a planar surface 3020 (e.g., metal sheet) that underwent treatment comprising heating portions of the surface (e.g., 3021), wherein the progression of the hatch within the heated portion is in the direction of the progression of the path-of-portions. Such treatment resulted in FIG. 30B showing an example of a side view of a positively warped object 3024. FIG. 35B shows an example of a positively warped object 3520 shown as a corresponding side view 3521. In the examples shown in FIGS. 35A and 35B, the 3D object is a sheet of stainless steel 316L.

When forming the tiles, the energy beam may transform a corresponding portion of a pre-transformed material within the material bed, the hardened material in at least a portion of a previously formed layer of hardened material, the material in the entire previously formed layer or hardened material, the material in at least a portion of a previously formed 3D object portion, the material in the entire previously formed 3D object portion, or any combination thereof.

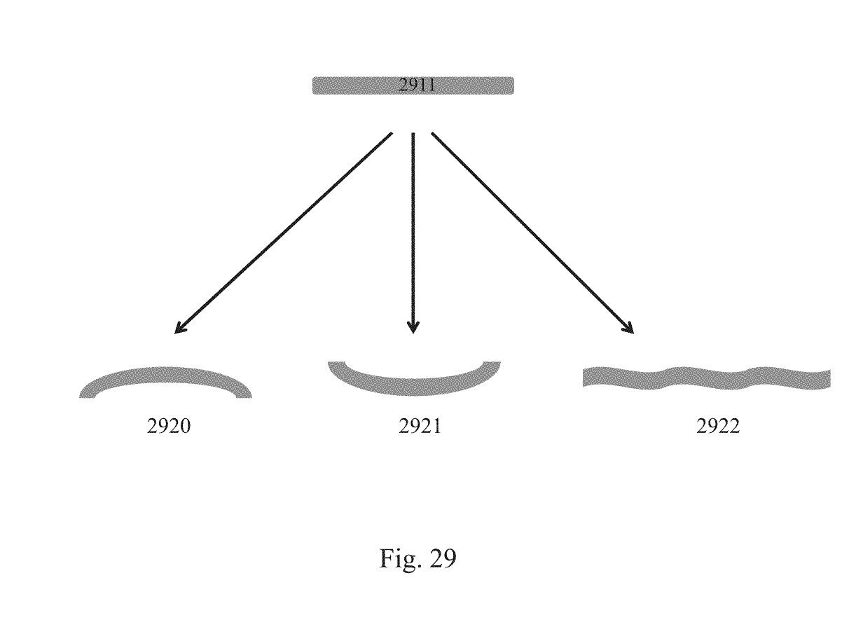

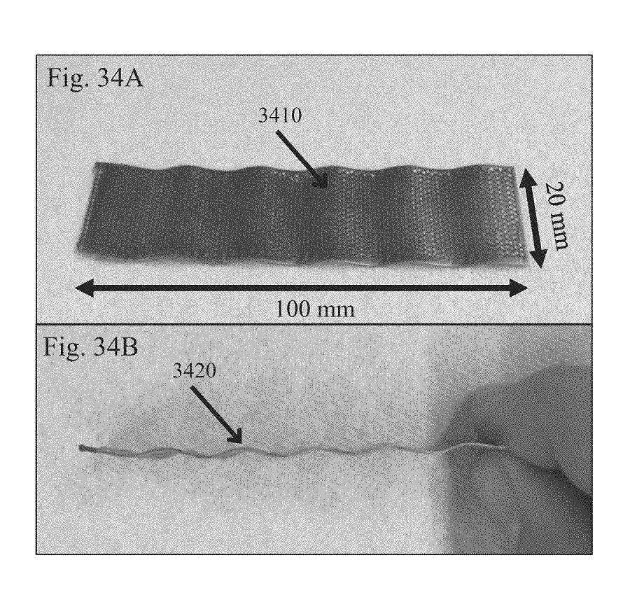

In some examples, the direction in which the internal hatches progress relative to the direction in which the path-of-tiles progresses determines the direction of deformation (e.g., warpage). At times, when the direction of the internal hatch progression opposes the direction of the path-of-tiles progression, the formed 3D object (or a portion thereof) will warp negatively, form a convex shape (e.g., a hill, FIG. 31A). At times, when the internal path progression corresponds the progression of the path-of-tiles, the formed 3D object (or a portion thereof) will warp positively, form a concave shape (e.g., valley, FIG. 31B). At times, a rippled structure can be generated by forming some of the tiles with an internal path that corresponds, and some of the tiles that opposes, the direction of the path-of-portions. FIG. 29 shows an example of a vertical cross section of an object (e.g., plane or wire) 2911 that underwent a manipulation (e.g., by forming heated portions, tile deposition, or a combination thereof). FIG. 29 shows examples of three possible results of the manipulation: negatively warped (e.g., convex) object 2920, positively warped (e.g., concave) object 2921, and rippled object 2922. FIGS. 34A and 34B show examples (top view and side view respectively) of a rippled object prepared by the methods disclosed herein. FIGS. 35A and 35B show examples of a warped object prepared by the methods disclosed herein. FIG. 35A shows an example of a negatively warped object with the side view of object 3510 is shown in the example of 3511. FIG. 35B shows an example of a positively warped object with the side view of object 3520 shown in the example of 3521.

The internal hatch(es) of the portions may be of substantially the same general shape as the shape of the path-of-portions (e.g., both sine waves). The internal hatch(es) of the portions may be of a different general shape as the shape of the path-of-portions (e.g., vector lines vs. a sine wave).

In another aspect provided herein is a system for generating a 3D object comprising: an enclosure for accommodating a layer of pre-transformed material (e.g., powder); an energy (e.g., energy beam) capable of transforming the pre-transformed material to form a transformed material, wherein the transformed material is capable of hardening to form at least a portion of a 3D object; and a controller that directs the energy to at least a portion of the layer of pre-transformed material according to a path (e.g., as described herein). The system may comprise an energy source, an optical system, a temperature system, a material delivery system, a pressure system, an atmosphere, a pump, a nozzle, a valve, a sensor, a central processing unit, a display, or an algorithm. The chamber may comprise a building platform. The system for generating a 3D object and its components may be any 3D printing system such as, for example, the one described in patent application serial number PCT/US15/36802, or in Provisional Patent Application Ser. No. 62/317,070, each of which is entirely incorporated herein by reference.

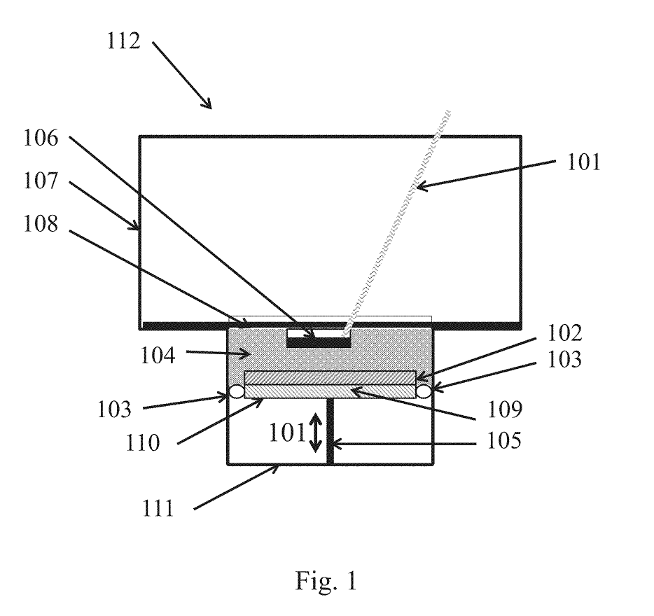

The pre-transformed material may be deposited in an enclosure (e.g., a container). FIG. 1 shows an example of a container 112. The container can contain the pre-transformed material (e.g., without spillage; FIG. 1, 104). The material may be placed in, or inserted to the container. The material may be deposited in, pushed to, sucked into, or lifted to the container. The material may be layered (e.g., spread) in the container. The container may comprise a substrate (e.g., FIG. 1, 109). The substrate may be situated adjacent to the bottom of the container (e.g., FIG. 1, 111). Bottom may be relative to the gravitational field, or relative to the position of the footprint of the energy beam (e.g., FIG. 1, 101) on the layer of pre-transformed material as part of a material bed. The footprint of the energy beam may follow a Gaussian bell shape. In some embodiments, the footprint of the energy beam does not follow a Gaussian bell shape. The container may comprise a platform comprising a base (e.g., FIG. 1, 102). The platform may comprise a substrate. The base may reside adjacent to the substrate. The pre-transformed material may be layered adjacent to a side of the container (e.g., on the bottom of the container). The pre-transformed material may be layered adjacent to the substrate and/or adjacent to the base. Adjacent to may be above. Adjacent to may be directly above, or directly on. The substrate may have one or more seals that enclose the material in a selected area within the container (e.g., FIG. 1, 103). The one or more seals may be flexible or non-flexible. The one or more seals may comprise a polymer or a resin. The one or more seals may comprise a round edge or a flat edge. The one or more seals may be bendable or non-bendable. The seals may be stiff. The container may comprise the base. The base may be situated within the container. The container may comprise the platform, which may be situated within the container.

The platform (also herein, “printing platform”) may be part of the container. The substrate and/or the base may be removable or non-removable. The building platform may be substantially horizontal, substantially planar, or non-planar. The building platform may have a surface that points towards the deposited pre-transformed material (e.g., powder material), which at times may point towards the top of the container. The building platform may have a surface that points away from the deposited pre-transformed material, which at times may point towards the bottom of the container. The building platform may have a surface that is substantially flat. The building platform may have a surface that is not flat. The building platform may have a surface that comprises protrusions or indentations. The building platform may have a surface that comprises embossing. The building platform may have a surface that comprises supporting features (e.g., auxiliary support). The building platform may have a surface that comprises a mold. The building platform may have a surface that comprises a wave formation. The surface may point towards the layer of pre-transformed material within the material bed. The wave may have an amplitude (e.g., vertical amplitude or at an angle). The platform (e.g., base) may comprise a mesh through which the pre-transformed material (e.g., the remainder) is able to flow though. The building platform may comprise a motor. The platform (e.g., substrate and/or base) may be fastened to the container. The platform (or any of its components) may be transportable. The transportation of the platform may be controlled and/or regulated by a controller (e.g., control system). The platform may be transportable horizontally, vertically, or at an angle (e.g., planar or compound).

The building platform may be vertically transferable, for example using an elevator. An elevation mechanism is shown as an example in FIG. 1, 105. The up and down arrow next to the elevation mechanism 105 signifies a possible direction of movement of the elevation mechanism, or a possible direction of movement effectuated by the elevation mechanism.

In some cases, auxiliary support(s) may adhere to the upper surface of the platform. In some examples, the auxiliary supports of the printed 3D object may touch the platform (e.g., the bottom of the enclosure, the substrate, or the base). Sometimes, the auxiliary support may adhere to the platform. In some embodiments, the auxiliary supports are an integral part of the platform. At times, auxiliary support(s) of the printed 3D object, do not touch the platform. In any of the methods described herein, the printed 3D object may be supported only by the pre-transformed material within the material bed (e.g., powder bed, FIG. 1, 104). Any auxiliary support(s) of the printed 3D object, if present, may be suspended adjacent to the platform. Occasionally, the platform may have a pre-hardened (e.g., pre-solidified) amount of material. Such pre-solidified material may provide support to the printed 3D object. At times, the platform may provide adherence to the material. At times, the platform does not provide adherence to the material. The platform may comprise elemental metal, metal alloy, elemental carbon, or ceramic. The platform may comprise a composite material (e.g., as disclosed herein). The platform may comprise glass, stone, zeolite, or a polymeric material. The polymeric material may include a hydrocarbon or fluorocarbon. The platform (e.g., base) may include Teflon. The platform may include compartments for printing small objects. Small may be relative to the size of the enclosure. The compartments may form a smaller compartment within the enclosure, which may accommodate a layer of pre-transformed material.

The methods described herein can be performed in the enclosure (e.g., container or chamber). One or more 3D objects can be formed in the enclosure. The enclosure may have a predetermined and/or controlled pressure. The enclosure may have a predetermined and/or controlled atmosphere. The control may be manual or via a control system.

The enclosure may comprise ambient pressure (e.g., 1 atmosphere), negative pressure (i.e., vacuum) or positive pressure. The vacuum may comprise pressure below 1 bar or below 1 atmosphere. The positively pressurized environment may comprise pressure above 1 bar or above 1 atmosphere. The pressure in the enclosure can be at least about 10⁻⁷ Torr, 10⁻⁶ Torr, 10⁻⁵ Torr, 10⁻⁴ Torr, 10⁻³ Torr, 10⁻² Torr, 10⁻¹ Torr, 1 Torr, 10 Torr, 100 Torr, 1 bar, 2 bar, 3 bar, 4 bar, 5 bar, 10 bar, 20 bar, 30 bar, 40 bar, 50 bar, 100 bar, 200 bar, 300 bar, 400 bar, 500 bar, 1000 bar, or 1100 bar. The pressure in the enclosure can be at least about 100 Torr, 200 Torr, 300 Torr, 400 Torr, 500 Torr, 600 Torr, 700 Torr, 720 Torr, 740 Torr, 750 Torr, 760 Torr, 900 Torr, 1000 Torr, 1100 Torr, or 1200 Torr. The pressure in the enclosure can be between any of the aforementioned enclosure pressure values (e.g., from about 10⁻⁷ Torr to about 1200 Torr, from about 10⁻⁷ Torr to about 1 Torr, from about 1 Torr to about 1200 Torr, or from about 10⁻² Torr to about 10 Torr). The chamber can be pressurized to a pressure of at least 10⁻⁷ Torr, 10⁻⁶ Torr, 10⁻⁵ Torr, 10⁻⁴ Torr, 10⁻³ Torr, 10⁻² Torr, 10⁻¹ Torr, 1 Torr, 10 Torr, 100 Torr, 1 bar, 2 bar, 3 bar, 4 bar, 5 bar, 10 bar, 20 bar, 30 bar, 40 bar, 50 bar, 100 bar, 200 bar, 300 bar, 400 bar, 500 bar, or 1000 bar. The chamber can be pressurized to a pressure of at most 10⁻⁷ Torr, 10⁻⁶ Torr, 10⁻⁵ Torr, 10⁻⁴ Torr, 10⁻³ Torr, 10⁻² Torr, 10⁻¹ Torr, 1 Torr, 10 Torr, 100 Torr, 1 bar, 2 bar, 3 bar, 4 bar, 5 bar, 10 bar, 20 bar, 30 bar, 40 bar, 50 bar, 100 bar, 200 bar, 300 bar, 400 bar, 500 bar, or 1000 bar. The pressure in the chamber can be at a range between any of the aforementioned pressure values (e.g., from about 10⁻⁷ Torr to about 1000 bar, from about 10⁻⁷ Torr to about 1 Torr, from about 1 Torr to about 100 Barr, from about 1 bar to about 10 bar, from about 1 bar to about 100 bar, or from about 100 bar to about 1000 bar). In some cases, the chamber pressure can be standard atmospheric pressure. The pressure may be measured at an ambient temperature (e.g., room temperature, 20° C., or 25° C.).

The enclosure may include an atmosphere. The enclosure may comprise a (e.g., substantially) inert atmosphere. The atmosphere in the enclosure may be substantially depleted by one or more gases present in the ambient atmosphere. The atmosphere in the enclosure may include a reduced level of one or more gases relative to the ambient atmosphere. For example, the atmosphere may be substantially depleted, or have reduced levels of water, oxygen, nitrogen, carbon dioxide, hydrogen sulfide, or any combination thereof. The level of the depleted or reduced level gas may be at most about 1 ppm, 10 ppm, 50 ppm, 100 ppm, 500 ppm, 1000 ppm, 5000 ppm, 10000 ppm, 25000 ppm, 50000 ppm, or 70000 ppm volume by volume (v/v). The level of the depleted or reduced level gas may be at least about 1 ppm, 10 ppm, 50 ppm, 100 ppm, 500 ppm, 1000 ppm, 5000 ppm, 10000 ppm, 25000 ppm, 50000 ppm, or 70000 ppm (v/v). The level of the oxygen gas may be at most about 1 ppm, 10 ppm, 50 ppm, 100 ppm, 500 ppm, 1000 ppm, 5000 ppm, 10000 ppm, 25000 ppm, 50000 ppm, or 70000 ppm (v/v). The level of the water vapor may be at most about 1 ppm, 10 ppm, 50 ppm, 100 ppm, 500 ppm, 1000 ppm, 5000 ppm, 10000 ppm, 25000 ppm, 50000 ppm, or 70000 ppm (v/v). The level of the gas (e.g., depleted or reduced level gas, oxygen, or water) may between any of the afore-mentioned levels of gas. The atmosphere may comprise air. The atmosphere may be inert. The atmosphere may be non-reactive. The atmosphere may be non-reactive with the material (e.g., the material deposited in the layer of material (e.g., powder), or the material comprising the 3D object). The atmosphere may prevent oxidation of the generated 3D object. The atmosphere may prevent oxidation of the pre-transformed material within the layer of pre-transformed material before its transformation, during its transformation, after its transformation, before its hardening, after its hardening, or any combination thereof. The atmosphere may comprise argon or nitrogen gas. The atmosphere may comprise a Nobel gas. The atmosphere can comprise a gas selected from the group consisting of argon, nitrogen, helium, neon, krypton, xenon, hydrogen, carbon monoxide, and carbon dioxide. The atmosphere may comprise hydrogen gas. The atmosphere may comprise a safe amount of hydrogen gas. The atmosphere may comprise a v/v percent of hydrogen gas of at least about 0.05%, 0.1%, 0.2%, 0.3%, 0.4%, 0.5%, 0.6%, 0.7%, 0.8%, 0.9%, 1%, 2%, 3%, 4%, or 5%, at ambient pressure (e.g., and ambient temperature). The atmosphere may comprise a v/v percent of hydrogen gas of at most about 0.05%, 0.1%, 0.2%, 0.3%, 0.4%, 0.5%, 0.6%, 0.7%, 0.8%, 0.9%, 1%, 2%, 3%, 4%, or 5%, at ambient pressure (e.g., and ambient temperature). The atmosphere may comprise any percent of hydrogen between the afore-mentioned percentages of hydrogen gas. The atmosphere may comprise a v/v hydrogen gas percent that is at least able to react with the material (e.g., at ambient temperature and/or at ambient pressure), and at most adhere to the prevalent work-safety standards in the jurisdiction (e.g., hydrogen codes and standards). The material may be the material within the layer of pre-transformed material (e.g., powder), the transformed material, the hardened material, or the material within the 3D object. Ambient refers to a condition to which people are generally accustomed. For example, ambient pressure may be 1 atmosphere. Ambient temperature may be a typical temperature to which humans are generally accustomed. For example, from about 15° C. to about 30° C., from about −30° C. to about 60° C., from about −20° C. to about 50° C., from 16° C. to about 26° C., from about 20° C. to about 25° C. “Room temperature” may be measured in a confined or in a non-confined space. For example, “room temperature” can be measured in a room, an office, a factory, a vehicle, a container, or outdoors. The vehicle may be a car, a truck, a bus, an airplane, a space shuttle, a space ship, a ship, a boat, or any other vehicle. Room temperature may represent the small range of temperatures at which the atmosphere feels neither hot nor cold, approximately 24° C. it may denote 20° C., 25° C., or any value from about 20° C. to about 25° C.

The energy beam may project energy to the material bed. The apparatuses, systems, and/or methods described herein can comprise at least one energy beam. In some cases, the apparatuses, systems, and/or methods described can comprise two, three, four, five, or more energy beams. The energy beam may include radiation comprising electromagnetic, electron, positron, proton, plasma, or ionic radiation. The electromagnetic beam may comprise microwave, infrared, ultraviolet or visible radiation. The ion beam may include a cation or an anion. The electromagnetic beam may comprise a laser beam. The energy beam may derive from a laser source. The energy source may be a laser source. The laser may comprise a fiber laser, a solid-state laser or a diode laser.

The laser source may comprise a Nd: YAG, Neodymium (e.g., neodymium-glass), or an Ytterbium laser. The laser may comprise a carbon dioxide laser (CO₂ laser). The laser may be a fiber laser. The laser may be a solid-state laser. The laser can be a diode laser. The energy source may comprise a diode array. The energy source may comprise a diode array laser. The laser may be a laser used for micro laser sintering. The energy beam (e.g., laser) may have a power of at least about 10 Watt (W), 30 W, 50 W, 80 W, 100 W, 120 W, 150 W, 200 W, 250 W, 300 W, 350 W, 400 W, 500 W, 750 W, 800 W, 900 W, 1000 W, 1500 W, 2000 W, 3000 W, or 4000 W. The energy beam may have a power of at most about 10 W, 30 W, 50 W, 80 W, 100 W, 120 W, 150 W, 200 W, 250 W, 300 W, 350 W, 400 W, 500 W, 750 W, 800 W, 900 W, 1000 W, 1500, 2000 W, 3000 W, or 4000 W. The energy beam may have a power between any of the afore-mentioned laser power values (e.g., from about 10 W to about 100 W, from about 100 W to about 1000 W, or from about 1000 W to about 4000 W). The energy beam may travel at a velocity of at least about 1 millimeter per second (mm/sec), 2 mm/sec, 3 mm/sec, 4 mm/sec, 5 mm/sec, 6 mm/sec, 7 mm/sec, 8 mm/sec, 9 mm/sec, 10 mm/sec, 12 mm/sec, 14 mm/sec, 15 mm/sec, 16 mm/sec, 18 mm/sec, 20 mm/sec, 25 mm/sec, 30 mm/sec, 40 mm/sec, 50 mm/sec, 100 mm/sec, 500 mm/sec, 600 mm/sec, 1000 mm/sec, 1400 mm/sec, 1500 mm/sec, or 2000 mm/sec. The energy beam may travel at a velocity of at most about 2 mm/sec, 3 mm/sec, 4 mm/sec, 5 mm/sec, 6 mm/sec, 7 mm/sec, 8 mm/sec, 9 mm/sec, 10 mm/sec, 12 mm/sec, 14 mm/sec, 15 mm/sec, 16 mm/sec, 18 mm/sec, 20 mm/sec, 25 mm/sec, 30 mm/sec, 40 mm/sec, 50 mm/sec, 100 mm/sec, 500 mm/sec, 1000 mm/sec, 1400 mm/sec, 1500 mm/sec, or 2000 mm/sec. The energy beam may travel at a velocity between any of the afore-mentioned velocities (e.g., from about 1 mm/sec to about 2000 mm/sec, from about 1 mm/sec to about 100 mm/sec, from about 2000 to about 20000, or from about 100 mm/sec to about 2000 mm/sec). The energy beam may derive from an electron gun. The energy beam may include a pulsed energy beam, a continuous wave energy beam, or a quasi-continuous wave energy beam. The pulse energy beam may have a repetition frequency of at least about 1 Kilo Hertz (KHz), 2 KHz, 3 KHz, 4 KHz, 5 KHz, 6 KHz, 7 KHz, 8 KHz, 9 KHz, 10 KHz, 20 KHz, 30 KHz, 40 KHz, 50 KHz, 60 KHz, 70 KHz, 80 KHz, 90 KHz, 100 KHz, 150 KHz, 200 KHz, 250 KHz, 300 KHz, 350 KHz, 400 KHz, 450 KHz, 500 KHz, 550 KHz, 600 KHz, 700 KHz, 800 KHz, 900 KHz, 1 Mega Hertz (MHz), 2 MHz, 3 MHz, 4 MHz, or 5 MHz. The pulse energy beam may have a repetition frequency of at most about 1 Kilo Hertz (KHz), 2 KHz, 3 KHz, 4 KHz, 5 KHz, 6 KHz, 7 KHz, 8 KHz, 9 KHz, 10 KHz, 20 KHz, 30 KHz, 40 KHz, 50 KHz, 60 KHz, 70 KHz, 80 KHz, 90 KHz, 100 KHz, 150 KHz, 200 KHz, 250 KHz, 300 KHz, 350 KHz, 400 KHz, 450 KHz, 500 KHz, 550 KHz, 600 KHz, 700 KHz, 800 KHz, 900 KHz, 1 Mega Hertz (MHz), 2 MHz, 3 MHz, 4 MHz, or 5 MHz. The pulse energy beam may have a repetition frequency between any of the afore-mentioned repetition frequencies (e.g., from about 1 KHz to about 5 MHz, from about 1 KHz to about 1 MHz, or from about 1 MHz to about 5 MHz).

The methods, apparatuses and/or systems disclosed herein may comprise Q-switching, mode coupling or mode locking to effectuate the pulsing energy beam. The apparatus or systems disclosed herein may comprise an on/off switch, a modulator, or a chopper to effectuate the pulsing energy beam. The on/off switch can be manually or automatically controlled. The switch may be controlled by the control system. The switch may alter the “pumping power” of the energy beam. The energy beam may be at times focused, non-focused, or defocused. In some instances, the defocus is substantially zero (e.g., the beam is non-focused).

The energy source(s) can project energy using a DLP modulator, a one-dimensional scanner, a two-dimensional scanner, or any combination thereof. The energy source(s) can be stationary or translatable. The energy source(s) can translate vertically, horizontally, or in an angle (e.g., planar or compound angle). The energy source(s) can be modulated. The energy beam(s) emitted by the energy source(s) can be modulated. The modulator can include an amplitude modulator, phase modulator, or polarization modulator. The modulation may alter the intensity of the energy beam. The modulation may alter the current supplied to the energy source (e.g., direct modulation). The modulation may affect the energy beam (e.g., external modulation such as external light modulator). The modulation may include direct modulation (e.g., by a modulator). The modulation may include an external modulator. The modulator can include an aucusto-optic modulator or an electro-optic modulator. The modulator can comprise an absorptive modulator or a refractive modulator. The modulation may alter the absorption coefficient the material that is used to modulate the energy beam. The modulator may alter the refractive index of the material that is used to modulate the energy beam.

The energy beam(s), energy source(s), and/or the platform of the energy beam array can be moved via a galvanometer scanner, a polygon, a mechanical stage (e.g., X-Y stage), a piezoelectric device, gimble, or any combination of thereof. The galvanometer may comprise a mirror. The galvanometer scanner may comprise a two-axis galvanometer scanner. The scanner may comprise a modulator (e.g., as described herein). The scanner may comprise a polygonal mirror. The scanner can be the same scanner for two or more energy sources and/or beams. At least two (e.g., each) energy source and/or beam may have a separate scanner. The energy sources can be translated independently of each other. In some cases, at least two energy sources and/or beams can be translated at different rates, and/or along different paths. For example, the movement of a first energy source may be faster as compared to the movement of a second energy source. The systems and/or apparatuses disclosed herein may comprise one or more shutters (e.g., safety shutters), on/off switches, or apertures.

The energy beam (e.g., laser) may have a FLS (e.g., a diameter) of its footprint on the on the exposed surface of the material bed of at least about 1 micrometer (μm), 5 μm, 10 μm, 20 μm, 30 μm, 40 μm, 50 μm, 60 μm, 70 μm, 80 μm, 90 μm, 100 μm, 200 μm, 300 μm, 400 μm, or 500 μm. The energy beam may have a FLS on the layer of it footprint on the exposed surface of the material bed of at most about 1 μm, 5 μm, 10 μm, 20 μm, 30 μm, 40 μm, 50 μm, 60 μm, 70 μm, 80 μm, 90 μm, 100 μm, 200 μm, 300 μm, 400 μm, or 500 μm. The energy beam may have a FLS on the exposed surface of the material bed between any of the afore-mentioned energy beam FLS values (e.g., from about 5 μm to about 500 μm, from about 5 μm to about 50 μm, or from about 50 μm to about 500 μm). The beam may be a focused beam. The beam may be a dispersed beam. The beam may be an aligned beam. The apparatus and/or systems described herein may further comprise a focusing coil, a deflection coil, or an energy beam power supply. The defocused energy beam may have a FLS of at least about 1 mm, 5 mm, 10 mm, 20 mm, 30 mm, 40 mm, 50 mm, or 100 mm. The defocused energy beam may have a FLS of at most about 1 mm, 5 mm, 10 mm, 20 mm, 30 mm, 40 mm, 50 mm, or 100 mm. The energy beam may have a defocused cross-sectional FLS on the layer of pre-transformed material between any of the afore-mentioned energy beam FLS values (e.g., from about 5 mm to about 100 mm, from about 5 mm to about 50 mm, or from about 50 mm to about 100 mm).

The power supply to any of the components described herein can be supplied by a grid, generator, local, or any combination thereof. The power supply can be from renewable or non-renewable sources. The renewable sources may comprise solar, wind, hydroelectric, or biofuel. The powder supply can comprise rechargeable batteries.

The exposure time of the energy beam may be at least 1 microsecond (μs), 5 μs, 10 μs, 20 μs, 30 μs, 40 μs, 50 μs, 60 μs, 70 μs, 80 μs, 90 μs, 100 μs, 200 μs, 300 μs, 400 μs, 500 μs, 800 μs, or 1000 μs. The exposure time of the energy beam may be most about 1 μs, 5 μs, 10 μs, 20 μs, 30 μs, 40 μs, 50 μs, 60 μs, 70 μs, 80 μs, 90 μs, 100 μs, 200 μs, 300 μs, 400 μs, 500 μs, 800 μs, or 1000 μs. The exposure time of the energy beam may be any value between the afore-mentioned exposure time values (e.g., from about 1 μs to about 1000 μs, from about 1 μs to about 200 μs, from about 1 μs to about 500 μs, from about 200 μs to about 500 μs, or from about 500 μs to about 1000 μs).

The methods, systems and/or the apparatus described herein can further comprise at least one energy source. In some cases, the system can comprise two, three, four, five, or more energy sources. An energy source can be a source configured to deliver energy to an area (e.g., a confined area). An energy source can deliver energy to the confined area through radiative heat transfer.

In another aspect, a system for generating a 3D object comprises: an enclosure for accommodating a layer of pre-transformed material; a first energy beam capable of heating the material to form a heated material, wherein the first energy beam does not transform the pre-transformed material; a second energy beam capable of transforming the pre-transformed material to form a transformed material, wherein the transformed material is capable of hardening to form at least a portion of a generated first 3D object; and a controller that directs the first energy beam to a portion of the layer of pre-transformed material according to a first path, and that directs the second energy beam to a portion of the layer of pre-transformed material according to a second path, wherein the first path and the second path span substantially the same area within the layer of pre-transformed material. The first 3D object can comprise a lesser degree of deformation as compared to a second 3D object that is generated by a method of 3D printing (e.g., additive manufacturing) that omits the first (e.g., heating) energy beam. In some examples, the portion of the layer can be smaller than the layer of the pre-transformed material. The systems described herein may further comprise a first energy source that supplies the first energy, and a second energy source that supplies the second energy. The systems described herein may further comprise an energy source that supplies both the first energy and the second energy.

In another aspect provided herein are systems for generating a 3D object comprising an enclosure that accommodates a layer of pre-transformed material; a first energy (e.g., energy beam), a second energy (e.g., energy beam), and a controller that can direct the first energy to a portion of the layer of pre-transformed material according to a first path, and that can direct the second energy to a portion of the layer of pre-transformed material according to a second path.

In some embodiments, the first and the second energy are able to transform the material within the layer of material (e.g., powder). The transformed material may harden to form a hardened material upon energy depletion. The hardened material may form at least a portion of the generated 3D object.

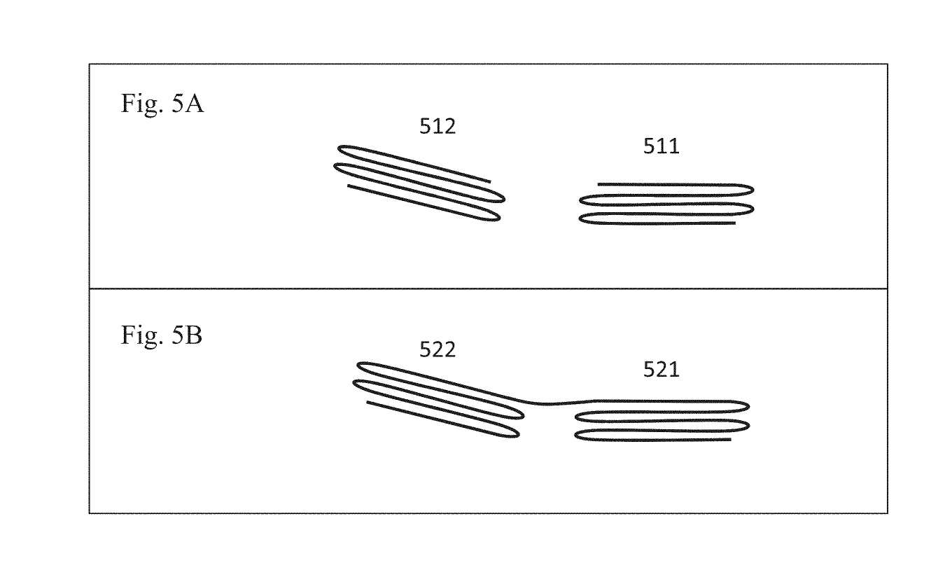

In some instances, the path, which by the energy travels, comprises a hatch line, heated portion path, or path of tiles. In some instances, the path, which by the energy travels, comprises a set of paths, a set of hatch lines, a set of heated portion paths, or a set of path of tiles. In some instances, the path tiles within the path tile set are connected to each other. In some instances, the path tiles within the path tile set are disconnected from each other. In some instances, at least two tiles are connected in their path. In some instances, at least two tiles are disconnected in their path. FIGS. 5A-B show examples of a horizontal cross section, top view, or bottom view of various path segments (e.g., tiles) within a set of path segments: FIG. 5A shows an example of disconnected path segments: FIG. 5A shows an example of a path tile set in which the tiles 511 and 512 within the path tile set are disconnected from each other. FIG. 5B shows an example connected path segments: FIG. 5B shows an example of a path tile set in which the path tiles 521 and 522 within the set are connected to each other. The path within the tiles may be any of the paths mentioned herein. In some instances, a controller can direct the first energy to a portion of the layer of pre-transformed material according to a first path tile within a path tile set that corresponds to the layer of pre-transformed material. The controller may direct the second energy to a portion of the layer of pre-transformed material according to a second path tile within the path tile set that corresponds to the same layer of pre-transformed material. The first tile set may be separated from the second tile set (e.g., by a first distance). The first tile set may at least in part overlap the second portion set. The first tile set may substantially overlap the second tile set. The first tile may be separated from the second tile (e.g., by a second distance). The first and second distance may be a first gap and a second gap respectively. The first tile may at least in part overlap the second tile. The first tile set may substantially overlap the second tile. The generated 3D object using separation of the energy path into path tiles as mentioned herein, can comprise a lesser degree of deformation as compared to a 3D object generated by 3D printing (e.g., additive manufacturing) method that uses an energy beam path that is not separated into tiles.

In some methods disclosed herein, at least a portion of the pre-transformed material within the enclosure is transformed to form a first set of spaced apart successive segments (e.g., tiles) in a first layer of pre-transformed material. The successive segments may comprise lines (e.g., wires). The methods disclosed herein may further comprise depositing a second layer of pre-transformed material within the enclosure, and transforming at least a portion of the second layer of pre-transformed material to generate a second transformed material. The method may further comprise hardening the transformed material to generate at least a portion of a 3D object. The second transformed material may comprise a second set of spaced apart successive segments. The second layer of pre-transformed material may be adjacent to (e.g., directly adjacent to) the first layer of pre-transformed material. In some examples, the second transformed (or hardened) material connect at least a portion of the first set spaced apart successive segments (e.g., tiles) to form at least a portion of the 3D object. In some examples, the second set of spaced apart successive segments of transformed material connects at least a portion of the first set spaced apart successive segments to form at least a portion of the 3D object. Examples of connecting at least a portion of the first set of successive segments that have been transformed can be seen in FIGS. 7A-B. The average acute angle between the direction normal to the field of gravity and the first average plane (e.g., during its formation) or the second average plane (e.g., during its formation) may be alpha (e.g., as disclosed herein). At times, the angle alpha of the first average plane (e.g., during its formation) or the second average plane (e.g., during its formation) is measured relative to: (i) the plane parallel to the average top leveled surface of the layer of material (e.g., powder material), (ii) average plane of the top surface of the building platform facing the deposited material, and/or (iii) a plane normal the direction of the gravitational field.

The energy source can supply any of the energies described herein (e.g., energy beams). The energy source may deliver energy to a point or to an area. The energy source may include an electron gun source. The energy source may include a laser source. The energy source may comprise an array of lasers. In an example, a laser can provide light energy at a peak wavelength of at least about 100 nanometer (nm), 500 nm, 1000 nm, 1010 nm, 1020 nm, 1030 nm, 1040 nm, 1050 nm, 1060 nm, 1070 nm, 1080 nm, 1090 nm, 1100 nm, 1200 nm, 1500 nm, 1600 nm, 1700 nm, 1800 nm, 1900 nm, or 2000 nm. In an example a laser can provide light energy at a peak wavelength of at most about 100 nanometer (nm), 500 nm, 1000 nm, 1010 nm, 1020 nm, 1030 nm, 1040 nm, 1050 nm, 1060 nm, 1070 nm, 1080 nm, 1090 nm, 1100 nm, 1200 nm, 1500 nm, 1600 nm, 1700 nm, 1800 nm, 1900 nm, or 2000 nm. In an example a laser can provide light energy at a peak wavelength between the afore-mentioned peak wavelengths (e.g., from 100 nm to 2000 nm, from 100 nm to 1100 nm, or from 1000 nm to 2000 nm). The energy beam can be incident on the top surface of the material bed. The energy beam can be incident on, or be directed to, a specified area of the material bed over a specified time period. The energy beam can be substantially perpendicular to the top (e.g., exposed) surface of the material bed. The material bed can absorb the energy from the energy beam (e.g., incident energy beam) and, as a result, a localized region of the material in the material bed can increase in temperature. The increase in temperature may transform the material within the material bed. The increase in temperature may heat and transform the material within the material bed. In some embodiments, the increase in temperature may heat and not transform the material within the material bed. The increase in temperature may heat the material within the material bed.

The energy beam and/or source can be moveable such that it can translate relative to the material bed. The energy beam and/or source can be moved by a scanner. The movement of the energy beam and/or source can comprise utilization of a scanner.

At one point in time, and/or (e.g., substantially) during the entire build of the 3D object: At least two of the energy beams and/or sources can be translated independently of each other or in concert with each other. At least two of the multiplicity of energy beams can be translated independently of each other or in concert with each other. In some cases, at least two of the energy beams can be translated at different rates such that the movement of the one is faster compared to the movement of at least one other energy beam. In some cases, at least two of the energy sources can be translated at different rates such that the movement of the one energy source is faster compared to the movement of at least another energy source. In some cases, at least two of the energy sources (e.g., all of the energy sources) can be translated at different paths. In some cases, at least two of the energy sources can be translated at substantially identical paths. In some cases, at least two of the energy sources can follow one another in time and/or space. In some cases, at least two of the energy sources translate substantially parallel to each other in time and/or space. The power per unit area of at least two of the energy beam may be (e.g., substantially) identical. The power per unit area of at least one of the energy beams may be varied (e.g., during the formation of the 3D object). The power per unit area of at least one of the energy beams may be different. The power per unit area of at least one of the energy beams may be different. The power per unit area of one energy beam may be greater than the power per unit area of a second energy beam. The energy beams may have the same or different wavelengths. A first energy beam may have a wavelength that is smaller or larger than the wavelength of a second energy beam. The energy beams can derive from the same energy source. At least one of the energy beams can derive from different energy sources. The energy beams can derive from different energy sources. At least two of the energy beams may have the same power (e.g., at one point in time, and/or (e.g., substantially) during the entire build of the 3D object). At least one of the beams may have a different power (e.g., at one point in time, and/or substantially during the entire build of the 3D object). The beams may have different powers (e.g., at one point in time, and/or (e.g., substantially) during the entire build of the 3D object). At least two of the energy beams may travel at (e.g., substantially) the same velocity. At least one of the energy beams may travel at different velocities. The velocity of travel (e.g. speed) of at least two energy beams may be (e.g., substantially) constant. The velocity of travel of at least two energy beams may be varied (e.g., during the formation of the 3D object or a portion thereof). The travel may refer to a travel relative to (e.g., on) the exposed surface of the material bed (e.g., powder material). The travel may refer to a travel close to the exposed surface of the material bed. The travel may be within the material bed. The at least one energy beam and/or source may travel relative to the material bed.

The energy (e.g., energy beam) may travel in a path. The path may comprise a hatch. The path of the energy beam may comprise repeating a path. For example, the first energy may repeat its own path. The second energy may repeat its own path, or the path of the first energy. The repetition may comprise a repetition of 1, 2, 3, 4, 5, 6, 7, 8, 9, 10 times or more. The energy may follow a path comprising parallel lines. For example, FIGS. 3A, 3C, and 3D show paths that comprise parallel lines. The lines may be hatch lines. The distance between each of the parallel lines or hatch lines, may be at least about 1 μm, 5 μm, 10 μm, 20 μm, 30 μm, 40 μm, 50 μm, 60 μm, 70 μm, 80 μm, 90 μm, or more. The distance between each of the parallel lines or hatch lines, may be at most about 1 μm, 5 μm, 10 μm, 20 μm, 30 μm, 40 μm, 50 μm, 60 μm, 70 μm, 80 μm, 90 μm, or less. The distance between each of the parallel lines or hatch lines may be any value between any of the afore-mentioned distance values (e.g., from about 1 μm to about 90 μm, from about 1 μm to about 50 μm, or from about 40 μm to about 90 μm). The distance between the parallel or parallel lines or hatch lines may be substantially the same in every layer (e.g., plane) of transformed material. The distance between the parallel lines or hatch lines in one layer (e.g., plane) of transformed material may be different than the distance between the parallel lines or hatch lines respectively in another layer (e.g., plane) of transformed material within the 3D object. The distance between the parallel lines or hatch lines portions within a layer (e.g., plane) of transformed material may be substantially constant. The distance between the parallel lines or hatch lines within a layer (e.g., plane) of transformed material may be varied. The distance between a first pair of parallel lines or hatch lines within a layer (e.g., plane) of transformed material may be different than the distance between a second pair of parallel lines or hatch lines within a layer (e.g., plane) of transformed material respectively. The first energy beam may follow a path comprising two hatch lines or paths that cross in at least one point. The hatch lines or paths may be straight or curved. The hatch lines or paths may be winding. FIG. 3B shows an example of a winding path. The first energy beam may follow a hatch line or path comprising a U shaped turn (e.g., FIG. 3A). The first energy beam may follow a hatch line or path devoid of U shaped turns (e.g., FIG. 3D).

The energy projected on/into the material may heat or transform the material. The excess of energy may subsequently deplete (e.g., to equalize the energy (e.g., heat) in the material bed). The manner of depletion of energy may potentially be guided, altered, or controlled. For example, the controller may control the energy along its traveling path to compensate for a difference in the energy depletion rate at various positions of the material (e.g., pre-transformed material, transformed material, hardened material, or at least a portion of the generated 3D object). The energy depletion may be from the transformed material within the material bed (e.g., layer of pre-transformed material), or from the hardened material within the material bed.

The controller may control the energy along the first path to allow a reduced amount of energy to concentrate at an edge of the 3D object. Control may comprise regulate, manipulate, restrict, direct, monitor, adjust, or manage. For example, the controller can control any of the energy characteristics or energy beam characteristics disclosed herein. For example, the controller can control the FLS of the energy beam cross-section on/within the layer of pre-transformed material in the material bed (e.g., powder). For example, the controller can control the flux of energy, energy density, power per unit area of the energy beam, wavelength, amplitude, power, travel rate, travel time, traveling path, or any combination thereof. The controller may direct the energy (e.g., energy beam) to at least a portion of the layer of pre-transformed material according to a path that deviates at least in part from a cross section of a desired 3D object. The deviation may be any path deviation mentioned herein. In some instances, the generated 3D object substantially corresponds to the desired 3D object. The desired 3D object can comprise a model of a 3D object (e.g., as mentioned herein). The model can comprise vector-based graphics. The model can comprise computer-aided design, electronic design automation, mechanical design automation, or computer aided drafting.

The controller may direct the energy beam to at least a portion of the layer of pre-transformed material in the material bed according to a path comprising successive segments of lines, wherein at least one first pair of the successive segments of lines vary in at least one factor from at least one second pair of the successive segments of lines. The successive segments can be parallel. The factor can be any factor mentioned herein pertaining the successive segments of lines. The factor can be a distance between the pair of successive segments. The factor may be an angle formed by a pair of successive segments as mentioned herein. The generated 3D object can comprise a lesser degree of deformation as compared to a 3D object that is generated by an additive manufacturing method that uses a path wherein the successive segments of lines do not vary in the at least one factor.

Energy (e.g., heat) can be transferred from the material bed to the cooling member (e.g., heat sink) through any one or combination of heat transfer mechanisms. The heat transfer mechanism may comprise conduction, radiation, or convection. The convection may comprise natural or forced convection. The cooling member can be solid, liquid, gas, or semi-solid. In some examples, the cooling member (e.g., heat sink) is solid. The cooling member may be located above, below, or to the side of the powder layer. The cooling member may comprise an energy conductive material. The cooling member may comprise an active energy transfer or a passive energy transfer. The cooling member may comprise a cooling liquid (e.g., aqueous or oil), cooling gas, or cooling solid. The cooling member may be further connected to a cooler and/or a thermostat. The gas, semi-solid, or liquid comprised in the cooling member may be stationary or circulating. The cooling member may comprise a material that conducts heat efficiently. The heat (thermal) conductivity of the cooling member may be at least about 20 Watts per meters times degrees Kelvin (W/mK), 50 W/mK, 100 W/mK, 150 W/mK, 200 W/mK, 205 W/mK, 300 W/mK, 350 W/mK, 400 W/mK, 450 W/mK, 500 W/mK, 550 W/mK, 600 W/mK, 700 W/mK, 800 W/mK, 900 W/mK, or 1000 W/mK. The heat conductivity of the heat sink may be at most about 20 W/mK, 50 W/mK, 100 W/mK, 150 W/mK, 200 W/mK, 205 W/mK, 300 W/mK, 350 W/mK, 400 W/mK, 450 W/mK, 500 W/mK, 550 W/mK, 600 W/mK, 700 W/mK, 800 W/mK, 900 W/mK, or 1000 W/mK. The heat conductivity of the heat sink may any value between the afore-mentioned heat conductivity values. The heat (thermal) conductivity of the cooling member may be measured at ambient temperature (e.g., room temperature) and/or pressure. For example, the heat conductivity may be measured at about 20° C. and a pressure of 1 atmosphere. The heat sink can be separated from the powder bed or powder layer by a gap. The gap can be filled with a gas. The cooling member may be any cooling member (e.g., that is used in 3D printing) such as, for example, the ones described in patent application serial number PCT/US15/36802, or in Provisional Patent Application Ser. No. 62/317,070, each of which is entirely incorporated herein by reference.

The second energy beam may substantially follow a path in which the first energy beam previously propagated. The second energy beam may follow a different path from the one in which the first energy beam previously propagated. The paths of the first and/or second energy beams may cross or not cross. The paths of the first and second energy beams may be (e.g., substantially) parallel to each other. The second energy beam may succeed the first energy beam in time and/or in position. The second energy beam may precede the first energy beam in time and/or in position. The second energy beam may operate (e.g., substantially) simultaneously with first energy beam. The multiple energy sources may follow each other paths, or follow different paths. When multiple energy beams are in operation, at least two energy sources may follow the same path, at least two energy sources may follow different paths, at least two energy sources may follow paths that cross at least at one point, at least two energy sources may follow paths that overlap at least at one point, or any combination thereof.

The first energy source may deliver a power per unit area to the material (e.g., powder material). The second energy source may deliver a power per unit area that is different by at least about 1.1, 1.2, 1.4, 1.5, 1.6, 1.8, 2, 3, 4, 5, 6, 7, 8, 9, 10, 15, 20, 25, 30, 35 or 40 times as compared to the power per unit are of the first energy source. The second energy source may deliver a power per unit area that is different by at most about 1.1, 1.2, 1.4, 1.5, 1.6, 1.8, 2, 3, 4, 5, 6, 7, 8, 9, 10, 15, 20, 25, 30, 35 or 40 times as compared to the power per unit are of the first energy source. The second energy source may deliver a power per unit area that is different by any value between the afore-mentioned multiplier values (e.g., from about 1.1 to about 40 times, from about 1.1. to about 20 times, or from about 20 times to about 40 times). Different may be smaller. Different may be larger. The second energy source may deliver a power per unit area that is substantially equal to the power per unit are of the first energy source.

The first energy beam may translate at a first velocity during its operation. The second energy beam may translate at a second velocity during its operation. The second energy source may translate at a velocity that is varied by at least about 1.5 times (*), 2*, 3*, 4*, 5*, 6*, 7*, 8*, 9*, 10*, 15*, 20*, 25*, 30*, 35*, 40*, 50*, 60*, 70*, 80*, 90*, 100* or 150* compared to the translation velocity of the first energy source. The second energy source may translate at a velocity that is varied by at most about 1.5*, 2*, 3*, 4*, 5*, 6*, 7*, 8*, 9*, 10*, 15*, 20*, 25*, 30*, 35*, 40*, 50*, 60*, 70*, 80*, 90*, 100* or 150* compared to translation velocity of the first energy source. The second energy source may translate at a velocity that is varied by any value between the afore-mentioned velocity multiplier values (e.g., from 1.5* to 150*, from 1.5* to 50*, from 10* to 150*, from 100* to 150*, or from 50* to 150*). The second energy source may deliver a power per unit area that is substantially equal to the power per unit are of the first energy source.

When the energy source is in operation, the material bed can have a certain temperature. The average temperature of the material bed can be “room temperature.” The average temperature of the material bed can have an average temperature during the operation of the energy (e.g., beam). The average temperature of the material bed can be an average temperature during the formation of the transformed material, the formation of the hardened material, or the generation of the 3D object. The average temperature can be below or just below the transforming temperature of the material. Just below can refer to a temperature that is at most about 1° C., 2° C., 3° C., 4° C., 5° C., 6° C., 7° C., 8° C., 9° C., 10° C., 15° C., or 20° C. below the transforming temperature. The average temperature of the material bed (e.g., pre-transformed material) can be at most about 10° C. (degrees Celsius), 20° C., 25° C., 30° C., 40° C., 50° C., 60° C., 70° C., 80° C., 90° C., 100° C., 120° C., 140° C., 150° C., 160° C., 180° C., 200° C., 250° C. ° C., 300° C., 400° C. ° C., 500° C., 600° C., 700° C. ° C., 800° C. ° C., 900° C. ° C., 1000° C., 1200° C., 1400° C., 1600° C., 1800° C., or 2000° C. The average temperature of the material bed (e.g., pre-transformed material) can be at least about 10° C., 20° C., 25° C., 30° C., 40° C., 50° C., 60° C., 70° C., 80° C., 90° C., 100° C., 120° C., 140° C., 150° C., 160° C., 180° C., 200° C., 250° C., 300° C., 400° C., 500° C., 600° C., 700° C., 800° C., 900° C., 1000° C., 1200° C., 1400° C., 1600° C., 1800° C., or 2000° C. The average temperature of the material bed (e.g., pre-transformed material) can be any temperature between the afore-mentioned material average temperatures. The average temperature of the material bed (e.g., pre-transformed material) may refer to the average temperature during the 3D printing. The pre-transformed material can be the material within the material bed that has not been transformed and generated at least a portion of the 3D object (e.g., the remainder). The material bed can be heated or cooled before, during, or after forming the 3D object (e.g., hardened material). Bulk heaters can heat the material bed. The bulk heaters can be situated adjacent to (e.g., above, below, or to the side of) the material bed, or within a material dispensing system. For example, the material can be heated using radiators (e.g., quartz radiators, or infrared emitters). The material bed temperature can be substantially maintained at a predetermined value. The temperature of the material bed can be monitored. The material temperature can be controlled manually and/or by a control system.

The pre-transformed material within the material bed can be heated by a first energy source such that the heating will transform the pre-transformed material. The remainder of the material that did not transform to generate at least a portion of the 3D object (e.g., the remainder) can be heated by a second energy source. The remainder can be at an average temperature that is less than the liquefying temperature of the material (e.g., during the 3D printing). The maximum temperature of the transformed portion of the material bed and the average temperature of the remainder of the material bed can be different. The solidus temperature of the material can be a temperature wherein the material is in a solid state at a given pressure (e.g., ambient pressure). Ambient may refer to the surrounding. After the portion of the material bed is heated to the temperature that is at least a liquefying temperature of the material by the first energy source, that portion of the material may be cooled to allow the transformed (e.g., liquefied) material portion to harden (e.g., solidify). In some cases, the liquefying temperature can be at least about 100° C., 200° C., 300° C., 400° C., or 500° C., and the solidus temperature can be at most about 500° C., 400° C., 300° C., 200° C., or 100° C. For example, the liquefying temperature is at least about 300° C. and the solidus temperature is less than about 300° C. In another example, the liquefying temperature is at least about 400° C. and the solidus temperature is less than about 400° C. The liquefying temperature may be different from the solidus temperature. In some instances, the temperature of the pre-transformed material is maintained above the solidus temperature of the material and below its liquefying temperature. In some examples, the material from which the pre-transformed material is composed has a super cooling temperature (or super cooling temperature regime). In some examples, as the first energy source heats up the pre-transformed material to cause at least a portion of it to melt, the molten material will remain molten as the material bed is held at or above the material super cooling temperature of the material, but below its melting point. When two or more materials make up the material layer at a specific ratio, the materials may form a eutectic material on transformation of the material. The liquefying temperature of the formed eutectic material may be the temperature at the eutectic point, close to the eutectic point, or far from the eutectic point. Close to the eutectic point may designate a temperature that is different from the eutectic temperature (i.e., temperature at the eutectic point) by at most about 0.1° C., 0.5° C., 1° C., 2° C., 4° C., 5° C., 6° C., 8° C., 10° C., or 15° C. A temperature that is farther from the eutectic point than the temperature close to the eutectic point is designated herein as a temperature far from the eutectic Point. The process of liquefying and solidifying a portion of the material can be repeated until the entire object has been formed. At the completion of the generated 3D object, it can be removed from the remainder of material in the container. The remaining material can be separated from the portion at the generated 3D object. The generated 3D object can be hardened and removed from the container (e.g., from the substrate or from the base).

The apparatus and/or systems described herein may comprise an optical system. The optical components may be controlled manually and/or via a control system (e.g., a controller). The optical system may be configured to direct at least one energy beam from the at least one energy source to a position on the material bed within the enclosure (e.g., a predetermined position). A scanner can be included in the optical system. The printing system may comprise a processor (e.g., a central processing unit). The processor can be programmed to control a trajectory of the at least one energy beam and/or energy source with the aid of the optical system. The systems and/or the apparatus described herein can further comprise a control system in communication with the at least one energy source and/or energy beam. The control system can regulate a supply of energy from the at least one energy source to the material in the container. The control system may control the various components of the optical system. The various components of the optical system may include optical components comprising a mirror, a lens (e.g., concave or convex), a fiber, a beam guide, a rotating polygon, or a prism. The lens may be a focusing or a dispersing lens. The lens may be a diverging or converging lens. The mirror can be a deflection mirror. The optical components may be tiltable and/or rotatable. The optical components may be tilted and/or rotated. The mirror may be a deflection mirror. The optical components may comprise an aperture. The aperture may be mechanical. The optical system may comprise a variable focusing device. The variable focusing device may be connected to the control system. The variable focusing device may be controlled by the control system and/or manually. The variable focusing device may comprise a modulator. The modulator may comprise an acousto-optical modulator, mechanical modulator, or an electro optical modulator. The focusing device may comprise an aperture (e.g., a diaphragm aperture).

The methods described herein may further comprise stabilizing the temperature within the enclosure. For example, stabilizing the temperature of the atmosphere or the pre-transformed material (e.g., within the material bed). Stabilization of the temperature may be to a predetermined temperature value. The methods described herein may further comprise altering the temperature within at least one portion of the container. Alteration of the temperature may be to a predetermined temperature. Alteration of the temperature may comprise heating and/or cooling the material bed. Elevating the temperature (e.g., of the material bed) may be to a temperature below the temperature at which the pre-transformed material fuses (e.g., melts or sinters), connects, or bonds.

The container described herein may comprise at least one sensor. The sensor may be connected and/or controlled by the control system (e.g., computer control system, or controller). The control system may be able to receive signals from the at least one sensor. The control system may act upon at least one signal received from the at least one sensor. The control may rely on feedback and/or feed forward mechanisms that has been pre-programmed. The feedback and/or feed forward mechanisms may rely on input from at least one sensor that is connected to the control unit.

The sensor can detect the amount material (e.g., pre-transformed material) in the enclosure. The controller may monitor the amount of material in the enclosure (e.g., within the material bed). The systems and/or the apparatus described herein can include a pressure sensor. The pressure sensor may measure the pressure of the chamber (e.g., pressure of the chamber atmosphere). The pressure sensor can be coupled to a control system. The pressure can be electronically and/or manually controlled. The controller may regulate the pressure (e.g., with the aid of one or more vacuum pumps) according to input from at least one pressure sensor. The sensor may comprise light sensor, image sensor, acoustic sensor, vibration sensor, chemical sensor, electrical sensor, magnetic sensor, fluidity sensor, movement sensor, speed sensor, position sensor, pressure sensor, force sensor, density sensor, metrology sensor, sonic sensor (e.g., ultrasonic sensor), or proximity sensor. The metrology sensor may comprise measurement sensor (e.g., height, length, width, angle, and/or volume). The metrology sensor may comprise a magnetic, acceleration, orientation, or optical sensor. The optical sensor may comprise a camera (e.g., IR camera, or CCD camera (e.g., single line CCD camera)). or CCD camera (e.g., single line CCD camera). The sensor may transmit and/or receive sound (e.g., echo), magnetic, electronic, or electromagnetic signal. The electromagnetic signal may comprise a visible, infrared, ultraviolet, ultrasound, radio wave, or microwave signal. The metrology sensor may measure the tile. The metrology sensor may measure the gap. The metrology sensor may measure at least a portion of the layer of material (e.g., pre-transformed, transformed, and/or hardened). The layer of material may be a pre-transformed material (e.g., powder), transformed material, or hardened material. The metrology sensor may measure at least a portion of the 3D object. The sensor may comprise a temperature sensor, weight sensor, powder level sensor, gas sensor, or humidity sensor. The gas sensor may sense any gas enumerated herein. The temperature sensor may comprise Bolometer, Bimetallic strip, calorimeter, Exhaust gas temperature gauge, Flame detection, Gardon gauge, Golay cell, Heat flux sensor, Infrared thermometer, Microbolometer, Microwave radiometer, Net radiometer, Quartz thermometer, Resistance temperature detector, Resistance thermometer, Silicon band gap temperature sensor, Special sensor microwave/imager, Temperature gauge, Thermistor, Thermocouple, Thermometer, Pyrometer, IR camera, or CCD camera (e.g., single line CCD camera). The temperature sensor may measure the temperature without contacting the material bed (e.g., non-contact measurements). The pyrometer may comprise a point pyrometer, or a multi-point pyrometer. The Infrared (IR) thermometer may comprise an IR camera. The pressure sensor may comprise Barograph, Barometer, Boost gauge, Bourdon gauge, hot filament ionization gauge, Ionization gauge, McLeod gauge, Oscillating U-tube, Permanent Downhole Gauge, Piezometer, Pirani gauge, Pressure sensor, Pressure gauge, tactile sensor, or Time pressure gauge. The position sensor may comprise Auxanometer, Capacitive displacement sensor, Capacitive sensing, Free fall sensor, Gravimeter, Gyroscopic sensor, Impact sensor, Inclinometer, Integrated circuit piezoelectric sensor, Laser rangefinder, Laser surface velocimeter, LIDAR, Linear encoder, Linear variable differential transformer (LVDT), Liquid capacitive inclinometers, Odometer, Photoelectric sensor, Piezoelectric accelerometer, Rate sensor, Rotary encoder, Rotary variable differential transformer, Selsyn, Shock detector, Shock data logger, Tilt sensor, Tachometer, Ultrasonic thickness gauge, Variable reluctance sensor, or Velocity receiver. The optical sensor may comprise a Charge-coupled device, Colorimeter, Contact image sensor, Electro-optical sensor, Infra-red sensor, Kinetic inductance detector, light emitting diode as light sensor, Light-addressable potentiometric sensor, Nichols radiometer, Fiber optic sensors, optical position sensor, photo detector, photodiode, photomultiplier tubes, phototransistor, photoelectric sensor, photoionization detector, photomultiplier, photo resistor, photo switch, phototube, scintillometer, Shack-Hartmann, single-photon avalanche diode, superconducting nanowire single-photon detector, transition edge sensor, visible light photon counter, or wave front sensor. The weight of the enclosure (e.g., container), or any components within the enclosure can be monitored by at least one weight sensor in or adjacent to the material. For example, a weight sensor can be situated at the bottom of the enclosure. The weight sensor can be situated between the bottom of the enclosure and the substrate. The weight sensor can be situated between the substrate and the base. The weight sensor can be situated between the bottom of the container and the base. The weight sensor can be situated between the bottom of the container and the top of the material bed. The weight sensor can comprise a pressure sensor. The weight sensor may comprise a spring scale, a hydraulic scale, a pneumatic scale, or a balance. At least a portion of the pressure sensor can be exposed on a bottom of the container. In some cases, the at least one weight sensor can comprise a button load cell. Alternatively, or additionally a sensor can be configured to monitor the weight of the material by monitoring a weight of a structure that contains the material (e.g., a material bed). One or more position sensors (e.g., height sensors) can measure the height of the material bed relative to the substrate. The position sensors can be optical sensors. The position sensors can determine a distance between one or more energy sources and a surface of the material bed. The surface of the material bed can be the upper surface of the material bed. For example, FIG. 1, 108 shows an example of an upper surface of the material bed 104.

The methods, systems and/or the apparatus described herein may comprise at least one valve. The valve may be shut or opened according to an input from the at least one sensor, or manually. The degree of valve opening or shutting may be regulated by the control system, for example, according to at least one input from at least one sensor. The systems and/or the apparatus described herein can include one or more valves, such as throttle valves.

The methods, systems and/or the apparatus described herein may comprise a motor. The motor may be controlled by the control system and/or manually. The apparatuses and/or systems described herein may include a system providing the material (e.g., powder material) to the material bed. The system for providing the material may be controlled by the control system, or manually. The motor may connect to a system providing the material (e.g., powder material) to the material bed. The system and/or apparatus of the present invention may comprise a material reservoir. The material may travel from the reservoir to the system and/or apparatus of the present invention may comprise a material reservoir. The material may travel from the reservoir to the system for providing the material to the material bed. The motor may alter (e.g., the position of) the substrate and/or to the base. The motor may alter (e.g., the position of) the elevator. The motor may alter an opening of the enclosure (e.g., its opening or closure). The motor may be a step motor or a servomotor. The methods, systems and/or the apparatus described herein may comprise a piston. The piston may be a trunk, crosshead, slipper, or deflector piston.

The systems and/or the apparatus described herein may comprise at least one nozzle. The nozzle may be regulated according to at least one input from at least one sensor. The nozzle may be controlled automatically or manually. The controller may control the nozzle. The nozzle may include jet (e.g., gas jet) nozzle, high velocity nozzle, propelling nozzle, magnetic nozzle, spray nozzle, vacuum nozzle, or shaping nozzle (e.g., a die). The nozzle can be a convergent or a divergent nozzle. The spray nozzle may comprise an atomizer nozzle, an air-aspirating nozzle, or a swirl nozzle.

The systems and/or the apparatus described herein may comprise at least one pump. The pump may be regulated according to at least one input from at least one sensor. The pump may be controlled automatically or manually. The controller may control the pump. The one or more pumps may comprise a positive displacement pump. The positive displacement pump may comprise rotary-type positive displacement pump, reciprocating-type positive displacement pump, or linear-type positive displacement pump. The positive displacement pump may comprise rotary lobe pump, progressive cavity pump, rotary gear pump, piston pump, diaphragm pump, screw pump, gear pump, hydraulic pump, rotary vane pump, regenerative (peripheral) pump, peristaltic pump, rope pump or flexible impeller. Rotary positive displacement pump may comprise gear pump, screw pump, or rotary vane pump. The reciprocating pump comprises plunger pump, diaphragm pump, piston pumps displacement pumps, or radial piston pump. The pump may comprise a valve-less pump, steam pump, gravity pump, eductor-jet pump, mixed-flow pump, bellow pump, axial-flow pumps, radial-flow pump, velocity pump, hydraulic ram pump, impulse pump, rope pump, compressed-air-powered double-diaphragm pump, triplex-style plunger pump, plunger pump, peristaltic pump, roots-type pumps, progressing cavity pump, screw pump, or gear pump. In some examples, the systems and/or the apparatus described herein include one or more vacuum pumps selected from mechanical pumps, rotary vain pumps, turbomolecular pumps, ion pumps, cryopumps, and diffusion pumps. The one or more vacuum pumps may comprise Rotary vane pump, diaphragm pump, liquid ring pump, piston pump, scroll pump, screw pump, Wankel pump, external vane pump, roots blower, multistage Roots pump, Toepler pump, or Lobe pump. The one or more vacuum pumps may comprise momentum transfer pump, regenerative pump, entrapment pump, Venturi vacuum pump, or team ejector.

The systems, apparatuses, and/or parts thereof may comprise Bluetooth technology. systems, apparatuses, and/or parts thereof may comprise a communication port. The communication port may be a serial port or a parallel port. The communication port may be a Universal Serial Bus port (i.e., USB). The systems, apparatuses, and/or parts thereof may comprise USB ports. The USB can be micro or mini USB. The USB port may relate to device classes comprising 00h, 01h, 02h, 03h, 05h, 06h, 07h, 08h, 09h, 0Ah, 0Bh, 0Dh, 0Eh, 0Fh, 10h, 11h, DCh, E0h, EFh, FEh, or FFh. The surface identification mechanism may comprise a plug and/or a socket (e.g., electrical, AC power, DC power). The systems, apparatuses, and/or parts thereof may comprise an adapter (e.g., AC and/or DC power adapter). The systems, apparatuses, and/or parts thereof may comprise a power connector. The power connector can be an electrical power connector. The power connector may comprise a magnetically attached power connector. The power connector can be a dock connector. The connector can be a data and power connector. The connector may comprise pins. The connector may comprise at least 10, 15, 18, 20, 22, 24, 26, 28, 30, 40, 42, 45, 50, 55, 80, or 100 pins.

The controller may monitor and/or direct (e.g., physical) alteration of the operating conditions of the apparatuses, software, and/or methods described herein. The controller may be a manual or a non-manual controller. The controller may be an automatic controller. The controller may operate upon request. The controller may be a programmable controller. The controller may be programmed. The controller may comprise a central processing unit (CPU). The controller may receive an input (e.g., from a sensor). The controller may deliver an output. The controller may comprise multiple controllers. The controller may receive multiple inputs. The controller may generate multiple outputs. The controller may be a single input single output controller (SISO) or a multiple input multiple output controller (MIMO). The controller may interpret the input signal received. The controller may acquire data from the one or more sensors. Acquire may comprise receive or extract. The data may comprise measurement, estimation, determination, generation, or any combination thereof. The controller may comprise feedback control. The controller may comprise feed-forward control. The control may comprise on-off control, proportional control, proportional-integral (PI) control, or proportional-integral-derivative (PID) control. The control may comprise open loop control, or closed loop control. The controller may comprise closed loop control. The controller may comprise open loop control. The controller may comprise a user interface. The user interface may comprise a keyboard, keypad, mouse, touch screen, microphone, speech recognition package, camera, imaging system, or any combination thereof. The outputs may include a display (e.g., screen), speaker, or printer. The controller may be any controller (e.g., a controller used in 3D printing) such as, for example, the controller disclosed in Provisional Patent Application Ser. No. 62/252,330, filed on Nov. 6, 2015, titled “APPARATUSES, SYSTEMS AND METHODS FOR THREE-DIMENSIONAL PRINTING,” or in Provisional Patent Application Ser. No. 62/325,402, filed on Apr. 20, 2016, titled “METHODS, SYSTEMS, APPARATUSES, AND SOFTWARE FOR ACCURATE THREE-DIMENSIONAL PRINTING,” each of which is entirely incorporated herein by reference.

The systems, methods, software, and/or apparatuses disclosed herein may comprise receiving a request for generating a 3D object (e.g., from a customer). The request can include (or be based on) a model (e.g., computer-aided design (CAD)) of the desired 3D object. Alternatively or additionally, a model of the desired 3D object may be generated. The model may be used to generate 3D printing instructions of the desired 3D object. The 3D printing instructions may exclude the 3D model. The 3D printing instructions may deviate from the 3D model. The 3D printing instructions may be based on simulations. The 3D printing instructions may use the 3D model. The 3D printing instructions may comprise using an algorithm (e.g., embedded in a software) that takes into account the 3D model. The algorithm may take into account a deviation from the 3D model. The 3D printing instructions may be used to print the desired 3D object. The printed 3D object may (e.g., substantially) correspond to the desired (e.g., requested) 3D object. The 3D printing instructions may comprise a module. For example, the 3D printing instructions may comprise a multiplicity of modules. The module may comprise open loop control. The module may comprise closed loop control. The module may comprise projected deformation of the 3D object (e.g., during the 3D printing printing or after the 3D printing). The plurality of modules may comprise various error correction operations. The error may comprise a deformation (e.g., warping). For example, the modules may comprise a rough, medium or fine error correction operations. The error may comprise a deformation. The multiplicity of modules may comprise a plurality of rought correction operations, plurality of medium, or plurality of fine correction operations. The algorithm used to form the 3D printing instructions may include closed loop control (e.g., a feedback control loop). In some embodiments, the algorithm used to form the 3D printing instructions excludes a closed loop control (e.g., feedback control loop). The closed loop control may comprise feedback or feed forward control loop. The 3D printing instructions may include taking into account metrology measurements of the generated 3D object (e.g., measurements of the 3D object) or parts thereof. The 3D printing instructions may exclude taking into account metrology measurements of the generated 3D object (e.g., measurements of the 3D object) or parts thereof.

In some embodiments, the 3D printing instructions may comprise an open loop control. The algorithm may use historical (e.g., empirical) data. The empirical data may be of at least one characteristic structure (e.g., that is included in the desired 3D object). The characteristic structure may be substantially similar at least a portion of the 3D object. The empirical data may be previously obtained. In some embodiments, the algorithm may use and/or comprise a theoretical model. The algorithm may use a model of energy flow (e.g., heat flow). The generation of the 3D object using an altered model may exclude an iterative process. The generation of the 3D object may not involve an alteration of the 3D model (e.g., CAD), but rather generate a new set of 3D printing instructions. At times, the generation of the 3D object may involve an alteration of the 3D model (e.g., CAD). In some embodiments, the algorithm is used to alter instructions received by at least one of the components involved in the 3D printing process (e.g., energy beam). In some embodiments, the algorithm does not alter (e.g., distort) the 3D model. Sometimes, the generation of the 3D object may comprise generating a new set of 3D printing instructions. The algorithm may comprise a generic approach to printing a desired 3D object or portions thereof. In some embodiments, the algorithm is not based on (i) altering 3D printing instructions that are based on the desired 3D object, (ii) measuring errors in the printed 3D object, and/or (iii) revising the printing instructions. In some embodiments, the algorithm is not based on an iterative process that takes into account the desired and/or printed 3D object (e.g., in real-time). The algorithm may be based on an estimation of one or more errors (e.g., anticipated errors) during the printing of the desired 3D object. The algorithm may (e.g., substantially) correct the estimated errors though the generation of respective 3D printing instructions that take into account the anticipated errors. In this manner, the algorithm may (e.g., substantially) circumvent the generation of otherwise anticipated errors. The algorithm may recommend inserting (e.g., or insert) corrective deformations in the 3D printing instruction, such that the generated 3D object (or a portion thereof) will have a reduced degree of errors (e.g., be (e.g., substantially) free of errors). The algorithm may be based on an estimation of one or more errors during the printing of the desired 3D object, and correcting those errors though the generation of respective 3D printing instructions that take into account the anticipated errors and thus circumvent their generation. The error may comprise a deviation from the model of the desired 3D object. The estimation may be based on simulation, modeling, and/or historical data (e.g., of representative structures or structure segments).

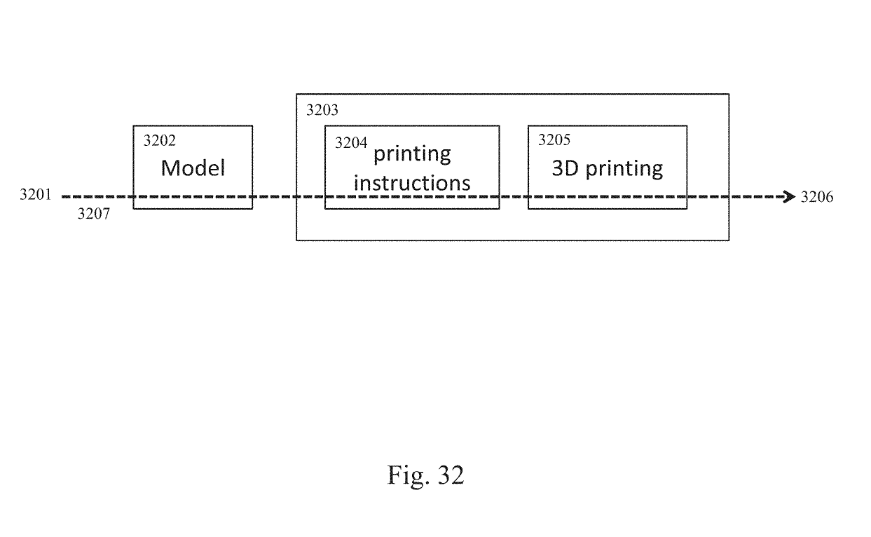

FIG. 32 shows an example of a flow chart representing 3D printing process operations that are executed by a 3D printing method, system, software, and/or apparatus described herein. The desired 3D object is requested in operation 3201. A 3D model is provided or generated in operation 3202. Operation 3204 illustrates the generation of printing instructions for the 3D object, in which both the model and the algorithm are utilized. The 3D object is subsequently generated using the printing instructions in operation 3205. The desired 3D object is delivered in operation 3206. Arrow 3207 designates the direction of the operations from operation 3201 to operation 3206. The absence of back feeding arrow represents the lack of closed loop control (e.g., feedback and/or feed forward loop control).

The controller can direct the energy beam to at least a portion of the layer of pre-transformed material according to at least one path, wherein an energy of the energy beam can comprise energy variation depending on the position of the corresponding path within the 3D object. The energy variation can include any energy variation or energy beam variation mentioned herein. The 3D object can comprise a lesser degree of deformation as compared to a 3D object generated by a 3D printing method (e.g., additive manufacturing) without the energy variation.

The controller may direct the energy beam to at least a portion of the layer of pre-transformed material according to at least one path. The path may comprise instructions that derive from a 3D model of a desired 3D object. The instructions for generating at least a portion of the 3D object comprise may be generated on the basis of a 3D model of a desired 3D object that has been altered. For example, the instructions for generating at least a portion of the 3D object comprise may be generated on the basis of a 3D model of a desired 3D object that has been tilted from its natural position. The tilted 3D model, or tilted 3D object may be tilted from its natural position by any of the tilt angles alpha mentioned herein. The tilt may minimize at least one area of a hanging structure (e.g., 3D plane section) as part of the 3D object. The tilt may comprise a tile of all the areas of hanging structures as part of the 3D object. The instructions may be given to the energy (e.g., energy beam) to transform the pre-transformed material within the material bed according to at least one path. The instructions may correspond to the desired 3D object that has been tilted from its natural position. The systems disclosed herein comprise printing the desired 3D object as a tilted 3D object with respect to its natural position. The system disclosed herein may facilitate any of the printing methods disclosed herein for printing a 3D object that is tilted from its natural position.

In some systems disclosed herein, the controller may direct the energy beam to at least a portion of the layer of pre-transformed material according to at least one path, wherein the path follows a direction of the hardened material that is susceptible to deformation. The deformation may be any deformation disclosed herein such as a deformation comprising bending. The deformation may comprise defects and/or irregularities. The defects and/or irregularities may comprise surface defects and/or irregularities respectively. The hardened material formed by the systems described herein may have a lower degree of deformation as compared to a hardened material printed by a 3D printing (e.g., additive manufacturing method) where the path does not follow a direction that is susceptible to deformation. In some instances, the system may comprise a first and second energy. The first energy may transform the pre-transformed material (designated as “transforming energy”). The second energy may heat the pre-transformed material (designated as “heating energy”) and not transform it. In some instances, the path that follows the direction susceptible to deformation may be the path of the transforming energy. In some instances, the path that follows the direction susceptible to deformation may be the path of the heating energy. In some instances, the path that follows the direction susceptible to deformation may be both the path of the transforming energy and the path of the heating energy. For example, a direction susceptible to deformation may be the long axis of a rectangle. In some systems disclosed herein, the controller may direct the energy to follow a path in a direction perpendicular to the direction susceptible to deformation. The controller may direct the energy to follow a path at an angle to the direction susceptible to deformation, wherein the acute angle is between 0° and 90° (e.g., excluding 0° and 90°). The direction of the path may depend on the nature of the deformation and the type of material, which is included within the 3D object.

The methods, systems and/or the apparatus described herein may further comprise a control system. The control system can be in communication with one or more energy sources and/or energy (e.g., energy beams). The energy sources may be of the same type or of different types. For example, the energy sources can be both lasers, or a laser and an electron beam. For example, the control system may be in communication with the first energy and/or with the second energy. The control system may regulate the one or more energies (e.g., energy beams). The control system may regulate the energy supplied by the one or more energy sources. For example, the control system may regulate the energy supplied by a first energy beam and by a second energy beam, to the pre-transformed material within the material bed. The control system may regulate the position of the one or more energy beams. For example, the control system may regulate the position of the first energy beam and/or the position of the second energy beam.

In another aspect, a system for generating a 3D object comprises: an enclosure for accommodating a layer of material (e.g., powder) within a material bed; an energy (e.g., energy beam) capable of transforming the material to form a transformed material, wherein the transformed material is capable of hardening to form a hardened material that is at least a portion of a generated 3D object; and a controller that directs the energy to a portion of the layer of pre-transformed material according to at least one instruction, wherein the at least one instruction depends on the density of the pre-transformed material. The at least one instruction may depend on the density of the material within the layer of material. The at least one instruction may depend on the density of the material that is situated beneath the layer of material (e.g., the remainder of material with the material bed that was not transformed into at least a portion of the 3D object, herein the “remainder”). The at least one instruction may depend on the density of the material (e.g., the remainder) that is situated directly beneath the layer of pre-transformed material. The at least one instruction may depend on the density of the pre-transformed material (e.g., the remainder) within the material bed. The density of the pre-transformed (e.g., powder) material may be from 40% material to 80% material. The percent may be weight-per-weight or volume-per-volume. The at least one instruction may comprise instructions relating to the characteristics of the energy or energy beam, or variation of that characteristics. The at least one instruction may comprise instructions relating to the characteristics of the path traveled by the energy (e.g., beam) or variation thereof. The at least one instruction may comprise instructions relating to the path traveled by the energy (e.g., beam) or variation thereof. The at least one instruction may comprise instructions relating to the energy (e.g., beam) or variation thereof. The at least one instruction may comprise instructions relating to a selected position in the transformed material, hardened material, or 3D object. In some examples, the controller may direct one or more energy beams to transform a portion of the a first layer of pre-transformed material to form a first transformed material, wherein the first transformed material may harden into a first hardened material; transform a portion of the a second layer of pre-transformed material to form a second transformed material, wherein the second transformed material may harden into a second hardened material; and transform a portion of the a third layer of material to form a third transformed material, wherein the third transformed material may harden into a third hardened material that traverses at least a portion of the first hardened material and at least a portion of the second hardened material. The one or more energy beams may comprise a first, a second, and a third energy beams. The first, second and third energy beams may be different by at least one energy characteristics (e.g., as disclosed herein). At least two of the first, second and third energy may be (e.g., substantially) identical. At least two of the first, second, and third energy may be different by at least one energy characteristics. At least two of the first, second, and third energy may originate from the same energy source. At least two of the first, second, and third energy may originate from a different energy source.

The controller may direct an energy (e.g., energy beam) to follow at least a first path, a second path and a third path. The controller may direct the energy to follow the first path and thereby transform a pre-transformed material of a first layer to form a first transformed material (e.g., that is later on hardened to a first hardened material). The controller may direct the energy beam to follow the second path and thereby transform the pre-transformed material of the second layer to form a second transformed material (e.g., that is later on hardened to a second hardened material). The second layer may immediately follow the first layer. The second layer may be any layer that follows the first layer. The second hardened material may be substantially parallel to the first hardened material. The controller may direct the energy to follow the third path and thereby transform the material of a third layer to form a third transformed material that is later on hardened to a third hardened material. The third layer may immediately follow the second layer. The third layer may be any layer that follows the second layer. In some instances, the controller may direct the energy to follow the third path and thereby transform the material within any of the accumulated layers ending with the third layer (i.e., including the third layer). For example, the controller may direct the energy to transform the pre-transformed material within the layer comprising the first layer, the second layer or the third layer. The first layer may be the bottom skin layer. The third transformed material may later on harden to a third hardened material. The third hardened material may be parallel to the second hardened material. The third hardened material may not be parallel to the second hardened material. The third hardened material may cover at least a portion of a surface of the 3D object. The surface may be a top surface. The top may be relative to the bottom of the enclosure above which the 3D object is generated. The thickness of the third hardened material may any thickness disclosed herein. The third hardened material may be the hardened cover as disclosed herein.

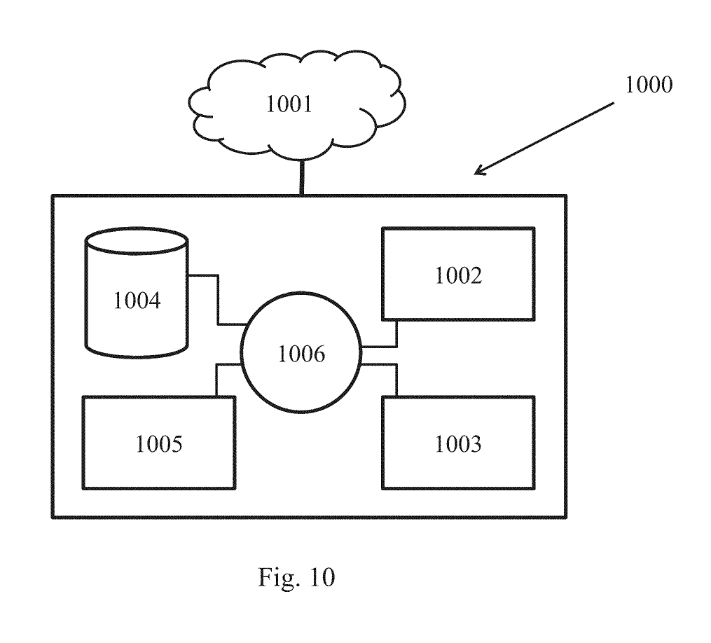

The systems and/or the apparatuses described herein may comprise a processor (e.g., a computer). The present disclosure provides computer control systems that are programmed to implement methods of the disclosure. FIG. 10 depicts a computer system 1000 that is programmed or otherwise configured to facilitate the creation of a 3D object. The computer system 1000 can regulate various features of the printing methods, apparatuses and systems of the present disclosure such as, for example, regulating heating, cooling and/or maintaining the temperature of the material within the enclosure, process parameters (e.g., enclosure pressure), the scanning route of the energy source, the application of the amount of energy emitted (e.g., to a selected location of a material by the energy source), or any combination thereof. The computer system 1000 can be part of and/or be in communication with a 3D printing system and/or apparatus (e.g., as disclosed herein). The computer may be coupled to one or more sensors connected to various parts of the printing system such as any of the sensors mentioned herein. The processor may be any processor (e.g., a processor used in 3D printing) such as, for example, the processor disclosed in any of the Provisional Patent applications having Ser. Nos. 62/252,330 and 62/325,402, each of which is entirely incorporated herein by reference.

The computer system (e.g., FIG. 10, 1000) may include a processor (e.g., a central processing unit (CPU)) 1006. The processor can be a single core or multi core processor. The processor can be a plurality of processors for parallel processing. The computer may comprise a multiple processor architecture. The computer may comprise a parallel processor architecture. The computer may comprise field programmable gate arrays (FGPA). The computer system may include memory or memory location 1005 (e.g., randomaccess memory, read-only memory, or flash memory), electronic storage unit 1004 (e.g., hard disk), communication interface 1002 (e.g., network adapter) for communicating with one or more other systems, peripheral devices 1003 such as cache, other memory, data storage, and/or electronic display adapters. The memory 1005, storage unit 1004, interface 1002, and/or peripheral devices 1003 may be in communication with the CPU 1006 through a communication bus (solid lines in FIG. 10) such as a motherboard. The storage unit 1004 can be a data storage unit (or data repository) for storing data. The computer system 1000 can be operatively coupled to a computer network (“network”) 1001 with the aid of the communication interface 1002. The network 1001 can be the Internet, an Internet and/or extranet, an intranet and/or extranet that is in communication with the Internet, or any combination thereof. The network in some cases is a telecommunication, data network, or any combination thereof. The network can include one or more computer servers, which can enable distributed computing such as cloud computing. The network, in some cases with the aid of the computer system 1000, can implement a peer-to-peer network, which may enable devices coupled to the computer system to behave as a client or a server.

The processing unit may include one or more cores. The computer system may comprise a single core processor, multi core processor, or a plurality of processors for parallel processing. The processing unit may comprise one or more central processing unit (CPU) and/or a graphic processing unit (GPU). The multiple cores may be disposed in a physical unit (e.g., Central Processing Unit, or Graphic Processing Unit). The processing unit may include one or more processing units. The physical unit may be a single physical unit. The physical unit may be a die. The physical unit may comprise cache coherency circuitry. The multiple cores may be disposed in close proximity. The physical unit may comprise an integrated circuit chip. The integrated circuit chip may comprise one or more transistors. The integrated circuit chip may comprise at least 0.2 billion transistors (BT), 0.5 BT, 1BT, 2 BT, 3 BT, 5 BT, 6 BT, 7 BT, 8 BT, 9 BT, 10 BT, 15 BT, 20 BT, 25 BT, 30 BT, 40 BT, or 50 BT. The integrated circuit chip may comprise any number of transistors between the afore-mentioned numbers (e.g., from about 0.2 BT to about 100 BT, from about 1 BT to about 8 BT, from about 8 BT to about 40 BT, or from about 40 BT to about 100 BT). The integrated circuit chip may have an area of at most 50 mm², 60 mm², 70 mm², 80 mm², 90 mm², 100 mm², 200 mm², 300 mm², 400 mm², 500 mm², 600 mm², 700 mm², or 800 mm². The integrated circuit chip may have an area of any value between the afore-mentioned values (e.g., from about 50 mm² to about 800 mm², from about 50 mm² to about 500 mm², or from about 500 mm² to about 800 mm²). The close proximity may allow substantial preservation of communication signals that travel between the cores. The close proximity may diminish communication signal degradation. A core as understood herein is a computing component having independent central processing capabilities. The computing system may comprise a multiplicity of cores, which are disposed on a single computing component. The multiplicity of cores may include two or more independent central processing units. The independent central processing units may constitute a unit that read and execute program instructions. The multiplicity of cores can be parallel cores. The multiplicity of cores can function in parallel. The multiplicity of cores may include at least 2, 10, 40, 100, 400, 1000, 2000, 3000, 4000, 5000, 6000, 7000, 8000, 9000, or 10000 cores. The multiplicity of cores may include cores of any number between the afore-mentioned numbers (e.g., from 2 to 40000, from 2 to 400, from 400 to 4000, from 2000 to 4000, or from 4000 to 10000 cores). The cores may communicate with each other via on chip communication networks; and/or control, data and communication channels. The processor may comprise low latency in data transfer (e.g., from one core to another). Latency may refer to the time delay between the cause and the effect of a physical change in the processor (e.g., a signal). Latency may refer to the time elapsed from the source (e.g., first core) sending a packet to the destination (e.g., second core) receiving it (also referred as two point latency). One point latency may refer to the time elapsed from the source (e.g., first core) sending a packet (e.g., signal) to the destination (e.g., second core) receiving it, and the designation sending a packet back to the source (e.g., the packet making a round trip). The latency may be sufficiently low to allow a high number of floating point operations per second (FLOPS). The number of FLOPS may be at least about 1 Tera Flops (T-FLOPS), 2 T-FLOPS, 3 T-FLOPS, 5 T-FLOPS, 6 T-FLOPS, 7 T-FLOPS, 8 T-FLOPS, 9 T-FLOPS, or 10 T-FLOPS. The number of flops may be at most about 5 T-FLOPS, 6 T-FLOPS, 7 T-FLOPS, 8 T-FLOPS, 9 T-FLOPS, 10 T-FLOPS, 20 T-FLOPS, or 30 T-FLOPS. The number of FLOPS may be any value between the afore-mentioned values (e.g., from about 1 T-FLOP to about 30 T-FLOP, from about 4 T-FLOPS to about 10 T-FLOPS, from about 1 T-FLOPS to about 10 T-FLOPS, or from about 10 T-FLOPS to about 30 T-FLOPS. The FLOPS can be measured according to a benchmark. The benchmark may be a HPC Challenge Benchmark. The benchmark may comprise mathematical operations (e.g., equation calculation such as linear equations), graphical operations (e.g., rendering), or encryption/decryption benchmark. The benchmark may comprise a High Performance UNPACK, matrix multiplication (e.g., DGEMM), sustained memory bandwidth to/from memory (e.g., STREAM), array transposing rate measurement (e.g., PTRANS), RandomAccess, rate of Fast Fourier Transform (e.g., on a large one-dimensional vector using the generalized Cooley-Tukey algorithm), or Communication Bandwidth and Latency (e.g., MPI-centric performance measurements based on the effective bandwidth/latency benchmark). UNPACK refers to a software library for performing numerical linear algebra on a digital computer. DGEMM refers to double precision general matrix multiplication. STREAM convention may sum the amount of data that an application code explicitly reads and the amount of data that the application code explicitly writes. PTRANS may measure the rate at which the system can transpose a large array (e.g., matrix). MPI refers to Message Passing Interface.

The processor 1006 can execute a sequence of machine-readable instructions, which can be embodied in a program or software. The instructions may be stored in a memory location, such as the memory 1005. The instructions can be directed to the processor, which can subsequently program or otherwise configure the processor to implement methods of the present disclosure. Examples of operations performed by the processor can include fetch, decode, execute, and write back.

The processor can be part of a circuit, such as an integrated circuit. One or more other components of the system 1000 can be included in the circuit. In some cases, the circuit is an application specific integrated circuit (ASIC), digital signal processor (DSP), a group of processing components, or any combination thereof.

The storage unit 1004 can store files, such as drivers, libraries and saved programs. The storage unit can store user data, e.g., user preferences and user programs. The computer system, in some cases, can include one or more additional data storage units that are external to the computer system, such as located on a remote server that is in communication with the computer system through an intranet or the Internet. The communication can be electrical, physical, proximal, remote, or any combination thereof.

The computer system can communicate with one or more remote communication devices through the network 1001. The remote communication devices may comprise a remote computer system. For instance, the computer system can communicate with a remote computer system of a user (e.g., operator). Examples of remote computer systems include personal computers (e.g., portable PC), slate or tablet PC's (e.g., Apple® iPad, Samsung® Galaxy Tab), telephones, Smart phones (e.g., Apple® iPhone, Android-enabled device, Blackberry®), or personal digital assistants. The user can access the computer system via the network. The remote communication device may comprise cellular phone, smart phone, or tablet. The remote communication device may comprise Bluetooth® technology.

Methods as described herein can be implemented by way of machine (e.g., computer processor) executable code stored on an electronic storage location of the computer system, such as, for example, on the memory 1005 or electronic storage unit 1004. The machine executable or machine-readable code can be provided in the form of software. During use, the processor 1006 can execute the code. In some cases, the code can be retrieved from the storage unit and stored on the memory for ready access by the processor 1006. In some situations, the electronic storage unit can be precluded, and machine-executable instructions are stored on memory 1005.

The code can be pre-compiled and configured for use with a machine have a processer adapted to execute the code, or can be compiled during runtime. The code can be supplied in a programming language that can be selected to enable the code to execute in a pre-compiled or as-compiled fashion.

Aspects of the systems, apparatus and/or methods provided herein, such as the computer system, can be embodied in programming (e.g., software). Various aspects of the technology may be thought of as “products” or “articles of manufacture” typically in the form of machine (or processor) executable code and/or associated data that is carried on or embodied in a type of machine-readable medium. Machine-executable code can be stored on an electronic storage unit, such memory (e.g., read-only memory, randomaccess memory, flash memory) or a hard disk. “Storage” type media can include any or all of the tangible memory of the computers, processors or the like, or associated modules thereof, such as various semiconductor memories, tape drives, disk drives and the like, which may provide non-transitory storage at any time for the software programming. All or portions of the software may at times be communicated through the Internet or various other telecommunication networks. Such communications, for example, may enable loading of the software from one computer or processor into another, for example, from a management server or host computer into the computer platform of an application server. Thus, another type of media that may bear the software elements includes optical, electrical and electromagnetic waves, such as used across physical interfaces between local devices, through wired and optical landline networks, and/or over various air-links. The physical elements that carry such waves, such as wired or wireless links, optical links or the like, also may be considered as media bearing the software. As used herein, unless restricted to non-transitory, tangible “storage” media, terms such as computer or machine “readable medium” refer to any medium that participates in providing instructions to a processor for execution.

Hence, a machine-readable medium, such as computer-executable code, may take many forms, including but not limited to, a tangible storage medium, a carrier wave medium or physical transmission medium. Non-volatile storage media include, for example, optical or magnetic disks, such as any of the storage devices in any computer(s) or the like, such as may be used to implement the databases, etc. shown in the drawings. Volatile storage media include dynamic memory, such as main memory of such a computer platform. Tangible transmission media include coaxial cables; wire (e.g., copper wire) and fiber optics, including the wires that comprise a bus within a computer system. Carrier-wave transmission media may take the form of electric or electromagnetic signals, or acoustic or light waves such as those generated during radio frequency (RF) and infrared (IR) data communications. Common forms of computer-readable media therefore include for example: a floppy disk, a flexible disk, hard disk, magnetic tape, any other magnetic medium, a CD-ROM, DVD or DVD-ROM, any other optical medium, punch cards paper tape, any other physical storage medium with patterns of holes, a RAM, a ROM, a PROM and EPROM, a FLASH-EPROM, any other memory chip or cartridge, a carrier wave transporting data or instructions, cables or links transporting such a carrier wave, or any other medium from which a computer may read programming code and/or data. Many of these forms of computer readable media may be involved in carrying one or more sequences of one or more instructions to a processor for execution.

The computer system can include or be in communication with an electronic display that comprises a user interface (UI) for providing, for example, a model design or graphical representation of an object to be printed (object to be formed). Examples of UI's include, without limitation, a graphical user interface (GUI) and web-based user interface. The computer system can monitor and/or control various aspects of the printing system. The control may be manual or programmed. The control may rely on feedback mechanisms that have been pre-programmed. The feedback mechanisms may rely on input from sensors (described herein) that are connected to the control unit (i.e., control system or control mechanism e.g., computer). The computer system may store historical data concerning various aspects of the operation of the printing system. The historical data may be retrieved at predetermined times or at a whim. The historical data may be accessed by an operator or by a user. The historical and/or operative data may be displayed on a display unit. The display unit (e.g., monitor) may display various parameters of the printing system (as described herein) in real time or in a delayed time. The display unit may display the currently printed 3D object (e.g., in real time), the ordered printed 3D object, the actually printed 3D object or any combination thereof. The display unit may display the printing progress of the printed 3D object, or various aspects thereof. The display unit may display at least one of the total time, time remaining and time expanded on printing the generated 3D object. The display unit may display the status of sensors, their reading and/or time for their calibration or maintenance. The display unit may display the type or types of material used and various characteristics of the material or materials such as temperature and flowability of the material (e.g., powder material). The display unit may display the amount of gas in the chamber. The gas may comprise oxygen, hydrogen, water vapor, or any of the afore-mentioned gasses. The display unit may display the pressure in the printing chamber (i.e., the chamber where the object is being formed). The computer may generate a report comprising various parameters of the printing system and/or printing process. The report may be generated at predetermined time(s), on a request (e.g., from an operator) or at a whim.

Methods and systems of the present disclosure can be used to form the object for various uses and applications. Such uses and applications include, without limitation, electronics, components of electronics (e.g., casings), machines, parts of machines and tools, implants, prosthetics, fashion items, clothing, shoes, jewelry. The implants may be to a hard or soft tissue. The implants may form adhesion with hard or soft tissue. The machines may include motor or motor parts. The machines may include a vehicle. The machines may comprise aerospace related machines. The machines may comprise airborne machines. The machines may include airplanes, drones, cars, trains, bicycles, boats, or satellites.

The processor can be in network communication with a remote computer system that supplies instructions to the computer system to generate the 3D object. The processor can be in network communication with the remote computer through a wired or through a wireless connection. The remote computer can be a laptop, desktop, smartphone, tablet, or other computer device. The remote computer can comprise a user interface through which a user can input design instructions and parameters for the generated 3D object. The instructions can be a set of values or parameters that describe the shape and dimensions of the 3D object. The instructions can be provided through a file having a Standard Tessellation Language file format. In an example, the instructions can come from a 3D modeling program (e.g., AutoCAD, SolidWorks, Google SketchUp, or SolidEdge). In some cases, the model of the 3D object can be generated from a provided sketch, image, or 3D object. The model can comprise vector-based graphics. The model can comprise computer-aided design, electronic design automation, mechanical design automation, or computer aided drafting. The remote computer system can supply design instruction to the processor. The processor can direct the at least one energy source in response to the instructions received from the remote computer. The processor can be further programmed to optimize a trajectory of path of the energy applied from the at least one energy source to a portion of the material to be transformed or to a remainder of the material that should not be transformed, respectively. Optimizing the trajectory of energy application can comprise minimizing time needed to heat the material, minimizing time needed to cool the material, minimizing the time needed to scan the area that needs to receive energy or minimizing the energy emitted by the at least one energy source.

In some cases, the computer processor can be programmed to calculate the power per unit area emitted by the energy source that should be provided to the material in order to achieve the desired result. The processor can be programmed to determine the time that an energy source should be incident on or projected to an area of a determined size in order to provide the necessary power density. In some instances, the computer controls and/or regulates the rate at which the energy beam travels on/within the material bed. In some cases, the desired result can be to provide uniform energy per unit area within the material in the container. The desired result can be to transform a portion of the material to be transformed with an energy source at a certain power per unit area. The desired result can be to not transform the remainder of the material that should not be transformed (e.g., only to heat the remainder) with an energy beam at a certain power per unit area. The desired result can be to heat a portion of the material to be heated with a first energy source at the first power per unit area and to transform a portion of the material to be transformed with a second, or with the first energy source at the second power per unit area. The computer processor can be programmed to optimize the application of energy from the various energy sources. Optimizing the energy application can comprise minimizing time needed to heat the powder, minimizing time needed to cool the powder, or minimizing the energy emitted by the energy source(s). In some instances, the computer controls and/or regulates the amount of time the energy beam transmits energy to a material area within the material bed or point within the material bed.

The computer system can include, or be in communication with, an electronic display unit that comprises a user interface (UI) for providing, for example, a model design or graphical representation of an object to be printed. Examples of UI's include a graphical user interface (GUI) and web-based user interface. The historical and/or operative data may be displayed on a display unit. The computer system may store historical data concerning various aspects of the operation of the cleaning system. The historical data may be retrieved at predetermined times and/or at a whim. The historical data may be accessed by an operator and/or by a user. The display unit (e.g., monitor) may display various parameters of the printing system (as described herein) in real time or in a delayed time. The display unit may display the desired printed 3D object (e.g., according to a model), the printed 3D object, real time display of the 3D object as it is being printed, or any combination thereof. The display unit may display the cleaning progress of the object, or various aspects thereof. The display unit may display at least one of the total time, time remaining, and time expanded on the cleaned object during the cleaning process. The display unit may display the status of sensors, their reading, and/or time for their calibration or maintenance. The display unit may display the type or types of material used and various characteristics of the material or materials such as temperature and flowability of the pre-transformed material. The display unit may display the amount of a certain gas in the chamber. The gas may comprise oxygen, hydrogen, water vapor, or any of the gasses mentioned herein. The display unit may display the pressure in the chamber. The computer may generate a report comprising various parameters of the methods, objects, apparatuses, or systems described herein. The report may be generated at predetermined time(s), on a request (e.g., from an operator) or at a whim.

Methods, apparatuses, and/or systems of the present disclosure can be implemented by way of one or more algorithms. An algorithm can be implemented by way of software upon execution by one or more computer processors. In some cases, the processor can be programmed to calculate the path of the energy beam and/or the power per unit area emitted by the energy source (e.g., that should be provided to the material bed in order to achieve the desired result). The processor can be programmed to determine the time that an energy beam should be incident on or projected to an area of a determined size in order to provide the necessary power density (e.g., to transform a pre-transformed material). The computer controls and/or may regulate the rate at which the energy is projected onto the material. The desired result may be to provide uniform energy per unit area to the entire generated hardened material within a layer of material (e.g., before its transformation, or powder material). The computer processor can be programmed to optimize the application of energy from one or more energy sources. Optimizing the energy application can comprise minimizing time needed to heat the material bed, minimizing time needed to cool the material bed, or minimizing the energy emitted by the energy source(s). In some instances, the computer controls and/or regulates the amount of time the energy beam transmits energy to an area or to a point of at least a portion of the material bed.

### EXAMPLES

The following is a non-limiting example of a method applied according the present disclosure. It will be obvious to those skilled in the art that this example is provided by way of illustration only. It is not intended that the invention be limited by the specific examples provided herein.

### Example 1

In a 25 cm by 25 cm by 30 cm container at ambient temperature and pressure, 1.56 kg Stainless Steel 316L powder of average particle size 35 μm is placed. The container is situated in an enclosure. The enclosure is purged with Argon gas for 5 min. The top surface of the powder is leveled. A 200 W, 1060 nm laser beam is directed to a point in on the surface of the powder for 110 milliseconds. The laser beam traveled across the powder in a predetermined line path according to predetermined instructions. The instructions include laser paths layer by layer, when the object is tilted by three degrees, then sliced and each slice is converted to a series of laser paths. A vertical cross section of the printed 3D object is illustrated in FIGS. 8A and 8B.

While preferred embodiments of the present invention have been shown and described herein, it will be obvious to those skilled in the art that such embodiments are provided by way of example only. It is not intended that the invention be limited by the specific examples provided within the specification. While the invention has been described with reference to the aforementioned specification, the descriptions and illustrations of the embodiments herein are not meant to be construed in a limiting sense. Numerous variations, changes, and substitutions will now occur to those skilled in the art without departing from the invention. Furthermore, it shall be understood that all aspects of the invention are not limited to the specific depictions, configurations, or relative proportions set forth herein which depend upon a variety of conditions and variables. It should be understood that various alternatives to the embodiments of the invention described herein might be employed in practicing the invention. It is therefore contemplated that the invention shall also cover any such alternatives, modifications, variations, or equivalents. It is intended that the following claims define the scope of the invention and that methods and structures within the scope of these claims and their equivalents be covered thereby.

What is claimed is:

1. An apparatus for printing a three-dimensional object, comprising one or more controllers that are programmed to direct:
(a) revising a morphology of a first model slice to form a second model slice, which first model slice is of a model three-dimensional object, which revising is to correct for a projected deformation during or after printing of the three-dimensional object in a three-dimensional printing process in accordance with the model three-dimensional object;
(b) generating at least one printing instruction in accordance with the second model slice, wherein the at least one printing instruction is for the printing of the three-dimensional object using the three-dimensional printing process; and
(c) performing the three-dimensional printing process to transform at least a portion of a material bed to a transformed material according to the at least one printing instruction to generate the three-dimensional object, which three-dimensional object is substantially identical to the model three-dimensional object, wherein the first model slice is different from a slice corresponding to a bottom skin layer.

2. The apparatus of claim 1, wherein the morphology comprises (i) a length of a circumference of the first model slice, (ii) a shape of a circumference of the first model slice, (iii) a volume of the first model slice, or (iv) a surface of the first model slice.

3. The apparatus of claim 1, wherein the projected deformation is a projected bending deformation.

4. The apparatus of claim 3, wherein the projected bending deformation comprises warping, arching, curving, or twisting.

5. The apparatus of claim 1, wherein revising the morphology uses data comprising (i) anticipated stress in the three-dimensional object, (ii) anticipated deformation of the three-dimensional object, or (iii) temperature depletion during the three-dimensional printing process.

6. The apparatus of claim 1, wherein during the three-dimensional printing process, the transformed material hardens into a hardened material as part of the three-dimensional object.

7. The apparatus of claim 6, wherein revising the morphology takes into account a manner in which the transformed material hardens as a function of a density of a particulate material within the material bed.

8. The apparatus of claim 1, wherein the three-dimensional object is suspended anchorlessly in the material bed during the three-dimensional printing process.

9. The apparatus of claim 1, wherein the three-dimensional object deviates from the model three-dimensional object by a deviation of at most about a sum of one hundred micrometers and a thousandth of a fundamental length scale of the model three-dimensional object.

10. The apparatus of claim 1, wherein the second model slice is stored in a computer memory.

11. An apparatus for printing a three-dimensional object, comprising one or more controllers that are programmed to direct:
(a) revising a morphology of a first model slice to form a second model slice, which first model slice is of a model three-dimensional object;
(b) generating at least one printing instruction in accordance with the second model slice, wherein the at least one printing instruction is for the printing of the three-dimensional object in a three-dimensional printing process in accordance with the model three-dimensional object; and
(c) performing the three-dimensional printing process to transform at least a portion of a material bed in an open loop control to form a transformed material according to the at least one printing instruction to form the three-dimensional object, which three-dimensional object is substantially identical to the model three-dimensional object, wherein the first model slice is different from a slice corresponding to a bottom skin layer.

12. The apparatus of claim 11, wherein the morphology comprises a length of a circumference of the first model slice, a shape of a circumference of the first model slice, a volume of the first model slice, or a surface of the first model slice.

13. The apparatus of claim 11, wherein in (c), the one or more controllers are further programmed to direct performing the three-dimensional printing process according to a closed loop control.

14. The apparatus of claim 13, wherein the closed loop control comprises feedback or feedforward control.

15. The apparatus of claim 11, wherein the open loop control comprises use of empirical data.

16. The apparatus of claim 15, wherein the empirical data is of at least one characteristic structure that is comprised in the model three-dimensional object.

17. The apparatus of claim 11, wherein the open loop control comprises use of a theoretical model.

18. The apparatus of claim 17, wherein the theoretical model comprises heat flow.

19. The apparatus of claim 11, wherein the at least one printing instruction excludes an iterative three-dimensional printing process based on at least a portion of the three-dimensional object that was printed.

20. The apparatus of claim 11, wherein the three-dimensional object is suspended anchorlessly in the material bed during the three-dimensional printing process.

21. The apparatus of claim 11, wherein the three-dimensional object deviates from the model three-dimensional object by a deviation of at most about a sum of one hundred micrometers and one thousandth of a fundamental length scale of the model three-dimensional object.
